(19) United States
(12) Patent Application Publication
(10) Pub. No.: US 2021/0213935 A1
(43) Pub. Date: Jul. 15, 2021

(54) Safety and Stability Control Method against Vehicle Tire Burst

(71) Applicants: Shan LU, Chengdu (CN); Boyan LU, Lynnwood, WA (US)

(72) Inventors: Shan LU, Chengdu (CN); Boyan LU, Lynnwood, WA (US)

(21) Appl. No.: 17/053,701

(22) PCT Filed: May 10, 2019
(86) PCT No.: PCT/CN2019/000100

§ 371 Date: Nov. 6, 2020

(30) Foreign Application Priority Data
May 14, 2018 (CN) PCT/CN2018/000175

(51) Int. Cl. B60W 30/02; B60W 50/00

(52) U.S. Cl. CPC B60W 30/02; B60W 50/0098; B60W 2050/0037; B60W 2530/20; B60W 2540/18; B60W 2050/0002; B60W 2710/202; B60W 2710/207; B60W 2710/182; B60W 2520/26; B60W 2520/14

(57) ABSTRACT

A safety and stability control method against automobile tire blowout, which is used for manned and unmanned driving vehicles and based on vehicle braking, driving, steering and suspension systems. The present method establishes tire blowout determination based on a tire pressure detection mode, a status tire pressure mode and a steering mechanics state mode, and uses a safety and stability control mode, model and algorithm, and control structure and process against automobile tire blowout. On the basis of a tire blowout state point, the vehicle braking, driving, steering, steering wheel steering force and suspension balancing control are carried out in a coordinated manner by entering and exiting a tire blowout control state and switching between a normal mode and a tire blowout control mode, so as to realize tire blowout control in which real or unreal tire blowout processes overlap. In cases where a tire blowout process state and the motion states of the wheel and vehicle with a blown tire are changed rapidly, the technical difficulties of the wheel and the vehicle being seriously unstable due to tire blowout and the extreme tire blowout state being difficult to control are overcome, solving the safety technical problems associated with automobile tire blowout.

### TECHNICAL FIELD

The invention belongs to the safety field in vehicle tire burst.

### BACKGROUND TECHNOLOGY

Vehicle tire burst, which is on expressways specially, is a kind of serious accident with high risk and high probability of occurrence. Tire burst safety of vehicle is a major subject which has not been effectively resolved at home and abroad. Retrieval of relevant technical literature has showed that the current technical solutions for this subject mainly contains the following. First, tire pressure monitoring system (TPMS) as a relatively mature widely is used in a variety of vehicles tire pressure detection technology. Related tests and technologies show that tire pressure monitoring can reduce the probability of tire burst, but the parameters related to tire pressure and tire temperature does not have strict correspondence with tire burst in time and space, therefore, TPMS cannot solve the problem of tire blow-out and tire blow-out safety truly in real time and effectively. Second, a tire blow-out safety, tire pressure displays and adjustable suspension system of vehicle (China patent, patent No. 97107850.5). The invention proposes a scheme of which system mainly composed of a tire pressure sensor, an electronic control device, a brake force balance device and a lift composite suspension, to realize the safety of vehicle tire blow-out through its balanced braking force and lifting control of the tire blow-out wheel suspension. However, the technical solution for system structure and control method are relatively simple, effect of lateral stability control of the vehicle is not satisfactory. Third, tire blow-out safety and stability control system of vehicle (China Patent, patent No. 01128885.x). The invention proposes a scheme of which a system of tire blow-out safety and stability control of vehicle is based on anti-lock braking system (ABS), vehicle stability control system (VSC); the system uses a brake force regulator composed of high-speed switch solenoid valves to distributing the braking force of each wheel, thus to realize safety and stability control of the vehicle tire blow-out. Although the technical solution gives a prototype of tire blow-out safety control system of the vehicle, a higher technology platform is required to solve the major technical problem of tire blow-out safety by making a major breakthrough in technical problems, such as tire blow-out status, tire blow-out judgement, stable deceleration and steady state control of vehicle. Fourth, a method and system of tire blow-out safety control of vehicle (China Patent, No. 200810119655.5)”. The invention proposes a technical scheme about maintaining vehicle original running direction by steering assist motor control; the technical solution has a certain effect in controlling the original direction of vehicle tire blow-out, but it is difficult to achieve the purpose of safe and stable control of the vehicle tire blow-out by controlling simply the original direction of the vehicle in the actual control process. Fifth, the system and method for blow-out tire brake control (China Patent, No. 201310403290). The system and method propose a technical scheme of wheel brake control through the difference signal of brake anti-lock control of blow-out tire wheel and non-tire burst wheels of the vehicle; the braking force involved in the solution does not consider related technical problems such as wheel and vehicle stability control, so that it is difficult to achieve the purpose of safety control of vehicle tire blow-out. With development of modern electronic technology, automatic control technology and vehicle safety technology, it is necessary to introduce a new safe and stable control method for vehicle tire blow-out, to solve this major problem which has long plagued to the vehicle tire blow-out safety. Based on “a tire blow-out safety, tire pressure displays and adjustable suspension system of vehicle, the U.S. Pat. No. 97,107,850.5, the application date: Dec. 30, 1997” and “a safety and stability control system of tire blow-out of vehicle, the patent Ser. No. 01/128,885x, the application date: Sep. 24, 2001”, the patentee and collaborator of the China Invention Patents propose a new technical scheme of safety and stability control method for vehicle tire blow-out, and hopes that the significant technology topic of vehicle tire blow-out safety may be solved by the new design concept and technical scheme.

### CONTENT OF INVENTION

Purpose of the invention is to provide a safety and stability control method for vehicle tire blow-out (hereinafter referred to as the method) Based on vehicle braking, driving, steering and suspension system of vehicle, the method can realize independent and coordinated controls of braking, driving, steering, engine or/and suspension for tire burst vehicle. The object of the invention is realized in this way: this method adopts mode, model and algorithm of tire burst safety and stability control, to realize structured program or software design for tire burst master control and tire burst control. The method sets the information unit, tire burst controller and execution unit, which cover vehicle driven by chemical energy or electric, vehicle of or driverless. Vehicle driver by man vehicles sets tire burst master controller. The driverless vehicle set central controller. The controllers include tire burst information collection and processing, parameter calculation, tire burst mode identification, tire burst judgement, tire burst control entering and exiting, control mode conversion, manual operation control or/and networking controller. Tire burst mode identification and tire burst judgement adopt indirect or direct way. The indirect way include characteristic tire pressure or state tire pressure, and the direct way uses tire pressure sensor; tire burst judgment is realized by tire burst mode identification of state tire pressure and tire pressure detection. The tire burst control is a stable deceleration control of wheels and vehicles, and is a stability control of vehicle direction, vehicle attitude, lane keeping, path tracking, collision avoidance and balance control of vehicle body. The purpose of the invention is realized in follow way. The tire burst determination and tire burst control involved by the method is based on the process of tire burst state. In the state process, an independent and coordinated control is realized by adjustment of whole dynamic process of vehicle and state control of braking, driving, steering, engine output or/and lifting adjustment of suspension. The tire burst control and controller mainly adopt following coordination, self-adaptive and active control modes. The control mode includes the following three active control modes and controllers. First, control modes and controller of tire blow-out for driven by man vehicle. The vehicle uses compatible mode of manual intervention control and active control for tire burst. The tire burst controller is set independently and can share equipment and resources of vehicle, such as the sensor, the electronic control unit which includes structure and function modules and actuator. The method sets tire blow-out judgment, control mode converting and tire blow-out controller. The tire blow-out judgement modes includes of detection tire pressure, state tire pressure and characteristic tire pressure judging types. Conversion of control mode mainly adopts converting of control mode between normal and tire blow-out working conditions, the converting of control mode between active control and manual intervention control in the tire blow-out working condition. The tire burst controller mainly adopts a compatible control mode of active control and manual intervention control for tire burst. Second. The tire blow-out control mode and controller for driverless vehicle with a manual auxiliary operation interface. The controller can realize tire blow-out control by means of the artificial interfaces of driving, braking and steering, and can share the sensors, machine vision, communication, navigation, positioning and artificial intelligence controllers of in-vehicle system of driverless vehicle. The controller sets tire blow-out and non-tire blowout judgment, control mode conversion and tire blow-out control which include tire blow-out collision avoidance, tire blow-out path tracking and tire blow-out posture control of driverless vehicle by environment perception, navigation, positioning, path planning and vehicle control decision including tire blow-out control decision. Tire blow-out judgment mainly adopts three modes of wheel detecting tire pressure, state tire pressure and characteristic tire pressure. The control mode conversion mainly adopts two way: a conversion way between driverless control in normal working condition and driverless control of intervening by manual operation interface, another conversion between driverless control in normal working condition and active control in tire blow-out working condition. The tire blow-out controller mainly adopts two compatible control mode: a compatible control of driverless control of vehicle with manual intervention or without manual operation interface, another compatible control of driverless or driven by man control and active control of tire blow-out vehicle with manual operation interface or without manual operation interface. Third, tire blow-out control and controller of driverless vehicle. The tire blow-out controller can share sensor, machine vision, communication, positioning, navigation and artificial intelligence controller with vehicle mounted system. The controller sets tire blow-out judgement, control mode conversion and tire blow-out controller. Under condition of which vehicle network has been constructed, and as a networking vehicle, an artificial intelligence networking controller is sets up to realize driverless controls which include tire blow-out control, coordination control of tire blow-out and collision avoidance and path tracking of the vehicle, by means of environmental awareness, positioning, navigation, path planning and control decision of vehicle. The tire blow-out judgement mainly adopts three determination modes: detection tire pressure, state tire pressure and characteristic tire pressure of vehicle. The control mode conversion mainly adopts following conversion way: a conversion between control of driverless vehicle in normal working condition and active control of driverless vehicle in tire blow-out working condition. The above control mode conversion is realized by the switching of coordination signals of the tire blow-out control. Based on the above control modes, the stable deceleration of blow-out tire vehicle and the steady state control of the whole vehicle are realized by coordinated adjusting of active anti-skid drive, engine braking, stable braking of brake, electronically control throttle and fuel injection of engine, power assistance steering, or/and electronic controlled or drive-by-wire steering and passive, half-active or active suspension.

(1). The information unit set in this method is mainly composed of sensors set by vehicle control system, tire burst control related sensors or signal acquisition and processing circuit. Based on the tire burst control structure and process, tire burst safety and stability control mode, model and algorithm, the tire burst control program or software is developed. The software adopts non modular or modular structure. In the process of tire burst control, the controller directly or through the data bus obtain the sensor detection signal output by the information unit, or obtain the vehicle Internet and global positioning navigation signal, mobile communication signal processed by the central computer or electronic control unit. The output signal of controller controls engine or electric vehicle power device, to adjust its power output. The output signal controls the brake regulator to adjust the braking force of each wheel and the whole vehicle. The output signal controls the power steering device to realize the control of steering rotational moment for tire burst. The output signal control the steering system by wire to adjusts the directive wheel angle θₑ or and rotation torque of steering wheel exerted by ground. The tire burst control for speed, active steering and path tracking can realized. When the exiting signal of tire burst control comes, the tire burst control of vehicle exit. The output signal controls the corresponding regulator and actuator set in execution unit to realize the control of each regulated object.

(2). The method introduces the concept of tire burst instability states for vehicle after tire burst, it includes two instability: tire burst instability of vehicle and control instability for tire burst vehicle to normal working condition. In the method, a concept of non equivalent and equivalent relative parameters and their deviations are introduced, so as to realize the comparison to equivalence and nonequivalence state parameters of each wheel under normal and tire burst conditions. This method introduces the concept of state tire pressure, a generalized tire pressure concept that is determined by the mathematical model and algorithm of wheel and vehicle structure state parameters and control parameters. Detecting tire pressure does not take as the only technical feature to determine tire burst. In a category including tire pressure, wheel angle velocity, angle acceleration and deceleration speed, slip rate, adhesion coefficient and vehicle yaw rate, the concept of tire burst state, tire burst characteristic parameters and parameter values are defined. The tire burst state process is determined quantitatively, and the tire burst state process and control process are integrated, thus, it make the state and control function become a continuous function in time and space. They are both related and continuous functions in the inter domain. This method defines the concept of tire burst judgment, and uses a fuzzy, conceptualized and stativization tire blow out judgment. As long as the wheel vehicle enters a specific state, it can be determined as a tire burst. It does not need to determine whether the vehicle has a real tire burst, and then enters the tire burst control. In this method, there is no need to set up a tire pressure sensor or reduce its detection conditions. It provides a practical feasibility for indirect measurement of tire pressure and tire burst control based on indirect measurement. The tire burst control to set or do not set tire pressure sensor is determined. This method establishes a mechanism and mode of entering and exiting of tire burst control, so that the vehicle can enter or exit from tire burst control in real time without real tire burst. Without the exiting mechanism of burst control, it is impossible to define tire blow out status, and there is no tire burst control based on the stativization, fuzzy and conceptualized tire burst control. In this method, the tire burst control modes such as active entering, automatic exiting in real-time and manual exiting are set according to the state of the wheel and vehicle. The artificial controller is set up to realize manual exiting to tire burst control, to realize docking of artificial control and active control for tire burst, to realize a certain control of uncertain tire burst, so that, the tire burst and tire burst control with the rapid change of wheel and vehicle state parameters have practical controllability and operability. The method determines the existence of critical point, inflection point and singularity of parameters to tire burst state and tire burst control. Based on these points, using the condition and threshold model, the tire burst control can be divided into different stages or time zones, including state point of pre period to tire burst, real tire burst period, inflection point period and separation of tires and rims. The piecewise continuous or discontinuous function control mode is adopted, to make the tire blow out control adapt to the tire burst and its state. This method adopts the conversion mode and structure of program, protocol or converter, and takes the tire burst signal as the conversion signal to realize the control and control mode conversion between normal and blow out conditions. Based on the driving, braking, engine, steering and suspension systems of driven by man or driverless vehicles, this method adopts the methods, modes, models and algorithms of tire burst master control, subsystem coordination and independent control to realize the coordinated control and composition of braking by engine, braking by braking equipment, engine output, steering wheel rotation force of steering wheel, active steering and body balance. A relatively complete tire burst control structure is designed. The driving, braking, steering, engine and suspension control of vehicle are constituted as an external cycle under normal conditions. The entering of tire burst control, tire burst control process, exiting of tire blow out control exiting, and control of drive, brake, steering, engine and suspension are constituted as the internal cycle under tire burst conditions. At the critical point, inflexion point, singular point and other points of tire burst or the transition period of each control stage, the parameters of wheel structure and motion state change rapidly. By reducing the steady-state control braking force for the tire burst wheel, reducing the balanced braking force of each wheel, increasing the differential braking force of each wheel in the stability control of the whole vehicle, and changing wheel angle acceleration and deceleration speed or and slip ratio that are equivalent to the braking force as control parameters, by changing the control mode of vehicle driving, braking, rotation force of steering wheel and rotation angle of steering wheel, the double instability of wheel and vehicle control under the condition of rapid change of instantaneous state of wheel and vehicle is solved successfully. This method integrates the control of normal and tire burst conditions of wheels and vehicles, allows the overlap of normal and tire burst conditions, and successfully solves control conflict between normal and tire burst conditions. Tire safety and stability control of vehicle are a kind of steady-state deceleration control of wheels and vehicles, a kind of stability control of vehicle direction, vehicle attitude, lane keeping, path tracking, collision avoidance and body balance.

(3). In order to accurately and concisely describe the content of the method, the method adopts necessary technical parameters and mathematical formulas. The technical parameters use two way or mode of expressions: words and letters. The two expressions way of words and letters are equivalent completely. Mathematical model uses two means of expression. First, the pre-letter of model indicates type of the mathematical model, the pre-letter is followed by parenthesis, and the letters in parentheses indicate modeling parameters; the concrete form is: Q (x, y, z). Second, the pre-letter indicates type of function model, and the equal sign is set after the letter; after the equal sign, function form is represented by letter, the letter of function in brackets is followed by a bracket, and the letters in the parenthesis are parameters and variables. The concrete form is: Q=f(x, y, z). In description of content of the method, the technical term of “normal working condition and tire blow-out condition” is used. The normal working condition refers to all running states of vehicle except the tire blow-out (tire burst) of the vehicle, and the tire blow-out condition refers to running states of vehicle in tire burst of wheel. The concept of tire blow-out and non-tire blow-out is defined by the method.

Based on tire burst control structure, mode and process of driven by man and driverless vehicles, the method adopts following steps.

### 1. Tire Burst Master Control and Master Controller

1). Parameter Calculation and Calculator

The parameters that are used in tire burst control of wheel may be determined by field test, parameters of sensor detection, mathematical model and algorithm. According to needs of control process of vehicle, the corresponding parameters and parameter values which include wheel angle acceleration and deceleration, slip rate, adhesion coefficient, vehicle speed, dynamic load, or/and effective rolling radius of the wheel, vertical and horizontal acceleration and deceleration of the vehicle are determined in real time. The observer of mathematics is used to estimate the physical quantities which are difficult to measure. Physical quantities estimation of the sideslip angle to vehicle mass center are determined by the global positioning system (GPS) or the observer based on the extended Kalman filter. The controller set by the method and system mounted by vehicle can share data and parameters detected by sensors and calculation parameters of vehicle, through physical wiring in vehicle or data bus which includes CNA.

2). Tire Burst Pattern Recognition and Tire Burst Judgment of Vehicle

Tire burst control of vehicle adopts a tire burst pattern recognition of characteristic tire pressure and state tire pressure. Based on the pattern recognition, a pattern and model of tire burst judgment are established, to realize tire burst judgment. Definition of vehicle tire burst: whether the tire burst of wheel is real or not, as long as showing of features for “abnormal state” characterized by motion state and structural mechanics parameters of wheel, steering mechanics state parameters of vehicle, vehicle running state and tire burst control parameters which are as a quantitative index are revealed, a qualitative condition and a quantitative model of tire burst judgement is established on the basis of tire burst pattern recognition; based on the condition and model of tire burst judgement, the tire burst of vehicle is determined when the qualitative conditions and quantitative condition are achieved. Defining characteristic and state tire pressures: the pressures are determined by characteristics of abnormal state under normal and tire burst conditions of the wheel and vehicle. According to the definition of tire burst, the characteristics of tire burst state determined this method are consistent with the characteristics of abnormal state under normal and tire burst conditions of the wheel and vehicle, and the characteristics are consistent with the state characteristics generated by the wheel, vehicle steering and the whole vehicle after the real tire burst of vehicle. The so-called consistent of state characteristics to both of them means that the two characteristics are same or equivalent basically. State tire pressure includes several characteristic tire pressures and it is constituted by characteristic tire pressure. The state pressure has combination characteristic of characteristic tire pressure. The characteristic tire pressure and the state tire pressure are dynamic in tire burst control. According to tire burst state process and the tire burst control process, tire burst judgement are divided into two stages. First stage: the determination stage of tire burst state pattern recognition. Based on abnormal state of wheel and vehicle under normal working conditions, the tire burst mode recognition, tire burst determination, entering and or exiting of tire burst control are determined by mechanical state parameters of wheel, steering of vehicle, vehicle motion and tire burst control. Second stage: determination stage of pattern recognition of tire burst control: based on tire burst control, the tire burst pattern recognition and judgement are determined by control parameters in tire burst control state. The continuing of tire burst control or its control exiting are determined by the tire burst judgement in the stage. In this method, the tire burst pattern recognition for state tire pressure or tire pressure detected by sensor is used. Tire burst pattern recognition of state tire pressure is a tire burst pattern recognition determined by feature parameters of motion state of wheel, steering mechanics state of vehicle and vehicle state. State tire pressure pᵣₑ is not a real tire pressure of wheel, it is consistent with the abnormal state characteristics of wheel and vehicle under normal and tire burst conditions, and is consistent with the state characteristics of wheels, steering vehicle and whole vehicle after the real tire burst. The so-called consistent of state characteristics means: they are basically same or equivalent. The states of vehicle is expressed by quantitative parameters or/and qualitative condition, which include states of wheel movement and steering, attitude, lane maintenance and path tracking of vehicle. The tire burst determination of tire pressure detected by sensor or state tire pressure is a process judgement of tire pressure. The determination of tire burst is based on the qualitative condition or quantitative model of tire burst recognition mode. The judgement period Hᵥ for tire burst is set; the tire burst judgement is realized in the logical cycle of its period Hᵥ.

(1). Tire burst pattern recognition of vehicle in the state stage of tire burst. Defining tire burst pattern recognition and its judgment. According to kinematics state and parameters of wheel, steering of vehicle and vehicle, the tire burst pattern recognition is determined by identification of abnormal state of vehicle under tire burst and normal working condition.

i. Tire burst pattern recognition of characteristic tire pressure x_{b} of wheel motion state, the x_{b} is referred to as pattern recognition of characteristic tire pressure. The x_{b} is made by comparison of a same parameter which is determined by non-equivalent relative parameters Dₖ and equivalent relative parameters Dₑ of wheelset of vehicle. The Dₖ and Dₑ are basis of vehicle tire burst pattern recognition determined by wheel motion state. Defining relative parameters D_{b} of two-wheels of wheelset: same parameters is adopted by two-wheel of wheelset. Defining non equivalent relative parameters Dₖ: relative parameters D_{b} which are not processed by equivalence are defined as the non equivalent relative parameter of two-wheel of wheelset. Defining same parameter of parameters assemble Eₙ: value of relative parameters D_{b} which are adopted by two-wheels of wheelset are equal or equivalent equal. Defining equivalent relative parameters Dₑ of two-wheels of wheelset: under condition of which one or more parameters taken in the parameters assemble Eₙ are equal or equivalent equal to two-wheel of wheelset, The one or more parameters taken in the non-equivalent relative parameters Dₖ characterized by motion state of two-wheels of wheelset are converted to one or more parameters Dₑ of the equivalent relative parameters of two-wheel for wheelset by converting models and algorithms. The non-equivalent relative parameters Dₖ includes braking force of wheel, rotation angle velocity of wheel and the slip ratio of wheel. The same parameters Eₙ includes braking force or driving force of wheel, moment inertia of wheel, friction coefficient and load of wheel, side declination angle of wheel, rotation angle of steering wheel, inner and outer wheel turning radius of vehicle. The equivalent relative parameters Dₑ include braking force, rotation angle velocity and slip ratio of wheel. According to equivalent processing of conversion model and algorithm, equivalent relevant parameters Dₖ are converted to the equivalent relative parameters Dₑ, under conditions of which parameters taken of two-wheels of wheelset in same parameters assemble Eₙ are equal or equivalent equal, the equivalent relative parameters Dₑ is determined by no equivalent relative parameters Dₖ. Any one parameter in equivalent relative parameters Dₑ of two-wheels of wheelset is determined by non-equivalent relative parameters Dₖ by means of equivalent treatment of transformation model and algorithm in which values of the parameters taken from the same parameters Eₙ are equal or equivalent equal. When state parameters of two wheels of wheelset are compared, the equivalent treatment can eliminate and isolate uncertainty effect to tire burst judgement, under conditions of which parameter value of two wheels of wheelset in Eₙ are not equal or not equivalent equal. The equivalent processing to parameters Dₖ can determine quantitatively the comparable relationship of state parameters that include braking force, rotational angular speed and slip rate of wheels. The tire burst pattern recognition may determine whether there is tire burst and tire burst wheel by equivalent treatment and comparison in same parameter taken by E. In order to simplify the comparison of the parameters in Dₖ and Dₑ, the deviation or proportional mode of e(Dₖ) or e(Dₑ) can be used to comparing of tire burst and no tire burst wheel. The non-equivalent, equivalent relative parameter deviation and the ratio of two wheels are defined as: In two wheels of wheelset, the deviation e(Dₖ) or e(Dₑ) between Dₖ₁ or Dₑ₁ of wheel 1 and Dₖ₂ or Dₑ₂ of wheel 2 is defined:

e(Dₖ)=Dₖ₁−Dₖ₂ [symbol] e(Dₑ)=Dₑ₁−Dₑ₂

in two wheels of wheelset, the ratio e(Dₖ) or e(Dₑ) between Dₖ₁ [symbol] Dₑ₁ of wheel 1 and the Dₖ₂ [symbol] Dₑ₂ of wheel 2 is defined:

$$g ( {D}_{k} ) = \frac{{D}_{k 1}}{{D}_{k 2}} , g ( {D}_{e} ) = \frac{{D}_{e 1}}{{D}_{e 2}}$$

Based on the e(Dₖ) and e(Dₑ), model and function model of the characteristic tire pressure x_{b} for mode recognition of tire burst of wheel motion state are established. In the same parameter set Eₙ, the parameter Eₙ is taken as E₁ . . . Eₙ₋₁, Eₙ; a set of characteristic tire pressures x_{b} to parameter Eₙ(E₁ . . . Eₙ₋₁, Eₙ) is formed by different parameters and number of parameters taken by x_{b}.

x_{b}(e(ωₖ)) [symbol] x_{b}=f(e(ωₑ))

Specific expression of characteristic tire pressure of the set x_{b}:

x_{b}[x_{b1},x_{b2} . . . x_{bn-1},x_{bn}].

When the parameter in non-equivalent relative parameter Dₖ is non-equivalent relative angle velocity deviation e(ωₖ) of two wheel of wheelset and the parameters in the same parameter Eₙ is taken as braking force of two-wheel, characteristic tire pressure x_{b1} inset x_{b} is function of the equivalent relative angle velocity deviation e(ω_{d1}) by which two-wheels of wheelset use same braking force Qᵢ. When the parameter in non-equivalent relative parameter Dₖ is non-equivalent relative angle velocity deviation e(ωₖ) of two-wheel and the parameters in the same parameter Eₙ are taken as wheel braking force Qᵢ and friction coefficient μᵢ, characteristic tire pressure x_{b2} inset x_{b} is function of the equivalent relative angle velocity deviation e(ω_{d2}) by which two-wheel of wheelset use same Qᵢ and The equivalent relative angle velocity deviation e(ω_{d2}) is determined by the no-equivalent relative angle velocity deviation e(ωₖ₂) for Qᵢ and which in two-wheels of wheelset are equal or equivalent. The set of characteristic tire pressure x_{b}: x_{b}[x_{b1}, x_{b2}]. The equivalent relative angle velocity deviation e(ωₑ) of the two-wheel in the formula can is replaced by the equivalent relative slip rate deviation e(sₑ) each other. Tire burst state mode recognition are determined by the division of control states of vehicle for non-braking and non-driving, driving, braking, straight and steering running control states of vehicle. In tire burst judgment of wheel motion state, the set of characteristic tire pressures can be determined:

x_{b}[x_{b1},x_{b2} . . . x_{bn-1},x_{bn}].

The conversion model between no-equivalent relative state parameters Dₖ and equivalent relative state parameters Dₑ are simplified by the division of different control states of vehicles, to adapt the judgement of tire burst under different control and motion states of vehicles. The judgement of tire burst for wheel motion state usually adopts the pattern recognition with deviation or proportion of equivalent or no-equivalent relative parameter (Dₑ or Dₖ) of two-wheel of balanced wheelset. Defining balance wheel set: the wheelset determined by two moment of opposite direction exerted on centroid of the vehicle is defined as balance wheelset; the moment parameter include the braking force, driving force or ground force exerted on the two wheels. Based on the tire burst pattern recognition of characteristic tire pressure set x_{b}, a tire burst judgment logic for determining front and rear axles or wheelset of diagonal alignment arrangement is established. Based on this judgment logic, tire burst wheel, tire burst wheelset or tire burst balancing wheel pair are determined.

ii. Tire burst pattern recognition of characteristic tire pressure x_{c} for vehicle steering mechanics state. This pattern recognition is determined by steering mechanics state of vehicle. During generation and formation of tire burst rotation moment M_{b}′, the M_{b}′ is transferred to steering wheel by steering system and it will be changed that tire burst state, size and direction of rotation torque M_{c} of rotation angle and rotational moment of steering wheel. When M_{b}′ reaches a critical state, the generation and state of tire burst rotation moment M_{b}′ can be identified, and direction of tire burst rotation moment M_{b}′ can be determined by the change characteristics of rotation angle δ and rotation torque M_{c} of steering wheel. The critical state of M_{b}′ can be determined by a critical point of angle δ and torque M_{c} of steering wheel. In process of tire burst, the angle δ and torque M_{c} of steering wheel change in size and direction, and the δ and M_{c} of steering wheel reaches a “specific point” which can identify tire burst. The “specific point” is called critical point of δ and M_{c}. Coordinate system of the size and direction of angle δ and torque M_{c} and its increment Δδ and ΔM_{c} of steering wheel are established. The coordinate system specifies origins of δ and M_{c}. The direction of δ [symbol] M_{c} [symbol] Δδ and ΔM_{c} are determined. Information process of M_{b}′, the critical points of δ and M_{c} are determined by the directions of δ [symbol] M_{c} [symbol] Δδ and ΔM_{c}. Based on the direction of δ [symbol] M_{c} [symbol] Δδ [symbol] ΔM_{c}, a judgement logic for determining burst wheel in front and rear axles or wheel pairs of diagonal arrangement is established. Tire burst wheel and tire burst wheelset or tire burst balancing wheelset are determined by this judgment logic.

iii, Tire burst pattern recognition of characteristic tire pressure x_{d} for vehicle motion state. Under tire burst state, unbalanced yaw moment for vehicle, namely. Tire burst yaw moment Mᵤ′ produced by wheel forces of which ground exert on tire burst wheel and other wheels to vehicle mass center result in changes of vehicle motion state and state parameters. Tire burst pattern recognition of characteristic tire pressure x_{d} is determined by motion state and state parameters of whole vehicle. Under normal and tire burst working conditions, theoretical and actual yaw angle velocity deviation e_{ω}_{ᵣ}(t), sideslip angle deviation e_{β}(t) of mass center of vehicle are determined in real-time. The tire burst pattern recognition of characteristic tire pressure x_{d} is determined by mathematical model with modeling parameters which including steering e_{ω}_{ᵣ}(t) and e_{β}(t), or \dot{u}ₓ, \dot{u}_{y} and δ;

x_{d}(e_{ω}_{ᵣ}(t) [symbol] e_{β}(t),\dot{u}ₓ,\dot{u}_{y}) [symbol] x_{d}=f(e_{ω}_{ᵣ}(t),e_{β}(t),\dot{u}ₓ,\dot{u}_{y})

In the model, the δ is rotation angle of steering wheel, the \dot{u}ₓ and the \dot{u}_{y} are longitudinal and lateral acceleration and deceleration of vehicle. According to the positive or negative judgment of x_{d}, the excessive or insufficient steering of the vehicle is determined, and tire burst wheel in front and rear axles or wheel pairs in diagonal arrangement is determined by direction of steering wheel angle δ and the judgment logic of excessive or insufficient of vehicle.

iv. One of the following two mode is used for tire burst pattern recognition of vehicle state tire pressure pᵣₑ. First, tire burst pattern recognition based on state tire pressure pᵣₑ characteristic function. The characteristic function of state tire pressure is called state tire pressure pᵣₑ in shorter form. The state tire pressure pᵣₑ is determined or constituted by the characteristic function of characteristic tire pressure x_{b} [symbol] x_{c} and x_{d}. The mathematical model of state tire pressure: pᵣₑ=f (x_{b} [symbol] x_{c} [symbol] x_{d}). In model, x_{b}, x_{c}, x_{d} have same or different weight. According to process of tire burst or/and control state and type of non driving and non braking, driving or braking of the vehicle, the relevant parameters in x_{b} [symbol] x_{c} and x_{d} are allocated the weight of x_{b} [symbol] x_{c} and x_{d} with corresponding weight coefficients. Second, the model of tire burst pattern recognition of state tire pressure pᵣₑ is established by related parameters of wheel motion state, steering mechanics state of vehicle and vehicle state that include e(ωₑ) and e(ωₖ), e(Sₑ) and e(Sₖ), e_{ω}_{ᵣ}(t) and e_{β}(t), e(Qₑ) and e(Qₖ), a_{y}, e_{M}_{ₐ}(t), μᵢ, N_{zi} and δ. According to control states and types of non-driving and non-braking, driving and braking, the tire burst pattern recognition is realized. The above parameters are in order: equivalent and non-equivalent relative angle velocity and slip ratio deviation of wheelset, yaw angle rate and sideslip angle deviation of quality center of vehicle, lateral acceleration of vehicle, equivalent and non-equivalent relative braking force deviation of wheelset, ground friction coefficient, wheel load and angle of steering wheel.

(2). Tire burst judgment at state stage for tire burst

i. The tire burst judgement on the basis of wheel motion state. The judgement is a tire burst judgement of characteristic tire pressure x_{b}. Based on comparison of equivalent relative parameter deviation e(Dₑ) of the left and right wheel of front and rear axles or diagonal arrangement wheelset, the tire burst pattern recognition of characteristic tire pressure x_{b} is determined by tire burst state process and types of non-driving and non-braking, driving, braking, straight running or steering of vehicle. The deviation e(Dₑ) includes equivalent relative angle velocity deviation e(ωₑ) and equivalent relative slip rate deviation e(Sₑ). The tire burst judgment model of x_{b} is established by the modeling parameter e(ωₑ) or e(Sₑ). The judgment model of tire burst includes logical threshold model and the threshold value is set. When the x_{b} reaches the threshold value, the judgment of tire burst is determined, and tire burst wheels and tire burst wheelsets are determined.

ii. Tire burst judgment to steering mechanics state of vehicle

Tire burst judgment on the basis of mechanics state of vehicle steering. The tire burst judgment is determined by characteristic tire pressure x_{c}. Based on the parameters of steering mechanics state of vehicle, the logic of tire burst pattern recognition of steering mechanics for the system is used to determine characteristic tire pressure x_{c}. The tire burst pattern recognition is realized according to characteristic tire pressure x_{c}. The tire burst pattern recognition of x_{c} can be determined by model of using tire burst rotation moment M_{b}′ as parameter:

x_{c}(M_{b}′),x_{c}=f(M_{b}′)

Under the conditions of vehicle straight running or steering, the direction of tire bursting rotation moment M_{b}′ is determined by a judgment logic of direction of angle δ, rotation moment M_{c} and its increment Δδ [symbol] ΔM_{c} of steering wheel. According to the judgment logic, the tire burst judgment is determined, from this, tire burst wheel, tire burst wheel pair or tire burst balance wheel pair are determined.

iii. Judgment for tire burst based on vehicle motion state

The judgment of tire burst of vehicle is a characteristic tire pressure x_{d}. Based on the pattern recognition of vehicle motion state, a tire burst judgment model of characteristic tire pressure x_{d} is established. The judgment model includes logic threshold model. Setting threshold value, the tire burst is determined when the value determined by threshold model reaches threshold value. According to the positive (+) or negative (−) of x_{d}, the excessive or insufficient steering of the vehicle is determined. The tire burst wheel in front axle and rear axles or in wheelset of diagonal arrangement are determined by the judgment logic of direction of steering wheel angle δ and excessive or insufficient of vehicle.

iv. Judgment combined of tire burst based on wheel motion state and vehicle state

The tire burst judgment is determined by combined pattern recognition of wheel motion state and vehicle motion state. The tire burst judgment is a judgment of state tire pressure pᵣₑ determined by functional model pᵣₑ[x_{b}, x_{d}]. Setting the logic threshold model and threshold value of functional model of state tire pressure pᵣₑ, the judgment of tire burst is determined when the value of pᵣₑ reaches its threshold value, otherwise the determination of tire burst is not established. Based on control states of vehicles and types of non-driving and non-braking, driving, braking, straight running and swerve running of vehicles, excessive steering or insufficient steering of vehicles, tire burst wheel, tire burst wheelsets or tire burst balancing wheelsets are determined.

v. A logic assignment for tire burst determining is expressed by positive and negative (“+” and “−”) of mathematical symbols. The logic symbols (+, −) in the process of electronic control are expressed by high or low electric level, or specific logic symbols code including numbers and letter. When the tire burst is determined, tire burst controller or a central master computer sends a tire burst signal I.

(3). Tire burst pattern recognition in the control stage of tire burst. The pattern recognition is based on the control state of tire burst vehicle; the control parameters of wheel, steering and vehicle are adopted by Judgment of tire burst in tire burst control stage.

i. Pattern recognition of wheel state in tire burst control stage

A tire burst pattern recognition and model of the characteristic tire pressure x_{b} is established by one of braking force deviation e_{q}(t), angle acceleration and deceleration degree deviation e_{ω}(t) or slip rate deviation eₛ(t) of differential brake of two-wheel for wheelset. The deviations are determined by modeling parameters of braking force Qᵢ, angle acceleration and deceleration degree \dot{ω}ᵢ and slip rate Sᵢ of wheel. Based on pattern recognition and model of characteristic pressure x_{b}, value of x_{b} are determined.

ii, Pattern recognition of steering control in tire burst control stage.

A tire burst pattern recognition and model of the characteristic tire pressure x_{c} is established by modeling parameters of tire burst rotation moment M′_{b}, or deviation e_{M}_{ₐ}(t) of the rotation moment Mₖ₁ [symbol] Mₖ₂ by two steering wheels of vehicle. According to the model, the value of characteristic tire pressure x_{c} for pattern recognition is determined.

iii, Pattern recognition of vehicle in tire burst control stage

A tire burst pattern recognition and model of the characteristic tire pressure x_{d} is established by yaw angle rate deviation e_{ω}_{ᵣ}(t), sideslip angle deviation e_{β}(t) to mass centroid of vehicle, or/and lateral acceleration deviation to normal and burst conditions in certain vehicle speed and steering angle. According to the model, the value of characteristic tire pressure x_{d} for pattern recognition is determined.

iv. Combination pattern recognition of control parameters for wheel, vehicle steering and vehicle state in tire burst control stage. The combination pattern recognition is determined by pattern recognition of characteristic tire pressure x_{b}, x_{c} and x_{d}, or x_{b} and x_{d}, namely pattern recognition of state tire pressure pᵣₑ[x_{b}, x_{c}, x_{d}], pᵣₑ[x_{b}, x_{d}]. The model of state tire pressure pᵣₑ is established. According to the model, value of pattern recognition of pᵣₑ is determined.

(4). Tire burst Judgment in the control stage of tire burst

In process of tire burst control, the characteristics of tire burst state and the values of characteristic functions x_{b}, x_{c} and x_{d} can convert each other among the characteristic functions x_{b}, x_{c} and x_{d}. In view of the transfer of tire burst characteristics and eigenvalues, tire burst determination model is established by relevant parameters in x_{b}, x_{c} and x_{d}. Based on control states and types of non-driving and non-braking, driving, braking, straight running and turning of vehicles, the judgment of tire burst is achieved by burst judgement model. In the control stage of tire burst of vehicle, the judgement model of state tire pressure pᵣₑ[x_{b}, x_{c}, x_{d}] or pᵣₑ [x_{b}, x_{d}] is used to determine tire burst of wheel and vehicle. The judgment of tire burst uses logic threshold model. The logic threshold value is set. When the value of relevant parameters or tire pressure pᵣₑ reaches the threshold value, the judgment of tire burst in tire burst control stage is maintained, and tire burst control of vehicle continues. When the value of relevant parameters or pᵣₑ does not reach the threshold value, the vehicle exits from tire burst control. The judgment of tire burst determined by this method is basis of tire burst safety control of vehicle.

3). Tire Burst Pattern Recognition and Tire Burst Determination for Detected Tire Pressure

(1). Tire pressure sensing and detection of wheel. Tire pressure is detected by an active, non-contact tire pressure sensor (TPMS) set on the wheel. TPMS is mainly composed of a transmitter set on the wheel and a receiver set on body of vehicle. A unidirectional communication of radio frequency (RF) or a bidirectional communication of radio frequency (RF) and Low frequency are adopted between transmitter and receiver. The sensor of tire pressure (TPMS) is driven by electric energy. The transmitter is a high integrated chip which integrates sensor module, wake-up chip, MCU, RF transmitter chip and circuit. The sensor module includes sensors of pressure, temperature, acceleration and voltage. The sensor module uses two mode of sleep and working. The transmitter uses this technology about sleeping and wake-up, adjustable cycle of signal detection, signal emission limited by number in a certain time and automatic adjustment of signal emission cycle to maximizing satisfy of performance requirements of tire burst control system during tire burst process. The technology can extend energy supply and electric service life.

(2). Tire burst pattern recognition and tire burst determination

Tire burst pattern recognition is based on detecting tire pressure of sensor. Tire burst judgement adopts threshold model. Setting a series of decreasing logic threshold aₚᵢ, a series of decreasing logic threshold values of tire pressure are set from aₚₙ . . . aₚ₂ to aₚ₁. The aₚₙ is threshold value of standard tire pressure. The aₚ₁ is zero value of tire pressure. When the detection value of tire pressure is large than aₚₙ, the overpressure alarm of tire will be given. When the tire pressure reaches the threshold value aₚ₂, judgement of tire burst of wheel will be determined. The prophase stage of tire burst control is determined by aₚₙ . . . aₚ₂. The time interval of the signal transmission cycle is determined by mathematical model of modeling parameters that include tire pressure value detected by sensor and it change rate. The time interval of signal launching cycle is decreased with decreasing of tire pressure value measured, and with the increase of change rate of tire pressure value measured. The tire pressure sensor (TPMS) and tire burst pattern recognition used by the method can meet the requirements of tire burst control in the maximum limit.

4). Entering, Exiting to Tire Burst Control and Conversion of Control and Control Mode

(1). Entering and exiting to tire burst control

i. First. Entering and exiting to tire burst control under condition of which tire burst of vehicle is determined. Qualitative condition, quantitative judgment mode and model are used to determine the entering of tire burst control. The determination of entering for tire burst control is realized by achieving the qualitative condition, or/and quantitative condition of judgment mode and model. Quantitative judgment model includes logical threshold model. The model adopts single parameter or multi-parameter threshold model. When the value determined by the threshold model reaches the threshold value, vehicle enters tire burst control, and the controller or the main control computer of the system sends the tire burst control entering signal iₐ. The single-parameter threshold model includes a threshold model with parameter of vehicle speed uₓ. The threshold value aᵤₐ is a value set by vehicle speed uₓ. In multi-parameter threshold model, threshold value a_{ub} is determined by model with parameters that includes speed uₓ, steering wheel angle δ and friction coefficient μᵢ. The a_{ub} is a function of speed uₓ, steering wheel angle δ or/and friction coefficient μᵢ. The function value of a_{ub} is reduced with the increase of rotation angle δ of steering wheel. The a_{ub} is a increasing function with increment of friction coefficient μᵢ. Second, the exiting of tire burst control under the condition of which tire burst judgement of vehicle is established. A qualitative condition, quantitative judgment mode and model are used to determine the exiting condition of tire burst control. The quantitative judgment mode and model of exiting of tire burst control are set. When reaching the exiting condition determined by the model, the exiting of tire burst control is realized. The quantitative model includes a logic threshold model. The logic threshold model uses a single parameter or multi-parameter threshold model. Determining the threshold value for the tire burst control exiting. When the threshold value determined by the threshold model is reached, the tire burst control of vehicle exits, and master controller or master control computer of tire burst issues the tire burst control exiting signal i_{b}.

ii. Exiting of the tire burst control in the tire burst control progress of vehicle. First. Under the condition of which tire burst judgement of vehicle is true, the exiting of tire burst control is realized when the tire burst judged by one of measuring tire pressure of sensor, characteristic tire pressure and state tire pressure is not true, or the judgment of tire burst is converted from its establishment to its no establishment, tire burst control exits. Second. Exiting of tire burst control in tire burst control phase. In the tire burst control, the tire burst pattern recognition is determined by the tire burst control state and its parameters. Based on the touch recognition, the tire burst judgment is established, the tire burst judgment is maintained and the tire burst control is carried out continuously if the judgment is established. The tire burst control exits from the stage if the judgment of tire burst is not determined during this stage.

iii. Tire burst control exiting determined by manual operation interface. When the exiting signal of tire burst control determined by the manual operation controller (RCC) arrives, tire burst control exits.

iv. When burst control of vehicle entering or exiting, the master controller or the master control computer sends out signals of the burst control entering signal iₐ or exiting signal i_{b}. The exiting of tire burst control of vehicle has a specific function and significance for the state tire pressure determined by this method; it make abnormal state for vehicle control become integrate under normal and burst conditions, so that, the tire burst control does not depend on fetters of tire pressure detected by tire pressure sensor.

(2). Transformation of tire burst control and control mode. Based on these definition of tire burst and tire burst judgment, the method provides a wide operating environment, time and space to the division of normal tire pressure, low tire pressure and tire burst interval, to the tire burst pattern recognition, control and control mode conversion between normal working conditions and tire burst working conditions. With the conversion of various tire blow out control and control mode, there is a very necessary and valuable control overlap between normal and blow out conditions. All kinds of tire burst control and the conversion of tire burst control mode provide a practical, operable and realizing method to control the double instability of vehicle caused by normal control under the condition of tire burst and tire burst.

i. Based on state process of tire burst, the method adopts a tire burst control mode and model corresponding to the process of tire burst. The conversions of tire burst control and control mode is an indispensable and important link for tire burst control. The conversion of control and control modes of vehicle includes the following four levels. First, for level of vehicle. The conversion of control mode between normal condition and tire burst condition of vehicle is an entering and exiting of tire burst control of vehicle in essence. The controller set by driven by man or undriven by man vehicle takes the tire burst control entering or exiting signals iₐ [symbol] i_{b} as switching signals of control and control mode conversion, the control and control mode conversion between normal and tire burst conditions of the vehicle are carried out. Under normal and tire burst conditions, the conversion of control mode covers various forms determined by the control modes of braking, steering and driving at next control level of the vehicle. Second, for local level of vehicle. It includes tire burst control for braking and steering, or/and suspension. In state process of tire burst control, tire burst control of vehicle adopts a conversion mode which adapts to control characteristics of braking, steering or/and suspension, according to change of vehicle state process. Third, for coordinated control level of tire burst to vehicle braking, steering or/and suspension. It includes the coordinated controls and control mode conversions of tire burst braking, steering or/and suspension. Fourth, conversion of other control mode and other control types associated with vehicle braking and steering tire burst control. According to coordinating regulations and procedures of control mode, these converting are realized, which include conversions of coordinated control for vehicle braking and throttle or fuel injection, conversions of coordinated control for braking and fuel power driving or electric driving of vehicle, conversions of coordinated controls for tire burst steering rotation force and rotation angle of directive wheel. Fifth, According to the starting point, transition point and critical point of tire burst state of wheel and vehicle, the tire burst state process and control process are divided into several state control periods or stages. The control period and its logical cycle are set based on the parameters and types of tire burst control. The upper and lower level control periods of tire burst are set. Superior control period includes early stage of control of burst tire, control time of real burst tire, control time of tire burst inflection point and control time of separation for rim and tire. In superior control periods, the control mode conversion is realized by converting signals including iₐ [symbol] i_{b} [symbol] i_{c} and i_{d}. The lower level control period include control cycle of periods of parameters and control types for tire burst, the control mode conversion is realized by converting signals iₐ(iₐ₁ [symbol] iₐ₂ [symbol] iₐ₃ . . . ) [symbol] i_{b}(i_{b1} [symbol] i_{b2} [symbol] i_{b3} . . . ) [symbol] i_{c}(i_{c1} [symbol] i_{c2} [symbol] i_{c3} . . . ) [symbol] i_{d}(i_{d1} [symbol] i_{d2} [symbol] i_{d3} . . . ). The conversion of each control cycle and the logical circulating of control periods for stages are realized on the control mode. The conversion signals of tire burst control and control mode are called as tire burst signal I. Based on different periods and logical circulating for tire burst and tire burst control, the control mode, model and algorithm for tire burst adapted to condition of vehicle tire burst are adopted by the controller. The control of tire burst is more precise and can meet the requirement of drastic change of tire burst state by conversion of control mode and model in each control periods and logical circulating of control periods.

ii. Conversion way or type of tire burst control and control mode

Conversions of different control modes and structures which include program, protocol and external converter are adopted by controller.

First, the program conversion mode. A same electronic control unit is set up by tire burst controller and corresponding on-board system. The electronic control unit takes the burst tire signal I as the conversion signal of control and control mode, and calls conversion subroutine of control mode stored in the electronic control unit, to realize automatically conversion of control and control modes, to realize entering and exiting of tire burst control, to realize automatically conversion of non burst tire and burst tire, to realize automatically conversion of control periods or stages of control parameters and modes and of each control periods and logical circulating of control periods. Second, protocol conversion. The electronic control unit set by the tire burst controller and the electronic control units of the vehicle control system are set up independently; the communication interface and protocol between the two electronic control units are set up. According to the communication protocol, the electronic control units uses signals I of tire burst, signals of related control models of sub-system and signals of the control types in each control logic cycle and periods as the conversion signal, to realize entering and exiting of tire burst control and the conversion of the above control and control modes. Third, conversion of external converter of electronic control units. When electronic control unit set by tire burst controller and the electronic control unit of the on-board system are set up independently, and there is no communication protocol between the two electronic control units, entering and exiting of tire burst control and the conversion of the above control modes between the two electronic control units are realized by the external converters which include front or rear converters set. A front converter is set in front position of the two electronic control unit. The measured signals of each sensor and tire burst signal I are input into front converter. When the tire burst signal I arrives, the front converter takes signals including tire burst signals I and conversion signals of the above control modes as the switching signal; the output state of signal of power supply or/and each electronic control unit is changed by control to input signals state of power supply or/and each electronic control unit, to realize the entering or exiting of tire burst control and the conversion of the above control and control modes of the two electronic control unit. A postposition converter is set in rear position of the two electronic control unit of tire burst controllers and the vehicle-control system; the output signal of the electronic control units of the vehicle-board control system and tire burst control system pass through the postposition converter, then, enters the corresponding execution device of vehicle-mounted control system. When tire burst signal I arrives, the output states of signal for the two electronic control unit are transformed by the signal I, to realize entering or exiting of tire burst control and the conversion of the above control and control modes of the two electronic control. The signals input state of electronic control unit refers to the two states where the electronic control unit have or does not have input of signals. Changing of the input state of the signals is a convert from input state of existing signals into input state of non signals, a convert from input state of non signals into the input state of existing signals. Similarly, signals output state of electronic control unit refers to state where the electronic control units have or do not have signal output. Changing of the output state of the signals is a convert from output state of the existing signals into the output state of the non-signal, or convert from output state of non-signals into the output state of existing signals.

iii. Conversion and converter of tire burst control mode of driverless vehicle.

Under the condition of which tire burst of vehicle is determined by central controller of driverless vehicle, the subroutine of control mode conversion set by master control computer is called based on the main programs of active driving, steering, braking, lane keeping, path tracking, collision avoidance, path selection and parking, to realize automatically the conversion of entering and exiting of tire burst control and the conversion of the above control and control modes, and each control cycle and logical circulating of control periods for stages.

(3). Division of tire burst status and tire burst control period or stage

The division of period or stage is based on the specific points of tire burst. A delimitation way or mode of characteristic parameters of tire burst and its joint control period or stage are adopted. After each control period or stage are delimited, the master controller outputs corresponding control signals to each control period. During each control period or stage of tire burst, the same or different tire burst control modes and models are adopted.

i. Delimiting mode of control period or stage based on specific point positions of tire burst. First, start point, sharp change point of tire burst state which include zero of tire pressure, rim separation point, wheel speed, angle acceleration and deceleration of wheel and transition point of tire burst control are determined. Real starting point of tire burst is determined by mathematical model of detecting tire pressure or state tire pressure and its change rate. The inflection point of tire burst control and control parameters, which includes the change point, singularity point of wheel angle acceleration and deceleration speed, and change point of braking force in braking process. Second. Based on tire burst state, the specific time and state point of the tire burst control, the period of tire burst control or stage of tire burst control is determined. The control periods includes early period of tire burst, period of real tire burst, period of inflection point of tire burst and separation period of rim and tire. Early period of tire burst: the period from control starting point set by controller of the tire burst to the real tire burst starting point. Real tire burst Period: the period from the real starting point of tire burst to inflection point of tire burst. The control period of tire burst inflection point: the period from the Inflection point of tire burst to the separation point of tire and rim. The inflection point of tire burst is determined by mathematical model of detecting tire pressure or state tire pressure and its change rate. In period of tire burst inflection point, the change of state parameters of wheel and vehicle is close to a critical point. Control period of separation point of tire and rim: the state and control period after the separation of tire rim, in which the detecting tire pressure and change rate are 0, and the wheel adhesion coefficient changes rapidly. Control period of separation point of tire and rim can be determined by mathematical model of modeling parameters which include vehicle lateral acceleration and wheel lateral deflection angle.

ii. Delimiting mode of control period of tire burst characteristic parameters. Based on tire burst status, tire burst control structure and type, the corresponding parameters in tire burst characteristic parameter set X are select, and the points of numerical of several stages in this parameter set X are set. Each point is set as the dividing point of tire burst status and tire burst control period. The tire burst status period, tire burst control period are constituted by regions in any two point. The burst status demarcated by the periods is basically same or equivalent to the real burst state process in that control period.

iii. Delimiting mode for the control period based on the combination of specific points and characteristic parameters of tire burst. Classification control system of upper and lower levels is adopted in the delimiting mode. The upper level control period can adopt one or more control periods, or it includes early control periods (stages) of tire burst, period of real tire burst, period of Inflection point of tire burst, separation period of tire and rim. The lower level control period: in each control period determined by the upper level, a numbers of series of numerical point positions is set, according to the control period of tire burst control parameters or the value of tire burst characteristic parameters set X; the tire burst status period and tire burst control period are constituted by regions in any two point of lower level control. The control periods of the lower level are set in numerical points

iv. Tire burs and control period of tire burs. First, the previous period of tire burst: the control period usually occurs in the low and medium decompression rate state of tire pressure. According to the actual state process of tire pressure, the vehicle will either enters the real tire burst period to control or exits the tire blow out control. Second, the real tire burst period: In the sampling period of detection tire pressure, the tire pressure variation value Δpᵣ is determined by a function model with modeling parameters pᵣ, \dot{p}ᵣ:

Δpᵣ=f((pᵣ₀−pᵣ),\dot{p}ᵣ)

When PID is adopted

Δpᵣ=k₁(pᵣ₀−pᵣ)+k₂\dot{p}ᵣ+k₃∫ₜ_{₁}^{t}^{₂}\dot{p}ᵣdt

Where pᵣ₀ is the standard tire pressure, t₁, t₂ is the sampling period time of detection tire pressure. According to the threshold model, the real tire burst period is determined, when the tire pressure change value Δpᵣ reaches the set threshold value a_{P1}. the ECU outputs the real tire burst control signal, tire burst control enters. Third, the tire burst inflection point period, variety of judgment methods are used. The first method is based on detecting tire pressure of sensor; when detecting tire pressure value is 0 and the equivalent or nonequivalent relative angle acceleration and deceleration velocity e(\dot{ω}ₑ) or slip ratio velocity e (sₑ) of two wheels of tire burst balance wheelset reaches set threshold value a_{P2}, it is determined to tire burst inflection point. The second method: in the sampling period of detection, a function model is determined by state tire pressure pᵣₑ and its change value pᵣₑ:

Δpᵣₑ=f(pᵣₑ,\dot{p}ᵣₑ)

According to the threshold model, when Δpᵣₑ reaches the set threshold value a_{P3} or when the positive and negative sign of equivalent or on equivalent relative angle velocity, angle plus/minus speed and slip rate changes, tire burst inflection point is determined. Fourth, separation period of

tire and rim for tire burst wheel: when steering angle of wheel reaches the threshold value, or equivalent relative side slip angle αᵢ of tire burst balance wheelset, vehicle lateral acceleration a_{y} reaches set threshold value, or when value determined by mathematical model of its parameters reaches set threshold value, separation of tire and rim is judged. Electronic control unit outputs the separation signal of tire and rim for tire burst. The control system of tire burst enters separation period of tire and rim for tire burst wheel.

5). Direction Determination of Tire Burst

Tire burst parameter direction determination is referred to as tire burst direction determination, it is one of the basic conditions to realize the steering control of tire burst vehicle. Based on the determination of the direction of tire burst, the method adopts the steering control of tire burst with independent control characteristics, and it is used in driven by man and driverless vehicles, vehicles of chemical and electric energy driving. First, the direction determination involves the judgement of the direction of the tire burst rotation torque, rotation angle of directive wheels, namely, steering wheels of touching ground, angle and torque of steering wheels and tire burst steering assistant torque. Second, in range of tire burst active steering, direction determination of tire burst includes the direction judgement of steering angle of tire burst wheel, tire burst rotation moment, steering assistant moment or steering driving moment. Third, in range of active steering by drive-by-wire, power steering and drive steering direction determination of tire burst includes the direction judgement of steering driving moment, rotation angle of directive wheels and steering angle of vehicle. All kinds of direction determination mentioned above are referred to as direction judgement of angle and torque. Rotary moment control of tire burst for steering wheel and directive wheels are abbreviated as rotary force control. The determination of tire burst direction is essentially a judgement of direction change for the rotation moment which applies directive wheels by ground. The direction change is caused by the destruction of the wheel structure during vehicle running. When the tire burst control entering the signal iₐ arrives, the rotating moment control of the tire burst for the directive wheels and the steering wheel starts. The determination of tire burst direction involves setting of specific coordinate system of two kinds of vectors including angle and torque, the calibration of angle and torque direction, the establishment of mathematical logic of direction judgement and configuration of logical combination. Two modes of rotation angle or rotation angle and torque are used to determine the direction. According to different setting of rotation angle and rotation torque, or/and different of parameter detection of sensor, the direction of tire burst adopts the two modes of corner and torque, or angle of tire burst. All kinds of angle and torque parameters to tire burst steering control are vectors. The coordinate system stipulating by this method provides a technical platform for data processing of relevant parameters including power steering, active steering and steering by wire control of driven by man and driverless vehicles. The rotation torque of directive wheels is a rotation moment exerted by ground to directive wheels. The steering assist moment to steering of vehicle is a steering assist or resistance moment inputted by the steering system.

(1). Rotation angle and rotation torque mode

In steering system of vehicle, two kinds of vector coordinate systems of angle and torque are established. The coordinate systems to vehicle include absolute coordinate system set in vehicle and relative coordinate system set in steering axis. The origin of coordinate and direction of rotation angle and rotation torque are set up. Direction determination of rotation angle and rotation torque: under of condition that origin of coordinate is as 0 point, it is determined to direction of left-handed and right-handed for angle and rotation torque in coordinate system, the direction of forward travel (+) and return travel (+) for angle and rotation torque in coordinate system, direction of angle and rotation torque increment or decrement of rotation angle and rotation torque. Establishment and calibration of coordinate system. First, Within range of any rotation angle and rotation direction in absolute coordinate system, a relative vector coordinate system for value and direction of angle and torque are established by standard of torque coordinate system and angle coordinate system. In each coordinate system of angle and torque, a direction calibration mode to rotation direction, direction of positive (+) route and negative (−) route of angle and torque, direction of increment and decrease of angle and torque are used. Second, relative coordinate system includes rotation angle and rotation torque coordinate system of steering wheel or/and directive wheel. Angle and torque of the steering wheel or/and directive wheel adopts two rotation ways for left-handed and right-handed, forward route and return route to the origin. The direction of rotation angle and rotation torque of steering wheel or/and directive steering wheel are characterized by positive (+) and negative (−) of mathematical symbols, from this, the judging direction of steering wheel or/and directive steering wheel are established by the logic combination of mathematics symbols (+), (−) and the judgment logic of its combination. The combination of mathematical logic, positive (+) and negative (−) of mathematical symbols and their changes can indicate the direction determination of all kinds of rotation angles and rotation torque of steering system under normal and tire burst working conditions.

(2). Rotation angle mode. Two kinds of angle coordinate systems which includes the absolute coordinate system set on the vehicle and the relative coordinate system set on the turning axis of the steering system are set up. Establishment and calibration of coordinate system: two or more relative coordinate systems are established in an absolute rotation angle coordinate system, to calibrate the magnitude and direction of the rotation angle. The calibration methods of direction for rotation angle: it can be adopted that rotation direction of left-handed and right-handed to rotation angle, the direction of forward route or return route to the origin, the direction of increment or decrement to rotation angle, in each coordinate system of the rotation angle. The coordinate systems includes the rotation angle and rotation torque coordinate system of the steering wheel or/and the directive wheel. In the process of tire burst of vehicle, the direction determination of rotation torque and rotation angle, the tire burst rotation torque and steering assistant moment of steering wheel or/and directive wheel are determined according to a special defined coordinate system and a combination of calibration for parameters directions. The coordinate systems constitutes as basis of moment measurement and direction determination of active steering driving device. Determination mode of steering wheel angle: rotation angle modes are used. It is established that more relative angle coordinate systems set on absolute coordinate system of vehicle and set on the transfer shaft of the steering system. The direction of rotation angle of steering wheel or/and directive wheel, and direction of their changes of increment and decrement are characterized by positive (+) and negative (−) of mathematical symbols, from this, the judging direction of steering wheel or/and directive wheel are established by the logic combination of mathematics symbols (+), (−) and the judgment logic of their combination. The combination of mathematical logic includes: first, the combination of mathematical logic, positive (+) and negative (−) of mathematical symbols and their changes can be used for direction judgement of all kinds of rotation angles and rotation torque of steering system under normal and tire burst working conditions. Second, the combination of positive and negative (−) of mathematical symbols and their changes can be used for the direction determination of all kinds of angle and torque under tire burst working condition. The direction determination of steering wheel or/and directive wheel system can also be applied for direction judgement in changing caused by structure damage of vehicle running system and serious deformation of ground.

6). Information Communication and Data Transmission

Information communication and data transmission. Under normal and tire burst environments can be used by vehicles of chemical or electric driving, and driven by man and driverless vehicles. Vehicle data network bus is a local area network. In the local area network, topological structure of Controller Area Network (CAN) is bus type. Data, address and control bus are set up. Bus of CPU, local area, system and communication are set up. When tire burst control system and subsystem of vehicle are designed by non-integration, it is adopted that vehicle local area network bus which includes CAN bus, Local Internet Connection Network (LIN) bus. Local Internet Connection Network (LIN) bus is used for distributed electric control system of vehicle, such as digital communication systems of tire burst controller, intelligent sensor and actuator. According to the structure and type of tire burst control system, the on-board network bus of the system adopts fault detection bus, safety and new X-by-wire bus which includes line controlled power steering, active steering (Steer-by-wire), brake-by-wire control (Brake-by-wire) of electronically hydraulic or electronically machinery and engine throttle and fuel injection (Throttle-by-wire) under normal and tire burst conditions. The traditional mechanical system is transformed into an electronic control system managed by high-performance CPU and connected by a high-speed fault-tolerant bus. Especially for the characteristics of the high frequency control of tire burst braking and steering, the conversion of high dynamic control mode and high dynamic response, the control system of tire burst electric control or wire-controlled braking, the tire burst wire-controlled steering and the tire burst throttle telex control are constituted to suit and meet the special environment and conditions of tire burst. The data transmission and communication of information for tire burst control system that include tire burst and no tire burst information unit, the main controller, controller and the execution unit are realized by vehicle network bust, vehicle network of traffic, physical wiring for integration design system.

7). Distance Detection Between Two Vehicles and Environment Identification

Environment identification of vehicle includes detection of distance between the tire burst vehicle and the surrounding vehicle, and environment recognition of driven by man and driverless vehicle. In distance of effective and limited running and space range of anti-collision for tire burst control, the effective control of the motion state, path tracking and collision-proof of tire-burst vehicle can be realized by detecting the distance between the tire burst vehicle and peripheral vehicles, and by identifying to peripheral objects. Tire burst vehicle and peripheral vehicles each other can exchange traffic information by means of tire-burst warning of sound and light emitted by tire-burst vehicle, or by means of vehicle network for traffic, mobile communication and exchange of traffic communication information. The tire burst vehicle can inform surrounding vehicles to avoid actively the tire-burst vehicle by control of their vehicle. In this way, peripheral vehicles can reserve a larger running distance and effective anti-collision space for the tire-burst vehicle under possible conditions of road.

(1). Distance detection between two vehicles is used for driven by man or Vehicle distance driverless vehicles.

i. detection mode of electromagnetic radar, laser radar and ultrasound. Based on the emission, reflection and state characteristics of physical waves, a mathematical model is established to determine the distance Lₜᵢ and relative speed u_{c} between front vehicles and rear vehicles, or/and the time zone tₐᵢ of collision avoidance. The parameter Lₜᵢ [symbol] u_{c} and tₐᵢ are a basic parameter of anti-collision control of brake and drive for tire burst vehicle. First, radar distance monitoring. Electromagnetic radar including millimeter wave beams may be used. Wave beam are transmitted by antenna. The reflected echo is received, and is input receiving module, and it is processed by mixing and amplifying. Based on beat and frequency difference signals and vehicle speed signals, the distance between front and rear vehicles, and their relative speed u_{c} are determined by processing module. The time zone tₐᵢ is calculated by mathematical formula with modeling parameters of Lₜᵢ and u_{c}. The tₐᵢ can be determined by ratio of the parameters Lₜᵢ, and u_{c}. Second, ultrasound distance measurement. The detection adopts a coordinated control mode of ultrasonic ranging and self-adaptive tire burst control for front and rear vehicles. Setting detection distance of ultrasonic ranging sensor, the braking distance and relative speed between the vehicle and the rear vehicle are not limited by control of the tire-burst vehicle in safe distance. Beyond the safe distance between the vehicle and front or rear vehicle, the rear vehicle enters detection distance of ultrasonic ranging sensor of the vehicle, the distance between the tire-burst vehicle and the rear vehicle is controlled by the tire-burst vehicle according to the driver's preview model and the distance control model to rear vehicle. When the rear vehicle enters the range of the ultrasonic monitoring distance of the tire-burst vehicle, the ultrasonic distance monitor of the tire-burst vehicle enters a effective working state. According to the receiving program, the ultrasonic distance monitor of the tire-burst vehicle determines pointing angle of ultrasonic beam, and uses the combination of multiple ultrasonic sensors and specific ultrasonic triggers, to obtain detection signal. The data of signal detected by each sensor is processed. The distance tₐᵢ between front and rear vehicles, and the relative speed u_{c} are determined. The dangerous time zone tₐᵢ is calculated. The coordinated control of collision prevention of front and rear vehicles is carried out according to time zone tₐᵢ.

ii. Machine vision distance monitoring. Vehicle distance monitoring uses common or/and infrared machine vision which include monocular or multi-eye vision, color image and stereo vision detection. A mode, models and algorithms for simulating human eyes are established. Based on color image graying, image binaryzation, edge detection, image smoothing, Open CV digital image processing of morphological operation and region growth, and vehicle detection method (Adoboost) on the basis of shadow feature, the distance measurement is realized by model and algorithm of vision ranging of computer and Open CV of camera. The characteristic signal is extract quickly by the images, and the vehicle distance from the camera sensor to other vehicle is determined by a certain algorithm of visual information processing in real time. The relative vehicle speed u_{c} is determined by parameters and its change of the vehicle speed, acceleration and deceleration speed, relative distance Lₜ of vehicles.

iii. Vehicles information commutation way (VICW). An interactive distance monitoring method of vehicle is used for transmitting and receiving of data by radio frequency transceiver. Geodetic longitude and latitude coordinates can be obtained by multi-mode compatible positioning. The method use Radio Frequency Identification (RFID) technology. The distance from the satellite to the vehicle receiving device is obtained by positioning of GPS. The equation is formed by more than three satellite signals and the distance formula in three-dimensional coordinates, to solve three-dimensional coordinates X, Y and Z of the vehicle position. The longitude and latitude information is defined on format. The longitude and latitude of the vehicle are measured by ranging model, to obtain location information of vehicle calibrated by the geodetic coordinate calibration. The identified object is identified actively by space coupling of radio frequency signal RFID, coupling of inductance or electromagnetic signal, and transmission characteristics of signal reflection. The radio frequency transceiver module sent all kinds of information about the precise position of the vehicle and the surrounding vehicles, and receives information about status changing of surrounding vehicles, so as to realize the mutual communication between the vehicles. Data processing module of the monitoring system obtains the intercommunication information of surrounding vehicles. Using corresponding model and algorithm, the data processing module of the monitoring system (VICW) can process dynamically the longitude and latitude position data of the vehicle and the surrounding vehicles at real-time. The data processing module can obtain the vehicle moving distance indicated by latitude and longitude degree coordinate based on positioning of satellite within scanning period T of latitude and longitude, to determine speed of vehicles, distance between the front vehicle and back vehicle and relative speed of vehicles. The latitude and longitude coordinate variations of the vehicle position in same direction and opposite direction is determined by judgment model of same direction and opposite direction of the vehicle. The running direction of the vehicle is judged by the longitude and latitude information matrix of vehicle at multiple time, to obtain relative running direction of the vehicle and surrounding vehicles, and orientation of surrounding vehicles which is located in front and rear of the vehicle. According to the longitude and latitude coordinate and their change value of the front and rear vehicles that run same direction, the distance Lₜᵢ and relative speed u_{ci} between two vehicles are calculated by the model and algorithm of measured distance and measured speed for vehicle. Display and alarm module: the module displays information about detected distance between the vehicle and other vehicle in real-time, and output signal of the distance Lₜᵢ and relative speed u_{c} between two vehicles and front vehicle or rear vehicle in real-time. Display and alarm module display detection distance information of between two vehicles in real time. Audible and visual alarming are realized by buzzer and LED. A threshold model is set by modeling parameters including distance Lₜᵢ from the vehicle to the front and rear vehicle and the anti-collision time zone tₐᵢ. When tₐᵢ reaches set threshold value, the anti-collision signal iₕ is sent out. The signal iₕ is divided into two routes, one way of signal iₕ enters acousto-optic alarm device, and other way of signal iₕ is put in data bus CAN of vehicle. The tire burst controllers that include main control, braking and driving controller obtains detection signals of relevant parameters Lₜᵢ, u_{c}, tₐᵢ and iₕ from data bus CAN in real-time.

(2). Environmental recognition. Environmental recognition which include recognition of road traffic state, object locating, location distribution of objects and locating distance of objects is used for driverless vehicle. The one of following identification methods or their combination is set.

i. Radar, Laser radar or ultrasonic ranging.

ii. Machine vision, positioning and ranging. The ordinary optical machines and infrared machines are used for distance detection of machine vision. The detection mode of monocular, multi-visual, color image and stereo vision are used. The feature signals are extracted quickly from captured images, and information processing of vision, image and video is completed by certain models and algorithms. The location and distribution of road, vehicles, obstacles and traffic conditions are determined to realize locating and navigation of vehicle, target recognition and path tracking of vehicle. Locating, navigation and path tracking of vehicle of driverless vehicle are determined by structuring and matching of satellite positioning, inertial navigation, electronic map, real-time map, dead reckoning, road state and running state of vehicle.

iii. Intelligent vehicle network of road traffic (IVNRT) is constructed. Road traffic information, surrounding environment information of vehicle, condition and information of running state among running vehicles are acquired and released by IVNRT, to realize communication among the vehicles and surrounding vehicles. A controller of IVNRT and a networked controller of vehicle are set up. Based on structure of intelligent vehicle network, the network and networked vehicles can communicate each other by wireless digital transmission and data processing module set by controller. Networked control of vehicle includes vehicle-borne wireless digital transmission and data processing control. It is set Submodules of digital receiving and transmitting, machine vision positioning and ranging, mobile communication, global satellite positioning navigation and navigation systems, wireless digital transmission and processing, environment and traffic data processing. Under normal and tire burst conditions, networked vehicles can realize wireless digital transmission and information exchange by intelligent vehicle network. Based on intelligent vehicle network and global positioning system, the lane line and orientation of vehicle, driving and running state of the vehicle, path tracking of the vehicle, the distance from the vehicle to other vehicles and obstacles, running states of the vehicle, front vehicle and rear vehicle of the central control system of driverless vehicle can be determined by means of geodetic coordinates, view coordinates and positioning map. These state information of the vehicle and peripheral vehicle include vehicle speed, relative vehicle speed, vehicle structure, driving or braking status of vehicle, tire burst and non-tire burst status of vehicle, tire burst control status, path tracking of the vehicle. First, for networked vehicles, the digital transmission module set by networked controller can obtain relevant datum of structural, running state parameter of the vehicle from the main controller of the driverless vehicle or driven by man vehicle, which includes the datum of state and control parameter of tire burst and process parameter of tire burst. These datum are processed by data processing module and are transmitted by data transmission module. The digital information of tire blowout vehicle is transmitted by mobile communication chip of data transmission module of the intelligent road traffic network. The relevant datum of tire burst vehicle are processed by intelligent vehicle network (IVNRT), then it are released to the surrounding networked vehicles by the network data module of IVNRT. Second. For networked vehicles, the digital transmission module set by controller receives traffic information of passing road by means of the network of networked vehicle, which includes information of traffic lights, signs and road condition, information of location, running status and control status of surrounding networked vehicles, related information of tire burst and tire burst control of vehicles, information of driving status, variation value of parameters and datum, during each detection and control cycle of tire burst vehicle. Third. The wireless digital transmission module set by controller of intelligent vehicle network of road traffic (IVNRT) may accept the request of information inquiry and navigation of vehicles. These request of information inquiry and navigation is processed by the data processing module of IVNRT, then it is fed back to the vehicle of making the request. Fourth, data transmission module set by networked vehicle can query relevant information of other networked vehicle passing through surrounding road with the wireless digital transmission module, so as to realize the wireless digital transmission and information exchange between the vehicle and vehicles of passing through the surrounding road, which include the running environment, road traffic and driving status information of vehicles.

8). Vehicle Tire Burst Control by Manual Key

Vehicle tire burst control use tire burst control by manual key. The control key adopts mode of multiple key position or/and many times key control in a certain period to determine set type of manual key position. The control key includes knob key and press key. Two key positions of “standby” and “off” of control key are set. Assigning values to the logic states U_{g} and U_{f} of the two key positions, the high and low level or the number can be used as identification of U_{g} and U_{f}. The master controller or the electronic control unit set by master controller can identify logic state, change of the logic or change of opening and closing of the two key position by data bus. When the key position of “standby” and “closing” changes, the logic state signals i_{g} and i_{f} are output. When vehicle control system is exerted by electricity, the tire burst controller of the system is reset or cleared to 0. The logic state of the RCC control key position U_{g} and U_{f} is determined by key position of “standby” or “off” of control key. When the key position is in the “off” state, the display lamp set in background of the key position will be on, until the manual operation of the knob or the key is implemented, to transfer it to the “standby” state of key position, thus the background display lamp will be off. During vehicle running, control key of RCC shall always be placed in the key position of “standby”. The mutual transfer of the two key positions is a compatibility control between active control of tire burst of the system and manual key operation control. The control logic of the manual key operation is taken as priority, and it covers the active control logic of the tire burst controller of the system.

9). Tire Burst Master Control Program or Software

(1). Computer control program or software.

According to tire burst control mode, model and algorithm, control structure, process and function, program language is used to programming. Datum are loaded. Analyzing and testing operation performance of programs, tire burst control main program and subprogram of brake, drive, steering, suspension, or/and path planning and path tracking of vehicle are prepared. Using programming by structuration, the program is constructed by three basic control structures which include sequence, condition and cycle. Program modular is formed by programing modularization, structured programming, planning and designing model. Defining functions and similar functions that are assembled in a single module. The program modular tested is integrated with other modular to form whole program organization of tire burst control. The program modules include tire burst control structure and function module.

(2). Master control program or software for tire burst of vehicle. According to control structure and process of tire burst master controller, a mode, model and algorithm of tire burst master control, a structured program design is adopted, to form tire burst master control programs or software which include program modules of tire burst information collecting and processing, parameters calculation, tire burst mode identification, tire burst judgment, tire burst control entering and exiting of tire burst control, control mode conversion, distance detection and environment identification, information communication and data transmission, tire burst direction determination, manual operation control, or/and networking control procedure of vehicle.

### 2. Tire Burst Brake Control

1). Tire Burst Brake Control and Controller

This method adopts the tire burst brake control with independent control characteristics. The tire burst brake covers chemical energy driven and electric driven vehicles, driven by man and driverless vehicles. The method set up tire burst brake control and controller.

(1). Control parameters and control variables of braking in process of vehicle tire burst. Under normal working conditions, the brake controller mainly provides balanced braking force to the whole vehicle. Therefore, the braking force Qᵢ for each wheel is acted as control variable, and the motion state of the vehicle is regulated by the braking force Qᵢ. Under the condition of tire burst, the control characteristic of vehicle changes. Based on unstable state of the vehicle, the tire burst brake controller regulates instability of the vehicle by means of differential braking to wheelset. Based on the purpose of tire burst braking control, tire burst braking controller uses parameters of wheel angle deceleration \dot{ω}ᵢ and slip rate Sᵢ as control variables, and adjust braking force Qᵢ of each wheel by using parameters of deceleration \dot{ω}ᵢ and slip rate Sᵢ, to control directly vehicle instability by changing of wheel state characteristics which is indicated by \dot{ω}ᵢ or Sᵢ. The \dot{ω}ᵢ and Sᵢ used for control variables is determined by the unbalanced braking control characteristics of tire burst stability control. Using \dot{ω}ᵢ and Sᵢ as control variables, the transfer chain of braking control is simplified, the dynamic response characteristic of braking of vehicle is improved, the transfer chain of braking control is shortened, the hysteretic response time of the whole vehicle state to braking wheel is reduced; the effect and influence of structural parameters of braking actuator to braking control characteristics are balanced or eliminated. In view of this, the wheel braking force sensor set in the braking actuator may not be adopted.

(2). Braking control mode and type

i. The determination of braking control period Hₕ for tire burst. According to state process of tire burst, requirement of braking control characteristic and response characteristic of braking actuator to control signal, the braking control period Hₕ is determined. The Hₕ is consistent with change of tire burst state process, and adapts to the control requirements of extreme change of tire burst state process, and meets the requirements of frequency response characteristics of electronically controlled hydraulic brake device or electronically controlled mechanical brake device. The Hₕ is a value set by controller, or is a dynamic value set by controller. The dynamic value of Hₕ is determined by mathematical model with the state parameters of wheel and vehicle. The mathematical mode of Hₕ include the Hₕ can be a function of tire pressure and its change rate. According to the requirements of anti-collision control for vehicle, the anti-collision control period Hₜ for vehicle is set. The values of Hₕ and Hₜ are the same or different. The braking control period Hₕ can be as period of logic cycle of braking control combination. Based on tire burst state, control stage and time zones tₐᵢ of anti-collision control for tire burst vehicle, the corresponding logic cycle of braking control combination is implemented based on the control cycle Hₕ. A mode or type of wheel steady braking A control, vehicle steady state C control, balanced braking B control of each wheel and total braking force D control of all wheel are adopted by related modeling parameter. These control mode is referred as braking A, B, C and D control modes. In each braking control period Hₕ, a group of braking A, C, B or D control and its logic cycle of combination control are executed. In each logic cycle of Hₕ, a control combination can be repeated, or can also be converted into another a control combination.

ii. Brake A. B, C, D independent control or its logical combination control. Based on vehicle motion equation of one or more freedom, vehicle longitudinal and lateral mechanics equation, vehicle yaw moment equation and wheel rotation equation, and tire model of wheel, it include:

Σₜ₌₁⁴Fₓᵢ=m\dot{u}ₓ [symbol] M=Σₗ₌₁⁴FₓᵢL [symbol] Fₓᵢ=f(Sᵢ,N_{zi},μᵢ,Rᵢ) [symbol] Jᵢ\dot{ω}ᵢFₓᵢRᵢ−Qᵢ

A relationship model between braking force Qᵢ and state parameters of angle acceleration, deceleration \dot{ω}ₜ, slip rate Sᵢ of each wheel is established. The quantitative relationship between the control variables Qᵢ and other control variables \dot{ω}ᵢ and Sᵢ is determined, to realize the conversion of the control variables from Qᵢ to \dot{ω}ᵢ or/and Sᵢ. The Fₓᵢ [symbol] \dot{u}ₓ [symbol] L and Jᵢ in the formulas is respectively wheel force exerted by the ground, the longitudinal acceleration of the vehicle, the distance from the wheel to mass center via longitudinal axis and the moment inertia of vehicle. In the independent control of A, B, C and D, or/and the control of their logical combination, the mathematical models of the relationship between one of control variables Sᵢ and parameters including αᵢ [symbol] N_{zi} [symbol] μᵢ [symbol] Gᵣᵢ Rᵢ are established under action of braking force Qᵢ of each wheel. The models include:

\dot{ω}ᵢ=f(Qᵢ,αᵢ,N_{zi},μᵢ,Rᵢ)

Sᵢ=f(Qᵢ,αᵢ,N_{zi},μᵢ,Gᵣᵢ,Rᵢ)

In the formulas, the αᵢ, N_{zi}, μᵢ, Gᵣᵢ and Rᵢ is respectively sideslip angle, load, friction coefficient, stiffness of wheel and effective rotation radius of wheel. Other letters have same meaning as those mentioned above. Based on vehicle motion equation of one or more freedom, vehicle longitudinal and lateral mechanics equation, vehicle yaw moment equation, wheel rotation equation and tire model of wheel, the logic combination of brake A, C, B or/and D control model are determined, according to state process of wheel tire burst and wheel stability, vehicle stability and vehicle attitude, or/and real-time change point and change value of relating parameters. Under certain state conditions of tire burst, the combination rules of control logic are as follows. Rule 1. The logic relationship of logical sum to two kinds of control model or type. The logic relationship is represented by sign “∪”. For example, BUC denotes simultaneous execution to two control types which include braking B and C control. BUC is algebraic sum of two control values B and C. The rule of logic combination is unconditional logic combination. If there is not substitution of other control logic, the logic control state will be maintained. Rule 2. The logic relationship of substitution and control conflict each other between two kinds of control model or type. The logical combination based on the rules is conditional logic combination. The logic relationship of substitution is represented by the logical symbol “⊂”. The right side control model or type can be replaced by the left side control model. The one of conditions is that control model or type on the right side takes precedence. For example, A⊂B denotes that B can be replaced by A under certain conditions. Namely, the left side control model or type can cove the control model or type of right side. The A⊂C logic for a wheel control is expressed as follows: first, C control is executed, and then A control is executed. When the control condition of A is reached, C control is changed to A control, or A control replaces C control. According to change point of normal condition, tire burst condition and control periods, or when the change value of brake control reaches a certain condition or threshold value, the substitution or conversion of logic combination control is realized or is completed at real-time. Rule 3. The logical relation of conditional sequential execution of each logic and logic combination. The logical relation is expressed by sign “←”. Whether the right side control is completed or not, when the set conditions are met, the left side control or control logic combination is executed on the direction of arrow. The symbol “←” expresses conditional control execution order of the upper and lower or equal logical relation. In upper and lower position logical relations, the logical combination of A, C, or/and B control is represented by symbol (E), the control form includes D←(E). The D←(E) indicates that D control can be implemented only under certain conditions of which logical combination of (E), namely logical combination of A control and C control has be completed. The one of representations of allelic logical relations includes N←(B); the N represents A control, C control and their combination control types in allelic logical relations. For example, control logic combination B←A∪C shows that B control can be executed only when certain conditions are reached, regardless of whether A∪C has been executed or not. The logic combination stipulates that the control quantity of unselected control type is 0. The form of logic combination include a single control type of A, C or B, and also includes A∪C [symbol] C∪A, D←A∪C [symbol] D←(E) type or mode. The control logic conversion is realized when the corresponding converting signals of tire burst brake control arrives.

iii. The controlling object of brake A control is all wheels. Brake A control includes anti-lock control of non-burst tire wheel and steady-state control of tire burst wheel. The steady-state of tire burst wheel control adopts two modes of releasing brake force or decreasing brake force of tire burst wheel. In the mode of decreasing brake force, the angle deceleration \dot{ω}ᵢ or/and slip rate Sᵢ are taken as control variables, and braking force Qᵢ is taken as parameter variables. The values of control variable \dot{ω}ᵢ or/and Sᵢ of burst tire wheel are reduced by equal or unequal amount and step by step, until the braking force is relieved. Brake force of burst tire wheel is adjusted indirectly.

iv. The controlling object of brake B control is all wheels. The balance braking forces of each wheel are involved in the longitudinal control (DEB) of wheels. Defining of balanced wheelset: each tire force exited by ground on the two wheel of the wheelset to torque of center mass of vehicle is opposite in direction. Balancing wheelset include burst tire and non-burst tire balancing wheel pairs. Defining concept of balance distribution and control of control variables for brake B control: using angle acceleration and deceleration speed \dot{ω}ᵢ and slip rate Sᵢ of each wheel as control variables, theoretically, the torque sum of each tire force to the center mass of vehicle is zero in the distribution of \dot{ω}ᵢ and Sᵢ of each wheel. The brake B control adopts balancing distribution and control form to two-wheel braking force of wheelset. One of comprehensive control variables \dot{ω}_{b}, S_{b} and Q_{fc} is distributed between two axles by mathematical model with one of state parameters \dot{ω}ᵢ, Sᵢ of two-wheel and load of front and rear axles. The control variables \dot{ω}ᵢ and Sᵢ of two-wheel to front and rear axles are allocated according to the equal or equivalent model. Among them, the values of comprehensive control variables \dot{ω}_{b}, S_{b} and Q_{fc} are determined by average or weighted average algorithm of values of \dot{ω}ᵢ, Sᵢ of each wheel.

v. The control object of tire burst braking C control is all wheels. The braking C control involves a most dangerous and most difficult control to tire burst under running states of straight line and steering of vehicle. The brake C control is based on state process for tire burst. The additional yaw moment Mᵤ produced by unbalanced braking moment of differential braking of wheelset are used for balancing yaw moment Mᵤ of tire burst, to control insufficient or excessive steering of vehicle in tire burst. The distribution of additional yaw moment Mᵤ to wheels adopts the parameter forms of angle deceleration \dot{ω}ᵢ, slip rate Sᵢ or braking force Qᵢ of each wheel. The distribution of additional yaw moment Mᵤ of control variable \dot{ω}ᵢ and Sᵢ have better control characteristics than the characteristics of parameter Qᵢ. The control mode of braking C control is as follows.

First, stability control of tire burst yaw moment and additional yaw moment of vehicle. Longitudinal tire force is generated by differential braking force of each wheel of the vehicle. The additional yaw moment Mᵤ is formed by moment of tire force to vehicle mass center. The tire burst yaw moment Mᵤ′ is balanced with additional yaw moment Mᵤ which can restores stable running state of the vehicle, to realize stability control of vehicle. Brake C control is based on dynamics equations of wheel and vehicle in straight running and steering of vehicle. Under normal and tire burst conditions, the stability control modes, models and algorithms of vehicle are established by modeling parameters which include motion, steering mechanics of wheel and motion state parameters of vehicle; models and ways of theoretical, experimental or empirical modeling are used. Or analytical formulas of mathematics are transformed into state space expressions. Under normal and tire burst conditions, the ideal and actual values of vehicle yaw angle velocity ωᵣ, sideslip angle β, longitudinal deceleration aₓ or/and lateral acceleration a_{y} of yaw control model for vehicle braking are determined by vehicle model and parameter values of sensor detection. The deviation between the ideal and actual values of the parameters is defined:

e_{ω}_{ᵣ}(t)=ωᵣ₁−ωᵣ₂ [symbol] e_{β}(t)=β₁−β₂

Under condition of tire burst, the additional yaw moment Mᵤ of brake C control takes e_{ω}_{ᵣ}(t) and e_{β}(t) as the main variables, and takes uₓ [symbol] aₓ [symbol] a_{y} as parametric variable. A mathematical model of additional yaw moment Mᵤ for tire burst is established:

Mᵤ(Pᵣₐ,uₓ,δ,e_{ω}_{ᵣ}(t),e_{β}(t),e(ωₑ),e(\dot{ω}ₑ),aₓ,a_{y},μᵢ)

In the model, the Pᵣₐ is tire pressure, the uₓ is vehicle speed, the δ is rotation angle of steering wheel, the e(ωₑ) and (\dot{ω}ₑ) are equivalent relative angle velocity deviation, angle acceleration or deceleration deviation of two wheels of balance wheelset, the aₓ and a_{y} are longitudinal and lateral acceleration of vehicle and the μᵢ is the friction coefficient. The tire pressure Pᵣₐ or the equivalent relative slip rate deviation e(Sₑ) can be interchanged with equivalent relative angle deceleration deviation e(\dot{ω}ₑ). On this basis, the basic formula of the optimal additional yaw moment Mᵤ includes:

Mᵤ=−k₁(e(ωₑ),e(\dot{ω}ₑ))e_{ω}_{ᵣ}(t)−k₂(e(ωₑ),e(\dot{ω}ₑ))e_{β}(f) or

Mᵤ=−k₁(Pᵣ)e_{ω}_{ᵣ}(t)−k₂(Pᵣ)e_{β}(t)

In the formula, k₁(e(ωₑ), e(\dot{ω}ₑ)) or/and k₂(e(ωₑ), e(\dot{ω}ₑ)), k₁(Pᵣ) or/and k₂(Pᵣ) are the feedback variables or parameter variables of tire burst state of vehicle, in which e(Sₑ) can be interchanged with e(\dot{ω}ₑ). In view of the control coupling between the yaw angle speed ωᵣ and the centroid sideslip angle β of vehicle, it is difficult to achieve ideal yaw angle speed ωᵣ and ideal centroid sideslip angle β at the same time. The optimal additional yaw moment Mᵤ can be determined by using control algorithm of modern control theory. One of the algorithms is to design an infinite time state observer based on LQR theory, to determine the optimal additional yaw moment Mᵤ. When equivalent model and algorithm are used, the modified model, model and algorithm of additional yaw moment Mᵤ, which include parameter feedback correction, time lag correction, tire burst impact correction, separation correction of wheel and rim, touchdown correction of rim, clamping correction and tire burst comprehensive modified mode, are adopted.

Second. A vehicle stability control model is established by modeling parameters of yaw angle velocity deviation e_{ω}_{ᵣ}(t), sideslip angle deviation e_{β}(t) of vehicle quality center, equivalent relative angle velocity deviation e(ωₑ) of tire burst wheel, longitudinal deceleration aₓ and lateral acceleration and deceleration a_{y} of vehicle, to determine distribution model of additional yaw moment Mᵤ to wheels. Defining concept of yaw control wheel: the wheel which can generate additional yaw moment Mᵤ by longitudinal differential braking of wheelset is called yaw control wheel. The additional yaw moment Mᵤ determined by tire force of yaw control wheel is a function of parameters which include angle acceleration and deceleration \dot{ω}ᵢ, slip Sᵢ, ground friction coefficient μᵢ and wheel load N_{zi}. Using parameter \dot{ω}ᵢ or Sᵢ as equivalent or equivalent form of parameter Qᵢ, the torque produced by longitudinal tire force of wheel to vehicle mass center is determined under differential braking force Qᵢ. The danger degree and control difficulty caused by tire burst in steering of vehicle are very high. Under tire burst condition, the longitudinal slip rate Sᵢ and adhesion state caused by differential braking of yaw control wheel are changed, and the lateral adhesion coefficient of front and rear axles are changed, and lateral tire force and the lateral sideslip angle of wheel are changed, and steering characteristics of vehicle are changed, to result reemergence of vehicle understeer or oversteer caused by braking in vehicle steering process. A special mode and model of distribution and control of the additional yaw moment Mᵤ to wheels, which is called brake in steering model, is adopted by the yaw control wheel in steering process. In braking process, the additional yaw moment Mᵤ includes additional yaw moment Mᵤᵣ produced by longitudinal braking of wheels and additional yaw moment Mₙ produced by braking in steering. The Mᵤᵣ is abbreviated as the additional yaw moment of longitudinal braking. The wheels of which produces Mᵤᵣ are called yaw control wheels. The wheel of which get a larger value of Mᵤᵣ in several yaw control wheels is known as efficiency yaw control wheel. The Mₙ is called additional yaw moment of steering in braking process. The Mₙ is a kind of yaw moment which is different from Mᵤᵣ. Producing of yaw moment Mₙ relates to the change of lateral adhesion state or coefficient adhesion caused by the slip rate change of wheels of front and rear axle under longitudinal braking force of vehicle. During the process of steering of vehicle and braking of wheel in same time, the longitudinal slip rate of wheels, the lateral adhesion coefficient of wheels, the adhesion state of wheels and the lateral tire force of the front and rear axles are changed, to cause producing of a yaw moment Mₙ. The Mₙ is formed under conditions produced by a deviation of yaw moment of front and rear axles to mass center of the vehicle. Under the action of yaw moment Mₙ, the wheels sideslip angle of front and rear axle to the longitudinal axis of vehicle mass center are changed, to result producing of another new insufficient or excessive steering of the vehicle. Under the action of longitudinal braking force, the yaw moment Mₙ is determined by the mathematical model with modeling parameters of the side slip angle deviation of wheels to front and rear axle. The Mₙ is an incremental function with increment of yaw moment deviation of front and rear axles to vehicle mass center. The direction of Mₙ is same or opposite to direction of Mᵤ. Additional yaw moment Mᵤ of vehicle is vector sum of additional yaw moment Mᵤᵣ produced by wheel longitudinal braking and additional yaw moment Mₙ produced by braking in vehicle steering process.

Mᵤ=Mᵤᵣ+Mₙ

The direction of Mₙ and Mᵤᵣ, namely, rotation direction of left or right-handed of vehicle, is represented by mathematical symbols “+” or “−”. When the direction of Mₙ is same as direction of Mᵤᵣ, the maximum value of Mᵤ is obtained, that is, under condition of additional yaw moment Mᵤᵣ produced by the minimum longitudinal differential braking force, the Mᵤ can balance with the tire burst yaw moment Mᵤ′. Under the combined action of Mᵤᵣ and Mₙ, the vehicle stability control has a better longitudinal and lateral dynamic characteristics which including slip state and attachment state of wheel, longitudinal and transverse tire force of wheel, yaw characteristics and frequency response characteristics of wheel. When yaw control wheel is efficiency yaw control wheel at the same time, tire burst vehicle can obtain the maximum efficiency yaw moment Mᵤᵣ which can realize the stability control under condition exerted by the minimum differential braking force to two wheels.

Third, distribution of each wheel of additional yaw moment Mᵤ that restores vehicle stability. The vehicle of symmetrical distribution of four wheels is referred to as four-wheeled vehicle. The rotation direction of yaw control wheel, efficiency yaw control wheel and yaw moment Mₙ can be determined by position of where the tire burst wheel located in the front, rear, left or right of vehicle, and direction of rotation angle of steering wheel, positive or/and negative of yaw angle velocity deviation of vehicle and insufficiency and excessive steering of vehicle. Selection of yaw control wheels. Mode 1: the wheels of which opposite side to tire burst wheel location of vehicle is yaw control wheels. Mode 2: the direction of additional yaw moment Mᵤ can be determined by positive (+) and negative (−) of yaw angle velocity deviation; from this, yaw control wheels can be determined by the direction of the Mᵤ. Mode 3: according to model and definition of efficiency additional yaw moment, and based on direction judgment of yaw moment Mₙ or judgment of positive and negative value of yaw moment Mₙ, under condition of which yaw control wheels are exerted same braking force, the wheel that higher value of additional yaw moment Mᵤ can be obtained in yaw control is efficiency yaw control wheel. For vehicle of four-wheel symmetric distribution, the number of yaw control wheels is two; it includes wheels which are located in opposite to side of the tire burst wheel. In the steering process, the outer side wheels of vehicle are yaw control wheel while the inner wheel get tire burst; the inner wheels of vehicle are the yaw control wheels while the outer side wheels get tire burst. The non-yaw control wheel includes one tire burst wheel and one wheel which can produce yaw moment of same direction as the tire burst yaw moment Mᵤ′ under differential braking.

Fourth. Distribution model of the additional yaw moment Mᵤ to wheels adopts single-wheel, two-wheel or three-wheel model. Single wheel model. In straight line running state of vehicle, Mᵤₖ equals Mᵤ, and Mₙ equals 0. In two wheels of yaw control, wheel bear by larger load is selected as the efficient yaw control wheel, because the diameter of tire burst wheel reduces and the load of each wheel redistributes for tire burst vehicle. Under the condition of braking of tire burst wheel in process steering, steering and braking control model of vehicle is adopted: Mᵤ=Mᵤᵣ+Mₙ. Under condition of which direction of Mᵤᵣ and Mₙ of vehicle is same, the wheel bear by larger load is efficiency yaw control wheel. Two-wheel model. In straight line running state of vehicle, The Mᵤₖ equals Mᵤ, and the Mₙ equals 0. The coordinated distribution model of two yaw control wheels is used, to determine distribution ratio of two yaw control wheel. A distribution model with modeling parameters of wheel load and rotation angle of steering wheels is established, according to weight ratio of two wheel loads. Under the condition of tire burst braking in steering, one of the front axle and rear axle is steering axle, and one of two yaw control wheels must be steering wheel. Based on allocation model of additional yaw moment Mᵤ to wheels: Mᵤ=Mᵤᵣ+Mₙ. Under condition of which direction of additional yaw moment Mᵤ including Mᵤᵣ and Mₙ is determined, a coordinated distribution model of two yaw control wheels is established by modeling parameters which include Mᵤᵣ and Mₙ, longitudinal and lateral adhesion coefficient or friction coefficient of braking and steering wheels, the load M_{zi} and load transfer amount ΔM_{zi}, rotation angle δ of steering wheel or rotation angle θₑ of directive wheel, Longitudinal brake slip rate Sᵢ of two yaw-controlled wheels, side-slip angle of wheels during braking in steering, or lateral adhesion coefficient of wheels. According to a theoretical or empirical model of friction circle, a coordinated distribution model of two yaw control wheels is established by the longitudinal and transverse adhesion coefficient or friction coefficient of wheel during braking and in steering process. Based on the coordinated allocation model, the efficiency yaw control wheels and distribution of additional yaw moment Mᵤ between two yaw control wheels is determined. Based on the braking friction circle model, a series of ideal values or limit values of longitudinal braking slip rate and side slip angle of yaw control wheels are determined by brake slip rate Sᵢ, steering wheel angle δ or directive wheel angle θₑ in steering and braking status process. Under the condition of keeping stable state of vehicle steering and braking wheels, yaw control wheels and distribution of additional yaw moment Mᵤ between yaw control wheels are determined. Three wheel model. The three wheels are composed of two yaw control wheels and one non yaw control wheel. The distribution of additional yaw moment Mᵤ of the two yaw control wheels are modeled according to the above two wheel model. According to the two wheel model, vehicle stability control under the condition of straight and steering of vehicle is realized. When braking force is exerted to no yaw control wheel, additional yaw moment Mᵤ is determined by the sum of the yaw moment vectors of two yaw control wheels and one non yaw control wheel. One yaw control wheel and one non yaw control wheel can form a balanced wheelset, and the distributed braking force of two yaw control wheels of the balance wheelset is equal or unequal. Under brake control state of the straight line running and steering of tire burst vehicle, and when the balanced wheelset is a no tire burst wheelset, whether it is a steering wheelset or not, logic combination of C∪B of B control of balanced braking of wheels and C control of vehicle steady state can be used by the balance wheelset. Under the condition of priority to meet the vehicle stability braking C control, the three wheel model can achieve the maximum braking force and the braking force of the burst braking C control is reduced. In the additional yaw moment Mᵤ generated by the burst braking C control, the additional yaw moment M_{b}′ for tire burst is balanced by additional yaw moment Mᵤᵣ generated by vehicle longitudinal braking, and it may compensate understeer or oversteer of vehicle by resulting of yaw moment Mₙ.

vi. Total braking force D control for tire burst. The D control is used to control movement state expressed by deceleration \dot{u}ₓ of tire burst vehicle and comprehensive angle deceleration \dot{ω}_{d} of wheels. The braking D control uses one of deceleration \dot{u}ₓ of vehicle, comprehensive angle deceleration \dot{ω}_{d}, comprehensive slip rate S_{d} and comprehensive braking force of wheel as control variables. The values of \dot{ω}_{d}, S_{d} and Q_{d} are determined by average or weighted average algorithm of \dot{ω}ᵢ, Sᵢ and Qᵢ of each wheel. The D control adopts forward or reverse direction control modes in transferring direction of control variable. In the forward mode, the target control values of \dot{ω}_{d} or S_{d} of each parameter form \dot{ω}ᵢ, Sᵢ for total braking force D control are determined by the vehicle deceleration \dot{u}ₓ; one value of the parameters of \dot{ω}ᵢ [symbol] Sᵢ and Qᵢ is allocated to each wheel, and the control logic combination may adopt (E)←D←\dot{u}ₓ. In reverse mode, one of the parameters of angle deceleration \dot{ω}ᵢ, slip rate Sᵢ and braking force Qᵢ is used as control variables, and the target control values or actual values of control values \dot{ω}_{dg} or S_{dg} of \dot{ω}ᵢ or Sᵢ for braking A, B and C control is determined. The control logic combination of \dot{u}ₓ←D←(E) is used, where E represents the logical combination of A, B and C control.

(3). Braking control for vehicle tire burst

i. Tire burst braking control adopts hierarchical coordinated control form. The upper level is the coordinated level and the lower level is the control level. The upper level determines control mode, model and logical combination of A, C, B and D control in the each braking control period Hₕ of logic cycle, as well as transformation rules and period Hₕ of each logical combination. The lower level of the control completes a sampling of relevant parameter signals of braking A, C, B, D control and their combination control once in each period Hₕ, and completes datum processing, according to braking A, C, B, D control types and their logical combination, control model and algorithm. In the each braking control period Hₕ, tire burst controller outputs control signals, to implement once allocation and adjustment of angle deceleration \dot{ω}ᵢ or slip rate Sᵢ of vehicle.

ii. In braking control, tire burst control adopts one of two modes when wheels enter steady-state control A. Mode 1. After completing a braking control mode, model and logic combination of this period Hₕ, it enters a braking control of a new cycle Hₕ₊₁. Mode 2. The braking control in this period Hₕ is terminated immediately, and it enters a new control cycle Hₕ₊₁ at the same time. In a new period, it adopted to control mode and model of anti-lock braking A control for non-burst tire wheels under normal conditions, or it adopted to steady-state braking A control for burst tire wheels under tire burst conditions; the original control logic combination of braking C, B and D control for burst tire wheels can be maintained, or a new control logic combination is adopted.

iii. A control mode, model and control logic combination are used, according to state process of tire burst, real-time change points and change values of the control parameters to wheel stability, vehicle stability, attitude or collision avoidance of vehicle as well as different stages or control times of tire burst braking control, a corresponding control mode, model and control logic combination are adopted. A stable deceleration and stability control of vehicle are achieved by logical cycle of control period Hₕ. In brake A, C, B and D control independently or its logic combination control, it may be established to relational models between deceleration \dot{ω}ᵢ and slip rate Sᵢ, or between braking force Qᵢ and state parameters \dot{ω}ᵢ [symbol] Sᵢ of wheel, based on motion equation of multi freedoms for vehicle, longitudinal and lateral mechanical equation of vehicle, yaw control model of vehicle, the rotation equation of wheel and tire burst model. The quantitative relationship between control variables \dot{ω}ᵢ and Sᵢ or between Sᵢ and Qᵢ can be determined, to realize conversion of the control variables.

iv. In the braking A, C, B and D independent control of or their logical combination control, if necessary, some relevant mathematical models between control variables including \dot{ω}ᵢ and Sᵢ and parameter variables including αᵢ [symbol] N_{zi} [symbol] Gᵣᵢ [symbol] Rᵢ are established under condition of which wheels are exerted by braking force Qᵢ. The relationship models or its equivalent models is used to determine function and influence of each parameter variable to its control variable. Among them, the αᵢ, N_{zi}, μᵢ, Gᵣᵢ and Rᵢ are wheel sideslip angle, wheel load, ground friction coefficient, stiffness and effective rotation radius of wheel. In the logic cycle of control period Hₕ of braking A, C, B and D control, the parameter Δωᵢ is equivalent to the parameter \dot{ω}ᵢ when the control period Hₕ is small. A mathematical model and algorithm of tire burst braking control are established by control variables which includes parameters \dot{u}ₓ, \dot{ω}ᵢ and Sᵢ. In the logic cycle of control period Hₕ, the target control values and the allocation values of one of control variables \dot{u}ₓ, \dot{ω}ᵢ and Sᵢ are determined by braking A, C, B or D control types and its logic combination in braking A, C, or B control. Where target control value of wheel comprehensive angle deceleration \dot{ω}_{d}, comprehensive slip rate S_{d} in braking D control are determined by target control value of parameter \dot{ω}ᵢ or Sᵢ of braking A, C, or B control of wheels.

(4). The specific control mode adopted in tire burst braking control obviously improves the performance and quality of the control which include various dynamic characteristics, frequency response characteristics, control chain and control effect of the braking control, to adapt Independent braking control or collision avoidance coordinated control for abnormal state of vehicle under normal working, whole state process of control periods of low tire pressure, real tire burst, inflection point of tire burst, separation of tire and rim and. Angle deceleration \dot{ω}ᵢ, slip rate Sᵢ of wheel and speed change rate \dot{u}ₓ of vehicle are taken as control variables in process of tire burst braking control. Through logical combination of braking A, C, B and D control types and their logic cycle of period Hₕ, it is realized to steady state control of wheel, posture and stability control of vehicle which are consistent with the state process of tire burst, and the control objectives of longitudinal and yaw of tire burst vehicle is achieved, under the conditions about which the effective rolling radius, adhesion coefficient and load of tire burst wheel change sharply and deteriorates instantaneously of vehicle motion state. The tire burst braking control uses a control mode coordinated with controls of electronic throttle of engine, fuel injection and tire burst steering, or with output control of electric power vehicle. The tire burst braking control uses a control mode coordinated with steering of vehicle. A brake control of engine idling may be adopted in period from the arriving of tire burst control entering signal iₐ to starting of tire burst braking control; brake control of engine idling exits according to the set conditions. The tire burst brake control uses many ways of exiting; when the tire burst brake control exit signal i_{b} arrives, the brake control of engine idling exit. For the vehicle driven by man or the driverless vehicle with the auxiliary manual operation interface, the exiting of tire burst brake control is realized by control of driving pedal. For vehicle of driverless vehicle, tire burst brake control exit when central master computer sends out the exiting command of tire burst brake control; tire burst brake control exit according to vehicle anti-collision coordination control requirements.

2). Idling Brake Control, Brake Compatibility Control and Controller for Tire Burst Engine

Braking of tire burst vehicle adopts braking control of engine idle or/and braking compatibility control. Braking control of idle engine can be started-up in control period from early stage of tire burst control to the real burst time. The braking compatibility controls can be used as vehicles driven by man or driverless vehicle with manual assistant braking operation device, the former is referred to braking control of artificial compatibility, and the latter is referred to braking control of automatic compatibility. On the basis of environmental identification of tire burst vehicle, the compatible control of manual braking adopts self-adaptive control mode of tire burst braking. The braking process of tire burs vehicle is characterized by the parameters which include the comprehensive angle deceleration \dot{ω}_{d} or comprehensive slip rate S_{d} of wheels. The tire burst state is characterized by tire burst characteristic parameter γ. The comprehensive angle deceleration \dot{ω}_{d} and comprehensive slip rate S_{d} are determined by average algorithm or weighted average algorithm of parameter \dot{ω}ᵢ or Sᵢ for wheels.

(1). Engine idle brake control and controller

The vehicle set or not set the engine idle brake controller. According to tire burst state process, vehicle with the controller can enter idle brake control of the fuel engine in the early stage of tire burst control, or in any time before the actual tire burst time. The engine idle brake control adopts dynamic mode. In the process of engine idle brake, engine injection quantity of fuel oil is zero, that is, fuel injection quantity of engine is stopped. The idle braking force of engine is determined by model of opening of throttle control. The idle braking force of engine is an increasing function with the opening increment of throttle. A threshold value of engine idle braking is set. When the engine running speed reaches the threshold value, the engine idle braking is stopped. The threshold value is greater than the idling brake set value of engine. Specific exiting modes of brake control of engine is set by following. When the tire burst signal i_{b} arrives, or vehicle enters the collision risk time zone (tₐ) of vehicle, or yaw angle rate deviation e_{ω}_{ᵣ}(t) of vehicle is greater than the set threshold value, or equivalent relative angle speed deviation e(ωₑ) or the angle deceleration e(\dot{ω}ₑ) deviation or slip rate deviation e(Sₑ) of driving axle wheelset reaches the set value or the threshold value is achieved, Namely, one or more of the above conditions is met, the engine idling brake exits. Before starting of the tire burst brake control, the engine brake control can be carried out, to adapt control of abnormal state of the vehicle during the time of overlap and interim between normal and tire burst conditions.

(2). Brake compatibility control of vehicle tire burst. According to separate or parallel operation state of tire burst active brake and pedal brake of vehicle, a compatibility mode of tire burst active brake control and anti-collision coordinated control of vehicle driven by fuel oil engine or electric engine is established, so as to solve the control conflict when the two control kinds of brake are operated in parallel. When two control kinds of the active brake and the pedal brake are operated separately, the two control does not conflict. The brake compatibility controller does not process compatibly to the input parameter signals of each control; output signal of brake control of the brake compatibility controller is not processed compatibly. When the tire burst active brake and the pedal brake, which hereinafter referred to as the two types of brake, are operated in parallel, the target control values of control variable including comprehensive angle deceleration \dot{ω}_{d}′ or comprehensive slip rate S_{d}′ of each wheel are determined by relationship models of \dot{ω}_{d}′ and S_{w}′, Q_{d}′ and S_{w}′, S_{d}′ and under certain braking force, among, the S_{w}′ is displacement of the brake pedal. The deviation e_{Qd}(t), e_{\dot{ω}d}(t) or e_{Sd}(t) between the target control value of active braking force Q_{d}, angle deceleration \dot{ω}_{d} or slip rate S_{d} and their actual values Q_{d}′, \dot{ω}_{d}′, S_{d}′ are defined:

e_{Sd}(t)=S_{d}−S_{d}′,e_{\dot{ω}d}(t)=\dot{ω}_{d}−\dot{ω}_{d}′

The control logic of brake compatibility is determined according to the positive (+) and negative (−) of deviation When the deviation is greater than zero, the comprehensive braking force Q_{da}, comprehensive slip rate S_{da} and comprehensive angle deceleration ω_{da} which are output by the brake compatibility controller are equal to its input values Q_{d} [symbol] S_{d} [symbol] ω_{d}. When the deviation is less than zero, one of the input parameters Q_{d}′, ω_{d}′, S_{d}′ is processed by the brake compatibility controller according to brake compatibility control model. A brake compatible function model is established by modeling parameters that include tire burst characteristic parameter γ, active braking force deviation e_{Qd}(t), angle deceleration deviation e_{ωd}(t) and the slip rate deviation e_{Sd}(t) in the positive and negative stroke of the brake pedal of braking system:

S_{da}=f(e_{Sd}(t),γ) [symbol] \dot{ω}_{da}=f(e(\dot{ω}ₑ),γ)

According to the model, brake compatibility controller processes to input parameter signals, from this, the output value of brake control is the output value processed by brake compatible controller. The modeling structure of the function model for brake compatibility control: the Q_{da} [symbol] ω_{da} and S_{da} are respectively increasing function of absolute value increment of deviation e_{Qd}(t), e_{\dot{ω}d}(t) or e_{Sd}(t) in positive stroke, and are respectively decreasing function with absolute value decrement of deviation e_{Qd}(t), e_{\dot{ω}d}(t) or e_{Sd}(t) in negative stroke. The asymmetric brake compatibility model is represented as: in the positive and negative stroke of the brake plate, the model has different structures; the deviation e_{Qd}(t), e_{Sd}(t), e_{\dot{ω}d}(t) and the weight of the tire burst characteristic parameter γ in the positive stroke of the brake pedal is less than those in the negative stroke of the brake pedal, and the function value of the parameter in the positive stroke of the brake pedal is less than those of the parameter in the negative stroke of the brake pedal:

$$\vert \frac{f ( + {e}_{\dot{ω} d} ( t ) , + γ )}{f ( - {e}_{\dot{ω} d} ( t ) ) , - {γ}^{′} )} \vert < 1 , \vert \frac{f ( + {e}_{Sd} ( t ) , + γ )}{f ( - {e}_{Sd} ( t ) , - γ )} \vert < 1$$

According to the characteristics of the tire burst state, braking control period and anti-collision time zone, a mathematical model of the tire burst characteristic parameter γ used brake compatibility control is established by modeling parameters which include ideal and actual yaw angle velocity deviation e_{ω}_{ᵣ}(t), the equivalent or non-equivalent relative angle speed deviation e(ωₑ) or e(ωₖ), angle deceleration speed deviation e(\dot{ω}ₑ), e(\dot{ω}ₖ) and the time zone tₐᵢ of tire burst:

γ=f(tₐᵢ,e_{ω}_{ᵣ}(t),e(ωₑ),e(\dot{ω}ₑ))

The modeling structure of the tire burst characteristic parameter γ is determined: the parameter γ is a increasing function of increment to absolute value of e_{ω}_{ᵣ}(t) [symbol] e(ωₑ) [symbol] e(\dot{ω}ₑ), and the parameter γ is a increasing function of decrement to parameter tₐᵢ. The modeling structure of the brake compatibility control: the Q_{da} [symbol] ω_{da} and S_{da} respectively are the decreasing function with increment of γ. Based on the model, self-adaptive coordinated control by man and machine for parallel operating of pedal braking of brake system and the active braking of vehicle tire burst can be determined by the control variables Q_{da} and S_{da}. After processing of brake compatibility, the control logic of wheel steady-state braking (A), balance braking (B), vehicle steady-state braking (C) and total braking force (D) control and their control logic combination are determined, in which the control logic combination includes A⊂B∪C←D [symbol] C⊂B∪A A⊂C←D, C⊂A←D. The brake compatibility controller adopts closed-loop control. When the deviation e_{Qd} (t), e_{Sd} (t) or e_{\dot{ω}d}(t) is negative, the input parameter signals of Q_{d}, S_{d}, or/and \dot{ω}_{d} of brake compatibility controller are processed compatibly by braking compatibility model with brake compatibility deviation e_{Qd}(t), e_{Sd}(t), e_{\dot{ω}d}(t) and parameter γ. After the brake compatibility treatment, the brake force distribution and brake force adjustment of each wheel are carried by the braking B control and braking C control, so that, the actual value of the active brake control for tire burst always tracks its target control value. After the brake compatibility treatment, the output value of active brake control for tire burst is its target control value Q_{da} or S_{da}, that is, the compatibility control of brake is a control of zero deviation. In early stage of tire burst and anti-collision safety time zone of the vehicle and rear vehicles, the value of parameter γ can be zero, thus the vehicle can adopt brake control logic combination A⊂B∪C. In real tire burst time or/and risk time for safety of anti-collision, brake control logic combination of A⊂C or C⊂A is adopted. Along with deterioration of tire burst state of the vehicle, or when the front vehicle and rear vehicles for tire burst enter the forbidden time zone for anti-collision, the brake control of tire burst wheel will be changed from steady state brake control to release of braking force of tire burst wheel. During logic cycle of period Hₕ of brake control, except the tire burst wheel, the differential braking force of steady-state brake C control of wheels are increased. By means of the coordination control between the actual value of each control variable Q_{da} [symbol] ω_{da} or S_{da} and the characteristic parameter value γ for vehicle tire burst, the target control value of Q_{da} [symbol] ω_{da} or S_{da} is reduced, until the target control value of control variable Q_{d}′ [symbol] \dot{ω}_{d}′ or S_{d}′ of the vehicle pedal braking is less than the target control value of control variable Q_{d} [symbol] ω_{d} or S_{d} of the tire burst active brake, to realize a compatible self-adaption control of artificial pedal brake and active brake of tire burst.

(3). Compatible control of active braking and collision avoidance coordinated braking for tire burst of driverless vehicle. Based on environment identification of tire burst vehicle, the compatibility control mode of the active brake and the anti-collision brake of driverless vehicle to tire burst vehicle is established by one of modeling parameters which include total amount of braking force Q_{d1}, comprehensive angle deceleration \dot{ω}_{d1} of wheel and deceleration speed \dot{u}ₓ₁ of vehicle, and by one of modeling parameters including corresponding total amount of braking force Q_{d2}, comprehensive angle deceleration \dot{ω}_{d2} and comprehensive slip rate S_{d2} of wheel. According to separate or parallel operation state of two types of braking anti-collision and active brake of tire burst vehicle, a brake operation compatibility mode is used, to solve control conflict of two kinds of brake parallel operation. First, when the tire burst active braking or collision avoidance braking is carried separately, the operation of brake control of the two types does not conflict, and the control of tire burst active brake or anti-collision active brake can be carried independently. Second, in case of parallel operation of two types of braking, the braking compatibility control is determined by the following braking compatibility modes, according to the anti-collision coordination control mode and model. The brake compatibility controller takes one of parameters of the above two braking types as modeling parameter, to define the deviation e_{qd}(t), e_{Sd}(t) e_{\dot{ω}d}(t) between the active braking parameters Q_{d1} [symbol] \dot{ω}_{d1} [symbol] S_{d1} and the coordinated braking parameters Q_{d2} [symbol] ω_{d2} [symbol] S_{d2} of anti-collision for tire burst:

e_{qd}(t)=Q_{d1}−Q_{d2},e_{Sd}(t)=S_{d1}−S_{d2} [symbol] e_{ωd}(t)=ω_{d1}−\dot{ω}_{d2}

The “larger” and “smaller” values of control parameters of two braking types are determined by the positive and negative deviation (+, −). The “larger” value is determined when the deviation is positive, and the “smaller” value is determined when the deviation is negative. The braking control parameters of two types of active brake of tire burst and anti-collision coordination control for vehicle are processed according to anti-collision control mode of the front vehicle and rear vehicle. When the braking control are in the time zone tₐᵢ of collision safety, the brake compatibility controller takes braking type of the “larger” value as the braking compatibility control type. One of Q_{d1}, \dot{ω}_{d1}, S_{d1}, \dot{u}ₓ₁ is acted as output of the braking compatibility controller. When the control of one of two brake types is in the collision risk or forbidden time zone tₐᵢ, the brake compatibility controller takes braking type of the “smaller” value as the braking compatibility control type. One of the Q_{d2} [symbol] S_{d2} [symbol] uₓ₂ is acted as output of brake compatibility controller. In parallel operation of the two types brake, the control conflict between the two brake types is solved to realize the compatibility control of active brake of tire burst and anti-collision brake of driverless vehicle.

3). Drive-by-Wire Brake Control and Controller

The controller includes brake controllers of electric hydraulic and wire controlling machinery. The electric hydraulic brake controller is above-mentioned. The wire controlling machinery controller is based on electric hydraulic brake controller and adds mechanical brake controller by wire controlling. An equivalent conversion model of parameters is established by brake controller. The parameters for stroke S_{w} of brake pedal or/and pedal force P_{w} of brake pedal, which is detected by sensor, are converted into other parameter forms which include deceleration \dot{u}ₓ of vehicle or/and total braking force of wheel, comprehensive angle deceleration \dot{ω}_{d} and slip rate S_{d}, according to the transforming model. In the light of above model and algorithm of tire burst brake control, target control value of one of parameters Q_{d} Δω_{d} [symbol] S_{d} for each wheel is determined. A dynamic control of brake control of brake-by-wire for tire burst is realized by logic cycle of control period Hₕ of brake A, B, C, D control and its combination. As parameters which include Q_{d}, \dot{u}ₓ, \dot{ω}_{d} and S_{d} lagging respond to \dot{S}_{w} or P_{w}, a compensator can be used, to carry out leading compensation for control phase of parameters. In the logic cycle of period Hₕ of brake control, the phase of low-frequency parameter signals S_{w} [symbol] \dot{S}_{w} detected by sensor is consistent with phase of parameter signals Q_{d} [symbol] \dot{u}ₓ [symbol] \dot{ω}_{d} [symbol] S_{d} by phase advance compensation, to improve the response speed of the brake control system and relevant parameters.

4). Environment Identification and Anti-Collision Control (Referred to as Anti-Collision Control) and Controller.

(1). Coordinated control of tire burst and collision avoidance. Radar, lidar and ultrasonic ranging sensors are used. A certain algorithm is used to determine relative distance Lₜ through the doppler frequency difference between transmitting and receiving waves. Define the relative speed of the front and rear vehicles: in the actual traffic detection, the sampling control period Hₜ is set. In period Hₜ is very small, the relative speed u_{c} of the front and rear vehicles is determined by Δt and ΔLₜ, where uₐ is absolute speed of the front vehicle:

$${u}_{c} = \frac{Δ {L}_{t}}{Δ t} , {u}_{b} = {u}_{a} + {u}_{c}$$

First. Self-adaption anti-collision control of vehicle. Based on environmental identification of the vehicle and rear vehicle, the anti-collision time zone tₐᵢ is determined by relative distance Lₜᵢ and relative speed u_{c} between the vehicle and the rear vehicle. The tₐᵢ is ratio of Lₜᵢ and u_{c}. A anti-collision threshold model with the parameter tₐᵢ of front vehicle and rear vehicle is established by anti-collision coordination controller for tire burst. Setting decreasing threshold set cₜᵢ of the tₐᵢ, threshold values in set cₜᵢ area set values which include Cₜ₁ [symbol] Cₜ₂ [symbol] Cₜ₃ [symbol] . . . Cₜₙ. Based on threshold model, the anti-collision time zone tₐᵢ of the vehicle and front vehicle or/and rear vehicle is divided into safety, danger, forbidden, collision levels which include tₐ₁ [symbol] tₐ₂ [symbol] tₐ₃ [symbol] . . . tₐₙ. Setting judgement conditions for collision between the vehicle and the rear vehicle: tₐₙ=cₜₙ. A coordinated control mode of collision avoidance, steady braking of wheel and vehicle is established. According to the single wheel model of braking D control of vehicle, the target control value of vehicle deceleration \dot{u}ₓ is determined. In limited range of target control series values of vehicle, acceleration and deceleration \dot{u}ₓ of vehicle, the brake A, B, C control logic combination and its distribution to wheels are determined by parameter forms of angle deceleration \dot{ω}ᵢ or slip ratio Sᵢ of each wheel. In the cycle of period Hₕ, the steady state braking C control of vehicle is used preferentially by changing of the A, B, C brake control logic combination which included C⊂B∪A [symbol] A⊂C [symbol] C⊂A, under conditions of transformation of logic combinations between differential braking and its distribution to each wheel. The angle deceleration \dot{ω}ᵢ or slip rate Sᵢ for braking B control orderly is decreased with decreasing of tₐᵢ or cₜᵢ step by step, to keep differential braking force of vehicle steady state braking C control of balanced wheelset for tire burst and no-tire burst. When vehicle enters time zone of collision, all braking forces of each wheel are released, or drive control of vehicle is started, and the time zone tₐᵢ of collision avoidance between the vehicle and the rear vehicle is limited in a reasonable range between “safety and danger”, to ensure that the vehicle does not touch the collision limit, namely, tₐᵢ=cₜₙ. The coordinated control of collision avoidance, wheel and vehicle steady-state braking are realized. Second, mutual adaptation anti-collision control for vehicle. The control is used for vehicles which be not equipped with distance detection system or only equipped with ultrasonic distance detection sensor. The controller of tire burst vehicle adopts a mutual adaptation control mode of steady-state braking and braking anti-colliding to rear vehicle. Based on experiment of driver's braking anti-collision, the driver's physiological response state to vehicle collision is determined. Based on the response state, a preview model of driver's braking anti-collision to tire burst front vehicle is established, and a braking coordination control model of the driver's physiological reaction lag time, braking control response time, brake retention time are established after the driver who is in rear vehicle finds tire burst signal of ahead vehicle. The above two models are collectively referred as the tire burst braking control model of collision avoidance of front and rear vehicles. In the early stage and real tire burst stage, the brake controller set by the tire burst vehicle carry on brake control, according to above two braking control model of collision avoiding of rear vehicle to tire burst front vehicle, to realize moderate braking of the tire burst vehicle. Based on the above two models, and brake A, B, C, D control logic combination and control cycle of period Hₕ, the coordinate and moderate braking control used by the front vehicle for tire burst can compensate time delay caused by the lag of physiological reaction and the reaction period of rear vehicle driver to collision avoiding, so as to avoid risk period of rear vehicle collide to front vehicle.

(2). Anti-collision control and controller for tire burst of vehicle driven by man. The vehicle anti-collision control in left and right direction adopts coordinated control mode, model and algorithm of braking, driving, rotation force of directive wheel or/and active steering. Based on rotation angle θₑₐ of directive wheel determined by active steering system AFS of vehicle, an actuator of AFS is exerted by additional angle θ_{eb} which is independent to driver operation. In the critical speed range of steady-state control of vehicle, an additional yaw moment which does not depend on driver's operation is determined to compensate the vehicle's insufficient or excessive steering caused by the tire burst. The actual steering angle θₑ of directive wheel is vector sum of the steering angle θₑₐ of directive wheel and the additional angle θ_{eb} of tire burst. In the active action of additional rotation angle θ_{eb} to tire burst, the vector sum of tire burst rotation angle tied and additional rotation angle θ_{eb} is zero. Running off of tire burst vehicle and excessive sideslip of directive wheel can be prevented by control of vehicle direction, wheel stability, vehicle attitude, stable acceleration and deceleration and path tracking of vehicle, to realize anti-collision control of the tire burst vehicle in left and right direction.

(3). Anti-collision control and controller t of driverless vehicle for tire burst

Based on coordinated control mode of anti-collision, braking, driving and stability of tire burst vehicle, the controller is equipped with control modules of machine vision, ranging, communication, navigation and positioning, to determine position of the vehicle, coordinates position from the vehicle to the front, rear, left, right vehicles and obstacles in real time; on this basis, the distance and relative speed between the vehicle and the front, rear, left, right vehicles and obstacles are calculated by control time zone of multiple levels which include safety, danger, no entry and collision. The collision-avoidance, steady-state of wheel and vehicle, and deceleration control of the tire burst vehicle are realized by independence or/and combination control of brake A, B, C, D in logic cycle of period Hₕ, control mode conversion of braking and driving, coordination control of active steering and active braking. The collision-avoidance control of tire burst vehicle includes collision-avoidance control of the vehicle and front, rear, left right vehicles, and around obstacles. According to the route planned by the controller, path tracking of the tire burst vehicle is carried, to arrive safe parking position of the vehicle.

5). Subroutine of Tire Burst Brake Control

According to the structure and process of tire burst brake control, brake control mode, model and algorithm of tire burst brake control subroutine or software is compiled. A structured programming is adopted. The subroutines mainly set control program modules that include control mode conversion, steady state of wheel, balance brake of vehicle, steady state of vehicle and total brake force (A, B, C, D) brake control, brake control parameters and A, B, C, D logic combination of brake control type, and include datum processing and control processing of brake, compatible control for tire burst active brake with pedal brake, brake and anti-collision coordination control of driven by man d and driverless vehicles, or/and set up brake program modules of drive-by-wire. The brake A. B, C, B control program modules include submodules of distribution and control of variables of brake A, B, C, D control type for wheels.

### 3. Steering Control for Tire Burst

1). Rotation Force Control of Steering Wheel for Tire Burst

The tire burst steering control of vehicle adopts steering rotation moment control for tire burst, which includes control mode of rotation angle and rotation angle speed control of steering wheel, steering assist moment control of steering wheel and rotary torque control of steering wheel. When tire burst occurs, rotary torque for tire burst is generated, and direction of rotary torque of steering wheel exerted by ground changes sharply. Under action of tire burst rotary force, the steering assistant controller will misjudge direction of the steering assistant moment, and the steering assistant device outputs the steering assistant moment according to direction of steering assistant moment for normal working condition; the assistant moment aggravates unstable state of the vehicle steering, to result in double instability of tire burst and tire burst control in steering process of vehicle. Under common action of tire burst rotary force torque and steering assist moment, the steering wheel and directive wheel are drawn to deflection instantaneously by the two force torque, and the vehicle deviates from the right running direction sharply. Based on the types of rotation angle sensor and torque sensor used in the system, a direction judgement modes of steering angle and steering torque of vehicle are used to determine the direction of rotary force of tire burst, the direction of rotation moment of steering wheel exerted by ground, the direction of steering assistant force or steering resistance torque. On the basis of coordinates, rules, procedures and logic of tire burst direction judgement established by the steering system and based on control mode, model and algorithm of tire burst rotary force adopted by the steering assist controller, the steering assist device can provide corresponding steering assist or resistance moment for steering system at any angle of steering wheel, to realize steering rotary force control of tire burst vehicle.

(1). Control and Controller of rotation angle of steering wheel for tire burst

In steering control of vehicle for tire burst, a control mode and model of steering angle δ and rotation angle velocity \dot{δ} are adopted to limit the rotation angle of steering wheel and rotation angle velocity of vehicle, to balance and reduce the impact of tire burst rotation force to steering wheel and vehicle. The steering angle control of steering wheel adopts steering characteristic function Yₖᵢ. The function Yₖᵢ includes the function Y_{kbi} which can determine limited value of rotation angle and angle velocity of steering wheel, and the function Yₖₐᵢ which can determine limited value of rotation angle of steering wheel.

i. i. Steering characteristic function Y_{kbi}. A mathematical model of the steering characteristic function Y_{kbi} is established by modeling parameters which include vehicle speed uᵢₓ, ground comprehensive friction coefficient μₖ, vehicle weight N_{z}, steering angle δ_{bi} of steering wheel and its derivative \dot{δ}_{bi}.

Y_{kbi}=f(δ_{bi},\dot{δ}_{bi},uₓᵢ,μₖ) or Y_{kbi}=f(δ_{bi},\dot{δ}_{bi},uₓᵢ,μₖ,N_{z},)

Among them, the μₖ is a standard value set or a real-time evaluation value, the μₖ is determined by the average or weighted average algorithm of friction coefficient of directive wheels. The value determined by Y_{kbi} is target control value or ideal value of rotation angle velocity of steering wheel. The value of Y_{kbi} is determined by the above mathematical model or/and field test. The model structure of Y_{kbi} is as follows: Y_{kbi} is incremental function with increasing of friction coefficient μₖ, and Y_{kbi} is incremental function of decreasing of speed uₓᵢ, and Y_{kbi} is incremental function with increasing of angle δ_{bi}. Based on series value uₓᵢ[uₓₙ . . . uₓ₃ [symbol] uₓ₂uₓ₄] of decreasing of vehicle speed uᵢₓ, the target control values of set Y_{kbi} [Y_{kbn} . . . Y_{kb3} [symbol] Y_{kb2} [symbol] Y_{kb1}] are determined by mathematical model with parameters rotation angle δ_{bi} of steering wheel and rotation angle velocity δ_{bi} at certain speed uₓᵢ. The values in the set Y_{kbi} are limit values or optimal values which can be reached by δ_{bi} and δ_{bi} of steering wheel under condition of which speed uₓᵢ, ground friction coefficient μₖ and vehicle weight N_{z} are certain values. The e_{ybi}(t) between series absolute value of the target control value Y_{kbi} of rotation angle velocity (>_{ybi} for steering wheel and the series actual value of steering wheel rotation angle velocity \dot{δ}_{ybi}′ of vehicle is defined under certain states of parameters uₓᵢ, μₖ, N_{z} and δ_{bi}. Under condition of certain vehicle speed uᵢₓ, and when e_{ybi}(t) is positive (+), it is indicated that rotation angle velocity \dot{δ}_{ybi} of steering wheel is in normal or normal working state. Under condition of which the vehicle speed uᵢₓ is certain value, and when the deviation e_{ybi}(t) is less than 0, the rotation angle speeded \dot{δ}_{ybi} of steering wheel is determined as tire burst control status. A mathematical model of steering assistant moment Mₐ₂ of steering wheel is established by modeling parameter of deviation e_{ybi}(t) of controller:

Mₐ₂=f(e_{ybi}(t))

In the logical cycle of control period Hₙ of rotation moment for steering wheel, the value of steering assistant moment Mₐ₂ of steering system is determined by mathematical model. Based on the positive (+) and negative (−) of deviation e_{ybi}(t), the steering assist moment or resistance moment to steering wheel is provided by steering assistant device, according to the direction of which absolutes value of rotation angle velocity for steering wheel is decreased. The rotation angle velocity of steering wheel is adjusted to make the deviation e_{ybi}(t) to 0. The rotation angle velocity deviation e_{ybi}(t) of steering wheel keeps tracking to its target control value, to limit the impact of tire burst rotary force to steering wheel.

ii. Steering characteristic function Yₖₐᵢ. A mathematical model of steering characteristic function Yₖₐᵢ is established by modeling parameters including vehicle speed uᵢₓ, ground comprehensive friction coefficient μₖ, vehicle weight N_{z}, steering wheel angle δₐᵢ and its derivative \dot{δ}ₐᵢ.

Yₖₐᵢ=f(δₐᵢ,uₓᵢ,μₖ)Yₖₐᵢ=f(δₐᵢ,uₓᵢ,μₖ,N_{z})

Among them, the value of μₖ is set as standard value or real-time evaluation value. The value of μₖ is determined by average or weighted average algorithm of friction coefficient of steering wheels. The value of Yₖₐᵢ is target control value or ideal value of steering wheel angle. The value of Yₖₐᵢ is determined by the above mathematical model or/and field test. The modeling structure of Yₖₐᵢ is as follows: the Yₖₐᵢ is an incremental function of increasing of μₖ, the Yₖₐᵢ is an incremental function of decreasing of uᵢₓ, and the Yₖₐᵢ is an incremental function of increasing of steering angle δₐᵢ steering wheel. According to series value uₓᵢ[uₓₙ . . . uₓ₃ [symbol] uₓ₂ [symbol] uₓ₁] of decreasing of vehicle speed uₓᵢ, the set Yₖₐᵢ[Yₖₐₙ . . . Yₖₐ₃ [symbol] Yₖₐ₂ [symbol] Yₖₐ₁] of target control values of corresponding steering angle δₐᵢ of steering wheel are determined by mathematical model at each speed. The values in the Yₖₐᵢ set are a limit value or a optimal values of the steering angle of steering wheel at a certain speed uᵢₓ, ground comprehensive friction coefficient μₖ and vehicle weight N_{z}. The deviation e_{yai}(t) between the target control value Yₖₐᵢ of rotation angle of steering wheel and the actual value of rotation angle δ_{yai} of steering wheel is defined under certain states of parameters uᵢₓ, μₖ and N_{z}. When deviation e_{yai}(t) is positive (+), it is indicated that rotation angle δ_{yai} of steering wheel at this time is within limit value of δ_{yai}, and is indicated rotation angle of steering wheel δ_{yai} is within the normal range. When deviation e_{yai}(t) is negative (−), it is indicated that rotation angle δ_{yai} of steering wheel is beyond limited range which is determined by rotation angle control of steering wheel for tire burst. A mathematical model of steering assistant or resistance moment Mₐ₁ is established by modeling parameter of deviation e_{yai}(t). In logical cycle of control period Hₙ of rotary moment for steering wheel, the direction of which decrease of absolutes value of rotation angle δ for steering wheel is determined according to positive (+) and negative (−) of deviation e_{yai}(t), and steering assistant or resistance moment Mₐ₁ is determined by mathematical model. Based on steering assistant or resistance moment Mₐ₁, a rotation moment to steering system is provided by steering assist motor, to limit the increase of steering wheel angle δ. The target control value Yₖₐᵢ of rotation steering of steering wheel is tracked by its actual angle δ, until e_{yai}(t) is 0. The rotation angle δ of steering wheel under the condition of tire burst is limited in region of ideal or maximum value of steering slip angle of vehicle. The control may be not complete direction judgment of related parameters for tire burst.

(2). Control and controller of power-assisted steering for tire burst

i. Assistance steering control of tire burst. The direction judgement of tire burst for the control uses two mode of torque angle or torque. On the basis of direction determination mode for tire burst, it is determined that direction of steering angle δ and torque M_{c} of steering wheel, or steering angle δ and torque M_{c} of directive wheel, and rotation moment Mₖ of directive wheel exerted by ground, rotation moment for tire burst and steering assistance moment Mₐ. Among them, Mₖ includes the rectifying torque Mⱼ of wheel and tire burst rotation moment M_{b}′ of directive wheel exerted by ground and resistance moment of directive wheel. A control model of power assistance steering and characteristic function of tire burst are determined by control variable including rotation torque M_{c} of steering wheel and parameter variable including vehicle speed uₓ. First. On positive and negative stroke of rotation angle δ of steering wheel, a control model of steering assistance moment is established by variable M_{c} and parameter uₓ under normal working condition:

Mₐ₁=f(M_{c},uₓ)

The characteristic function and characteristic curve of steering assist moment Mₐ₁ are determined by the model under normal working condition. The characteristic curve includes three types of straight line, broken line or curve. The modeling structure and characteristics of steering assistant moment Mₐ₁ are as follows. On positive and reverse stroke of rotation angle of steering wheel, the characteristic functions and curves are same or different. The so-called “difference” refers to: on the positive and negative stroke of rotation angle of steering wheel, the characteristic function adopted by control model of the Mₐ₁ is different, and value of the Mₐ₁ is different in same value or point of variable and parameter, otherwise it is same. The steering assistant moment Mₐ₁ is decreasing function with increment of vehicle speed uₓ; the Mₐ₁ is incremental function of absolute value of increment of rotation torque M_{c} of steering wheel. Based on calculated values of each parameters, a numerical chart which is stored in the electronic control unit is drawn. Under normal and tire burst conditions, the electronic control unit by means of looking-up table call power assistance steering control procedure and extracts the target control value of steering assistant moment Mₐ₁ of steering wheel, based on parameters of rotation torque M_{c} of steering wheel, vehicle speed uₓ and rotation angle δ of steering wheel. After the direction of tire burst rotation force M_{b}′ is determined, a mechanical equation of steering assist control for tire burst are adopted to determine the target control value of tire burst rotation force M_{b}′. In steering assistant control for tire burst, the rotating moment M_{b}′ of tire burst is balanced by an additional assistant moment Mₐ₂, namely, the Mₐ₂ equals the M_{b}:

Mₐ₂=−M_{b}′=M_{b}

Under the condition of tire burst, the target control value of steering assistant moment Mₐ is vector sum of detection value Mₐ₁ of torque sensor of steering wheel and additional balanced steering assistant moment Mₐ₂ for tire burst. In rotary moment control of steering wheel, the phase advance compensation of steering assistant moment Mₐ is carried out by compensation model to improve response speed of power steering system EPS. When necessary, the steering assist control and rotation angle control of steering wheel for the tire burst are constituted as a composite control. The stable steering control of tire burst vehicle can be realized effectively by limiting maximum angle or/and rotation angle velocity of steering wheel. According to the relationship model between steering assistant torque Mₐ and electrical control parameters of electrical power steering system, the steering assist torque Mₐ is converted into control parameters of power device, in which it includes current iₘₐ or/and voltage Vₘₐ. The steering assist control sets limiting value a_{b} of balance rotary moment |M_{b}| for tire burst. In control, |M_{b}| is less than a_{b} which is larger than the maximum value of the rotary moment of tire burst |M_{b}′|. The maximum value of |M_{b}′| is determined by field tests. A phase compensation model of assistance steering is established by tire burst steering assistance controller. The advance compensation of phase of the steering assistance moment Mₐ is carried out by the compensation model in the control, to improve the response speed of rotary force control of steering wheel.

(3). Control and controller of rotary torque of steering wheel for tire burst

i. Determining of tire burst direction. The determination of tire burst direction uses one of modes of angle and torque, angle, to realize judgement of direction of steering assistant moment Mₐ and operation direction of electric device directly. Defining deviation ΔM_{c} between target control value of steering torque M_{c1} of steering wheel and the real-time value M_{c2} detected by torque sensor of steering wheel:

ΔM_{c}=M_{c1}−M_{c2}

The parameters direction of steering assistant moment Mₐ and the direction of steering power parameters of electric device are determined by the positive and negative (+, −) of deviation ΔM_{c}. The direction of steering power parameters include the direction of the current iₘ of the motor or the rotating direction of the assistant motor. When increment ΔM_{c} of rotation torque M_{c} of steering wheel is positive, the direction of steering assistant moment Mₐ is the direction of increasing of assistant moment M_{c}; when ΔM_{c} is negative (−), the direction of steering assist moment Mₐ is the direction of decreasing of steering assistant moment Mₐ, that is, the direction of increasing of resistance moment Mₐ.

ii. Rotation torque control of steering wheel. A control mode, control model of rotation torque M_{c} of steering wheel and characteristic function are established by control variable rotation angle δ of steering wheel, parameter speed uₓ and rotation angle velocity \dot{δ} of steering wheel under normal working conditions:

M_{c}=f(δ,uₓ) [symbol] M_{c}=f(δ,\dot{δ},uₓ)

The model determines characteristic function and characteristic curve of rotation torque of steering wheel under normal working conditions. The characteristic curve includes three types: straight line, broken line or curve. The value determined by the control model of rotation torque M_{c} of steering wheel and characteristic function are target control value of steering wheel rotation torque of vehicle. The model structure and characteristics of the M_{c} are as follows. On the positive or negative stroke of rotation angle of steering wheel, the characteristic function and curve are same or different, the so-called “difference” means: in the positive and reverse stroke of rotation angle of steering wheel, the characteristic function for M_{c} is different, and the value of M_{c} is different at same point of variable and parameter, otherwise it is same. The steering wheel rotation torque M_{c} determined by control model of steering assistant moment is decreasing function of increment of the parameter uₓ, and is incremental function of the absolute value of increment of δ and \dot{δ}. Based on calculated values of each parameter, a numerical chart which is stored in the electronic control unit is drawn. Under normal and tire burst conditions, through look-up table method, control procedure of power assistant steering is called by electronic control unit, and target control value of steering assistant moment M_{c1} of steering wheel is extracted from the electronic unit, based on parameters of steering wheel angle δ, rotation angle velocity \dot{δ} of steering wheel and vehicle speed uₓ. The actual value of rotation torque M_{c2} of steering wheel is determined by the real-time detection value of torque sensor. Defining the deviation ΔM_{c} of rotation torque M_{c} of steering wheel between the target control value of steering wheel torque M_{c1} and the real-time detection value M_{c2} of torque sensor of steering wheel:

ΔM_{c}=M_{c1}−M_{c2}

The steering assistance or resistance moment Mₐ of steering wheel is determined by the function model of deviation ΔM_{c} under normal and tire burst conditions.

Mₐ=f(ΔM_{c})

Based on the steering characteristic function, the rotation torque control of steering wheel uses variety of modes. Mode 1. Basic rectifying torque type. Base on the mode, a function model of rotation torque M_{c} for steering wheel are set up by modeling parameters of vehicle speed uₓ and steering wheel angle: M_{c}=f(δ, uₓ), The target control value of M_{c1} is determined by specific function forms which include broken line and curve. At any point of rotation angle of steering wheel, the derivative of M_{c1} basically is the same as the derivative of aligning torque Mⱼ. Under action of the Mⱼ, driver of vehicle can obtain the best or better road sense from steering wheel. In function model of rotation torque M_{c1} of steering wheel, the M_{c1} and the Mⱼ are incremental function of the increase of steering wheel angle δ at certain speed uₓ, and M_{c1} is irrelevant to the steering wheel angle velocity \dot{δ}. The real-time detection value M_{c2} of torque sensor of steering wheel or/and road sense which is transmitted by steering wheel changes with the changing of the steering wheel angle velocity \dot{δ}. Mode 2: Balanced aligning torque model, function model of rotation torque M_{c} of steering wheel is established by modeling parameters of vehicle speed uₓ, rotation angle δ of steering wheel and rotating angle velocity \dot{δ}: M_{c}=f(δ, \dot{δ}, uₓ). In the model of M_{c}, target control value M_{c1} of M_{c} is determined by concrete function form of the model. At any point of rotation angle of steering wheel, the derivative of M_{c1} basically is same as that of aligning torque Mⱼ. The derivative of M_{c1} basically is same as the derivative of the aligning torque Mⱼ of directive wheel. In torque function model of the M_{c}, the M_{c1} increases with the increase of δ under condition of a certain speed uₓ. Meanwhile, the target control value M_{c1} of torque M_{c} of steering wheel and the real-time detection value M_{c2} determined by steering wheel torque sensor are correlated synchronously with angle velocity \dot{δ} of steering wheel. In each logic cycle of steering torque control period Hₙ of steering wheel, the M_{c1} and M_{c2} increase or decrease synchronously with the increasing or decreasing of δ on appropriate proportions in the positive and reverse stroke of steering wheel angle δ. Based on the definition of rotation torque of steering wheel, the ΔM_{c} of rotation torque M_{c} of steering wheel is a difference value between M_{c1} and M_{c2}:

ΔM_{c}=M_{c1}−M_{c2}

A functional model of steering assistant moment Mₐ is established, the value of Mₐ is determined by model of difference ΔM_{c}.

ΔM_{c}=f(ΔM_{c})

Under the action of steering assist or resistance torque Mₐ, the driver can obtain the best feel or road feel from steering wheel of steering system, no matter what steering system is in normal or tire burst working condition. Adjustment force of steering assistance for steering wheel torque is enlarged. According to relationship model between rotation torque of steering wheel and power parameters, the ΔM_{c} is converted into power parameters of electric devices, in which the parameters M_{c}, current i_{cm} and voltage V_{mc} are vectors.

(4). Control subroutine or software of tire burst rotation moment

Based on control structure, control flow, control mode, model and algorithm of tire burst rotation force (moment), a subprogram of tire burst rotation moment control is developed. Subprogram use a structured design. The subprogram mainly sets direction determination modules of related parameters including rotation angle and rotation torque of steering wheel, and rotation moment of power assistance steering. Steering subroutine of steering wheel mainly is composed by program modules of rotation angle δ and rotation angle speed of steering wheel. Control program module of steering assistant torque for tire burst mainly is composed by E control program module of steering assistant torque under normal working conditions and G control module of relationship between steering assistant torque and current or/and voltage of steering assistant device, and program module of control algorithm for tire burst rotation torque.

2).

Tire burst active steering control for driven by man vehicle or the active steering control of an vehicle driven by man with an auxiliary steering interface for a tire burst. The tire burst active steering control covers vehicles which are driven by chemical energy and electric drive. In the process of tire burst, the active steering control of tire burst vehicle includes additional steering angle of active steering and electronic servo power steering control, as well as coordinated control for additional angle of active steering and rotation driving moment of directive wheel. When the burst control entering signal iₐ arrives, the active steering control starts. Based on active steering system (AFS), vehicle stability control program (ESP) or/and four wheel steering (FWS) system, the active steering system for tire burst use mainly coordinated control mode of AFS and ESP. The coordinated control mode of AFS and ESP is realized by active steering controller of electronic mechanical or controller of steering of drive-by-wire with road sense controller. The controller uses active steering control structure, and set control process, control mode, model, algorithm and control program or software. When tire burst signal I arrives, the control and control mode converter takes tire burst signal I as the conversion signal, and adopts three kinds of mode and structure of program conversion, protocol conversion and conversion of external location, to realize entering and exiting of tire burst control, and control and control mode conversion for normal and tire burst working conditions.

(1). Active steering control and controller of driven by man vehicle and the active steering driverless vehicle with an auxiliary steering interface for tire burst

i. Active additional angle control and controller for tire burst. According to coordinate system and judging rules, procedures and judging logic of tire burst direction determined by the method, the insufficient and excessive steering of vehicle are determined by positive and negative (+, −) of direction of steering wheel rotation angle δ and yaw angle velocity deviation e_{ωr}(t) of vehicle. On the basis of direction judging of steering wheel angle δ, insufficient or excessive steering of vehicles and position of tire burst wheel, the direction of additional rotation angle θ_{eb} (+, −) of directive wheel, which is used by tire burst steering control of vehicle, is determined. On the basis of its direction judging, a balancing tire burst additional angle θ_{eb} which is independent of the driver's operation is applies to actuator of active steering system (AFS), to compensate for the insufficiency or excessive steering of vehicle. The actual angle θₑ of directive wheel of vehicle is vector sum of both for steering angle θₑₐ of directive wheel determined by driver's operation and the balancing tire burst additional rotation θ_{eb}

θₑ=θₑₐ+θ_{eb}

The direction of balancing tire burst additional angle θ_{eb} is opposite to the direction of steering angle θ_{eb}′ of tire burst of wheel.

θ_{eb}=−θ_{eb}′

In linear superposition of angle θ_{eb} and angle θ_{eb}′, the vector sum of angle θ_{eb} and angle θ_{eb}′ is 0. A control mode and model of the additional balance angle θ_{eb} of directive wheel to tire burst are established by the modeling parameters which include vehicle yaw angle velocity ωᵣ, vehicle sideslip angle β to vehicle quality center, or/and lateral acceleration \dot{u}_{y}, adhesion coefficient φᵢ or friction coefficient μᵢ and slip Sᵢ of directive wheel. Based on tire burst state parameter and stage determined by the state parameters, the target control value of additional steering angle θ_{eb} of directive wheel tire burst is determined by using corresponding control mode or/and algorithm which includes PID, sliding mode control, optimal control or fuzzy control for modern control theory:

θ_{eb}(e_{ωr}(t),e_{β}(t),e(Sₑ),\dot{u}_{y})

The equivalent function model includes:

θ_{eb}=f(e_{β}(t),e_{ωr}(t),θ_{eb}=f(e_{ωr}(t),e_{β}(t),\dot{u}_{y}),θ_{eb}=f(e_{ωr}(t),e_{β}(t),e(Sₑ))

Based on mechanical analysis of tire burst steering angle θ_{eb}′, the θ_{eb}′ can be divided as θ_{eb1}′, θ_{eb2}′, θ_{eb3}′:

$${θ}_{eb}^{′} = {θ}_{eb 1}^{′} + {θ}_{eb 2}^{′} + {θ}_{eb 3}^{′} , {θ}_{eb 1}^{′} = \frac{{R}_{i 0} - {R}_{i}}{b}$$

$${θ}_{eb 2}^{′} = f ( e ( {ω}_{e} ) , e ( {\dot{ω}}_{e} ) , {\dot{u}}_{y} , {u}_{x} ) , {θ}_{eb 3}^{′} = f ( {M}_{b}^{′} )$$

In formula, Rᵢ₀, Rᵢ, b, e(ωₑ), e(\dot{ω}ₑ), e(Sₑ), M_{b}′, u_{y}, uₓ and e_{ωr}(t) are respectively standard radius of wheel, radius of tire burst wheel, distance between two wheels of front axle or rear axle, equivalent relative angle speed deviation, angle deceleration speed deviation, slip rate deviation of tire burst balance wheelset for steering or non-steering, tire burst rotation force (torque) of steering wheel, vehicle lateral acceleration or deceleration, vehicle speed, deviation between ideal yaw angle rate ωᵣ₁ and actual yaw angle rate ωᵣ₂ of vehicle. Defining the deviation e_{θ}(t) between target control value θₑ₁ of directive wheel angle θₑ and its actual value θₑ₂, a control model of directive wheel angle θₑ is established by modeling parameter of deviation e_{θ}(t). The control adopted open-loop or closed-loop control. In the control cycle of period H_{y}, the active steering system AFS adopt a actuator that can superimposes two vector of directive wheel angle θₑₐ and additional balanced angle θ_{eb} for tire burst. The actual value of rotation angle θₑ₂ of directive wheel is always tracked to its target control value θₑ₁, to realize the control which deviation e_{θ}(t) is 0. In the active steering control of tire burst, when necessary, a coordinated control mode of rotation angle θₑ of directive wheel of vehicle and differential braking of electronic stability control program ESP can be adopted by active steering controller for tire burst

ii. Steering control and controller of electronic servo power for tire burst

The servo power steering control of active steering for tire burst includes direction judgement for tire burst and servo power control for tire burst. When tire burst occurs, rotary force produced by tire burst and servo-assisted control in normal working conditions will lead to double instability of tire burst and its control of vehicle. Therefore, servo-assisted steering controller for tire burst vehicle should be established. First. The direction determination of tire burst. The coordinates, rules, procedures and logic of determination of tire burst direction are established by this method. The direction judgement of rotation moment of directive wheel exerted by ground, the steering assist or resistance moment of the directive wheel are determined by angle and torque mode of direction judgement. The determination of direction of tire burst become to the basis of tire burst assist steering control and the tire burst active steering control. Second. Tire burst power steering control. Torque control mode and model of tire burst assist steering or tire burst active steering of vehicle are determined by this method. Control mode 1, tire burst assist steering. A control model of the steering assist moment Mₐ and characteristic function of Mₐ are established by control variable M_{c}, parameter variable speed uₓ and steering wheel angle δ, to determine steering assist moment Mₐ₁, additional balancing moment Mₐ₂ for tire burst and their sum of vectors. Among them, the tire burst rotation moment M_{b}′ can be balanced by additional balancing moment Mₐ₂. The target control value of steering assisting or resistance moment Mₐ of vehicle is determined, and the phase leading compensation of steering assist moment Mₐ is carried out by the compensation model. Control mode and model 2, assist steering for tire burst. Torque control mode of tire burst of steering wheel. A torque control model of steering wheel and characteristic function are established by modeling parameters rotation angle δ of steering wheel, vehicle speed uₓ and rotation angle velocity \dot{δ} of steering wheel, to determine target control value of torque steering M_{c1} of steering wheel and the deviation ΔM_{c} between the target control value of steering wheel torque M_{c1} and real-time value torque M_{c2} of steering wheel measured by torque sensor. Based on the function model with deviation ΔM_{c}, the steering assist or resistance moment Mₐ of steering wheel is determined under normal and tire burst conditions. In the logic cycle of steering control period H_{y} of vehicle, the servo power assisting or resistance moment can be adjusted actively by electronic servo power steering controller at any steering position of steering wheel, therefrom to realize the power steering control for vehicle tire burst in real-time.

iii. Active steering control subroutine or software to tire burst of vehicle driven by man

Based on the control structure and process, control mode, model and algorithm of tire burst active steering, a control subroutine of tire burst active steering is developed. The subroutine is designed by using a structured pattern. The subroutine is composed by modules which include control module of steering wheel rotation angle of active steering, module of additional steering angle of steering wheel or directive wheel to tire burst. Direction judgment module of electronic servo power assisted steering, assistance torque control modules of electronic servo steering or/and coordination control program modules of tire burst active steering and electronic stability control program system (ESP) are used.

(2). Active steering control and controller with driven by man vehicle with drive-by-wire

Steering control of drive-by-wire is a kind control by high-speed fault-tolerant bus connection, high-performance CPU control and management. The control is realized by operation to steering wheel. Redundancy design is adopted by steering control. A combination system of steering of drive-by-wire to wheel is set up. The combination system includes drive-by-wire steering of front-wheel and mechanical steering of rear-wheel, or drive-by-wire steering of front and rear axle, or drive-by-wire steering of four-wheel of electric power vehicle. Drive-by-wire steering control of vehicle includes steering control of directive wheel and steering road sense control of steering wheel. The steering control of directive wheel adopts the coupling control mode of two parameter of rotary angle θₑ and rotary driving moment Mₕ of directive wheel. The absolute coordinate system set in vehicle is established. The coordinate system of steering control stipulates that zero point of directive wheel rotation angle θₑ is origin. Whether the vehicle or wheel turns to left or turns right, the positive route of rotation angle of directive wheel, that is the increment or direction of the rotation angle is defined as positive (+), and the negative route of rotation angle of directive wheel, that is decrement of rotation angle θₑ, or direction of rotation angle θₑ is defined as negative (−). A relative coordinate system is set in the steering axle of steering system. Relative coordinate system rotates with steering axle of steering system. The origin of coordinate system is zero point of the steering torque and steering angle. The absolute and relative coordinates of above-mentioned steering angle and steering torque are used for the control of the steering angle and steering torque of the drive-by-wire active steering system. Based on dynamic equation of steering system, a dynamic model for tire burst is establishes by the parameters that includes rotation angle θₑ of directive wheel, rotation moment Mₖ of directive wheel exerted by ground and rotation driving moment Mₕ transmitted by motor to steering wheel:

Mₕ−Mₖ=jᵤ\ddot{θ}ₑ−Bᵤ\dot{θ}ₑ [symbol] Mₖ=Mⱼ+M_{b}′+Mₘ

In the formula, jᵤ and Bᵤ are equivalent rotational of inertia and equivalent resistance coefficient of steering system, M_{b}′ is the rotating moment of tire burst, Mₘ is rotating friction torque of directive wheel exerted by the ground, the Mⱼ is the aligning torque. The magnitude and direction of Mₖ change dynamically. Based on structure of steering system, a dynamic model of steering system which includes motor, steering mechanism (gear, rack) and wheel is established. The model is transformed by Laplace transform to determine transfer function. The corresponding control is realized by steering controller on algorithm which includes PID, fuzzy, neural network and optimal of modern control theory. The steering controller is designed, to make response time and overshoot of the system keep in an optimal range. In steering control, a dynamic response of relevant parameters including vehicle yaw rate ωᵣ is determined by control for ideal transmission ratio and dynamic transmission ratio Cₙ of steering system, state feedback of parameters such as yaw rate ωᵣ and centroid side deflection angle β of vehicle, the control coupling of angle θₑ of directive wheel and rotation moment Mₖ of steering wheel exerted by ground, steering driving moment Mₕ of steering system, thereby to solve some technical problems about overshoot and stability steering of vehicle, sharp change of magnitude and direction of rotating moment M_{b}′ etc. First, dynamic models of the steering system which includes steering motor, gear transmission device and directive wheel can be established:

$${T}_{m} - \frac{{T}_{a}}{G} = {J}_{m} {\ddot{θ}}_{m} + {B}_{m} {\dot{θ}}_{m} , {T}_{m} = {k}_{t} {i}_{m}$$

In the formula, Tₘ [symbol] Jₘ [symbol] θₘ [symbol] Bₘ [symbol] G [symbol] kₜ [symbol] iₘ are respectively rotation torque of motor, turn round inertia, rotation angle, viscous friction coefficient, rotation speed ratio, electromagnetic torque constant of motor and current of motor. The Tₐ is moment of pinion shaft. The Tₐ is determined by the mathematical model of rotation moment Mₖ of directive wheel:

Tₐ=f(Mₖ)

The Mₖ is determined by test parameter value of the torque sensor set in the steering system. When equivalent model is adopted:

Tₐ=λₐMₖ

λₐ is equivalent coefficient. The λₐ is determined by parameter including moment of inertia Jₘₐ, viscous friction coefficient and other parameters of the wheel and steering mechanism.

Second, steering motor and electrical model

Vₘ=Riₘ+Lₘiₘ+kᵢ\dot{θ}ₘ

Where, Vₘ [symbol] R [symbol] Lₘ are counter electromotive force, armature resistance and inductance respectively

Third, model of steering wheel and steering mechanism:

Tₐ−Tᵣ=Jₛ\ddot{θ}ₛ+Bₛ\dot{θ}ₛ

In the formula, the Tᵣ [symbol] Jₛ [symbol] Bₛ are equivalent steering resistance moment of pinion shaft, the moment of inertia of steering wheel and steering mechanism, viscous friction coefficient of each transmission device. Neglecting torsional rigidity of motor, the transfer function is obtained by the speed matching between the motor and the pinion shaft. Neglecting the Tᵣ, The Laplace transformation is performed to obtain transfer function:

$${G}_{s} = \frac{V ( s )}{E ( s )} = \frac{{k}_{t} G}{( {L}_{m} s + R ) [ {J}_{m} {G}^{2} + {J}_{s} ) {s}^{2} + ( {G}^{2} {B}_{m} + {B}_{s} ) s ] + {G}^{2} {k}_{t} {k}_{i} s}$$

The dynamic model established by modeling parameters which include wheel rotation angle θₑ, steering rotation moment Mₖ and rotation driving moment Mₕ of directive wheel are transformed by Laplace transform, to determine transfer function. A steering controller is designed through corresponding control algorithm which include PID, fuzzy, neural network and optimal modern control of modern control theory. The control modes and models are used to normal and tire burst working condition, bumpy road surface, overshoot of driver and fault of vehicle. The coupled control mode of two-parameter for steering wheel rotation angle θₑ and rotation driving moment Mₕ of steering wheel are adopted. The steering controller is designed to make response time and overshoot of the system keep in an optimal range. In steering control, a dynamic response of relevant parameters which include vehicle yaw angle rate ωᵣ is determined by control for ideal transmission ratio or dynamic transmission ratio Cₙ of steering system, state feedback of parameters such as yaw rate ωᵣ and centroid side deflection angle β of vehicle, the control coupling of rotation angle θₑ of directive wheel and rotation moment Mₖ of steering wheel exerted by ground, steering driving moment Mₕ of steering system, thereby to solve some technical problems about overshoot and stability steering of vehicle in sharp change of magnitude and direction of rotating moment M_{b}′. The deviation e_{δ}(t) between target control value δ₁ of rotation angle δ of steering wheel and its actual value δ₂ is defined. The deviation e_{θ}(t) between target control value Qₑ₁ of steering wheel angle θₑ and its actual value θₑ₂ is defined. The deviations e_{δ}(t) and e_{θ}(t) are used to determine driving direction of rotary driving moment Mₕ of directive wheel and direction of control parameters θₑ and Mₕ.

i. Rotation angle θₑ control of directive wheel for tire burst. In the coordinate system determined by this method, the steering angle of vehicle and wheels, the yaw angle velocity of vehicle and insufficient or excessive steering angle of vehicles are vectors. Angle θₑₐ of directive wheel is determined by steering wheel angle θₑₐ under normal working conditions. Under tire burst working conditions, an additional burst tire balanced angle θ_{eb} which is independent of the driver's steering control and operation is applied to directive wheel of steering system by controller of rotation angle of steering wheel. Within critical speed range of vehicle steady-state control, the insufficiency or oversteering steering of tire burst vehicle is compensated by θ_{eb}. The target angle θₑ of directive wheel is a linear superposition value of vector of directive wheel angle θₑₐ and the additional balance angle θ_{eb}: θₑ=θₑₐ+θ_{eb}. The transmission ratio Cₙ between steering wheel angle θₑ and directive wheel angle θₑ is a constant value or dynamic value. The dynamic value is determined by mathematical model with parameter vehicle speed uₓ. The mathematical model determined of additional balance angle θ_{eb} for tire burst is established by modeling parameters including vehicle speed uₓ, rotation angle δ of steering wheel, yaw angle velocity e_{ωr}(t) of vehicle, sideslip angle e_{β}(t) to mass center of vehicle, or/and ground friction coefficient and lateral acceleration \dot{u}_{y}. The target control value of θ_{eb} is determined. Setting control period H_{y} of vehicle steering, and the H_{y} is as a set value, or the H_{y} is a dynamic value determined by mathematical model of modeling parameters which includes angle increment Δδ of steering wheel and frequency f_{y} in unit time. Among them, the Δδ is called the comprehensive increment of rotation angle of steering wheel. Or the Δδ is a ratio between absolute value sum of positive and negative changing value of directive wheel rotation angle and the number n of angle changing in unit time: Δδ=(|Δδ₁|+|Δδ₂| . . . +|δₙ|)/n. The frequency f_{y} is determined by the response frequency of the motor or steering system. The coordinated control model of directive wheel angle θₑ and rotation driving moment Mₕ of directive wheel is established by modeling parameters which includes deviation e_{δ}(t) between the target control value of steering wheel angle δ₁ and its actual value δ₂, or the deviation e_{θ}(t) between the target control value of directive wheel angle θₑ₁ and its actual value θₑ₂. The driving direction and value of rotation driving moment Mₕ are determined. In control cycle of period H_{y}, the actual value of rotation angle θₑ₂ of directive wheel always traces its target control value θₑ₁ under the action of rotating driving moment Mₕ.

ii. Rotary driving torque control and controller of steering wheel for tire burst

According to the regulations of magnitude and direction of angle and torque in coordinate system of the drive-by-wire active steering, two sets of independent coupling and coordinating control systems of rotation angle δ and rotation driving torque Mₕ of steering wheel in left steering and right steering of vehicle are established on left side and right side of origin position of steering wheel angle δ. In the origin of steering wheel angle δ, namely zero point of left steering or right steering of vehicle, the direction conversion of electric control parameters of electric drive device are realized by electronic control unit of controller, therefrom, to adapt coupling or coordinated control of two control variables θₑ and Mₕ. The electric control parameters of direction conversion include current or voltage. Based on dynamic equation of steering system, a control model of driving moment Mₕ of directive wheel for driven by man vehicle is established by coordinated control variables θₑ and Mₕ, modeling parameters which include the rotation force Mₖ of directive wheel exerted by ground, deviation e_{δ}(t) of target control value of steering wheel rotation angle δ and its actual angle value, or/and rotation angle velocity \dot{δ}ₑ. On the basis of control model, target control value of Mₕ is determined. According to the positive and negative of deviation e_{δ}(t) between the target control value δ₁ and its actual value δ₂ of steering wheel, direction of rotation driving moment Mₕ of directive wheel is determined. The rotation moment Mₖ of directive wheel exerted by ground includes the rotation moment M_{b}′ of tire burst. When tire burst of vehicle occurs, the size and direction of change. Rotation angle θₑ of directive wheel is controlled, and rotation driving moment Mₕ of directive wheel needs to be adjusted in real time. Two modes are used to determine the Mₕ. Mode 1: the rotation torque sensor set in the between directive wheel and the steering system of mechanical transmission device detects the rotation torque Mₖ of directive wheel exerted by ground. According to differential equation:

Mₕ−Mₖ=jᵤ\ddot{θ}ₑ−Bᵤ\dot{θ}ₑ

Target control value of Mₕ is determined. Where, jᵤ [symbol] Bᵤ are equivalent moment inertia and equivalent resistance coefficient of steering system respectively. In view of lagging of detection signal of sensor, the phase compensation of Mₖ is carried out. In steering control cycle of period H_{y}, a compensation coefficient Gₑ(y) is determined by the mathematical model with modeling parameters which include the deviation e(θₑ) between target control value θₑ₁ and actual value θₑ₂ of rotation angle of directive wheel and its derivative e(θₑ), and damping coefficient Q of transmission device:

Gₑ(y)=f(e(θₑ),ė(θₑ),H_{y})

Where Gₑ(y) is an increasing function to increment of absolute values of e(θₑ) [symbol] ė(θₑ) and [symbol] . Mode 2. In the steering control cycle of period H_{y}, a equivalent mathematical model is established by modeling parameter including parameters e(θₑ) and e(ωₑ), to determine rotation moment Mₖ of directive wheel exerted by ground and rotation driving moment Mₕ of directive wheel. The mathematical model includes:

Mₖ=f(θₑ₁,θₑ₂,ė(θₑ),e(ωₑ),e(\dot{ω}ₑ)),Mₕ=jᵤ\ddot{θ}ₑ−Bᵤ\dot{θ}ₑ+Mₖ

The equivalent mathematical model for determining driving torque Mₕ of directive wheel of vehicle driven by man or driverless vehicle is adopted. The mathematical expression includes:

$${M}_{h} = {k}_{1} {G}_{e} ( y ) ( {J}_{n} \vert {\dot{θ}}_{e} \vert + {e}_{θ} ( t ) + {M}_{k} )$$

$${G}_{e} ( y ) = \frac{1 + {k}_{2} {H}_{y}}{1 + {H}_{y}} , {k}_{2} > 1$$

In the control model and formula, the Jₙ is equivalent moment inertia of directive wheel of drive system, the Gₑ(y) is leading compensation coefficient, The H_{y} is steering control period, the e(θₑ) is d [symbol] rivative of deviation between the target control value of directive wheel angle θₑ₁ and its actual value of θₑ₂, k₁ and k₂ are coefficients. The equivalent relative angle velocity deviation ė(θₑ) of the left wheel and right wheel of the balance wheelset can be replaced by the equivalent relative slip ratio deviation e(Sₑ) of two directive wheels. The torque sensor is set on steering driving axle. Defining deviation eₘ(t) of rotary driving moment between detected value Mₕ₂ of the sensor and target control value Mₕ₁ of rotary driving moment of directive wheel, open-loop or closed-loop control is adopted during logical cycle of steering control period H_{y}. The target control value Mₕ₁ of rotary driving moment of directive wheel is always tracked by actual value of driving force Mₕ₂ by feedback control of deviation eₘ(t). The driving device for drive-by-wire steering includes motor and transmission device. Based on the interaction of rotation moment Mₖ of directive wheel exerted by ground and rotary driving moment Mₕ of directive wheel, the target control value θ₁ of directive wheel angle θₑ is always tracked by its actual value θ₂, by means of active or self-adaptive joint adjustment and coupling control of rotation driving torque Mₕ and steering wheel angle θₑ in any position of left turning or right turning of vehicle, and under the action of coordination control of driving torque Mₕ and rotation angle θₑ of directive wheel. For vehicle of left running or right running, and at zero position of steering angle of directive wheel, the controller will make one conversion to direction of electronically controlled parameters including rotation driving torque Mₕ of directive wheels. In left steering or right steering of vehicle, the direction of electronically controlled parameters that includes current and voltage are opposite, to realize the conversion of rotation direction of driving torque Mₕ. In the control process of left-turn and right-turn of vehicle, two sets coupling control systems which are independent and coordinate each other are established by direction conversion and control of parameters of rotation angle δ of steering wheel and driving rotation moment Mₕ of steering driving system in both sides of zero position of the δ and the Mₕ, according to coordinates rule set by vehicle. Whether vehicle is in state of straight running or steering, the tire burst rotation moment M_{b}′ is generated when tire burst of wheel occurs, therefrom to cause changes of the size and direction of the rotation moment Mₖ of directive wheel exerted by ground. At any position of angle θₑ of directive wheel and angle δ of steering wheel, the deflection and displacement of directive wheel angle θₑ and steering wheel angle δ for tire burst are generated immediately. In the first time of appearing of rotating moment deviation e_{θ}(t) of directive wheels and deviation e_{δ}(t) of rotation angle of steering wheel for tire burst, the direction of tire burst rotation moment M_{b}′ and rotation moment Mₖ of directive wheel exerted by ground are determined. At the same time, the control direction of directive wheel angle θₑ and the rotation driving moment Mₕ also are determined. When the tire burst rotation moment M_{b}′ is produced by tire burst, the rotation driving moment Mₕ₂ of directive wheel is timely detected by torque sensor set between the driving shaft and the directive wheel. A mathematical model of rotation driving moment of directive wheel is established by the parameters that include rotation driving moment eₘ(t) between the target control value Mₕ₁ and its actual value Mₕ₂ of directive wheel. According to the mathematical mode, the value of the rotary driving force Mₕ of directive wheel is adjusted in the cycle of period H_{y} of steering control, so that target control value of rotation angle θₑ of directive wheel is tracked by its actual value. The direction deviation of directive wheel and vehicle, which are caused by impact of tire burst rotating moment M_{b}′ is eliminated or is compensated, to realize stability control of tire-burst vehicle. Road-sense control and controller. Based on the relationship model among rotation angle of steering wheel, vehicle speed, lateral acceleration and steering resistance moment, a control mode of real road-sense is adopted. A mathematical model of road induction feedback force M_{wa} of a road induction device is established by control variables including driving moment Mₕ of directive wheel or/and ground rotation moment Mₖ of steering wheel exerted by ground, and by modeling parameters including relevant parameters of ground, vehicle and vehicle steering, to determine the target control value of road induction feedback force M_{wa}. The road sensor device which include road induction motor or road induction device of magnetorheological output feedback force of road sense. By motor of road induction or of road induction device of magnetic current variant, the driver can obtain road sense information which reflects road surface, wheel, running state and tire burst state of vehicle.

iii. Active control subroutine or software of drive-by-wire steering of vehicle driven by man.

Based on the structure, flow, control mode, model and algorithm of the active steering control, a control subroutine of the active steering control of vehicle is compiled. A subroutine of structured design is used. The subroutines include direction determination modules of rotation angle δ of steering wheel, tire burst rotation moment M_{b}′ or rotation moment Mₖ of directive wheel exerted by ground, rotation driving moment Mₕ of directive wheel; the subroutines include control program module of rotation angle θₑₐ of directive wheel, additional angle θ_{eb} of directive wheel, rotation moment Mₖ of directive wheel exerted by ground, driving rotation moment Mₕ of directive wheel, and coordination control program module of the active steering and electronic stability control program system ESP, or/and program module of real road sense for tire burst or no tire burst.

3). Active Steering Control and Controller of Driverless Vehicle

(1). Central controller of driverless vehicle. The central master controller includes sub-controllers of environment perception and recognition, positioning and navigation, path planning, control decision for normal and tire burst working state, it includes fields of tire burst vehicle stability control, tire burst collision prevention, path tracking, addressing to parking and path planning of parking. When the entering signal iₐ of tire burst control arrives, the vehicle get into a control mode for tire burst: the central controller sets up various sensors of environmental perception and vehicle control, and set up machine vision, global satellite positioning, mobile communication, navigation, artificial intelligence controllers, or/and sets up intelligent vehicle network controller in condition of which intelligent vehicle network has be established. During state process and control period of tire burst, steady state of wheels, stability and attitude control of vehicles, stable deceleration or acceleration control of the whole vehicle in a entirety are planned by environment perception, positioning, navigation, path planning and control decision-making of vehicle, according to direction of tire burst, tire burst control mode, model and algorithm of braking, driving, rotation force of steering wheel, active steering and suspension control; the central master controller unified plans coordination control of lane holding of tire-burst vehicle, anti-collision control of the vehicle to the front and rear vehicles or/and with obstacles; the central master controller makes a strategic decision of vehicle speed, running path and path tracking of vehicle, or/and makes a decision of parking location and path to the parking site after vehicle tire-burst, to realize the parking control of tire burst vehicle.

(2). Lane maintenance and direction controller of tire burst vehicle

i. The environment sensing, positioning and navigating sub controller.

The controller obtains information of road traffic, road signs, road vehicles and obstacles by system of global satellite positioning, vehicle-borne radar, machine vision which include camera of optical electronic and computer processing, mobile communication, or/and vehicle network; based on the information, the controller processes the information, and carries out positioning, driving and navigation to vehicle, and determine distance between the vehicle and the front and rear vehicles, Lane lines, obstacles, relative speed between front vehicle and rear vehicles; the controller makes overall layout of locating of the vehicle and the surrounding vehicles, running environment and running planning.

ii. Path planning sub-controller. Based on environment perception, positioning, navigation and stability control of tire burst vehicle, a control mode and algorithm of wheel, steering and vehicle in normal and tire burst working conditions are used to determine target control value of parameters that include vehicle speed uₓ, the rotation angle θₗᵣ of tire-burst vehicle and rotation angle θₑ of directive wheel. The mathematics model and algorithm is set up by modeling parameters which include uₓ, θₗᵣ, θₑ, Lₛ, L_{g}, θ_{w}, Rₛ, Sᵢ, to formulate position coordinates charts of the vehicles, to plan running paths charts of the vehicle, to determine running routing of the vehicle according to the running charts and running paths. In the parameters, the uₓ is vehicle speed, θₗᵣ is steering angle of tire-burst vehicle, θₑ is rotation angle of directive wheel, L_{g} is distance from the vehicle to left vehicles or/and right vehicles, Lₛ is distance from the vehicle to obstacle or/and vehicle Lane, Lₜ is distance from the vehicle to front vehicle or rear vehicle or/and obstacle, θ_{w} is the orientation angle of the lane that includes the lane line in coordinates, Rₛ is turning radius of gyration or curvature of running path of lane or vehicle, Sᵢ is slip ratio of directive wheel and μᵢ is ground friction coefficient of tire-burst vehicle.

iii. Control decision of sub-controller. Under normal and tire burst working conditions, a coordinated control mode and models of running of vehicle are established by environment identification, positioning of vehicle and lane as well as obstacle, navigation and path planning of the vehicle. The vehicle speed uₓ, steering angle θₗᵣ of vehicle, rotation angle θₑ of directive wheel and their target control value are determined by relevant parameters and above coordinated control mode and models, to realize coordinated controls of vehicle lane maintenance, path tracking, vehicle attitude, collision avoidance and steady-state control of wheel and vehicle. The mathematical model of ideal steering angle θₗᵣ of vehicle and rotation angle θₑ of directive wheel are established, include:

θₗᵣ(Lₜ,L_{g},θ_{w},uₓ,Rₛ,Sᵢ,μᵢ) [symbol] θₗᵣ(γ,uₓ,Rₛ,Sᵢ,μᵢ)

θₑ(Lₜ,L_{g},θ_{w},uₓ,Rₛ,Sᵢ,μᵢ) [symbol] θₑ(γ,uₓ,Rₛ,Sᵢ,μᵢ)

The modeling structure of the model: the ideal or target control value of rotation angle θₗᵣ of vehicles and rotation angle θₑ of directive wheel are a decreased function to increment of parameters Rₛ and μᵢ, and is increased function to increment of wheel slip rate Sᵢ; the vehicle speed uₓ is a decreased function with increment of θₗᵣ or θₑ. Based on coordinate positions of lane, surrounding vehicles, obstacles and the tire burst vehicle, the direction and size of control variable θₗᵣ and θₑ of vehicle are determined by parameters including L_{g} [symbol] Lₛ [symbol] θ_{w} [symbol] Rₕ [symbol] uₓ. Defining three types of deviations of vehicles and wheels. Deviation 1: the deviation e_{θT}(t) between ideal steering angle θₗᵣ of the vehicle to path planning, path tracking determined by the central controller and actual steering angle θₑ′ of directive wheel is defined. The actual steering angle θₑ′ of the directive wheel contains the steering angle caused by the tire burst rotating moment M_{b}′ under the condition of tire burst. Deviation 2: the deviation e_{θlr}(t) between ideal steering angle θₗᵣ of vehicle and actual steering angle θₗᵣ′ of vehicle is defined. Deviation 3: deviation e_{θ}(t) between ideal rotation angle of directive wheel and actual rotation angle θₑ′ of directive wheel is defined:

e_{θT}(t)=θₗₑ−θₑ′ [symbol] e_{θlr}(t)=θₗᵣ−θₗᵣ′ [symbol] e_{θ}(t)=θₑ−θₑ′

A mathematical model of steering vehicle is established by modeling parameters including θₗᵣ [symbol] θₑ and their deviation e_{θT}(t), e_{θlr}(t) and e_{θ}(t), to determine target control values of steering of vehicle and wheels in real-time. The deviation e_{θT}(t) between ideal steering angle θₗᵣ of vehicle and actual steering angle θₑ′ of wheel can determine sideslip angle and sideslip state of directive wheel. Dynamic control period H_{θn} of rotation angle of directive wheel is set up, and the equivalent model and algorithm of H_{θn} are determined by modeling parameters including speed uₓ and angle deviation e_{θlr}(t) of vehicle. The θₑ and the θₗᵣ are the main control parameters for lane planning, Lane maintenance and path tracking of driverless vehicles.

(3). Drive-by-wire active steering controller of vehicle. The active steering controller is a kind controller by connection of high-speed fault-tolerant bus and management of high-performance CPU control and. The controller adopts redundancy design, and sets up a combination system of directive wheel and drive-by-wire steering of vehicle, and adopts various control modes and structures including steering of front and rear axles or steering of four-wheel by drive-by-wire independently. The combination system sets central control computer of artificial intelligence, dual or triple steering control unit, dual or multiple software, two or three groups of electronic control unit, active steering unit and motors provided with independent structure and combination structure. Based on dynamic system constituted by directive wheels, steering motor, steering device and rotation force of wheel exerted by ground, it are formed that multiple control function loops which include feedback control loops of drive-by-wire steering and steering failure control of vehicle in control. Directive wheel controller and drive-by-wire failure sub-controller are set up. A failure auxiliary steering control of yaw moment produced by differential braking of wheels of braking system is adopted, to realize failure protection of drive-by-wire steering. The x-by-wire bus is used in the controller. The information and data exchange of vehicle-mounted systems are realized by the vehicle-mounted data bus.

i. Active steering control and controller for tire burst. The steering controller of vehicle for tire burst takes vehicle speed uₓ, steering angle θₗᵣ of vehicle, rotation angle θₑ and rotation driving moment Mₕ of directive wheel as main control variables. Based on target control values of vehicle speed uₓ, curvature or steering radius Rₕ of traffic lane, path and vehicle, steering angle θₗᵣ of vehicle and rotation angle θₑ of directive wheel determined by path tracking control of central controller, it is determined that coordinated or coupled control mode, model and algorithm of two coupled control parameters which include θₑ and Mₕ of steering wheel; according to the mode and model of active steering control and the parameters θₑ and Mₕ for tire burst, target control value of θₑ and Mₕ are calculated under working condition of normal and tire burst. An equivalent model and algorithm of dynamic control period H_{θn} of steering wheel angle are determined by modeling parameters including speed uₓ and rotation angle deviation e_{θlr}(t) of vehicle. During each control period H_{θn}, the target control values of rotation angle θₑ of directive wheel for vehicle path planning and t path racking are determined by the controller with modeling parameters which include deviation e_{θT}(t) between ideal steering angle θₗᵣ of vehicle and actual steering angle θₑ′ of directive wheel, deviation e_{θlr}(t) between ideal steering angle θₗᵣ and actual steering angle θₗᵣ′ of vehicle, and angle θₑ of directive wheel under the condition of vehicle tire burst. Based on deviation values of e_{θlr-1}(t) [symbol] e_{θT-1}(t) and θₑ₋₁ of the previous control cycle H_{θn-1}, the target control value of rotation angle θₑ of directive wheel in the period H_{θn} is determined by the above control model. Define the deviation e_{θ}(t) between ideal rotation angle θₑ and actual rotation angle θₑ′ of directive wheel. The rotation angle θₑ of directive wheel uses closed loop control. In logical cycle of each control period H_{θn}, the zero value of deviation e_{θ}(t) is taken as the control objective, so that the actual value of directive wheel angle θₑ′ always tracks the target control value of θₑ.

ii. Rotary driving moment control and controller of steering wheel of tire burst vehicle. A active steering control and controller of drive-by-wire are adopted. Based on the judgement regulations of magnitude and direction of steering torque and steering angle in coordinate system of active steering of drive-by-wire, two sets independent coupling control system of vehicle rotation angle θₗᵣ or/and directive wheel rotation angle θₑ and rotation drive torque Mₕ of directive wheel in both sides of zero or origin of directive wheel rotation angle θₑ are established when left steering and right steering of vehicle, to adapt coordinated control of two parameters of angle θₗᵣ and rotary drive moment Mₕ of vehicle. At the coordinate origin of vehicle steering angle θₗᵣ, namely zero point of left steering or right steering of vehicle, the direction of electronically control parameters, which include direction of current or voltage of electric driving device, and rotary direction of motor or translational driving of electric driving device are converted by electronic control unit of controller, to adapt to the coupling or coordinated control between the rotation angle θₑ and the rotating driving torque Mₕ. Using rotation angle θₑ of directive wheel and rotation driving moment Mₕ of directive wheel exerted by ground as control variables, and based on dynamics equation of steering system, a coordinated control model of rotation driving moment Mₕ of directive wheel is established by modeling parameters including rotation moment Mₖ of steering wheel exerted by ground, rotation angle deviation e_{θ}(t) and rotation angle velocity \dot{θ}ₑ of directive wheel, to determine the target control value of Mₕ. The direction of rotation driving moment Mₕ of directive wheel is determined by deviation e_{θ}(t) between the target control value θₑ₁ and its actual value θₑ₂ of the directive wheel. Defining deviation eₘ(t) between detection value M_{b}′ of torque sensor and target control value Mₕ of rotary drive moment of the directive wheel. Open-loop or closed-loop control of rotation driving torque of steering wheel is adopted under condition of tire burst and non-tire burst. In the logic cycle of steering control period H_{y}, the target control value Mₕ of rotary drive moment of steering wheel is always tracked by its actual value M_{b}′ based on the return control of torque deviation eₘ(t). Under action of ground rotation moment Mₖ and rotation driving moment Mₕ of steering wheel, the rotation angle θₑ of directive wheel is controlled by active or adaptive uniting adjustment of driving torque Mₕ and rotation angle θₑ of directive wheel at any steering angle position of left side or right side of the vehicle, so that actual value θₑ₂ of steering angle of steering wheel keeps track to its target control value θₑ₁. The driving device of steering system includes a motor or translating device. At the zero position of angle of directive wheel, and when left steering or right steering of vehicle, the rotary driving torque controller of directive wheel makes a one-time conversion to the direction of control parameters including driving torque Mₕ of directive wheel at the zero position of the angle, or makes a change to the direction of driving current and voltage of directive wheel. In the control of left steering and right steering of vehicle, the steering drive system is constituted by two independent coupling control systems of steering angle θₗᵣ of vehicle and driving moment Mₕ of steering wheel, according to their coordinates. When tire burst occurs, the deviation of rotation angle θₑ of directive wheel is produced at any steering angle position of rotation angle θₑ of directive wheel. In the moment of which the directive wheel angle deviation e_{θ}(t) is generated, the active steering controller of drive-by-wire determines the changed direction of the tire burst rotation moment M_{b}′ and rotation moment Mₖ of directive wheel exerted by ground, the direction of control direction of rotation angle θₑ of directive wheel and the driving moment Mₕ. At the moment of which tire burst rotational torque M_{b}′ occurs, the torque sensor installed between driving axle of steering system and the directive wheel detects actual rotation driving moment Mₕ₂ of directive wheel in time. Based on a mathematical model of the deviation eₘ(t) between target control value Mₕ₁ of directive wheel rotation driving moment and its actual value Mₕ₂, value of directive wheel rotation driving moment is adjusted in the logic cycle of period H_{y} of steering control, so that the target control value of rotation angle θₑ of directive wheel is tracked by its actual value. The direction deviation of directive wheel and vehicle caused by impulse of tire burst rotary moment M_{b}′ is eliminated or is compensated, to realize stability control of steering of tire burst vehicle.

iii. Path planning, path tracking and safe parking of tire burst vehicle

First. A networked controller of Internet automotive network is set up. Through the global satellite positioning system and mobile communication system, the wireless digital transmission module set by networked controller of vehicle sends signals of position, tire burst status, running and control status of the vehicle to coupling network of the passing vehicles of periphery region. The wireless digital transmission module of the tire burst vehicle can obtain the query information required by the tire burst vehicle, which includes addressing of parking position of the tire burst vehicle and planning path to the parking position by coupling network of the vehicle. Second. A view processing analyzer of artificial intelligence is set up. During running process of vehicle, the processor and analyzer set by the controller classifies and process camera screenshots of surrounding road traffic and environment by category, and temporarily store the typical images, and replace screenshots according to a certain period or/and level, and determine the typical images stored. The typical images stored in the main control computer include emergency parking lane, ramp exiting and parking space of beside road of highway. Based on artificial intelligence, the typical features and abstract features of image obtained. In tire burst control of the vehicle, the tire burst controller set in the networked vehicle uses machine vision recognition or/and networking search mode, and processes and analyzes the images of road and surrounding environment taken by the machine vision in real-time. According to the image features and abstract features, the road image and its surrounding environment image taken from machine vision is compared with the typical classification image of parking location stored in the main control computer. The safely parking position of emergency parking lane, ramp exit or highway side is determined by analysis and judgment of computer. The tire burst vehicle can be driven to the planned parking position, according to the parking line.

(4). Anti-collision control and controller t of driverless vehicle for tire burst

Based on coordinated control mode of anti-collision, braking, driving and stability of tire burst vehicle, the controller is equipped with control modules of machine vision, ranging, communication, navigation and positioning, to determine position of the vehicle, coordinates position from the vehicle to the front, rear, left, right vehicles and obstacles in real time; on this basis, the distance and relative speed between the vehicle and the front, rear, left, right vehicles and obstacles are calculated by control time zone of multiple levels which include safety, danger, no entry and collision. The collision-avoidance, steady-state of wheel and vehicle, and deceleration control of the tire burst vehicle are realized by independence or/and combination control of brake A, B, C, D in logic cycle of period Hₕ, control mode conversion of braking and driving, coordination control of active steering and active braking. The collision-avoidance control of tire burst vehicle includes collision-avoidance control of the vehicle and front, rear, left right vehicles, and around obstacles. According to the route planned by the controller, path tracking of the tire burst vehicle is carried, to arrive safe parking position of the vehicle.

(5). Failure control of active steering of drive-by-wire for tire burst and no tire burst vehicle and controller. The controller adopts the overall failure control mode. When steering of vehicle driver by man or driverless vehicles fails or lose efficacy, the controller of drive-by-wire steering set by central master controller processes to relevant datum according to a mode, model and algorithm of steering losing efficacy control. The controller outputs signals of unbalanced differential braking of wheels and controls hydraulic braking system (HBS) or the electronic hydraulic braking system (EHS), or the electronic mechanical braking system (EMS), to realize steering failure control by exerting an additional yaw moment to vehicle of drive-by-wire steering, which is produced by differential braking of wheels. Based on vehicle dynamics control system (VDC) or electronic stability program system (ESP), the controller adopts a control modes, models or/and algorithms of wheel steady-state braking A control, balance braking B control, vehicle steady-state braking C control and total braking force D control (shorter form: braking A, B, C and D control). When steering failure control signal i_{z} arrives, the controller take speed uₓ, ideal and actual yaw angle speed deviation of vehicle, sideslip angle deviation e_{β}(t) for vehicle quality center, deviation e_{θlr}(t) between ideal steering angle θₗᵣ of vehicle and the actual steering angle θₗᵣ′ of vehicle, or/and deviation e_{θT}(t) of steering angle of directive wheel and vehicle as main modeling parameters, and adopts several control kinds of logical combination which include A⊂B∪C [symbol] A⊂C [symbol] C⊂A. According to vehicle motion equations which include two freedom or multi degree freedom model of vehicle, the relationship model between rotation angle θₑ of steering wheel and vehicle yaw angle speed ωᵣ₁ is determined at a certain speed uₓ or/and the ground adhesion coefficient μ. The controller calculates ideal yaw rate ωᵣ₁ and sideslip angle β₁ of vehicle. The actual yaw angle rate ωᵣ₂ of vehicle is measured by yaw angle rate sensor in real time. The deviation e_{ω}_{ᵣ}(t) between ideal and actual yaw angle speed and the deviation e_{β}(t) between ideal and actual centroid sideslip angle are defined. A mathematical model which determines optimal steering additional yaw moment Mᵤ by differential braking force of wheels is established by modeling parameters of deviation of e_{ω}_{ᵣ}(t) and e_{β}(t). An optimal steering additional yaw moment under differential braking of wheels is determined by infinite time state observer designed by LQR theory. The mathematical model between rotation angle θₑ of directive wheel and yaw moment Mᵤ of drive-by-wire vehicle is established. Based on the mathematical model, the target control value of additional yaw moment Mᵤ of which can make vehicle achieve a certain steering angle θₗᵣ or can make wheel achieve a certain steering angle θₑ is determined by differential braking of wheels. Under normal, tire burst and other working conditions of vehicle, the distribution among wheels of optimal additional yaw moment Mᵤ which is used to vehicle steering can adopt one form of control variables of braking force Qᵢ, angle deceleration speed \dot{ω}ᵢ, negative increment Δωᵢ of angle velocity or slip rate Sᵢ of wheels, and the distribution and control are limited in stable region of characteristic function curve of wheel brake model. The steering failure control is realized by cycle of period H_{y} of logic combination for brake control A⊂B∪C [symbol] A⊂C [symbol] C⊂A. Under condition of parallel operation of manual braking operation interface and wheel active differential braking, the failure control of drive-by-wire steering adopts the control logic combination of C⊂A∪B. The brake force in balance braking B control is determined by function model of which the braking force is output from manual brake operation interface. When a wheel enters brake anti-lock control, braking force Qᵢ or one of Δωᵢ [symbol] Sᵢ of wheel in balance braking B control is reduced in a new braking period Hₕ₊₁, until balance braking force of the wheel is 0. According to threshold model, the brake control logic combination A⊂B∪C is adopted when the absolute value of deviation e_{ω}_{ᵣ}(t) or/and e_{β}(t) is less than the set threshold value C_{kω}_{ᵣ}. The brake control logic combination A⊂C or C⊂A is adopted when the absolute value of deviation e_{ω}_{ᵣ}(t) or/and e_{β}(t) is greater than C_{kω}_{ᵣ}. The overall failure control of drive-by-wire steering of vehicle and stable deceleration control of vehicle are realized through the logic cycle of brake period Hₕ.

(6). Subroutine or software of steering by drive-by-wire of driverless vehicle

Based on main program of environment perception, positioning, navigation, path planning and control decision-making set in the central controller, the control subroutine of the active steering control of tire burst vehicle is compiled according to the control structure and process, control mode, model and algorithm. The subroutine adopts a mode of a structural design. The subroutine sets program module of direction judgment of relevant parameters of steering angle and steering torque of vehicle. The subroutine sets program modules and coordination control program modules of the steering angle θₗᵣ of vehicle, steering angle θₑ of directive wheel and rotation driving moment Mₕ of directive wheel to tire burst. The subroutine set up program modules of anti-collision, braking, driving, stability control of wheel and vehicle, or/and failure control of drive-by-wire steering of the tire burst vehicle.

### 4. Drive Control and Controller for Tire Burst

The method adopts a corresponding control mode and model of tire burst driving. Setting the entry conditions of driving control for vehicle tire burst. After tire burst control entry signal iₐ arrives, the tire burst drive controller of driven by man vehicle or driverless vehicle with auxiliary driving operation interface starts tire burst driving control and send drive control entry signal, according to requirements for tire burst drive control which is identified by driver's characteristic function Wᵢ of vehicle acceleration control willingness or/and collision avoidance control of driverless vehicle. Based on tire burst state and vehicle stability control state, a coordinated control mode, model and algorithm of driving and braking, driving and steering for tire burst are established. The vehicle acceleration \dot{u}ₓ and vehicle speed uₓ is determined. The vehicle enters a coordinated control of driving and secondary stability for tire burs.

(1). Driving control and controller for tire burst vehicle

i. Tire burst drive control for manned vehicle or driverless vehicle with manual auxiliary operation interface. During tire burst control, the characteristic function Wᵢ (Wₐᵢ [symbol] W_{bi}) which shows driver's willingness of acceleration and deceleration control of vehicle is introduced. According to condition and model of self-adapting exiting and returning of tire-burst driving control, the tire-burst control of tire-burst driving controller enters or retreat based on the characteristic function Wᵢ for driver's control intention. The adaptive control model, control logic and logic sequence limited by the condition are established with modeling parameters which include stroke hᵢ of driving pedal and its change rate \dot{h}_{ι}. Based on the division of first, second or multiple stroke of driving pedal and the direction division of positive or negative stroke of driving pedal, a control model which includes logic threshold model of active exiting from tire burst braking control, entering of engine driving control and automatic return of tire burst braking control are established. The value of logic threshold model and control logic are set. When tire burst control entering signal iₐ arrives, and if driving pedal of vehicle is in its one stroke, no matter where driving pedal is located, the engine of vehicle or driving device of electric vehicle will terminate driving output to vehicle immediately. In the two or more strokes of the driving pedal, and when the value determined by the characteristic function Wᵢ reaches a set threshold value, the tire burst braking control exits actively, and vehicle enters driving control limited by condition. In the return stroke of two or more of the driving pedal, and when the value determined by characteristic function Wᵢ reaches set threshold value, the driving control of vehicle exits, and tire burst braking control returns actively. According to the division of first, second and multiple stroke of driving pedal, a asymmetric function model of positive and negative stroke of driving pedal is established by modeling parameters which include driving pedal stroke hᵢ and its derivative h̅_{ι}. The so-called asymmetric functions model with parameters hᵢ and \dot{h}_{ι} refer to: the parameters set by model and modeling structure of functional model in positive and reverse stroke of driving pedal are not identical completely or not exactly same, and the values of function mode Wᵢ are completely different or not identical completely at the same point set by its variables or parameters hᵢ. In first stroke of driving pedal of vehicle, tire blowout drive control does not started. In second or more strokes of driving pedal, the value of function W_{b1} at any hᵢ point of positive stroke pedal of the driving pedal is less than function value of W_{b2} at any same hᵢ point of reverse stroke pedal of the driving pedal. The positive (+) and negative (−) of stroke hᵢ of driving pedal can indicate driver's willingness to accelerate or decelerate of the vehicle. For self-adaptive exiting and entering of tire burst braking control, a logical threshold model with parameter Wₐᵢ is adopted under control of the operating interface of driving pedal. A decreased datum set of cₕₐᵢ and c_{hbi} of logical threshold of positive and negative stroke of driving pedal is set. The set of cₕₐᵢ includes eₕₐ₂, eₕₐ₃ . . . cₕₐₙ. The set of c_{hbi} includes C_{hb2}, c_{hb3} . . . e_{hbn}. During second time or multiple times positive stroke of driving pedal, the burst tire braking control exits actively and tire burst drive controls enters actively when of value Wₐᵢ reaches the threshold value cₕₐᵢ. The burst driving control exits actively when W_{bi} reaches the threshold value c_{hbi}. In the second or multiple times reverse stroke of driving pedal, the tire burst brake control actively returns when travel hᵢ of driving pedal is 0. In tire burst control of the first, second and multiple stroke of the driving pedal, a control of opening degree of throttle and fuel injection quantity of engine or output of the driving device of electric vehicle adopt control model with parameters which include stroke hᵢ of driving pedal stroke, to realize the tire burst driving control of the vehicle. Definition of the first, second and multiple stroke of driving pedal: when the tire burst control entering signal iₐ arrives, the any stroke position of driving pedal or any stroke position of positive and negative of starting from zero position is called one stroke, and the positive and negative stroke restarted after first stroke which returns to zero is called second stroke, and the strokes of driving pedal after the second stroke are called multiple stroke. The two type signals of burst control entering signal and tire burst control automatic restart signal after control exiting from mode of man-machine alternating are called as burst control entering signal iₐ. The burst control entering signal and burst control exiting signal can be expressed by the high and low electrical level or specific logic symbols which include digital and digital code. When tire burst braking control identified by driving pedal operation interface exits or returns actively, the electronic control unit outputs man-machine alternating braking control exiting signal iₖ or tire burst braking control return signal iₐ.

ii. Driving control of driverless vehicle. According to control requirements to acceleration \dot{u}ₓ, speed uₓ and path tracking of vehicle, the central controller of driverless vehicle determines parameter forms of one of driving force Qₚ of vehicle, comprehensive angle acceleration \dot{ω}ₚ or comprehensive driving slip ratio Sₚ of wheels, and determines algorithm of parameter Q_{P}, \dot{ω}_{P} or Sₚ of each wheel. Using equivalent models of relationship between one of parameters Qₚ, \dot{ω}ₚ, Sₚ and one of throttle opening Dⱼ, fuel injection quantity Qⱼ. One of parameters Qₚ [symbol] ωₚ or Sₚ are converted to one of throttle opening Dⱼ and fuel injection quantity Qⱼ of fuel engine; from this, one of above parameters is converted to current or/and voltage of the electric drive device of the electric vehicle. When necessary, the conversion of control parameters is determined by the relevant datum of field test.

iii. Self-adaptive drive control for tire burst. One of target control values \dot{ω}ₚₖ Sₚₖ or Qₚₖ of comprehensive angle acceleration ωₚ of wheels, comprehensive driving slip ratio Sₚ of wheels and driving force Qₚ of vehicle is determined by self-adaptive control model. The Qₚₖ is determined by mathematical model with parameters γ and Qₚ. The \dot{ω}ₚₖ is determined by the mathematical model with parameters γ and \dot{ω}ₚ. The Sₚₖ is determined by mathematical model with parameters γ and Sₚ:

Qₚₖ=f(γ,Qₚ) [symbol] \dot{ω}ₚₖ=f(γ,\dot{ω}ₚ) [symbol] Sₚₖ=f(γ,Sₚ)

In formula the γ is tire burst characteristic parameter. The γ is determined by mathematical model with parameters which include collision avoidance time zone tₐᵢ, vehicle yaw angle velocity deviation e_{ω}_{ᵣ}(t), sideslip angle deviation e_{β}(t) to mass center of vehicle, or equivalent relative angle velocity deviation e(ωₑ) and angle acceleration deviation e(\dot{ω}ₑ) of two wheel for balance wheel pair of tire burst vehicle.

γ=f(tₐᵢ,e_{ω}_{ᵣ}(t),e(ωₑ),e(\dot{ω}ₑ)) or γ=f(tₐᵢ,e_{ω}_{ᵣ}(t),e(ωₑ),e_{β}(t))

The modeling structures of models \dot{ω}ₚₖ and Sₚₖ are as follows. The Qₚₖ, \dot{ω}ₚₖ, Sₚₖ are decreasing functions of increment of γ. The γ is an incremental function of decrement of anti-collision control time zone tₐᵢ, and the γ is an incremental function of absolute value of increment of e_{ω}_{ᵣ}(t), e_{β}(t), e(ωₑ) and e(\dot{ω}ₑ). When the vehicle enters danger or forbidden time zone tₐᵢ that the vehicle collides with front vehicle, the driving of the vehicle is relieved. When the vehicle exits from the dangerous time zone tₐᵢ of colliding with front vehicle, it returns to the tire burst drive control.

iv. Allocation in each wheel of one of target control value for control variables Qₚₖ [symbol] \dot{ω}ₚₖ and Sₚₖ. The Qₚₖ [symbol] \dot{ω}ₚₖ or Sₚₖ is allocated to no-burst tire wheel, or two wheels of wheelset of driving axle, or two wheels of steering wheelset. First. The tire burst driving control of vehicle set by a drive shaft and a non-drive shaft. When tire burst of one wheel of driving axle arises, the Qₚₖ [symbol] \dot{ω}ₚₖ or Sₚₖ is distributed to the wheelset of driving axle. Under action of differential mechanism of steering axle, two wheels of the wheel pair of driving axle obtain same tire force. When tire burst wheel of steering axle is driven to slip, that is, the parameter value \dot{ω}ₚₖ₁, Sₚₖ₁ of tire burst wheel is larger than the parameter value \dot{ω}ₚₖ₂ Sₚₖ₂ of the no burst tire wheel, the driving force provided by the driving axle fails to reach the target control values of Qₚₖ [symbol] \dot{ω}ₚₖ Sₚₖ, the tire burst wheel of the steering axle can be braked, so that, values of the \dot{ω}ₚₖ₁ and \dot{ω}ₚₖ₂ of left and right wheels of the driving axle may be equal, or Sₚₖ₁ is equal to Sₚₖ₂. The coordinated control model of steering and driving is established to determine the additional angle θₚ of directive wheel; the insufficient or excessive steering of vehicle, which is caused by applying braking force to tire burst wheel, is compensated, to balance the vehicle instability caused by the braking. When wheel tire burst of non-driving axle, the driving force is allocated to wheelset of the driving axle. For four-wheel vehicle with front and rear drive axles, the driving force is allocated to two wheel of wheel pair of no tire burst drive axle under state of wheel tire burst of one drive axle. Second. Tire burst drive control of electric vehicle. When vehicle sets two driving axles, or when four wheels are driven independently, the driving force exerts on two wheels of no tire burst wheelset; in the same time, the driving force can exert on the no tire burst wheel of the tire burst wheelset, and the driving force of the wheelset produces unbalanced yaw moment Mᵤ₁ to mass center of vehicle. The unbalanced yaw moment Mᵤ₁ to mass center of vehicle is compensated by unbalanced yaw moment Mᵤ₂ produced by differential driving force exerted on the two wheels of no tire burst wheelset. The vector sum of Mᵤ₁ and Mᵤ₂ is 0. The sum of yaw moment exerting on the vehicle mass center of all wheels is 0, thus, to realize balanced driving for the whole vehicle.

(2) Stability control of driving for tire burst vehicle

The coordinated control mode of driving, braking stability or/and balance control of active steering of tire burst vehicle are adopted.

i. In driving control of tire-burst vehicle, the logical combination A⊂C [symbol] C or A of braking stability C control of vehicle and wheel braking stability A control are adopted. During the cycle of its logical combination control, the additional yaw moment Mᵤ exerting on mass center of vehicle is formed by longitudinal tire force produced by differential braking or differential driving of each wheel. The Mᵤ is used to balance the tire burst yaw moment Mᵤ′, the unbalancing driving yaw moment Mₚ or/and the braking yaw moment Mₙ produced in steering of vehicle; the Mᵤ can be use to compensate insufficient or excessive steering of vehicle, to control the dual instability caused by tire burst of vehicle and control according to normal working of vehicle.

ii. For active steering vehicles, a combined control mode of braking stability and active steering balancing of vehicle is adopted. Based on rotation angle δ of steering wheel or rotation angle θₑₐ of directive wheel determined by driverless vehicle, the additional rotation angle θ_{eb} of the vehicle is exerted to actuator of the active steering system AFS; the additional rotation angle θ_{eb} can be not determined by operation of driver, or by control of driverless vehicle under state of normal working condition. Within critical speed range of vehicle, the unbalanced driving moment M_{b}′ or/and brake yaw moment Mₙ produced in steering of vehicle can be compensated by yaw moment produced by additional rotation angle θ_{eb}, to balance insufficient or excessive steering of the vehicle. The combined control is especially suitable for vehicles with one driving axle and one steering axle, and is especially suitable for vehicles in which the driving axle and the steering axle are as a same axle. In vehicle driving stability control, the distribution of additional angle θ_{eb} of vehicle and the additional yaw moment Mᵤ produced by differential braking or differential driving of each wheel is realized by distribution model with modeling parameters that include longitudinal slip ratio of wheel, or longitudinal slip ratio of wheel and side slip angle of steering wheel, based on the friction ellipse theory model of wheel.

(3). Tire burst driving control subroutine or software

Based on the control structure and process, control mode, model and algorithm for tire burst, the control program or software of tire burst drive of vehicle is developed. The program adopts a mode of structured design. The wheel drive control subroutine includes program modules of control mode conversion between braking and drive for tire burs, self-adaptive drive control of driven by man vehicle, drive control of driverless vehicle and stability drive control for tire burst vehicle.

### 5. Suspension Lifting Control

1). Suspension Lifting Control and Controller

Based on vehicle passive, semi-active or active suspension system, a coordinated control mode, model and algorithm of suspension are established by using modern control theory and corresponding algorithms, such as ceiling damping, PID, optimum, self-adaptive, neural network, sliding mode variable structure or fuzzy control for tire burst and normal working condition. The target control value of elastic element stiffness Gᵥ of suspension, damping Bᵥ of shock absorber, position height Sᵥ of suspension are determined by the control mode, model and algorithm. Second judgment model of suspension control for tire burst is established. The model includes threshold models of single parameter or multi parameter. When tire burst control entering signal iₐ arrives, the second judgment of suspension control is made by the main and secondary threshold model. Based on secondary threshold model, the controller outputs the second starting or entering signal iᵥₐ or exiting signal iᵥₑ for the tire burst suspension control, to realize the conversion of suspension control mode of normal and tire burst condition.

(1) Suspension Lifting Control

i. Entering and exiting of suspension lifting control for tire burst. The controller sets a threshold model with modeling parameters of tire pressure pᵣ(pᵣₐ [symbol] pᵣₑ) or effective rolling half-way Rᵢ of wheel, lateral acceleration \dot{u}_{y}. A threshold (value) aᵥ (aᵥ₁ [symbol] aᵥ₂) of threshold model is determined. After the tire burst control entering signal iᵥₐ arrives, and when the pᵣₐ or Rᵢ reaches the main threshold aᵥ₁ and the \dot{u}_{y} reaches the sub-threshold aᵥ₂, or \dot{u}_{y} reaches the main threshold aᵥ₂ and pᵣₑ reaches the sub-threshold aᵥ₁, or one of the pᵣₐ and the \dot{u}_{y} reaches the corresponding threshold aᵥ₁ or aᵥ₂, the vehicle enters tire burst suspension control. The electronic control unit set by the controller sends out the suspension control entering signal iᵥₐ for tire burst; otherwise the exiting signal iᵥₑ of tire burst control is output, the suspension control of tire burst exits. The aᵥ₂ is determined by model with parameters which include half distance Lᵥ₂ between front and rear axles of vehicle, half wheelbase of front or rear axles half-spacing Lᵥ₁, the vehicle centroid height hₖ and the vehicle rollover angle γ_{d} of tire burst.

$${a}_{v 2} = \frac{{L}_{vv}}{{kh}_{k}} g + cos {γ}_{d} , {L}_{vv} = \sqrt{{L}_{v 1}^{2} + {L}_{v 2}^{2}}$$

When vehicle enters real control period or inflection control period for tire burst, the threshold value aᵥ₂ is adjusted by the coefficient K.

ii. Suspension lifting controller. A coordinated control modes of Gᵥ [symbol] Bᵥ and Sᵥ are established by the controller with control variable of suspension displacement Sᵥ, shock absorption resistance Bᵥ and suspension stiffness, to determines target control values of Gᵥ [symbol] Bᵥ and Sᵥ of tire burst wheel. According to the modes, the amplitude and frequency of suspension in the vertical direction of vehicle body are calculated. The pneumatic or/and hydraulic spring suspension adopts pneumatic or/and hydraulic power source, and servo pressure regulating device

First. According to the coordinated control mode of control values Gᵥ [symbol] Bᵥ and Sᵥ, corresponding mathematical models of the Gᵥ [symbol] Bᵥ and Sᵥ is established respectively by modeling parameters which include input pressure pᵥ, or/and flow Qᵥ, load N_{zi} of the regulating device, and include damping coefficient kⱼ of throttle opening of liquid flow between working cylinders of shock absorber, fluid viscosity v_{y}, suspension displacement Sᵥ and the displacement velocity \dot{S}ᵥ and acceleration \ddot{S}ᵥ, and the velocity and acceleration velocity of fluid flowing through throttle valve, and elastic coefficient kₓ of spring suspension:

Sᵥ=f(pᵥ,N_{zi},Gᵥ),Sᵥ=Sᵥ₁+Sᵥ₂+Sᵥ₃

Bᵥ=f(\dot{S}ᵥ,\ddot{S}ᵥ,kⱼ,v_{y}),Gᵥ=f(kₓ,pᵥ) or Gᵥ=f(k_{xb},hᵥ)

In the formula, the Sᵥ₁ is static position height parameter of suspension, the Sᵥ₂ is position height adjustment parameter for normal working condition, the Sᵥ₃ is position height adjustment parameter of suspension for tire burst, the kₓ is elasticity coefficient of spiral spring, the hᵥ is elastic deformation length of spiral spring. The regulating value Sᵥ₃ is determined by the function model with the parameters which include effective rolling radius Rᵢ or tire pressure pᵣₐ of tire burst wheel:

Sᵥ₃=f(Rᵢ) [symbol] Rᵢ=f(pᵣₐ)

When the suspension travel position is adjusted by using pneumatic or hydraulic lifting devices, the relationship model are established by the parameters which include the input pressure of the hydraulic cylinder pᵥ or/and the flow Qᵥ, the position height of independent suspension travel Sᵥ and the load N_{zi} of hydraulic cylinder or/and air bag of adjusting device:

N_{zk}=f(Sᵥ,pᵥ,Qᵥ)

The target control value of the suspension position height Sᵥ of each wheel is converted to the input pressure pᵥ or/and flow Qᵥ of the adjusting device. In the formula, N_{zk} is the dynamic load of tire burst vehicle. The N_{zk} is sum of each wheel load N_{zi} for tire burst vehicle under normal working conditions and load variation value ΔN_{zi} of tire burst wheel:

N_{zk}=N_{zi}+ΔN_{zi}

The value of load variation ΔN_{zi} is determined by the equivalent function model between the effective rolling radius Rᵢ or tire pressure and ΔN_{zi} of the wheel:

ΔN_{zi}=f(Rᵢ) or ΔN_{zi}=f(pᵣₐ)

In order to simplify the calculation, the characteristic functions with parameter of tire burst load variation ΔN_{zi} and the tire pressure pᵣₐ are determined by the test. The load N_{zi} and its variation ΔN_{zi} of each wheel under condition of tire burst are determined. Setting the load N_{z0} of wheel under the normal working condition of the wheel, the load variation value ΔN_{zi} in dynamic test is detected under states of the decreasing series value Δpᵣₐ of tire pressure for the wheel or the effective rolling radius ΔRᵢ of wheel. A datum sheet is established by the characteristic functions with the parameters Δpᵣₐ or ΔRᵢ and ΔN_{zi}. The datum sheet are stored in the electronic control unit. In the tire burst control, the value of ΔN_{zi} can be taken out by input parameters of pᵣₐ or ΔRₜ. The value of ΔN_{zi} can is acted as the calculated parameter value. Delimiting the deviation eᵥ(t) between measured position height Sf of suspension and the target control value Sᵥ, the position height of tire burst wheel or/and position height of each wheel is adjusted by feedback control of deviation eᵥ(t). The balance of vehicle body and load balance distribution of the tire burst vehicle are maintained by adjusting the height of position of suspension.

Second. Suspension travel Sᵥ, shock absorption resistance Bᵥ and stiffness Gᵥ coordinated controller. The coordinated control models of the control variables Gᵥ [symbol] Bᵥ and Sᵥ of suspension are established:

Sᵥ(Gᵥ,Bᵥ)

The target control values of \dot{S}ᵥ and \ddot{S}ᵥ are suitable for the shock absorption resistance Bᵥ control of hydraulic damper suspension. For suspension with magnetorheological fluid damper, the shock absorption resistance Bᵥ is adjusted to a lower constant. A hydraulic shock absorber is composed in suspension of gas or hydraulic pressure spring. Under certain conditions of which travel Sᵥ, velocity \dot{S}ᵥ and acceleration \ddot{S}ᵥ of suspension or damping piston of absorber are determined, the shock absorption resistance Bᵥ of the hydraulic absorber is determined by the opening degree of the damper valve and fluid viscosity of the damper. A magnetorheological (MR) damper is combined in the pneumatic or hydraulic spring suspension. Under the condition of which the opening of the damper valve is fixed, the shock absorption resistance Bᵥ can be adjusted by controlling viscosity of electronically controlled MR.

(2). Suspension control program or software for tire burst

Based on the structure, flow, control mode, model and algorithm of suspension lifting control for tire burst, a tire burst suspension lifting control subroutine is developed. The subroutine adopts a structured design. The program sets suspension control program modules which include secondary entering of suspension control of tire burst vehicle, the conversion of tire burst and non-tire burst control modes, travel Sᵥ control of wheel suspension, coordination control of Gᵥ [symbol] Bᵥ and Sᵥ of wheel suspension, and program module of servo control for input parameters which include pressure pᵥ or/and flow Qᵥ of adjusting device for suspension travel.

### 6. Technology Scheme and Effect of the Tire Burst Control

The method has the following technical characteristics and advantages which are compared to the existing technology. The method adopts a new concept and technical scheme of tire burst control for vehicles. The new concept and technical scheme covers the main key technologies of tire burst control for driven by man vehicles and driverless vehicles. This technology includes the “double instability” control for tire burst vehicles. The method defines and establishes a determination mode of tire burst by detecting tire pressure of tire pressure sensor, characteristic tire pressure and state tire pressure. Based on the real tire burst point, inflection point of tire burst, controls singularity and time zone of collision-proof control in the process of tire burst control, the method make the tire burst control adapt to the process of tire burst state process in logical cycle of control period, to realizes phasing, processing and control time zoning of tire burst control. The method adopted mechanism of tire burst control entering and exiting, control mode conversion between normal conditions and burst conditions, the self-adaptive control modes of tire burst for wheel and vehicles. Modes of active control, state control and man-machine exchange control are established. In this method, the main control of tire burst, engine braking, braking of brake device, throttle opening or/and fuel injection of engine, rotation moment of steering wheel, active steering, suspension lifting controller of tire burst are set up. Based on the type and structure of control, the corresponding control module are set up. The coordinated control modes and models of vehicle braking, driving, steering, steering wheel rotation force and suspension are set up by means of on-board data bus and special data bus of X-by-wire for tire burst, to realize tire burst control in normal working and tire burst condition, and real or non-real tire burst process. The tire burst control concept adopted in this method is novel, and the technical scheme is mature; under condition of rapid change of tire burst state process of vehicle, movement states of tire burst wheel and running attitude of vehicle, the important technical barriers that include severe instability of wheel and vehicle, and controlling difficulty of extreme state for vehicle tire burst are broken through; therefrom it is solved that the important technical topic which has puzzled by safety of vehicle tire burst for a long time.

### DESCRIPTION OF DRAWING

FIG. 1 shows the control mode, structure and flow chart for vehicle tire burst

### MODE OF CARRYING OUT THE INVENTION

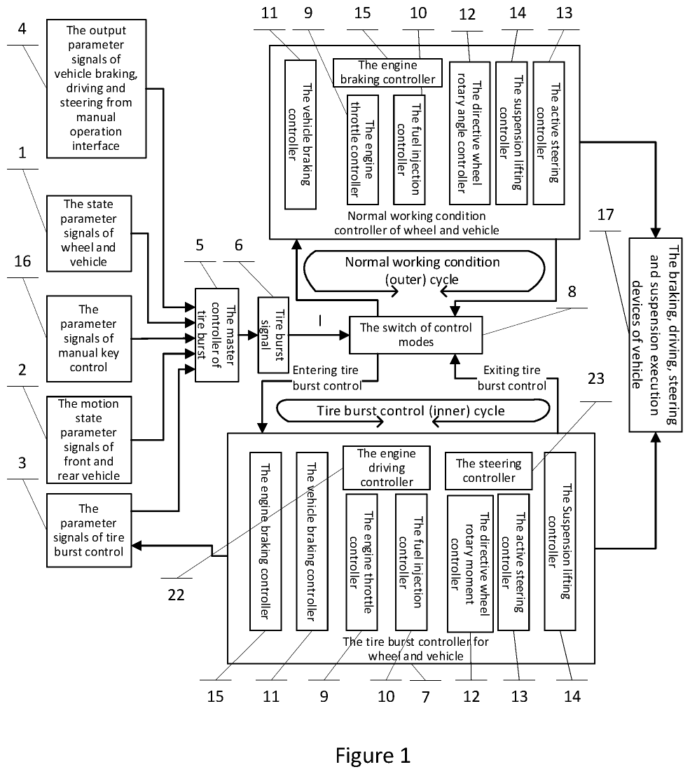

1). Control Mode, Structure and Process of Vehicle Tire Burst. See FIG. 1.

The master controller 5 of tire burst takes parameter signals 1 of wheel and vehicle, signals 2 of state parameters for front and real vehicle or/and the parameters signals of environment perception and route planning of driverless vehicle, the parameter signals 3 of tire burst control, output parameter signal 4 of vehicle braking, driving and steering of manual operation interface, and parameters signal I 16 of manual key control as input parameters signals, and controls tire burst of vehicle according to the signals of tire burst control parameter. The relevant parameters are calculated on basis of the mode, model and algorithm for tire burst control. Tire burst mode recognition of state tire pressure and characteristic value for tire burst are determined; judgement of tire burst, division of control stages for tire burst and control, control mode conversion for tire burst are completed; coordinated control of multiple controllers, manual operation and active control for tire burst can be realized. According to status process of tire burst, definition of tire burst and judgment mode, tire burst is determined by master controller 5; master controller 5 output tire burst signal I 6. The tire burst signal I 6 output by master controller 5 inputs converter 8 of control modes directly or by date bus. The converter 8 realizes conversion of control modes between normal working condition and tire burst working condition. The tire burst controller 7 of wheel and vehicle obtains the parameter signals directly from the relevant sensors or from the main controller 5 of the tire burst. Based on the on-board system, and under the coordination of the main controller 5, the controller 7 enters the independent parallel control or the joint coordinated control, to make the system enter the inner cycle of tire burst control. In inner cycle control and according to mode model and algorithm of throttle opening control or/and fuel injection control, the engine throttle controller 9 or/and fuel injection controller 10 close throttle or dynamically adjust throttle opening, and terminate or dynamically adjust fuel injection of fuel injection controller 10; throttle and fuel injection controller 9 and 10 achieve jointly engine drive control 22. According to the coordinated control mode, model and algorithm of tire burst active braking and vehicle collision avoidance, the vehicle braking controller 11 adopts wheel steady state braking, vehicle balanced braking, vehicle steady state braking and total braking force (A), (B), (C), (D) control, and adopts their logic combination and logical cycle of control, to realize vehicle steady deceleration and vehicle state control. Based on the power steering system, the rotary force controller of steering for tire burst vehicle realizes the dual controls of the power assistant steering or resistance steering for tire burst at any angle of the steering wheel, according to the control mode, model and algorithm of steering wheel rotation angle, steering assistant moment or rotation torque of steering wheel for tire burst. According to control mode, model and algorithm of active steering for tire burst, the active steering controller 13 exerts an additional angle to steering wheel, to balance tire burst steering angle of vehicle. The rotation force controller 12 of steering wheel and active steering controller 13 of tire burst vehicle jointly realize active steering control 23 of tire burst vehicle. Suspension lifting controller 14 adopts coordinated control mode, model and algorithm of travel, damping and stiffness of suspension. The tilting or probability rollover of vehicle after tire burst is reduced by adjusting suspension lifting, and the load of each wheel is balanced. Tire burst control parameter signal 3 of vehicle is returned to tire burst master controller 5 by control feedback line. The engine brake controller 15 of system is set up. The brake control by engine is mainly suitable for the pre-tire burst period. The master controller 5 specially set manual control key to exiting of tire burst control or returning; the controller outputs the parameter signal I 6; signal I 6 is input the master controller 5 through control line; the manual keying control logic covers the active control logic of tire burst. By means of three man-machine operation interfaces of braking, driving and steering control of vehicle, the self-adaptive control of man-machine exchange is realized. The self-adaptive control logic of human-computer exchange covers conditionally the active control logic of tire burst of vehicle. Under normal working conditions, the on-board controller can obtain the parameter signals directly from relevant sensors, or/and the master controller 5 or/and the control mode converter 8 through the data bus 21; the on-board controller can control the corresponding braking, driving, steering and suspension execution devices 17 according to control modes of normal working conditions, to realize outer cycle of control of on-board system. The output signals of tire burst master controller and controller of on-board system input corresponding braking, driving, steering and suspension execution device 17 through control mode converter 8, to realize the vehicle control inner cycle under working condition of tire burst.

### 2). Tire Burst Pattern Recognition and Tire Burst Determination.

The tire burst pattern recognition and tire burst judgement of vehicle are based on wheel state, steering state of vehicle and vehicle state. According to tire burst pattern identification and types of running state and structures of vehicle, which include non-braking and non-driving, driving and braking, tire burst judgement conditions and models which include the tire pressure pᵣₑ [x_{b}, x_{d}] are adopted. A judgement logic for tire burst is establish to realize tire burst pattern recognition and tire burst judgment. The three types of running state and structure of vehicle are expressed by positive (+) and negative (−) of mathematical symbols.

(1). The structure of non-braking and non-driving state of vehicle is characterized by positive (+) and negative (−). The judgment logic for tire burst is established in the state. In the state process, pressure pᵣₑ₁ is determined by the equivalent mathematical model and algorithm. The mathematical model is established by modeling parameter including yaw angle velocity deviation e_{ω}_{ᵣ}(t), side slip angle deviation e_{β}(t) for mass center of vehicle, non-equivalent relative angle velocity deviation e(ωₖ) of left and right wheels of wheelset, ground friction coefficient μᵢ, wheel load N_{zi} and rotation angle δ of steering wheel:

pᵣₑ₁=f(e(ωₖ),e_{β}(t),e_{ω}_{ᵣ}(t),λᵢ) or λᵢ=f(μᵢ [symbol] N_{zi} [symbol] δ)

In process of the state, the braking force Qᵢ and driving force Qₚ are zero. The deviation e(ωₖ) of non-equivalent relative angle velocity ωₖ and deviation e(\dot{ω}ₖ) of non-equivalent relative angle acceleration or deceleration \dot{ω}ₖ are equal to, or are equivalent to, equivalent relative parameter deviation e(ωₑ) and e(\dot{ω}ₑ), under condition of which parameter values of μᵢ [symbol] N_{zi} [symbol] δ [symbol] Qᵢ taken by two wheels of balance wheelset are equal or equivalent equal. In the same parameters set E(λᵢ μᵢ [symbol] N_{zi} [symbol] δ [symbol] Qᵢ), values of λᵢ taken by the two wheels of the balance wheelset can be taken as 0 or 1, and e(\dot{ω}ₖ) can be replaced by non-equivalent relative slip rate deviation e(Sₖ). Based on state tire pressure pᵣₑ₁ and threshold model for tire burst judgement, the absolute value of non-equivalent relative angle velocity deviation e(ωₖ) in balancing wheelset for front and rear axles is compared. The wheelset of which bigger absolute value of deviation e(ωₖ) is taken in the two balance wheelset is tire burst balancing wheelset, and the wheel of which bigger ωₖ value is taken in two wheels of the balance wheelset is tire burst wheel. Under condition of non-braking and non-driving of vehicle, the wheels are in free rolling state, thus the correction coefficient λᵢ is determined by model with modeling parameters of μᵢ [symbol] N_{zi} and δ. Wheels can be in state of rolling freely without braking and driving. After λᵢ is corrected equivalently, the equivalent and non-equivalent relative angle velocity, angle acceleration and deceleration of left wheel and right wheel are basically equal.

(2). Driving state structure (+). In the state, for the non-driving axle wheelset and the driving axle wheelset, the equivalent mathematical model of state pressure pᵣₑ is established by modeling parameters which include yaw angle velocity deviation e_{ω}_{ᵣ}(t), the sideslip angle deviation e_{β}(t) of vehicle, the non-equivalent or equivalent relative angle velocity deviation e(ωₖ), e(ωₑ) of the left wheel and right wheel of wheelsets, ground friction coefficient μᵢ, wheel load N_{zi} and steering wheel angle δ:

pᵣₑ₂=f(e_{ω}_{ᵣ}(t),e_{β}(t),e(ωₖ),e(\dot{ω}ₖ),λᵢ) or

pᵣₑ₂=f(e_{ω}_{ᵣ}(t),e(ωₑ),e(\dot{ω}ₑ),λᵢ) or

λᵢ=f(μᵢ [symbol] N_{zi} [symbol] δ)

Under condition of which load N_{zi} of left wheel and right wheel change is little, the ground friction coefficient μᵢ of the left wheel and right wheel is equal and the rotation angle δ of steering wheel is small, the compensation coefficient of Aᵢ can be taken as 0 or 1. The left wheel and right wheel of balancing wheelset for non-driving axle adopt non-equivalent relative angle velocity deviation e(ωₖ) and angle acceleration and deceleration deviation e(\dot{ω}ₑ). The equivalent relative angle velocity deviation e(ωₑ) and angle acceleration and deceleration deviation e(\dot{ω}ₑ) are used in the left and right wheels of the drive axle. Under condition of the ground friction coefficient of left and right wheels is equal, and the driving moment Qᵤᵢ of left and right wheels of driving axle is equal, the deviation e(ωₑ) and e(ωₖ), e(\dot{ω}ₑ) and e(\dot{ω}ₖ) of left and right wheels are equivalent or equivalent equal, thus λᵢ can be taken as 0 or 1. The state tire pressure pᵣₑ₂ is compensated by λᵢ under the condition of which friction coefficient μᵢ of the left wheel and right wheel is different. The tire burst judgement is made by threshold model of state tire pressure pᵣₑ₂. After tire burst is determined, the equivalent relative angle velocity ωₑ of the left wheel and right wheel of the driving axle is compared. Based on the state tire pressure pᵣₑ₂ and the tire burst judgement threshold model, the non-equivalent relative angle velocity ωₖ of left wheel and right wheel of non-driving axle is compared, and the equivalent relative angle velocity ωₑ of left wheel and right wheel of driving axle is compared. The wheel with bigger value of ωₑ and ωₖ in two wheelsets of driving axle and non-driving axle is tire burst wheel, and the balance wheelset of which larger value of e(ωₑ) is taken in the two axles is tire burst balance wheelset. During the real tire burst time and inflection point time for tire burst, driving of the vehicle has be exited actually under condition of which vehicle has be not implemented control of anti-collision.

(3). Braking state structure (+). The parameter of rotary moment deviation e_{M}_{ₐ}(t) of directive wheel for tire burs may be used, or not used, in the braking state structure. When the e_{M}_{ₐ}(t) of directive wheel may be used, the e_{M}_{ₐ}(t) can be replaced by the rotary torque deviation ΔM_{c} of steering wheel or steering assisting moment deviation ΔMₐ. Braking state structure 1. Under braking condition of normal working, the left wheel and right wheel of front axle and rear axle have same braking force. If vehicle are not carried out steady state control of differential braking of wheels, it indicates that the vehicle is in normal condition or before time of tire burst. The mathematical model of tire pressure pᵣₑ₃ is established by modeling parameters which include e(ωₖ), e(ωₖ), e_{β}(t), e(ωₑ), e(Qₖ) and λᵢ:

pᵣₑ₃=f(e_{ω}_{ᵣ}(t),e(ωₖ),e_{β}(t),e(ωₑ),e(Qₖ),λᵢ) [symbol] λᵢ=f(μᵢ [symbol] N_{zi} [symbol] δ)

Where, the e(Qₖ) is the non-equivalent relative braking force deviation of the balanced wheelset. When the steering angle of directive wheel is small, and the load Nᵢ of vehicle varies slightly, and the friction coefficients of left and right wheels are equal, or is deemed to be equal, the value of λᵢ can be taken as 0 or 1. Under condition of which friction coefficient μᵢ of the left wheel and right wheel is different, and steering angle δ and load transferred by wheels is smaller, the λᵢ is determined by equivalent correction model with parameters of μᵢ, N_{zi} and δ of left wheel and right wheel; the non-equivalent angle velocity deviation e(ωₖ) and non-equivalent angle deceleration deviation e(\dot{ω}ₖ) of the left wheel and right wheel of the two axles are actually equivalent to equivalent relative angle velocity deviation e(ωₑ) and angle deceleration deviation e(\dot{ω}ₖ) under the condition of which the braking force Qᵢ of the left and right wheels of the two axles is equal. After tire burst is determined, absolute values of e(ωₑ) and e(ωₖ) of front axle and rear axles are compared based on state tire pressure pᵣₑ₃ and threshold model of tire burst judgement; the wheel that takes a bigger absolute value of ωₑ or ωₖ is tire burst wheel, or the positive and negative sign of e(ωₖ) and e(ωₑ) can be used to determine tire burst wheel. The balanced wheelset with tire burst wheel is tire burst balanced wheelset. The braking state structure 2. The state structure is a state structure of which tire burst vehicle enters steady state control for differential braking of the wheels. In this state structure, two ways are used to determine state tire pressure pᵣₑ. First way. The way is based on “braking state structure 1”, to determine state tire pressure pᵣₑ₄₁, that is, the pᵣₑ₃ is equal to the pᵣₑ₄₁, then to determine tire burst of vehicle. Second way. For vehicle of which parameters of wheel braking force Qᵢ and angle velocity ωᵢ are taken as control variables, the state tire pressure pᵣₑ₄₁ is calculated under the condition of differential braking of wheels. The first algorithm of pᵣₑ₄ is based on judgment of tire burst of “the braking state structure 1”; the two wheels of tire burst balancing wheelset are exerted by equal braking force; the following calculation model of determining state tire pressure pᵣₑ₄₁ is adopted; when the left wheel and right wheel of tire burst balancing wheelset are exerted by equal braking force Qᵢ, one of the same parameters in Eₙ is Qᵢ, it satisfies the condition of same braking force Qᵢ taken by two wheels of tire burst balancing wheelset, and effective rolling radius Rᵢ of two wheels of tire burst balancing wheelset is regards as a same; from this, the e(ωₖ) is equivalent to e(ωₑ). Under state of which differential braking of two wheels of non-tire burst balanced wheelset is carried by the following calculation model of pᵣₑ₄₂, the same parameters in the set Eₙ are taken as Qᵢ and Rᵢ, the parameters e(ωₑ) and e(\dot{ω}ₑ) in calculation model of pᵣₑ₄₂ simultaneously satisfy the condition of which the values of Qᵢ and Rᵢ of each wheels are equivalent or equivalent equality. Algorithm 2 of state tire pressure pᵣₑ₄. The unbalanced braking force of steady-state control of differential braking for vehicle is applied to two wheels of balanced wheelset of tire burst and no tire burst. The calculation model of pᵣₑ₄₃ is adopted as follows.

pᵣₑ₄₁=f(e_{ω}_{ᵣ}(t),e_{β}(t),e(ωₖ),e(\dot{ω}ₖ),λᵢ),pᵣₑ₄₂=f(e_{ω}_{ᵣ}(t),e_{β}(t),e(ωₑ),λᵢ)

pᵣₑ₄₃=f(e_{ω}_{ᵣ}(t)>e_{β}(t),e(ωₑ),e(Qₑ),λᵢ),λᵢ=f(μᵢ [symbol] N_{zi} [symbol] δ)

Under the state in which same parameter Rᵢ of each wheel in the set Eₙ is set, The parameters e(ωₑ) and e(\dot{ω}ₑ) should satisfy the conditions of which braking force Qᵢ and the effective rolling radius Rᵢ of two-wheel of balanced wheelset are equivalent or equivalent equality, and the e(Qₑ) in calculation model of pᵣₑ₄₃ may be replaced by the non-equivalent relative braking force deviation e(Qₖ) of two-wheels of balanced wheelset, and the “abnormal change” of vehicle yaw angle velocity deviation eₐ, (t) in tire burst control is compensated by change of parameter e(Qₖ). Among them, the λᵢ is determined by the equivalent model with parameters μᵢ [symbol] N_{zi} and δ of left wheel and right wheel. In the above formulas, equivalent relative angle deceleration deviation e(\dot{ω}ₑ) can be interchanged with equivalent relative slip rate e(Sₑ). The tire burst is determined by state tire pressure pᵣₑ and the value of the tire burst threshold model. The absolute values of e(ωₑ) of the front axle and rear axle are compared after the tire burst is determined, and the balance wheelset of which the larger absolute value of e(ωₑ) is taken in the two axles is tire burst balance wheelset. The wheel of which the larger absolute value of e(ωₑ) or e(ωₖ) is taken are tire burst wheel. In the balancing wheelset for tire burst, the positive and negative sign of e(ωₖ) also is used to determine the tire burst wheel and tire burst balanced wheelset. When rotation angle δ of steering wheel is Larger, and ground friction coefficient μᵢ for two wheels of left and right is set to be equal, the rotation turning radius of the vehicle is determined by parameters such as rotation angle δ of the steering wheel, vehicle speed uₓ or/and side deviation angle αᵢ of steering wheel; from this, it is determine to deviation of running distance and rotating angle velocity deviation Δω₁₂ of left wheel and right wheel. According to Δω₁₂ or the variation value of load of left wheel and right wheel of vehicle, the correction factor λᵢ is determined by the function model with Δω₁₂ or/and variable value ΔN_{z12} of load of wheel left wheel and right. In order to simplify the calculation of correction factor λᵢ, the load transfer ΔN_{z12} of two-wheel of front axle and rear axle can be neglected; the functional relationship between correction factor λᵢ and variable δ, parameter uₓ is determined by field test, and the numerical chart of functional relationship is compiled. The numerical chart is stored in electronic control unit. In braking control, the λᵢ is checked and called by using main parameters including uₓ, δ and μᵢ. The value of parameter λᵢ is used to determine equivalent parameter values of Left and right wheels of front axle and rear axle and state tire pressure pᵣₑ.

### 3). Direction Determination Mode of Angle and Torque for Tire Burs.

(1). Based on the origin rules of rotation angle δ and rotation torque M_{c} coordinate of steering wheel, the rules of rotation direction for Left and right angle δ, the rules of direction positive (+) negative (−) of rotation torque M_{c} and increment or decrease ΔM_{c} of M_{c} of steering wheel, and the rules of positive (+) negative (−) direction of tire burst rotation moment and steering assist moment Mₐ, it can be established to the judgment logic of positive (+) and negative (−) direction of burst tire rotation moment and steering assistant moment Mₐ when steering wheel or directive wheel turns to right or to left, M_{b}′ or when it is in right-handed rotating. The judgment logic can be shown by the following logic chart of judgement mode of steering angle and torque direction. According to the logic chart of the judgment logic, the direction of burst tire rotation moment M_{b}′ and the steering assistant moment Mₐ can be determined. Direction determination of tire burst use the following model or their joint model.

The Direction determination mode of angle and torque: right-hand rotating logic chart

of direction of rotation angle δ.

| | M_{c}(right | | | |
|---|---|---|---|---|
| δ | rotation direction) | ΔM_{c} | M′_{b} | Mₐ |
| + | + | + or 0 | 0 | 0 |
| − | −(+ transferring to −) | − or 0 | 0 | 0 |
| − | + | − or 0 | 0 | 0 |
| + | − | + | + | − |
| + | −(+ transferring to −) | + | + | − |
| − | −(+ transferring to −) | + or 0 | 0 | 0 |
| − | + | + | − | + |

The direction judgement mode of rotation angle and rotation torque: left-handed logic diagram chart of angle δ can be omitted in this article. Based on the origin regulation of steering wheel angle δ and torque M_{c}, and when rotation angle δ of the steering wheel or the rotation angle θₑ of directive wheels is in left turning, the positive (+) and negative (−) regulation of steering wheel torque or the positive (+) negative (−) regulation of torque measured by sensor are contrary with the positive (+) and negative (−) regulation of right turning of steering wheel. According to the rules of positive (+) negative (−) of left-hand turn of steering wheel, the logic of the direction judgement of tire burst moment and steering assistant moment Mₐ can be established when the rotation angle δ of steering wheel is left-handed rotating. Except for the rotation direction of angle δ of steering wheel and positive (+) negative (−) rules adopted by the steering wheel which is in left-handed turn are different to right turn, the parameters, structure, judgement flow and method used in direction judgment logic and logic chart of tire burst rotation moment and steering assistant moment Mₐ are same as those used in right turn of steering wheel.

(2). The direction determination mode of rotation angle. Based on the origin rules of steering wheel angle δ and torque M_{c}, the rules of left or right rotation of angle δ of steering wheel and angle of directive wheel, the positive (+) and negative (−) rules of absolute angle δ that is measured by two sensors set on the rotation shaft of steering system to non-rotating reference system of vehicle, positive (+) and negative (−) rules of angle difference Δδ, the positive (+) and negative (−) rules of direction of tire burst rotation moment M_{b}′ and the steering assistance moment Mₐ, it is determined to the positive (+) and negative (−) of rotation angle difference Δδ. the positive (+) and negative (−) of Δδ indicate the positive (+) and (+ negative (−) of rotation direction of steering wheel rotation torque M_{c}; the judgement logic of direction of tire burst rotation torque M_{b}′ and steering assist moment Mₐ are determined when steering wheel or directive wheel turns to right. The judgment logic can be represented by the following logic diagram of “direction judgment mode of steering angle”. According to the logic diagram, the direction of tire burst rotation moment M_{b}′ and the direction of steering assistance moment Mₐ are determined. Based on detection signal of two sensors set on rotation shaft of steering system, two relative coordinate systems of steering wheel angle δ, which is set in steering system, are adopted; direction of angle and torque of steering wheel or directive wheel, direction of tire burst rotation moment M_{b}′ and steering assistance moment Mₐ are determined by the direction Judgement mode of steering angle for tire burst.

The direction Judgement mode of angle: Logic chart of steering wheel right rotation with positive difference Δδ

| δ | Δδ | ΔM_{c} | M′_{b} | Mₐ |
|---|---|---|---|---|
| + | + | + or 0 | 0 | 0 |
| − | −(+ transferring to −) | − or 0 | 0 | 0 |
| − | + | − or 0 | 0 | 0 |
| + | − | + | + | − |
| + | −(+ transferring to −) | + | + | − |
| − | −(+ transferring to −) | + or 0 | 0 | 0 |
| − | + | + | − | + |

The direction judgement mode of rotation angle. The left-hand logic diagram of steering wheel is omitted in this article. Based on the origin regulation of steering wheel angle δ and torque M_{c}, and when rotation angle δ of the steering wheel or turning angle θₑ of directive wheels is in left turning, the positive (+) and negative (−) rule of steering wheel torque or the positive (+) negative (−) regulation of torque measured by sensor are contrary with the positive (+) and negative (−) rule of right turning of steering wheel. According to the rules of positive (+) negative (−) of left-hand turn of steering wheel, the logic of direction judgement of tire burst rotation moment and steering assistant moment Mₐ can be established when the turning angle δ of steering wheel is left-handed rotating. Except for it is different to the rotation direction of the steering wheel angle δ and positive (+) negative (−) rules adopted by the steering wheel which is left-handed turn, the parameters, structure, judgement flow and method used in direction judgment logic and logic chart of tire burst moment and steering assistant moment Mₐ in left turning of steering wheel are same as those used in right turn of steering wheel.

(3). In the above tables, it is indicated that vehicle is in normal working condition, or wheel is not in tire burst state, when the rotation moment M_{b}′ of tire burst is 0. Whether there is a tire burst which can be determined by the positive (+) or negative (−) of the tire burst rotation moment M_{b}. When tire burst rotation moment M_{b}′ is positive (+), it is indicates that the direction of M_{b}′ is consistent with the direction of the positive route of steering wheel angle δ, and the direction of steering assistant moment Mₐ is consistent with the direction of the negative route of steering wheel angle δ. When tire burst rotation moment M_{b}′ is a negative (−), it indicates that the direction of M_{b}′ is consistent with the direction of the negative route of steering wheel angle δ, and the direction of steering assistant moment Mₐ is consistent with the direction of the positive route of steering wheel angle δ. When increment ΔM_{c} of steering assistant moment Mₐ is 0, it indicates that the rotation force Mₖ of steering wheel exerted by ground is in a force balance state, and it indicates that derivative M_{fc} of parameter Mₖ is 0.

(4). Mode of indirect determination of tire burst direction. In the control of tire burst rotation torque, the dynamic characteristics of indirect judgment of tire burst direction are not ideal.

i. The indirect direction judgment of tire burst rotation moment M_{b}′ use a mode of position of tire burst wheel and the field test. When tire burst of wheel of front axle occur, the direction of tire burst rotation moment M_{b}′ points to direction of same side of the tire burst position. On the same way, for tire burst of wheel of rear axle, the direction of rotation moment M_{b}′ for tire burst can be determined by the position of tire burst wheel, the direction of rotation angle of steering wheel and field test.

ii. Determining of direction of the tire burst rotation moment M_{b}′ adopt yaw judgement model of vehicle. After tire burst of vehicle occur, the understeering of the left turning of vehicle and the oversteering of the right turning of vehicle can indicate that tire burst of right front wheel occur, the understeering of right turning vehicle and the oversteering of left turning vehicle indicate that tire burst of left front wheel occur. According to direction of rotation angle δ of steering wheel and the understeering or oversteering of vehicle, the direction of tire burst of rear wheel and direction of tire burst rotation torque M_{b}′ of steering wheel can be determined also.

4).

The tire burst braking control of this method adopt wheel braking steady A, vehicle stability braking C, wheel balanced braking B and total braking force D control, as well as their logical combination control. The A, B, C, D control and their logical combination control for tire burst braking can realize compatibility control with vehicle stability control (VSC), vehicle dynamics control (VDC) or electronic stabilization program system (ESP). The tire burst braking control takes one or more modeling parameters of angle deceleration \dot{ω}ᵢ, slip rate Sᵢ of wheel, vehicle deceleration \dot{u}ₓ and braking force Qᵢ as control variables; the control of tire burst brake can be realize in the logic cycle of period Hₕ for control of A, C, B, D and its combination control. In its dynamic control for tire burst, the braking C control should be used in priority.

(1) Steady-state braking A control of wheels. The braking A control include steady-state braking control of tire burst wheel and anti-lock braking control of no tire burst wheel. In normal working conditions, slip rate Sᵢ of tire burst wheel do not have the specific meaning of peak value slip rate of anti-lock braking control. When tire burst control entering signal iₐ arrives, the braking controller terminates or reduce the braking force exerted to tire burst wheel, it can make tire burst wheel be in a pure rolling state without braking, or be in steady-state braking A control for tire burst wheel, according to one of the parameter form of control variable \dot{ω}ᵢ, Sᵢ and Qᵢ for braking A control. In the control of tire burst braking A, the braking force of tire burst wheel is decreased in step by step on equal or unequal value, based on characteristics of the motion state of tire burst wheel. The brake A controller take \dot{ω}ᵢ and Sᵢ as control variables and control objectives, and takes brake force Qᵢ as parameter variables; A mathematical model is established by the control variables and modeling parameters, to determine control structure and characteristics of braking A control by certain algorithm. Under braking A control, tire burst wheel and no tire burst wheels can obtain a dynamic and steady-state braking force. A general analytic mathematics formula can be adopted by the model of braking A control, or it can transformed into expression of state space, and the dynamics system of wheel is expressed by state equation. On this basis, the appropriate control algorithm is determined by applying modern control theory. Braking control period Hₕ of tire burst is obtained. In process of logical cycle of period Hₕ, the braking force Qᵢ is reduced step by step according to the characteristics of the movement state of the tire burst wheel, and reduction of braking force Qᵢ of tire burst wheel can be realized by the reducing of target control values \dot{ω}ₖᵢ and Sₖᵢ of control variables ωᵢ and Sᵢ, until \dot{ω}ₖᵢ and Sₖᵢ achieve a set value or zero. During the control process, the actual values ωᵢ and Sᵢ of tire burst wheel fluctuate around their target control values \dot{ω}ₖᵢ and Sₖᵢ. The braking force Qᵢ is decreased gradually, equally or unequally to 0, thus indirectly adjusting the braking force Qᵢ of wheels.

(2) Braking stability C control of vehicle

According to parameter forms of one of angle deceleration \dot{ω}ᵢ or/and slip rate Sᵢ, vehicle additional yaw moment Mᵤ of brake C control is used to direct or indirect distribution of braking force of each wheel. The distribution of additional yaw moment Mᵤ of brake C control for wheels can be expressed as follows. According to brake C control mode and model, and on basis of position relationship of tire burst wheel, yaw control wheel and non-yaw control wheel the efficient yaw control wheel and yaw control wheels are determined by quantitative relationship of which additional yaw moment Mᵤ is vector sum of additional yaw moment Mᵤᵣ determined by longitudinal differential braking of wheels and additional yaw moment Mₙ of braking in steering; the distribution of additional yaw moment Mᵤ under straight and steering state of vehicle is determined by the efficient yaw control wheel and yaw control wheels. The additional yaw moment Mᵤ is not allocated to the tire burst wheel. The allocation models of Mᵤ can adopt one of single wheel, two wheel and three wheel models or their combination, according to the states of vehicle in normal and burst working conditions.

i. Under braking in straight running state of vehicle, the Mᵤ is equal Mᵤᵣ. The Mᵤᵣ is additional yaw moment produced by longitudinal differential braking of wheels. The Mᵤ is distributed according to coordination distribution model of single wheel, two wheel or three wheel. In the single wheel or two wheel, the Mᵤ can be allocated to any one or two of the yaw control wheels.

ii. Under braking in steering state of vehicle, allocation of additional yaw moment Mᵤ to wheels adopts single wheel, two wheel or three wheel mathematical model, a. The allocation model of two wheel is as following. For vehicle of which front axle is steering axle, the allocation model of additional yaw moment Mᵤ of wheels is established by modeling parameters which include additional yaw moment Mᵤᵣ determined by longitudinal differential braking force of wheels, additional yaw moment Mₙ determined by braking in vehicle steering, slip rate Sᵢ, rotation angle δ of steering wheel or rotation angle θₑ of directive wheel and Load M_{zi} of yaw control wheels. Based on the allocation model of additional yaw moment Mᵤ, the allocation of Mᵤ to three yaw control wheels can be determined. A variety of yaw control modes can be formed by different combinations of three yaw control wheels. First, for tire burst of right front wheel in state of right-turning of vehicle, the left front wheel can be determined as efficiency yaw control wheel, according to vector model with modeling parameter Mᵤ that includes Mᵤᵣ and Mₙ, load N_{z}j of each wheel and their transfer amount ΔN_{zi} which shifts to left rear wheel and left front wheels in tire burst; when direction of Mᵤᵣ and Mₙ is same, the maximum value of additional yaw moment Mᵤ is achieved under condition of certain differential braking force. For two yaw control wheels of left front and left rear, the distribution proportion of Mᵤ is determined in the process of braking and steering. The distribution model of two yaw control wheels of left front and left rear is established by modeling parameters which include braking slip ratio Sᵢ of left front wheel and left rear wheel and rotation angle θₑ of directive wheels. Based on the model, the distribution of additional yaw moment Mᵤ of the two yaw control wheel is realized. The steering of vehicle, longitudinal slip ratio Sᵢ and lateral slip angle of two yaw control wheels for left front wheel and left rear wheel are controlled by the distribution of additional yaw moment Mᵤ between two yaw control wheels. The tire burst yaw moment Mᵤ′ produced by tire burst of right front wheel is balanced by Mᵤᵣ and Mₙ, therefrom, Insufficient or excessive steering of vehicle is balanced or eliminated. Second, tire burst of left front wheel under state of right-turning of vehicle. According to vector model with modeling parameter Mᵤ that includes Mᵤᵣ and Mₙ, the Mᵤ can achieve maximum value when the direction of Mᵤᵣ and Mₙ is same; the right rear wheel is determined as the efficient yaw control wheel. Based on the load N_{zi} of each wheel and their transfer amount ΔN_{zi} which is shifted to right rear wheel and front wheel in tire burst state, the distribution model of two yaw control wheels is established by parameters which include the rotation angle θₑ of right front wheel, side or transverse slip angle and longitudinal slip ratio Sᵢ of right front wheel and longitudinal slip ratio Sᵢ of right rear wheel, and load N_{zi} of each wheel. Based on this model, the distribution of additional yaw moment Mᵤ between two yaw control wheels is realized; the steering of vehicle and slip rate Sᵢ of right front and right rear wheel are also controlled at the same time. The tire burst yaw moment Mᵤ′ produced by tire burst of left front is balanced by Mᵤᵣ and Mₙ, thus, Insufficient or excessive insufficient steering of tire burst vehicle is balanced or eliminated by Mᵤᵣ, Mₙ and their superposition. Third, the tire burst of right rear wheel in state of right-turning of vehicle. According to the vector model of Mᵤ including Mᵤᵣ and Mₙ, The additional yaw moment Mᵤ of vehicle achieves the maximum value when direction of Mᵤᵣ and Mₙ are same; the left rear wheel is efficient yaw control wheel, and the left front wheel and left rear wheel are yaw control wheels. Based on load N_{zi} of each wheel and their transfer amount ΔN_{zi} which shifts to left rear and left front wheels in tire burst state, the distribution model of two yaw control wheels is established by modeling parameters including the steering angle θₑ of left front wheel, side slip angle and longitudinal ratio Sᵢ of left front wheel, longitudinal slip ratio Sᵢ of left rear and load N_{zi} of each wheel. The coordinated distribution of additional yaw moment Mᵤ of two yaw control wheels of left front and left rear is realized. The steering of vehicle and the steering angle of left front wheel, and the slip rate Sᵢ of left front and left rear wheels are controlled simultaneously by the distribution of additional yaw moment Mᵤ between left front wheel and left rear wheel. The combination of Mᵤᵣ and Mₙ can balance the tire burst yaw moment Mᵤ′ produced by tire burst of right rear wheel. Insufficient or excessive steering of tire burst vehicle is compensated or eliminated produced by superposition effect of Mᵤᵣ and Mₙ. Fourth, the left rear wheel of right-turning vehicle. According to the vector model of Mᵤ including Mₙ and Mᵤᵣ, the Mᵤ achieves maximum value in the same direction of Mᵤᵣ and Mₙ, therefrom it can be determined that right rear wheel is the efficient yaw control wheel, and the right front wheel and right rear wheels are yaw control wheel. In tire burst control, the distribution model of two yaw control wheels is established by modeling parameters including steering angle θₑ of right front wheel, side slip angle and longitudinal slip ratio Sᵢ of right front wheel, longitudinal slip ratio Sᵢ of right rear and load N_{zi} of each wheel, based on the load N_{zi} of each wheel and their transfer amount ΔN_{zi} which shifts to left rear and left front wheels in tire burst state. The steering angle θₑ of right front wheel and stable steering of the vehicle are controlled by distribution of additional yaw moment Mᵤ between the two yaw control wheels; the slip rate Sᵢ of right front wheel and right rear wheel are controlled simultaneously. The combination control of Mᵤᵣ and Mₙ can balance tire burst yaw moment Mᵤ′ produced by left rear tire burst. Insufficient or excessive steering of tire burst vehicle is compensated or eliminated by superposition effect of Mᵤᵣ and Mₙ. Similarly, the controlled wheel selection, control principle, rules and system of tire burst control of the left-turn vehicle are same as those of the right-turn vehicle.

(3). In duration from arriving of burst control entering signal iₐ to starting point of real burst time or/and the safety time of vehicle collision avoidance control, the braking A, C, B and D control may adopt the forms of B←A∪C or D←B∪A∪C logic combination and its logic cycle of period Hₕ. During real tire burst time, namely before or after time of the real tire burst point, braking force of tire burst wheel is relieved. When control combination of B←A∪C and it logic cycle are adopted, the control combination of A⊂C can be replaced by C control, that is, braking C control override A⊂C control. The differential braking control variable of brake C control for each wheel may adopt one of the parameter forms of \dot{ω}_{c}, S_{c}, Q_{c}. The target control value \dot{ω}_{ck}, S_{ck} or Q_{ck} of control variable \dot{ω}_{c}, S_{c} or Q_{c} are determined by the difference between target control value Q_{ck1} [symbol] \dot{ω}_{ck1} S_{ck1} of left wheel and the target control value of Q_{ck2} [symbol] \dot{ω}_{ck2} S_{ck2} of right wheel. According to the direction of the additional yaw moment Mᵤ of tire burst, the wheel in which one of control variable \dot{ω}_{c}, S_{c} or Q_{c} of left wheel and right wheel of wheelset is assigned by smaller value is determined. The smaller values of the control variables in the left wheel and right wheel may are taken as zero. The distribution rules of \dot{ω}_{ck}, S_{ck}, Q_{ck} are expressed as: values of \dot{ω}_{ck}, S_{ck}, Q_{ck} are allocated to no-tire burst wheelset, and are allocated to no tire burst wheel in the tire burst wheelset. During each control period after real starting point of tire burst, the difference braking force of balanced brake B control of each wheel are decreased or are terminated with the increase of the differential braking force of C control for each wheelset, thus, tire burst brake control enters the logical cycle of braking C control or braking A∪C control.

1-17. (canceled)

18. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. The method use a control of steady state of wheel, steady state steering of vehicle and driving stability of vehicle tire burst, which adapt to state process of tire burst vehicle, and it can realize driving direction, vehicle attitude, lane keeping, path tracking, anti-collision and balance control of vehicle body. One of tire burst pattern recognition and tire burst determination determined by models of relevant parameters that include wheel, vehicle steering, vehicle running state and control parameters. Under condition of which tire burst judgement is determined, a qualitative condition, quantitative judgment mode or/and model are adopted. When a qualitative condition, or/and qualitative judgment mode, or/and value determined by judgment model is reached, the vehicle can enter tire burst control or exit from tire burst control. Based on state process of tire burst vehicle, the tire burst vehicle adopts one of control and control mode conversion of program, protocol and external converter set in electronic control units. The program conversion: for vehicle in which tire burst and non-burst control adopt a same electronic control unit, the electronic control unit call conversion subroutine of control and control mode in the electronic control unit to realize the tire burst control and mode conversion automatically. Protocol conversion: the control and control mode conversion between burst tire control and non-burst tire control of vehicle are realized automatically according to the communication protocol between two electronic control units used in tire burst and non-burst tire control of vehicle. The conversions of control and control mode include entering and exiting of tire burst control, control and control mode conversion between tire burst and non-tire burst, control and control mode conversion of control parameters and types of brake, steering, drive or/and suspension in control periods and its logic cycle. In tire burst control process of vehicle, absolute and relative coordinate systems of vehicle are set, to calibrate direction of relevant angle and torque of parameters in coordinate system. A mathematical logic of direction judgement of relevant parameters that include steering angle and steering torque of tire burst vehicle is established to determine direction of the parameters. A tire burst braking control with independent control characteristics is adopted by tire burst vehicle. Additional yaw moment Mᵤ used for restoring stability control of tire burst vehicle is determined. Distribution of additional yaw moment Mᵤ for each wheel can use braking force Qᵢ, or uses one of parameter form of angle deceleration \dot{ω}ᵢ and slip ratio Sᵢ of each wheel. The braking force Qᵢ of each wheel is indirectly or directly adjusted by means of specific control variables which include angle deceleration \dot{ω}ᵢ, Slip ratio Sᵢ of wheel, to improve response characteristics to brake control device of tire burst vehicle. One of wheel brake steady-state A control, vehicle brake steady-state C control, wheel balancing brake B control, total braking force D control, as well as the logic combination of control type of A [symbol] B [symbol] C [symbol] D is adopted in logic cycle of control time Hₕ of vehicle braking, to adapted to tire burst state process of vehicle. During steering process of tire burst vehicle, the system adopts one of rotation moment control of steering of tire burst vehicle, which include limitation control of rotation angle velocity \dot{δ}_{bi} or/and rotation angle δ of steering wheel, or balance control of additional balancing moment Mₐ₂ and tire burst rotation torque M_{b}′, or rotation moment M_{c} control of steering wheel. According to the rotation force control mode, or model or/and algorithm adopted by the controller of power steering assisted, the device of power assist steering can provide a corresponding steering assist or resistance torque at any angle position of steering wheel of steering system of tire burst vehicle, so as to realize steering rotation torque control of the tire burst vehicle.

19. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Definition to vehicle tire burst: whether the tire burst of wheel is real or not real, the tire burst of vehicle is determined by “abnormal state” characterized to parameters of motion state and structural mechanics of wheel, steering mechanics state parameters of vehicle, vehicle running state and tire burst control parameters that is as a qualitative and quantitative index and qualitative condition, when the qualitative conditions and quantitative condition are achieved. Under the condition of tire burst and normal working conditions, the recognition pattern expressed by various abnormal states characterizing of motion and mechanics parameters of wheel, vehicle steering and vehicle is called tire burst pattern recognition Definition of tire burst state pattern recognition: according to dynamic state and parameters of wheel, or/and steering of vehicle and vehicle, which is referred to as tire burst pattern recognition. Tire burst pattern recognition that include state tire pressure pᵣₑ and characteristic tire pressure x_{b} [symbol] x_{c} [symbol] x_{d}. The method uses one of tire burst pattern recognition of tire pressure detected by sensor, state tire pressure pᵣₑ, characteristic tire pressure x_{b} [symbol] x_{c} [symbol] x_{d}.
(1). Tire burst pattern recognition of characteristic tire pressure and state tire pressure
Tire burst pattern recognition in state stage for tire burst. One of following tire burst pattern recognition is used.
i. Tire burst pattern recognition of characteristic tire pressure x_{b} of wheel motion state. Based on types of non driving and non braking, driving, braking of vehicle, the x_{b} is referred to as pattern recognition of characteristic tire pressure. The x_{b} is made by comparison of a same parameter which is determined by non-equivalent relative parameters Dₖ and equivalent relative parameters Dₑ of two wheels of wheelset. Defining to relative parameter set D_{b} of two-wheels of wheelset: the set of same parameters adopted by two-wheel of wheelset. Defining to non-equivalent relative parameters set Dₖ: relative parameters in D_{b} which are not processed by equivalence. Defining to some parameters set Eₙ: under condition of which value of one or several of relative parameters in D_{b} adopted by two-wheels of wheelset is equal or equivalent equal, the set of the parameters is known as parameters set Eₙ. Defining to equivalent relative parameter of two-wheels of wheelset: under condition of which one or several parameters in Eₙ taken separately by two-wheel of wheelset is equal or equivalent equal, one non-equivalent relative parameter taken in Dₖ is converted to one equivalent relative parameter in Dₑ by converting models and algorithms, the set of equivalent relative parameters be called as set Dₑ. Equivalent relative parameter deviation between two wheels of wheelset in Dₑ is defined or is determined. Related parameter or/and parameter value taken in equivalent relative parameter Dₑ of two wheels of wheelset are compared to make tire burst pattern recognition of characteristic tire pressure x_{b}. Defining to wheelset: two wheels of front axle and rear axle or diagonal arrangement are wheelset. Defining to balance wheelset: two wheels of wheelset of which braking force, driving force or ground force acting on the second wheel have opposite directions to the vehicle centroid torque.
ii. Tire burst pattern recognition of characteristic tire pressure x_{c} for steering mechanics state of vehicle. This pattern recognition is determined by steering mechanics state and parameters of vehicle. Based on characteristic of which tire burst rotation moment M_{b}′ transfer to steering wheel, direction of tire burst rotation moment M_{b}′ can be determined by rotation torque M_{c} and ΔM_{c} of steering wheel, rotation angle δ and increment Δδ, of steering under conditions of which the size and direction of δ [symbol] M_{c} [symbol] Δδ and ΔM_{c} are determined, at a critical point of size for M_{b}′. Based on the direction of M_{b}′, the tire burst pattern recognition and recognition logic are established. Burst pattern recognition characteristic tire pressure x_{c} of vehicle steering mechanics state is determined.
iii, Tire burst pattern recognition of characteristic tire pressure x_{d} for vehicle motion state. Under tire burst state, unbalanced yaw moment for vehicle, namely, tire burst yaw moment Mᵤ′ to vehicle mass center is produced by wheel forces of which ground exert on tire burst wheel and other wheels, to result in changes of vehicle motion state and state parameters. The tire burst pattern recognition of characteristic tire pressure x_{d} is determined by mathematical model with modeling parameters which manly include yaw angle velocity deviation steering e_{ω}_{ᵣ}(t) of vehicle and sideslip angle deviation e_{β}(t) of mass center of vehicle. According to the positive (+) or negative (−) of yaw moment of the vehicle and the direction of the steering wheel angle, oversteer or understeer of the vehicle is determined. The judgment logic of vehicle oversteer or understeer of vehicle is established, to make tire burst pattern recognition of characteristic tire pressure x_{d} for vehicle motion state.
iv. State tire pressure set pᵣₑ pattern recognition of vehicle for tire burs. A tire burst pattern recognition of state tire pressure pᵣₑ(x_{b}, x_{c}, x_{d}) or pᵣₑ(x_{b}, x_{d}) with related parameters which manly include wheel motion state, steering mechanical state and vehicle state parameters is determined in state process of tire burst state of vehicle, or/and the conditions and characteristics of non-driving and non-braking, driving or braking control states and types of vehicle.
(2). Tire burst pattern recognition in the control stage of tire burst. One of following tire burst pattern recognition is used.
i. Pattern recognition of wheel state in tire burst control stage. In tire burst control progress, Braking force deviation e_{q}(t), angle acceleration and deceleration degree deviation e_{ω}(t) or slip rate deviation eₛ(t) of two-wheel for wheelset are determined by modeling parameters that include braking force Qᵢ, angle acceleration and deceleration degree \dot{ω}ᵢ and slip rate Sᵢ of wheel. Tire burst pattern recognition model of the characteristic tire pressure x_{b} is established by one of e_{q}(t) [symbol] e_{ω}(t) [symbol] eₛ(t) or their combination. Based on pattern recognition and model of characteristic pressure x_{b}, value of x_{b} are determined.
ii, Pattern recognition of steering control of vehicle in tire burst control stage.
A tire burst pattern recognition the characteristic tire pressure x_{c} is established by modeling parameters with tire burst rotation moment M_{b}, or the rotation moment deviation e_{M}_{ₐ}(t) of two rotation moment Mₖ₁ and Mₖ₂ exert to two steering wheels by ground. According to the model, the value of characteristic tire pressure x_{c} for pattern recognition is determined.
iii, Pattern recognition of vehicle in tire burst control stage
Under normal and burst conditions, a tire burst pattern recognition of characteristic tire pressure x_{d} is established by parameters including yaw angle rate deviation e_{ω}_{ᵣ}(t) of vehicle, sideslip angle deviation e_{β}(t) to mass centroid of vehicle in certain vehicle speed and steering angle. According to the recognition model, the value of characteristic tire pressure x_{d} for pattern recognition is determined.
iv. State tire pressure set pᵣₑ pattern recognition of vehicle for tire burs. A tire burst identification model of state tire pressure pᵣₑ(x_{b}, x_{c}, x_{d}) or pᵣₑ(x_{b}, x_{d}) with related parameters which include wheel motion state, vehicle steering mechanical state and vehicle state parameters. According to process of tire burst state of vehicle, or/and the type and characteristics of non-driving and non-braking, driving or braking control states and types of vehicle, a tire burst pattern recognition of state tire pressure pᵣₑ is determined.

20. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Setting tire burst judgement period Hᵥ. The method uses one of tire burst judgment mode of tire pressure detected by sensor, state tire pressure pᵣₑ, characteristic tire pressure x_{b} [symbol] x_{c} [symbol] x_{d}. Based on one of the tire burst pattern recognition, a judgment mode and judgment logic of front axle and rear axle or diagonally arranged wheel pairs for tire burst are established. Based on the judgment logic, tire burst, or/and tire burst wheel, or/and tire burst wheel pair, or/and tire burst balance wheel pair are determined.
(1). Tire burst determination of tire burst pattern recognition for tire pressure detected by sensor. Based on the series decreasing logic threshold aₚᵢ from aₚₙ . . . aₚ₂ to aₚ₁, the tire burst mode recognition sets or does not set threshold from aₚₙ to aₚ₃. Where, the aₚₙ is standard tire pressure value. The threshold value adopted by the tire burst pattern recognition is aₚ₂ or aₚ₁. The value aₚ₁ of tire pressure is 0, and the aₚ₂ is a set value that is greater than 0. When tire pressure reaches threshold aₚ₁ or aₚ₂, the tire burst judgment is established.
(2). Tire burst Judgment in state stage of tire burst.
In tire burst judgement cycle of each period Hᵥ, condition or/and model of tire burst judgement are set. Based on one of tire burst pattern recognition of characteristic tire pressure x_{b}, x_{c}, x_{d}, state tire pressure pᵣₑ and tire pressure detected by sensor, tire burst judgment condition or/and judgment model are set, which include threshold model. Threshold value should be set, and judgement logic is determined. When the value determined by threshold model reaches set threshold value, the tire burst judgment is established, otherwise, the tire burst determination is not established.
(3). Determination of tire burst in tire burst control stage
i. In process of tire burst control and tire burst judgement cycle of periods Hᵥ, the characteristics of tire burst state and the values of characteristic functions x_{b}, x_{c}, x_{d}, pᵣₑ may convert each other among x_{b}, x_{c}, x_{d}, pᵣₑ. In view of the transferring of tire burst characteristics and eigenvalues, tire burst determination model is established by relevant parameters in x_{b}, x_{c}, x_{d} and x_{d}. Based on control states and types of non-driving and non-braking, driving, braking, straight running and turning of vehicles, the judgment of tire burst is achieved by burst judgement model. In the control stage of tire burst of vehicle, one of the judgement model of state tire pressure pᵣₑ[x_{b}, x_{c}, x_{d}] or pᵣₑ [x_{b}<x_{d}] is used to determine tire burst of wheel and vehicle. The judgment model of tire burst uses logic threshold model. The logic threshold value is set and judgement logic is determined. When the value of relevant parameters or tire pressure pᵣₑ reaches the threshold value, the judgment of tire burst in tire burst control stage is maintained, and tire burst control of vehicle continues. When the value determined by threshold model do not reach the threshold value, the tire burst control of vehicle exits.
ii. A logic assignment for tire burst determining is expressed by positive and negative (“+” and “−”) of mathematical symbols. The logic symbols (+, −) in process of electronic control are expressed by high or low electric level, or specific logic symbols code that include numbers and letter. When tire burst is determined, tire burst controller or a central master computer sends a tire burst signal I.

21. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. The method uses entry control or/and exiting control for tire burst.
(1). Entering of tire burst control of vehicle
Under condition of which tire burst of vehicle is determined, entering of tire burst control of vehicle adopts qualitative condition, or/and judgment mode, or/and model. The qualitative conditions manly include motion state condition of vehicle, or/and environmental identification. The judgment model includes logical threshold model. Threshold and decision logic are set. Single parameter or/and multi-parameter threshold model is adopted. According to decision logic, the determination of entering for tire burst control is realized by achieving threshold of threshold model.
i. The single-parameter threshold model includes a threshold model with parameter of vehicle speed uₓ. The threshold value aᵤₐ is a value set by vehicle speed uₓ.
ii. In multi-parameter threshold model, threshold value a_{ub} is determined by model with parameters that includes speed uₓ, steering wheel angle δ or/and friction coefficient μᵢ. The a_{ub} is a function of speed uₓ, steering wheel angle δ or/and friction coefficient μᵢ. The function value of a_{ub} is reduced with the increase of rotation angle δ of steering wheel. The a_{ub} is a increasing function with increment of friction coefficient μᵢ. When the value determined by the threshold model reaches the threshold value, vehicle enters tire burst control.
(2). Exiting of tire burst control of vehicle
A qualitative condition, or/and judgment mode, or/and judgement model are set. The qualitative conditions include state condition of vehicle motion, or/and environmental identification, or/and whether tire burst judgment is established, or/and whether manual control exiting interface for tire burst is set. The model of exiting of tire burst control of vehicle includes a logic threshold model. The logic threshold model uses a single parameter or/and multi-parameter threshold model. When reaching the exiting condition determined by a model, the exiting of tire burst control is realized. One of following specific types is adopted.
i. Exiting of tire burst control in tire burst control progress of vehicle.
According to tire burst mode recognition determined by tire burst control status and its parameters, and according to the qualitative conditions, or/and mode, or/and model of exiting of tire burst control, the tire burst control is maintained when judgement of tire burst is established. Otherwise, tire burst control is exited.
ii. Under the condition of which the judgment of tire burst is established, and according to one of the tire pressure detected by the sensor, characteristic tire burst and state tire pressure, the determined tire burst judgment is not established, or the judgment is changed from established to not established, the tire burst control exits.
iii. Tire burst control exiting determined by manual operation interface. When exiting signal of tire burst control determined by manual operation controller (RCC) arrives, tire burst control exits.
(3). When burst control of vehicle entering or exiting, the master controller or the master control computer sends out signals of the burst control entering signal iₐ or exiting signal i_{b}. The exiting of tire burst control of vehicle has a specific function and significance for state tire pressure or characteristic tire pressure determined by this method; it make abnormal state for vehicle under normal and tire burst conditions control become a integrate, so that, the tire burst control does not depend on fetters of tire pressure detected by sensor.

22. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, the method uses transformation of tire burst control, control mode and control model adapted to state process of tire burst vehicle.
(1). The method uses one or several of following conversion of control, control mode, control model.
i. For level of vehicle. Conversion of control and control modes that include entering and exiting of tire burst control of vehicle, conversion of control and control mode between normal working condition and tire burst conditions of the vehicle. The conversion is carried by tire burst control entering or exiting signals iₐ [symbol] i_{b} as switching signals.
ii. For local level of vehicle, it includes tire burst control for braking, steering, or/and suspension. In state process of tire burst control of vehicle, tire burst control of vehicle adopts a conversion mode which adapts to control characteristics of braking, steering or/and suspension, according to change of vehicle state process.
iii. For level of coordinated control of vehicle braking, steering, or/and suspension to tire burst, it includes the coordinated controls and control mode conversions of tire burst braking, steering or/and suspension.
iv. For level of coordinated control to tire burst control mode or type with other related control modes or control type of vehicle system. The Conversions include conversions of coordinated control of braking with throttle or/and fuel injection of engine, conversions of coordinated control for braking with fuel power driving or electric driving of vehicle, conversions of coordinated controls for tire burst steering rotation force with rotation angle of directive wheel, according to the regulations and procedures of coordination control.
v. According to starting point, transition point and critical point of tire burst state of wheel and vehicle, the tire burst state process and control process of vehicle are divided into several state control periods or stages. The control period and its logical cycle are set based on the parameters and types of tire burst control. The upper and lower level control periods or stages of tire burst are set. Superior control period includes early stage of control of burst tire, or/and control period of real burst tire, or/and control period of tire burst inflection point, or/and control period of separation for rim and tire. In superior control periods, the control mode conversion is realized by converting signals. The lower level control period or stages include control cycle of periods or stages of control parameters and control types for tire burst, the control mode conversion of control parameters and control types for tire burst is realized by converting signals. The tire burst control is more accurate and can meet the requirements of drastic change of tire burst state by control mode and model conversion in each control cycle of lower level control period.
(2). Conversion way or type of tire burst control and control mode One of conversions of modes or types which include program converter, protocol converter and external converter are adopted by controller, according to the different mode or type of the electronic control unit set by tire burst controller and the on-board controller.
i. The program conversion way or type. An electronic control unit is set up by tire burst controller and corresponding on-board system as an entirety. The electronic control unit takes conversion signals that include burst tire signal I, related control signals of each subsystem and control type in each control cycle as switch, and calls conversion subroutine of control mode stored in the electronic control unit, to realize automatically conversion of controls and control modes. The conversions of control modes of various kinds include entering and exiting of tire burst control, or/and conversions of control and control mode of non-burst tire and burst tire, conversions of control and control modes in control periods or stages of control parameters and control modes.
ii. Protocol conversion way or type. The electronic control unit set by the tire burst controller and the electronic control units set by vehicle control system are provided independently. The communication interface and protocol between the two electronic control units are set up. According to the communication protocol, the electronic control units (ECU) uses conversion signals to realize conversion of various kinds of control and control modes.
iii. Way or type of conversion of external converter of electronic control units. When ECU set by tire burst controller and ECU of the on-board system are provided independently, and there is no communication protocol between the two electronic control units, an external converter is set. External converter includes pre converter and post converter set on ECU. The former converter and the latter converter can realize conversion of control and control modes by changing input states and output states of control parameters of controllers. Defining input state of the signals of electronic control unit: the two states where the electronic control unit have or does not have input of signals. Changing of input state of the signals is a signals convert from input state of existing signals into input state of non-signals, or a convert from input state of non-signals into input state of existing signals. Similarly, signals output state of electronic control unit refers to state where the electronic control units has or do not have signal output. Changing of the output state of signals is a convert of signals from output state of the existing signals into the output state of non-signal, or convert from output state of non-signals into the output state of existing signals. The tire burst control is more accurate and can meet requirements of drastic change of tire burst state of vehicle by conversion of various control modes and model.

23. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, the method uses direction determination of related parameter of tire burst vehicle, which is referred to tire burst direction determination.
(1). Coordinate system, calibration of parameter direction and direction judgment logic of parameters to tire burst are set, In coordinate system, calibration of relevant parameters includes: calibration of rotation direction of angle or/and torque direction, or/and calibration of forward travel direction and return travel direction of angle or/and torque, or/and calibration of increment direction and decrement direction of angle or/and torque. Based on calibration of direction of relevant parameters, the mathematical logic of direction judgment of relevant parameters that include angle or/and torque is established, and configuration of logical combination of relevant parameters is determined.
(2). According to different settings of angle or/and torque parameters, or/and different settings of detection sensors, modes of direction judgement of related parameters for tire burst are determined. This modes include angle torque mode or angle mode.
(3). The coordinate system determined by this method provides a technical platform to data processing of relevant parameters which include power steering, active steering and steering by wire control of manned and unmanned vehicles.

24. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. The tire burst direction determination mainly includes coordinate system, calibration of related parameter direction and direction judgment logic of tire burst. Direction determination of steering parameters for tire burst vehicles is one basic conditions to realize steering control of tire burst vehicle. The method uses direction determination of following one parameter or more parameters, it includes:
First. In range of rotation moment control of steering of tire burst vehicle, direction determination includes direction judgements of rotation moment of directive wheel exerted by ground, tire burst rotation moment, rotation angle or rotation moment of steering wheel or/and directive wheel and tire burst steering assistant torque.
Second. In range of active steering of tire burst vehicle, direction determination includes direction judgements of tire burst rotation moment, steering angle and rotation moment for tire burst, steering assistant moment or/and steering driving moment.
Third. In range of active steering by drive-by-wire of tire burst vehicle, direction determination includes of tire burst rotation moment, rotation driving moment and rotation angle of directive wheels.
An accurate direction judgment to various control of angle and torque parameters of steering for tire burst vehicle determination can be provided.
(1). mode of rotation angle and rotation torque
In steering system of vehicle, two kinds of vector coordinate system of angle and torque are established. The coordinate systems to vehicle include absolute coordinate system set in vehicle and relative coordinate system set on steering axis of steering system. The origin of coordinate and direction of rotation angle and rotation torque are set up. The direction determination of rotation angle and rotation torque: under of which condition of origin of coordinate is 0 point, it is determined to direction of left-handed rotation and right-handed rotation for rotation angle and rotation torque in coordinate system, or/and direction of forward travel (+) and return travel (+) to rotation angle and rotation torque in coordinate system, or/and direction of increment or decrement of rotation angle and rotation torque. Establishment and calibration of coordinate system include the following. Within range of absolute coordinate system, a relative coordinate system for value and direction of angle and torque are established. A direction calibration mode that includes rotation direction of left-handed and right-handed to rotation angle, or/and direction of positive (+) route and negative (−) route of angle and torque to the origin, or/and direction of increment and decrease of angle and torque to the origin are used in coordinate systems of angle and torque. The direction of rotation angle and rotation torque are represented by positive (+) and negative (−) of mathematical symbols. The mathematical logic and logic combination of direction judgment of angle and torque are established. Based on the mathematical logic and its combination, direction judgment of all kinds of angle and torque can be determined under normal and tire burst conditions.
(2). Rotation angle mode. Two kinds of angle coordinate systems which include the absolute coordinate system set on the vehicle and the relative coordinate system set on the turning axis of the steering system are set up. Establishment and calibration of coordinate system: two or more relative coordinate systems are established in an absolute rotation angle coordinate system, to calibrate the magnitude and direction of rotation angle. The calibration mode of direction: it can be adopted that rotation direction of left-handed rotation and right-handed rotation of rotation angle, or/and the direction of forward route or return route to the origin, or/and the direction of increment and decrement to the origin in each coordinate system. The direction of rotation angle are represented by positive (+) and negative (−) of mathematical symbols, so that, the mathematical logic combination and the judgment logic of combination are established. Based on the mathematical logic and its combination, direction judgment of all kinds of rotation angle can be determined under normal and tire burst conditions.

25. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. In tire burst working condition, one of information communication and data transmission that include on-board method network bus, vehicle information interactive distance detection, vehicle road traffic network, or one of their combination are adopted.
(1). Data network bus of vehicle adopts one of the following types or modes, or/and one of their combination type.
i. Data network bus of vehicle is a local area network. In the local area network, topological structure of Controller Area Network (CAN) is bus type. The CAN includes data, address and control bus. CPU, or/and local area, or/and system, or/and communication are set up.
ii. Local Interconnect Network (LIN) bus is used for distributed electric control system of vehicle, which includes digital communication systems of tire burst controller, sensor and actuator.
iii. According to the structure and type of tire burst control system, the on-board network bus of the system adopts fault detection bus, or/and safety bus, or/and one of new X-by-wire bus which includes drive-by-wire power steering, drive-by-wire active steering, drive-by-wire brake of electronically hydraulic or electronically machinery, drive-by-wire engine throttle, fuel injection bus under tire burst conditions. The traditional mechanical system is transformed into an electronic control system managed by high-performance CPU and connected by a high-speed fault-tolerant bus. Especially for the characteristics of high frequency control of vehicle, it is constituted to conversion of high dynamic control mode and high dynamic response control in distributed wire control system, telex control systems of drive-by-wire braking or/and drive-by-wire steering or/and drive-by-wire throttle, to apply and meet to the special environment and conditions for tire burst. Under working condition of tire burst and no tire burst, the data transmission and information communication of information unit, the main controller, controller and execution unit are realized by following vehicle data network bus, or/and physical wiring for integration design system.
(2). Under normal tire burst conditions, tire burst vehicles of driverless and drive by man or may adopt one of external information communication and data transmission which include one of following modes or types, one of their combination.
i. Interactive Information communication and data transmission of vehicle. The method uses radio frequency (RF) receiving and transmitting module to realize data transmission and receiving. Earth longitude and latitude coordinates are obtained according to multi-mode compatible positioning. Radio frequency identification (RFID) technology is used. The distance from satellite to vehicle receiving device can be obtained by locating of GPS. Based on more than three satellite signals, and applying of distance formula of three-dimensional coordinates, equations are composed by the distance formulas, to solve X, Y, Z three-dimensional coordinates of the vehicle position. The format to the longitude and latitude information is defined, to obtain longitude and latitude position information of the vehicle calibrated by geodetic coordinates. The identified objects may be actively identified by spatial coupling and reflection transmission of electromagnetic signal which include radio frequency (RF) signal. The vehicle can send accurate information about the vehicle to surrounding vehicles in real time, and the vehicle can receive the location and changed status information of surrounding vehicles in real time, to realize communication between the vehicle and surrounding vehicles.
ii. Information communication and data transmission of road traffic vehicle network. Networked vehicles can obtain or release information about road traffic and surrounding environment of the networked vehicle, state of driving vehicles by means of vehicle coupling network, to realize the communication between the vehicle and surrounding vehicles.

26. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. In driving passes of tire burst vehicle, one of distance monitoring of the following are used, to determine distance Lₜᵢ, relative speed u_{c} and time zone tₐᵢ to tire burst collision avoidance between the front vehicle and rear or front vehicle. One of the following detection modes and their combination types shall be adopted to the tire burst vehicle.
(1). A coordinated control mode of ultrasonic ranging and self-adaptive tire burst control. Distance detected by ultrasonic ranging sensor is set. When the tire burst control entry signal iₐ arrives, the distance Lₜᵢ and relative speed between the vehicle and the front or the rear vehicle are not limited by tire-burst vehicle in scope of safe distance. When the rear vehicle enters detection distance of ultrasonic ranging sensor of the tire burst vehicle, a coordinated control mode of ultrasonic ranging and self-adaptive tire burst control to tire burst braking control of the vehicle is adopted. According to the driver' preview model of rear vehicle or the driver preview model to front vehicle, the braking and deceleration strength of tire burst stability control of vehicle and distance between the vehicle and the rear vehicle in the effective range of anti-collision are limited, to realize coordinated control of ultrasonic ranging and self-adaptive tire burst control of the vehicle. Based on datum processing of signal detected by ultrasonic ranging sensors, distance Lₜ and relative speed u_{c} between front vehicle and rear vehicle are determined. The dangerous time zone tₐᵢ is calculated by mathematical formula with parameter Lₜ and u_{c}.
(2). Machine vision distance monitoring. The feature signal is extracted quickly from the captured image, and a certain algorithm is used to complete the visual information processing. Machine vision which include monocular or multi-eye vision, color image and stereo vision detection. A mode, or/and models, or/and algorithms for simulating human eyes are established. One of algorithms is adopted: it includes color image graying, binaryzation of image, edge detection, image smoothing, open CV digital image processing of morphological operation and region growth; a detection system including distance of shadow feature is used. Distance measurement is realized by model or/and algorithm of vision ranging of computer. Vehicle distance Lₜ from the camera sensor to other vehicle is determined by visual information processing in real time. The dangerous time zone tₐᵢ is calculated by mathematical formula with distance Lₜ and relative speed u_{c}.
(3). Vehicles information commutation way (VICW).
i. An interactive distance monitoring method of vehicle is used for transmitting and receiving of vehicles. Geodetic longitude and latitude coordinates can be obtained by multi-mode compatible positioning. The method use Radio Frequency Identification (RFID) technology. The distance from the satellite to the vehicle receiving device is obtained by positioning of GPS. The distance from satellite to vehicle receiving device can be obtained by locating of GPS. Based on more than three satellite signals, and applying of distance formula of three-dimensional coordinates, equations are composed by the distance formulas, to solve X, Y, Z three-dimensional coordinates of the vehicle position. The longitude and latitude information is defined on format. The longitude and latitude of the vehicle are measured by ranging model, to obtain location information of vehicle calibrated by the geodetic coordinate calibration.
ii. The identified object is identified actively by space coupling of electromagnetic signal and transmission characteristics of signal, which includes radio frequency signal RFID. The detecting system sent all kinds of information about the precise position of the vehicle and the surrounding vehicles, and receives information about status changing of surrounding vehicles, so as to realize the mutual communication between vehicles. Based on the intercommunication information between the vehicle and surrounding vehicles, the detecting system can process to longitude and latitude position datum of the vehicle and the surrounding vehicles at real-time dynamically, by means of models or/and algorithm. Based on the datum processing, the detecting system can obtain the information of vehicle moving distance indicated by latitude and longitude degree coordinate. According to the information, the moving distance of vehicles is calculated by positioning of satellite within scanning period T of latitude and longitude. According to the longitude and latitude coordinate and position change value of the front vehicle and rear vehicle that run in same direction or reverse direction, the distance Lₜᵢ and relative speed u_{ci} between two vehicles are calculated by the model and algorithm of measured distance and measured speed for vehicle.

27. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Environment identification includes road traffic condition recognition, determination of driving vehicle location and object location, location distribution and location distance. In effective and limited running distance and space range of anti-collision for tire burst control, the effective control of the motion state, path tracking and collision-proof of tire-burst vehicle can be realized. Tire burst vehicle and peripheral vehicles each other can exchange traffic information by means of tire-burst warning of sound and light emitted by tire-burst vehicle, or/and by means of vehicle traffic network, or/and mobile communication. The tire burst vehicle can inform surrounding vehicles to avoid actively the tire-burst vehicle by control of their vehicle. In this way, peripheral vehicles can reserve a larger running distance and effective anti-collision space to the tire-burst vehicle under possible environment conditions of road. The one of following environment identification mode or their combination is set.
(1). Machine vision, positioning and ranging. The detection mode of monocular or multi-visual, color image or/and stereo vision are used. The feature signals are extracted quickly from captured images, and information processing of vision, and image or/and video is completed by certain models or/and algorithms to realize distance monitoring based on machine vision. The location and distribution of road, vehicles, obstacles and traffic conditions are determined by machine vision, locating and navigation of vehicle, target recognition and path tracking of vehicle are realized by using corresponding matching of satellite positioning, inertial navigation, electronic map or/and real-time map, dead reckoning, road condition and running state of vehicle.
(2). Under the condition of establishing road traffic network (IVNRT), networked vehicles can acquire and release information of the vehicle, surrounding environment information of the vehicle, state and information of running state of periphery vehicles by IVNRT, to realize communication among the vehicle and surrounding vehicles. According to the structure of automobile traffic network system, a controller of road traffic network and networked controller of vehicle are set up. The vehicle traffic network and networked vehicles can communicate each other by wireless digital transmission and data processing of oneself controllers. Networked control of vehicle includes wireless digital transmission of vehicle-borne system and data processing. It is set to submodules of digital receiving and transmitting, machine vision positioning and ranging, mobile communication, global satellite positioning and navigation, wireless digital transmission and processing, environment and traffic data processing. Under normal and tire burst conditions, networked vehicles can realize wireless digital transmission and information exchange by vehicle traffic network. Based on vehicle traffic network or/and global positioning system, driverless vehicle can determine related information that include lane line, driving orientation of the vehicle, driving and running state of the vehicle, path tracking of the vehicle, the distance from the vehicle to other vehicles and obstacles by means of geodetic coordinates, view coordinates and positioning map. The state information of the vehicle includes vehicle speed, tire burst and non-tire burst status, tire burst control status and path tracking of the vehicle.
First. Networked vehicles can release relevant datum and information of structural state parameter, running state parameter of the vehicle to vehicle traffic network, which includes datum of control parameter and process parameter of the tire burst vehicle. These datum of tire burst vehicle are processed by vehicle traffic network and are transmitted by mobile communication to the surrounding networked vehicles.
Second. networked vehicles can receive traffic information of passing road by vehicle traffic network, which includes information of traffic lights and signboard, information of vehicle location, information of running status and control status of surrounding networked vehicles, related information of tire burst and tire burst control of vehicles, information of driving status, variation information of parameters and datum during each detection and control cycle of tire burst vehicle.
Third. Networked vehicles can receive information query and navigation requests of other networked vehicle through vehicle traffic network. These request of information inquiry and navigation is processed by the data processing module of IVNRT, then it is fed back to the vehicle of making the request.
Fourth. The networked vehicles can query relevant information of networked vehicles in around road through the wireless digital transmission of vehicle traffic network, so as to realize information exchange between the vehicles and surrounding vehicles. The information includes running environment of vehicles, road traffic and driving status of vehicles.

28. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst conditions, following parameters, control variables, braking control types, braking control periods and its logic cycle of active brake control of tire burst vehicle are used by active brake control for tire burst vehicle.
(1). Under condition of which tire burst judgment is established, a conversion mode of program or agreement are adopted, to realize conversion of control and control mode of related control parameters and its control type of tire burst vehicle in logic cycle of each control of control period Hₕ.
(2). Control parameters and control variables of tire burst braking control.
According to state process of tire burst vehicle, tire burst braking control mainly adopts one or several parameters that include angle deceleration \dot{ω}ᵢ of wheel, slip rate Sᵢ, braking force Qᵢ and vehicle deceleration \dot{u}ₓ. Under the specific condition of tire burst, angle deceleration \dot{ω}ᵢ and slip rate Sᵢ or vehicle deceleration \dot{u}ₓ are taken as control variables, and braking force Qᵢ is as parametric variable; from this, the braking force Qᵢ of each wheel may be adjusted indirectly by wheels deceleration \dot{ω}ᵢ and slip rate Sᵢ that show characteristic change of wheels state, to control directly vehicle instability by changing of wheel state characteristics which is indicated by \dot{ω}ᵢ or Sᵢ. Under the specific condition of tire burst, the \dot{ω}ᵢ and Sᵢ used as control variables is determined by unbalanced braking control of wheels to stability control of tire burst vehicle. From this, transfer chain of braking control is simplified, the dynamic response characteristic of braking of vehicle is improved, hysteretic response time of the whole vehicle state to braking wheel is reduced. The effect and influence of structural parameters of braking actuator to braking control characteristics are balanced or eliminated. In view of this, or braking force sensor set in the braking actuator may not be adopted.
(3). Different braking control modes or types for tire burst are adopted, which mainly includes wheel steady-state braking A control, wheel balanced braking B control, vehicle steady-state C control, and total braking force D control. These control are referred to as brake A, B, C, D control. In tire burst braking control, one of brake A, B, C and D control is adopted.
(4). The braking control period Hₕ for tire burst.
i. According to state process of tire burst vehicle, requirement of braking control characteristic and response characteristic to control signal of braking actuator, the braking control period Hₕ is determined. The Hₕ is consistent with change of tire burst state process, and adapts to the control requirements of extreme change of tire burst state process, and meets the requirements of frequency response characteristics controlled by hydraulic brake device or electronically controlled mechanical brake device.
ii. The Hₕ is a value set by tire burst control, or is a dynamic value set by for tire burst control. The dynamic value of Hₕ is determined by mathematical model with the state parameters of wheel and vehicle. The braking control period Hₕ can be as period of logic cycle of control parameter and their combination, or/and is as period of a mode or type of wheel steady braking A control, vehicle steady state brake C control, balanced brake B control of each wheel, total brake force D control and their combination. Based on tire burst state, control stage and time zones tₐᵢ of anti-collision control for tire burst vehicle, the corresponding logic cycle of braking control combination is implemented based on the control cycle period Hₕ. In each braking control period Hₕ, one of brake A, B, C, D control or one of their logic cycle of combination control is executed. In each logic cycle of Hₕ, one of brake A, B, C, D control their logic cycle of control combination can be repeated, or can also be converted into another a control and a combination control.
(5). Cycles of braking control for vehicle tire burst
In tire burst braking control, tire burst control of vehicle adopts one of following two modes when wheels enter cycles of brake A, B, C, D control or their logic combination. Mode 1. After braking control and control mode that include brake A, B, C, D control or their logic combination for burst tire vehicle in the period Hₕ are completed, it enters a braking control and braking control mode in a new cycle Hₕ₊₁. Mode 2. The braking control and control mode in this period Hₕ is terminated immediately, and it enters a new control cycle Hₕ₊₁ at the same time. In a new period, the original brake control and control mode which include braking A, C, B and D control or their logic combination for burst tire can be maintained, or a new brake control and control mode is adopted.
(6). Tire burst braking control adopts a form of hierarchical coordinated control.
The upper level is a coordinated level, and the lower level is a control level. The upper level control determines control mode, model or type and logical combination of A, C, B and D control in the each braking control period Hₕ of logic cycle, and determines transformation rules of their control in each period Hₕ of each control and each logical combination. The lower level control completes a sampling of relevant parameter signals of braking A, C, B, D control and their combination control in each period Hₕ, and completes datum processing according to braking A, C, B, D control types and their logical combination, control model or/and algorithm. In the each braking control period Hₕ, tire burst controller outputs control signals, to implement once allocation and adjustment of related control parameters that include angle deceleration \dot{ω}ᵢ, or/and slip rate Sᵢ or/and braking force Qᵢ of wheels. In each braking control cycle Hₕ, one of independent braking control of brake A, C, B and D control or one of their logic combination control is implemented. A group of control logic can be repeated in cycles, and can also be converted into another group of control logic combination according to the conversion signal.

29. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, the method adopts one of mode or types of steady-state A control of wheel, or/and balanced braking B control of wheels, or/and total braking force D control of wheels, which are referred to as braking A, B, D control.
(1). Brake A control includes anti-lock control of non-burst tire wheel and steady-state control of tire burst wheel. The steady-state of tire burst wheel control adopts two modes that includes releasing brake force or decreasing brake force to tire burst wheel. In the mode of decreasing brake force, the angle deceleration \dot{ω}ᵢ or/and slip rate Sᵢ are taken as control variables, and braking force Qᵢ is taken as parameter variables. The values of control variable \dot{ω}ᵢ or/and Sᵢ of burst tire wheel are reduced by equal or unequal amount and step by step, until the braking force is relieved. Brake force of burst tire wheel is adjusted indirectly.
(2). Balance braking B control of each wheel are involved in the longitudinal control (DEB) of wheels. Defining of balanced wheelset: each tire force moment exited by ground on the two wheel of the wheelset to torque of center mass of vehicle is opposite in direction. Balancing wheelset include burst tire and non-burst tire balancing wheel pairs. Defining concept of balance distribution and control of control variables for brake B control: using angle acceleration and deceleration speed \dot{ω}ᵢ and slip rate Sᵢ of each wheel as control variables, theoretically, the torque sum of each tire force to the center mass of vehicle is zero in the distribution of \dot{ω}ᵢ and Sᵢ of each wheel. The brake B control adopts balancing distribution and control form to two-wheel braking force of wheelset. One of comprehensive control variables \dot{ω}_{b}, S_{b} and Q_{b} is distributed between two axles by mathematical model with one of state parameters \dot{ω}ᵢ, Sᵢ of two-wheel and load of front and rear axles. The control variables \dot{ω}ᵢ and Sᵢ of two-wheel to front and rear axles are allocated according to the equal or equivalent model of brake force. Among them, the values of comprehensive control variables \dot{ω}_{b}, S_{b} are determined by average or weighted average algorithm of values of \dot{ω}ᵢ, Sᵢ of each wheel.
(3). Total braking force D control for tire burst. Total braking force D is sum of braking force Qᵢ of each wheels. The brake D control is used to control of movement state expressed by deceleration \dot{u}ₓ of tire burst vehicle or comprehensive angle deceleration \dot{ω}_{d} of wheels. The braking D control uses one of deceleration \dot{u}ₓ of vehicle, comprehensive angle deceleration \dot{ω}_{d}, comprehensive slip rate S_{d}, braking force Q_{d} of all wheels. The values of \dot{ω}_{d}, S_{d} and Q_{d} are determined by an algorithm of \dot{ω}ᵢ, Sᵢ and Qᵢ of each wheel. The D control adopts forward direction control mode or reverse direction control modes in transferring direction of control variable. In reverse mode, one of the parameters of angle deceleration \dot{ω}ᵢ, slip rate Sᵢ and braking force Qᵢ is used as control variables, and the target control values or actual values of control \dot{ω}_{dg} or S_{dg} or Q_{d} for braking A, B and C control is determined. The control logic combination of \dot{u}ₓ←D←(E) is used. In the forward mode, the target control values of \dot{ω}_{d} or S_{d} or Q_{d} of each parameter forms \dot{ω}ᵢ or Sᵢ or Qᵢ for total braking force D control are determined by the vehicle deceleration \dot{u}ₓ. Value of one of parameters \dot{ω}ᵢ, Sᵢ, Qᵢ is allocated to each wheel, and the control logic combination may adopt (E)←D←\dot{u}ₓ, where E represents the logical combination of brake A, C or/and B control.

30. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, the method adopts steady-state brake C control of vehicle that is referred to as braking C control.
(1). Coordinate system, calibration of parameter direction and direction judgment logic of parameters to tire burst are set. In coordinate system, direction judgment of relevant parameters include: direction judging of steering wheel rotation angle, vehicle yaw angle speed, vehicle yaw moment, additional yaw moment Mᵤ to restore tire burst vehicle stability.
(2). Based on wheel, vehicle steering and vehicle dynamics equations or/and mode, a vehicle stability control mode, model or/and algorithm that mainly includes PID, or sliding mode control, or optimal control, or fuzzy control algorithm are established by system of theoretical, experiment or experience models with related modeling parameters that include wheel motion state, vehicle steering mechanics state and vehicle driving state parameters under normal and tire burst conditions. The modes use a mathematical analytic formula, or it is convert to space state expression of mathematical model. The driving state parameters of vehicle are determined, which mainly include yaw angle velocity ωᵣ of vehicle, sideslip angle β of vehicle centroid, or/and longitudinal deceleration aₓ and lateral acceleration a_{y}. The deviations between ideal and actual values of state parameters of vehicle is determined, which include yaw angle speed deviation e_{ω}_{ᵣ}(t) and sideslip angle deviation e_{β}(t) of vehicle centroid. Based on vehicle or/and wheel state parameters, a mathematical model or/and control algorithm of additional yaw moment Mᵤ that can restore stability control for tire burst vehicle is established by modeling parameters that include yaw rate deviation e_{ω}_{ᵣ}(t) and centroid sideslip angle deviation e_{β}(t) of vehicle, or/and wheel equivalent or non equivalent angle velocity deviation e(ωₑ) [symbol] e(ωₖ), or wheel equivalent or non equivalent slip ratio deviation e(Sₑ) [symbol] e(Sₖ).
(3). Additional yaw moment Mᵤ includes the additional yaw moment Mᵤᵣ generated by longitudinal differential braking of the wheels and the additional yaw moment Mₙ produced by braking in steering. The Mᵤ can be used for balancing tire burst yaw moment Mᵤ′ and controlling insufficient or excessive steering or sideslip of vehicle in tire burst. The distribution of additional yaw moment Mᵤ to wheels adopts one of parameter forms of angle deceleration \dot{ω}ᵢ, slip rate Sᵢ or braking force Qᵢ. A distribution model of additional yaw moment Mᵤ to wheels is established by one of control variables that include angle deceleration \dot{ω}ᵢ, slip rate Sᵢ, braking force Qᵢ, and by parameters that include ground friction coefficient μᵢ and load N_{zi} of each wheel. Target control value of additional yaw moment Mᵤ of vehicle is determined. According to the mathematical model of additional yaw moment Mᵤ, the target control value of the Mᵤ is determined. Stability control of tire burst vehicle is realized by allocating of additional yaw moment Mᵤ to each wheel.

31. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, the method adopts steady-state brake C control of vehicle that is referred to as braking C control. The vehicle includes vehicle of symmetrical distribution to four wheels, which is referred to as four-wheeled vehicle.
(1). A distribution of additional yaw moment Mᵤ to wheels. When vehicle is braking and steering at the same time, the additional yaw moment Mᵤ is sum of vectors of additional yaw moment Mᵤᵣ generated by wheel longitudinal braking and additional yaw moment Mₙ produced by braking in vehicle steering. Defining of additional yaw moment Mₙ in vehicle steering. Under condition of braking in vehicle cornering, it is changed to the longitudinal slip rate, adhesion coefficient of longitudinal and transverse, adhesion state and transverse tire force of front axle and rear axle. From this, the additional yaw moment Mₙ is formed by yaw moment deviation between two lateral forces of front axle and rear axle, which acts on vehicle mass center. The direction of additional yaw moment Mₙ is determined. Defining to yaw control wheel: the wheel applied by larger differential braking force in balancing wheelset is called as yaw control wheel. Defining to efficiency yaw control wheel: under of condition in which two yaw control wheelset are exerted by differential braking force, the wheel that can obtain larger additional yaw moment Mᵤᵣ in two yaw control wheelset is called as efficiency yaw control wheel. In process of braking and steering at the same time, and under condition in which two yaw control wheelset are exerted by equal amount of differential braking force, larger value of additional yaw moment Mᵤ can be obtained by vehicle when the direction of Mₙ and Mᵤᵣ is the same, otherwise it gets a smaller value.
(2). Distribution or allocation to each wheel of additional yaw moment Mᵤ that can restores vehicle stability. Under condition of which direction of additional yaw moment Mᵤᵣ and Mₙ is determined, and according to state process of tire burst vehicle and brake A, B, C, D control or/and its logical combination, distribution or allocation of additional yaw moment Mᵤ to each wheel adopt model of single wheel, or/and two vehicle, or/and three wheel.
i. Under straight line running state of vehicle, the distribution of additional yaw moment Mᵤ of single wheel, two wheels and three wheels: Mᵤ is equal to Mᵤᵣ, namely, Mₙ is equal to 0. One of yaw control wheels or the yaw control wheel with larger load is selected as the efficient yaw control wheel. The allocation of additional yaw moment Mᵤ is determined by distribution ratio of two yaw control wheels.
ii. Two wheels models. Under running states of braking in steering of vehicle, and according to direction determination of additional yaw moment Mᵤ and their model:
Mᵤ=Mᵤᵣ+Mₙ
Two yaw control wheels and efficient yaw control wheel are determined. When direction of Mᵤᵣ and Mᵤ is the same, the Mᵤ may obtain the maximum value. Based on the theoretical model of brake friction circle, a coordination allocation model of additional moments Mᵤ of two yaw control wheel are established by modeling parameters that include wheel load N_{zi}, wheel slip rate Sᵢ, wheel side slip angle, rotation angle δ of steering wheel or rotation angle θₑ of directive wheel. A coordination control among parameters that include slip rate Sᵢ of two yaw control wheel, side slip angle of directive wheels, rotation angle δ of steering wheel or rotation angle of directive wheel θₑ is implemented by additional moments Mᵤ of two yaw control wheels.
iii. Three wheels models. The three wheels consist of two yaw control wheels and one non yaw control wheel. Under braking in steering of vehicle, and according to direction determination of additional yaw moment Mᵤ and their model:
Mᵤ=Mᵤᵣ+Mₙ
Two yaw control wheels and an efficient yaw control wheels are determined. When direction of Mᵤᵣ and Mᵤ is the same, additional moments Mᵤ may obtain the maximum value, efficiency yaw control wheel and two yaw control wheels are determined. Based on theoretical model of brake friction circle, coordination allocation model of additional moments Mᵤ in two yaw control wheels are established by modeling parameters that include wheel load M_{zi}, wheel slip rate Sᵢ, wheel side slip angle, rotation angle δ of steering wheel or rotation angle θₑ of directive wheel. The coordination allocation model and the stability control of tire burst vehicle are realized by brake control and allocation of additional moments Mᵤ to two yaw control wheels. When braking force applies to non-yaw control wheel, additional yaw moment Mᵤ is vector sum of yaw moment generated by one yaw control wheel and one non yaw control wheel. A yaw control wheel and a non-yaw control wheel form a balance wheelset. The braking force distributed by two wheels of the balancing wheelset is equal or unequal. In the three wheel model, it is decreased to the additional moments Mᵤ produced by differential braking force of tire burst brake C control of two yaw control wheels. Tire burst yaw moment of vehicle is balanced by additional yaw moment Mᵤᵣ generated by vehicle longitudinal differential braking force and yaw moment common Mₙ produced in braking and steering of vehicle, to compensate or/and balance understeer or oversteer of tire burst vehicle.

32. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. According to the state process of tire burst vehicle, logic combination rules of control modes or types that include braking A, B, C, D control and their combination are determined. Logic combination rules mainly include the following.
(1). Rule 1. A logic relationship of logical sum to two kinds of control model or type. The logic relationship is represented by sign “∪”. In brake control, the logical rule symbol “↑” and various types or modes of brake control can constitute various models or types of logical combination of brake control. The types or modes of braking control mainly include wheel steady-state braking A control, vehicle steady-state braking C control, wheel balanced braking B control and total braking force D control. The logical combination on the rule is an unconditional logic combination, and the logical combination determined by the logic rule indicates that two kinds of controls are executed at the same time, and the logical combination is an algebraic sum of control values of control of the two kinds.
(2). Rule 2. A logic relationship of substitution and control conflict between two kinds of control model or type. The logical combination based on the rules is a conditional logic combination. The logic relationship of substitution is represented by the logical symbol “⊂”. It is composed by the combination of symbol “⊂” and various types or modes of brake control. The logical relationship is constituted as a relationship where a type or mode can be replaced by other type or mode under certain conditions. The conditions include: according to order, a control mode or type on the right side is taken as precedence, or under certain conditions, the control mode or type on the left side can replace or cover the control mode or type on the right side.
(3). Rule 3. A logical relation of conditional sequential execution of each logic and logic combination. The logical relation is expressed by sign “←”. The logic rule is expressed as: whether the right side control is completed or is not completed, when the set conditions are met, the left side control or control logic combination is executed on the direction of arrow. The logic rule is also expressed as: the logical combination on both sides of the symbol “←” has a logic relationship of equal position or upper and lower. The control on both sides of the symbol “←” mainly includes one of the control types or modes of brake A, B, C and D control, or one of the logical combinations of its control. The logical combination of brake control mainly includes logical combination composed by brake A, B, C, D control modes or types and various logic rules or logic symbols. The logic combination stipulates that the control quantity of the unselected control type is 0.

33. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Brake compatibility control to tire burst vehicle. Brake compatible control mainly includes adaptive compatible control of tire burst active brake and tire burst artificial brake.
According to separate or parallel operation state of tire burst active brake and pedal brake of vehicle, a compatibility control mode of tire burst active brake and pedal brake of vehicle is established, so as to solve the control conflict when the two control kinds of brake are operated in parallel. When two control kinds of the active brake and the pedal brake are operated separately, the two control does not conflict. The brake compatibility controller does not process compatibly to the input parameter signals of brake control. The output signal of the brake compatibility controller is a signal of no processed compatibly. When tire burst active brake and pedal brake of vehicle, which hereinafter referred to as the two types of brake, are operated in parallel, the target control values of control variable that include comprehensive angle deceleration \dot{ω}_{d}′ or comprehensive slip rate S_{d}′ of each wheel are determined by relationship models between \dot{ω}_{d}′ and S_{w}′, Q_{d}′ and S_{w}′, S_{d}′ and S_{w}′ under certain braking force. Among, the S_{w}′ is displacement of the brake pedal. The deviation e_{Qd}(t), e_{\dot{ω}d}(t) or e_{Sd}(t) between the target control value of active braking force Q_{d}, angle deceleration \dot{ω}_{d}, slip rate S_{d} and their actual values Q_{d}′, \dot{ω}_{d}′, S_{d}′ are defined. According to a certain algorithm, comprehensive active braking force Q_{d}, angle deceleration \dot{ω}_{d} or slip rate S_{d} of each wheels can be determined by braking force Qᵢ, angle deceleration \dot{ω}_{d} Slip ratio S_{d} of all wheels. The control logic of brake compatibility is determined by the positive (+) and negative (−) of deviation of deviation e_{Qd}(t), e_{\dot{ω}d}(t) or e_{Sd}(t). When the deviation is greater than zero, the value of comprehensive braking force Q_{d}, comprehensive slip rate S_{d} and comprehensive angle deceleration \dot{ω}_{d} which are output by the brake compatibility controller are equal to its input values Q_{d} [symbol] S_{d} [symbol] \dot{ω}_{d}. When the deviation is less than zero, one of the input parameters Q_{d}′, \dot{ω}_{d}′, S_{d}′ is processed by the brake compatibility controller according to brake compatibility control model. A brake compatible function model is established by modeling parameters that include tire burst characteristic parameter γ, one of active braking force deviation e_{Qd}(t), angle deceleration deviation e_{\dot{ω}d}(t) and slip rate deviation e_{Sd}(t) in the positive and negative travel of the brake pedal of braking system. According to the model, brake compatibility controller processes to input parameter signals, from this, the output value of brake controller is the output value processed by brake compatible controller. Modeling structure of the function model for brake compatibility control: the value Q_{da} [symbol] \dot{ω}_{da} and S_{da} of parameters Q_{d} [symbol] \dot{ω}_{d} and S_{d} processed by brake compatible controller are respectively increasing function with increment of absolute value of deviation e_{Qd}(t), e_{\dot{ω}d}(t), e_{Sd}(t) in positive travel, and are respectively decreasing function with decrement of absolute value of deviation e_{Qd}(t), e_{\dot{ω}d}(t), e_{Sd}(t) in negative travel. The asymmetric brake compatibility model is represented as: on the positive travel and negative travel of brake plate, the model has different structures; the weight of deviation e_{Qd}(t), e_{Sd}(t), e_{\dot{ω}d}(t) and the tire burst characteristic parameter γ in the positive travel of the brake pedal is less than those in negative travel of the brake pedal, and the function value of the parameter in the positive travel of the brake pedal is less than those of the parameter in the negative travel of the brake pedal. According to state characteristics of tire burst vehicle and braking control period, a mathematical model of the tire burst characteristic parameter γ used brake compatibility control is established by modeling parameters which include ideal and actual yaw angle velocity deviation e_{ω}_{ᵣ}(t) of vehicle, or/and the equivalent or non-equivalent relative angle speed deviation e(ωₑ) or e(ωₖ), angle deceleration speed deviation e(\dot{ω}ₑ), e(\dot{ω}ₖ). The modeling structure of the tire burst characteristic parameter γ is determined: the parameter γ is an increasing function with increment of absolute value of e_{ω}_{ᵣ}(t) e(ωₑ) [symbol] e(\dot{ω}ₑ), and the parameter γ is an increasing function with decrement of parameter tₐᵢ of collision avoidance time zone. The modeling structure of the brake compatibility control: the Q_{da} [symbol] \dot{ω}_{da} and S_{da} respectively are the decreasing function with increment of the tire burst characteristic parameter γ. Based on the model, self-adaptive coordinated control for parallel operating of pedal braking of brake system and the active braking of tire burst vehicle can be determined.

34. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Brake compatibility control for tire burst vehicle.
(1). Brake compatibility control. Based on parameter forms of control variable comprehensive braking force Q_{da}, comprehensive slip rate S_{da} and comprehensive angle deceleration \dot{ω}_{da}, One of logical combination for wheel steady-state braking A control, balance braking B control, vehicle steady-state braking C control, total braking force D control and their control logic combination are determined, in which the control logic combination includes A⊂B∪C←D [symbol] C⊂B∪A [symbol] A⊂C←D [symbol] C⊂A←D. The brake compatibility controller adopts closed-loop control. When one of deviation e_{Qd}(t), or e_{\dot{ω}d}(t) or e_{Sd}(t) between target control value of comprehensive active braking force Q_{d}, or angle deceleration \dot{ω}_{d} or slip rate S_{d} and their actual values Q_{d}′, or \dot{ω}_{d}′ or S_{d}′ is negative(−), the input parameter signals of Q_{d} or S_{d} or \dot{ω}_{d} of brake compatibility controller are processed compatibly by braking compatibility model with brake compatibility deviation e_{Qd}(t), e_{Sd}(t), e_{\dot{ω}d}(t) and parameter γ. After the brake compatibility treatment, the brake force distribution and brake force adjustment of each wheel are carried by the braking B control or/and braking C control, so that, the actual value of the active brake control for tire burst always tracks its target control value. After the brake compatibility treatment, the output value of active brake control of tire burst vehicle is its target control value.
(2). In early stage of tire burst and anti-collision safety time zone of the vehicle and rear vehicles, the value of parameter γ can be zero, thus the vehicle can adopt brake control logic combination A c B∪C. In real tire burst time or/and risk time for safety of anti-collision, brake control logic combination of A⊂C or C⊂A is adopted. Along with deterioration of tire burst state of the vehicle, or when the front vehicle and rear vehicles for tire burst enter the forbidden time zone for anti-collision, the brake control of tire burst wheel will be changed from steady state brake control to release of braking force of tire burst wheel. During logic cycle of period Hₕ of brake control, except the tire burst wheel, the differential braking force of steady-state brake C control of wheels are increased. By means of the coordination control between the actual value of each control variable Q_{da} [symbol] \dot{ω}_{da} or S_{da} and the characteristic parameter value γ for vehicle tire burst, the target control value of Q_{da} [symbol] \dot{ω}_{da} or S_{da} is reduced, until the value of control variable Q_{d}′ [symbol] \dot{ω}_{d}′ or S_{d}′ of the vehicle pedal braking is less than the target control value of control variable Q_{d} [symbol] \dot{ω}_{d} or S_{d} of the tire burst active brake, to realize a compatible self-adaption control of artificial pedal brake and active brake of tire burst.

35. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, a tire burst brake control is adopted.
(1). According to state process of tire burst vehicle, the control and control mode conversion of vehicle braking control includes several levels and types, and conversion type of control and control mode of a program or an agreement is adopted. Among them, program conversion: the electronic control unit (ECU) set by tire burst controller call subroutine of control mode and model conversion in ECU, to carry out control and control mode conversion that mainly include brake related control parameters, control type or/and its logical combination in cycle of control period.
(2). One or more of wheel braking control parameters of tire burst vehicle, which mainly include angle deceleration \dot{ω}ᵢ, Slip ratio Sᵢ, braking force Qᵢ of wheel, vehicle deceleration \dot{u}_{xd}, are used as control variables. According to state process characteristics of tire burst vehicle, brake control characteristics that include response characteristics to control signal of brake actuator, a control mode or type of tire burst braking are set. The control mode or type mainly includes wheel steady-state braking A control, vehicle steady-state brake C control, wheels balanced braking B control and total braking force D control. The one or several of control mode or type of brake A, B, C and D control is adopted.
i. The steady-state brake A control of tire burst wheel adopts two modes: brake force of tire burst wheel is released or brake force of tire burst wheel is gradually decreased to 0.
ii. Wheel balance brake B control: Under condition in which one of parameter is distributed by the two wheel of wheelset. In theory, the sum of force moment to vehicle centroid, which is formed by tire force of two wheel of wheelset, is 0.
iii. Vehicle steady-state braking C control. Based on the state process of tire burst vehicle, the unbalanced braking torque of differential braking of wheelset is used, to generate an additional yaw moment Mᵤ to the whole vehicle. The Mᵤ can balance tire burst yaw moment Mᵤ′. The deviation between target control value and actual value of additional yaw moment Mᵤ are determined. In distribution of additional yaw moment Mᵤ generated by differential braking force of wheels for brake C control, a mathematical model of is established by modeling parameters that include transfer amount of load of each wheel, the longitudinal slip rate of wheels, or/and steering angle of directive wheel, or/and the side slip angle of directive wheel. Based on this model, a distribution of additional yaw moment Mᵤ of differential braking force of wheels is determined. The understeer or oversteer of the tire burst vehicle is controlled by distribution of additional yaw moment Mᵤ to wheels. The stable driving state of the vehicle is restored by control cycle of distribution to differential braking force of wheels.
iv. Brake D control. The brake D control is used to control of movement state determined by vehicle speed uₓ and deceleration \dot{u}ₓ of tire burst vehicle. The braking D control uses one of control variables of deceleration \dot{u}ₓ of vehicle, comprehensive angle deceleration \dot{ω}_{d}, comprehensive slip rate S_{d} and comprehensive braking force Q_{d} of wheels. The brake D control adopts control modes of forward direction or reverse direction on transferring direction of control variable; it includes control logic of (E)←D←\dot{u}ₓ or \dot{u}ₓ←D←(E). In formula, the (E) indicates control logic combination of brake A, B, C control.
(3) The logic combination rules of braking control mode or type are set. The logical combination of braking control mode or type mainly includes the logical combinations of braking control mode or type and logic rules or logic symbols.
(4) Based on dynamic models, equations or/and algorithms of vehicle or/and wheel under normal and tire burst conditions, the additional yaw moment Mᵤ to restoring stability control of tire burst vehicle is determined by theoretical model with modeling parameters that include steering mechanics and motion of vehicle, motion of vehicle, or/and wheel motion state parameters. Or the additional yaw moment Mᵤ is determined by test in field or empirical modeling.
(5). Determining braking control period Hₕ of cycle, the Hₕ is a set value or dynamic value, and its dynamic value is determined by the mathematical model with related parameters of wheel.
(6). The stable deceleration control of tire burst wheel and vehicle can be realized by using logic cycle of control periodic Hₕ of brake control mode or type that includes wheel steady-state braking A control, vehicle steady-state C control, wheels balanced braking B control, total braking force D control, so as to meet the requirements of various kinds control to drastic change of tire burst state of wheel and vehicle.
(7) According to the structure or/and process, brake control mode, model or/and algorithm of tire burst brake control subsystem, the program or software of tire burst brake control is compiled, which mainly includes program module of brake A, B, C, D control type or/and their combination of control related parameters, program module of brake data processing, program module of compatible control of tire burst active brake with pedal brake, or/and program module of braking and collision avoidance. The program or software is written into the ECU for tire burst braking control.

36. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under the condition of which tire burst judgment is established, an control mode that can limit angle speed δ_{bi} or/and rotation angle δ_{bi} of steering wheel are adopted, to balance and reduce attack of tire burst rotation force to steering wheel and vehicle.
(1). A conversion of control and control mode of program type or protocol type is adopted, to realize control and control mode conversion of related parameters that mainly include conversion of control and control mode of tire burst and no tire burst of related parameters, angle velocity S_{bi} or/and steering angle δ_{bi} or steering control types of steering wheel for tire burst vehicle in the cycles of control period Hₙ.
(2). Steering characteristic function Yₖₐᵢ. A mathematical model of steering characteristic function Yₖₐᵢ is established by modeling parameters including vehicle speed uᵢₓ, ground comprehensive friction coefficient μₖ, vehicle weight N_{z}, steering wheel angle δₐᵢ and its derivative \dot{δ}ₐᵢ:
Yₖₐᵢ=f(δₐᵢ,uₓᵢ,μₖ) or Yₖₐᵢ=f(δₐᵢ,uₓᵢ,μₖ,N_{z})
The modeling structure of Yₖₐᵢ is as follows: the Yₖₐᵢ is an incremental function with increasing of μₖ, the Yₖₐᵢ is an incremental function with decreasing of uᵢₓ, and the Yₖₐᵢ is an incremental function with increasing of steering angle δₐᵢ steering wheel. According to series value uₓᵢ [uₓₙ . . . uₓ₃ [symbol] uₓ₂ [symbol] uₓ₁] of decreasing of vehicle speed uₓᵢ, the set Yₖₐᵢ [Yₖₐₙ . . . Yₖₐ₃ [symbol] Yₖₐ₂ [symbol] Fₖₐ₁] of target control values for corresponding steering angle δₐᵢ of steering wheel are determined by mathematical model at certain uₓᵢ, μₖ, N_{z}. The values in the set Yₖₐᵢ are a limit values or target control value or optimal values which can be reached by rotation δₐᵢ of steering wheel at a certain speed uᵢₓ, ground comprehensive friction coefficient μₖ and vehicle weight N_{z}. The deviation e_{yai}(t) between the target control value Yₖₐᵢ of rotation angle of steering wheel and the actual value of rotation angle δ_{yai} of steering wheel is defined under certain states of parameters uᵢₓ, μₖ and N_{z}. A mathematical model of steering assistant or resistance moment Mₐ₁ is established by modeling parameter of deviation e_{yai}(t):
Mₐ₁=f(e_{yai}(t))
In logical cycle of control period Hₙ of rotary moment for steering wheel, the direction of which absolutes value of steering wheel rotation angle δ is reduced is determined by positive (+) and negative (−) of deviation e_{yai}(t), and steering assistant or resistance moment Mₐ₁ is determined by mathematical model with modeling parameters deviation e_{yai}(t). Based on control value of steering power assistant or power resistance moment Mₐ₁, a rotation moment of steering system is provided by steering assist motor, to limit the increase of steering wheel angle δ. The target control value Yₖₐᵢ of rotation steering angle of steering wheel is tracked by its actual angle δ, until e_{yai}(t) is 0. The rotation angle δ of steering wheel is limited, to restrict impact of tire burst rotation force to steering wheel.
(3). A mathematical model of the steering characteristic function Y_{kbi} is established by modeling parameters which include vehicle speed uᵢₓ, ground comprehensive friction coefficient μₖ, steering wheel load or vehicle weight N_{z}, steering angle δ_{bi} of steering wheel and its derivative δ_{bi}:
Y_{kbi}=f(δ_{bi},\dot{δ}_{bi},uₓᵢ,μₖ) or Y_{kbi}=f(δ_{bi},\dot{δ}_{bi},uₓᵢ,uₖ,N_{z},)
The value determined by Y_{kbi} is target control value or ideal value of rotation angle velocity δ_{bi} of steering wheel. The model structure of Y_{kbi} is as follows: Y_{kbi} is incremental function with increasing of friction coefficient μₖ, and Y_{kbi} is incremental function with decreasing of speed uₓᵢ, and Y_{kbi} is incremental function with increasing of angle δ_{bi} of steering wheel. Based on series value uₓᵢ[uₓₙ . . . uₓ₃ [symbol] uₓ₂ [symbol] uₓ₁] of decreasing of vehicle speed uᵢₓ, the set Y_{kbi}[Y_{kbn} . . . Y_{kb3} [symbol] Y_{kb2} [symbol] Y_{kb1}] of target control values of rotation angle velocity δ_{bi} of steering wheel are determined at certain uₓᵢ, μₖ, N_{z}. The values in the set Y_{kb1} are limit values or optimal or values which can be reached by \dot{δ}_{bi} of steering wheel at certain uₓᵢ, μₖ, N_{z}. The deviation e_{ybi}(t) between series absolute value of target control value Y_{kbi} of rotation angle velocity \dot{δ}_{ybi} for steering wheel and the series actual value of steering wheel rotation angle velocity \dot{δ}_{ybi}′ of vehicle is defined under certain states of parameters uₓᵢ, μₖ, N_{z} and δ_{bi}. A mathematical model of steering assistant moment Mₐ₂ of steering wheel is established by modeling parameter of deviation e_{ybi}(t) in the logical cycle of control period Hₙ of rotation moment for steering wheel:
Mₐ₂=f(e_{ybi}(t))
Based on the positive (+) and negative (−) and size of absolute value of deviation e_{ybi}(t), the steering power assistant moment or power resistance moment to steering wheel is provided by steering assistant device, according to the direction of which absolutes value of rotation angle velocity for steering wheel is decreased. The rotation angle velocity of steering wheel is adjusted, to make the deviation e_{ybi}(t) to 0. The rotation angle velocity deviation e_{ybi}(t) of steering wheel keeps tracking to its target control value, to limit the impact of tire burst rotary force to steering wheel.

37. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. In control of steering rotation torque for tire burst, a steering assistance control supplied by power for tire burs is adopted.
(1). A conversion of control and control mode of program type protocol type is adopted, to implement the control and control mode conversion of related parameters which mainly include angle and/or torque, or/and steering control types of tire burst vehicle, in the cycles of control period Hₙ of tire burst steering power control of steering wheel.
(2). Setting direction determination coordinates of steering of vehicle, judgment rules, judgment procedures and judgment logic, a direction determination mode of parameter of steering angle and torque is adopted, to determine direction of relevant parameters that include angle or/and torque of steering wheel, rotation torque for tire burst and steering assistance moment for tire burst of vehicle steering system.
(3). Control of power steering assisted for tire burst
Under tire burst conditions, a control mode, model or/and characteristic function of power assisted steering are established by modeling parameters that include steering wheel rotation moment M_{c} taken as control variable, and rotation angle δ of steering wheel and vehicle speed uₓ taken as parameter:
Mₐ₁=f(M_{c},uₓ)
Based on the control mode, model or/and characteristic function, an assistance steering moment Mₐ₁ supplied by power is determined under normal conditions. The modeling structure and characteristics of steering assistance torque Mₐ₁ are as follows: in the forward travel and reverse travel of steering wheel rotation angle, the characteristic function or/and curve are the same or different, and the Mₐ₁ is a decreasing function with increment of speed uₓ. The Mₐ₁ is increasing function with increment of absolute value of rotation moment M_{c} of steering wheel. After direction judgment of tire burst rotation moment M_{b}′ is determined, a mechanical model of determining target control value of tire burst rotation moment M_{b}′ is used. The M_{b}′ is balanced by a balancing moment M_{b}. The M_{b} is equal to additional balance assistance moment Mₐ₂. The M_{b}′ is equal to negative (−) M_{b}. Under condition of tire burst, the target control value of rotation torque Mₐ of steering wheel is vectors sum of value Mₐ₁ detected by rotation moment sensor of steering wheel and additional balance assistance moment Mₐ₂ for tire burst. Under conditions of which direction judgment of related parameters of steering angle and rotation torque are determined, the rotation moment control of steering wheel can be realized by exerting steering assistance torque Mₐ to steering system of vehicle, in logic cycle of control period Hₙ of power-assisted steering control for tire burst.

38. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. In control of steering rotation torque for tire burst vehicle, a control mode of rotation torque control of steering wheel for tire burst is adopted.
(1). A conversion of control and control mode of program or protocol is adopted, to implement the control and control mode conversion of related parameters which mainly include angle and torque, or/and control types of steering of tire burst vehicle, in the cycles of control period Hₙ of tire burst steering power assisting control of steering wheel.
(2). Direction determination of relevant parameters for tire burst, which referred to as tire burst direction determination. A coordinate system of direction determination of relevant parameters that include angle and torque for tire burst is set. The tire burst direction determination uses a judgment mode of rotation torque or/and rotation angle, to determine direction of steering assistance torque Mₐ and operation or movement move direction of electric device of steering system directly. The deviation ΔM_{c} between target control value M_{c1} of rotation torque of steering wheel and detection value of rotation torque M_{c2} measured by sensor of steering wheel is defined in real time:
ΔM_{c}=M_{c1}−M_{c2};
The direction of steering assistance torque Mₐ, the direction of power parameters of electric device are determined by positive (+) and negative (−) of deviation ΔM_{c}, which includes direction of motor current iₘ and rotation direction of booster motor.
(3) Rotation moment control of steering wheel. A control model or/and characteristic function of rotation torque of steering wheel under normal working conditions are determined by modeling parameters that include rotation angle δ of steering wheel, vehicle speed uₓ or/and angle velocity \dot{δ}:
M_{c}=f(δ,uₓ) or M_{c}=f(δ,\dot{δ},uₓ)
The values determined by control model or characteristic function is target control value of rotation torque of steering wheel. The modeling structure of control model or characteristics function is the following. In the forward and reverse travel of steering wheel rotation angle, the characteristic function are the same or different. The characteristic function of steering wheel rotation moment M_{c} is a decreasing function with increment of vehicle speed uₓ. The characteristic function is an increasing function with the increment of absolute value of steering wheel rotation angle δ and rotation angle speed \dot{δ}. The model or characteristic function includes return force type of steering vehicle or/and directive steering. A function model of rotation torque of steering wheel is established by modeling parameters that include vehicle speed uₓ, rotation angle δ of steering wheel or/and rotational angle velocity \dot{δ}, to determine target control value M_{c1} of steering wheel rotation moment M_{c}. The change rate of the M_{c} is basically consistent to change rate of return force moment Mⱼ of steering wheel or/and directive wheel. Actual value M_{c2} of rotation torque of steering wheel is determined by real-time detection value of torque sensor. The deviation ΔM_{c} between target control value M_{c1} of rotation torque of steering wheel and real-time detection value M_{c2} of torque sensor is defined. Based on deviation ΔM_{c}, a model of power assistance or resistance moment Mₐ of steering wheel under normal and tire burst conditions is established:
Mₐ=f(ΔM_{c})
Under condition of which the direction of assistance or resistance moment Mₐ is determined, the assistance or resistance moment Mₐ of steering wheel under tire burst conditions is determined. In every cycles for period Hₙ of torque control of steering wheel for tire burst vehicle, and under action of steering power assistance or resistance Mₐ of power steering device, it can balance or compensate to impact of tire burst rotation moment. Under tire burst conditions, the steering wheels is exerted by stable or optimal rotation torque that is basically the same as return torque of directive wheel exerted by ground under normal conditions. The driver can obtain fine feel to operation of steering wheel, and can obtain fine road feel at any angle of the steering wheel.

39. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. In tire burst condition, the method adopts an additional angle control of active steering of vehicle.
(1). In the cycles of control period Hₙ of rotation angle control of steering wheel or/and directive wheels for tire burst vehicle, a conversion of control and control mode of program type or protocol type is adopted, to implement control and control mode conversion of related parameters which mainly include angle or/and steering control of tire burst vehicle.
(2). Direction determination of related parameters of active steering of vehicle driven by man for tire burst. According to coordinate system, judging rules, procedures and judging logic of tire burst direction, the insufficient steering and excessive steering of tire burst vehicle are determined by positive (+) and negative (−) of direction of steering wheel rotation angle δ and yaw angle velocity deviation e_{ω}_{ᵣ}(t) of vehicle. On the basis of direction judging of steering wheel angle δ, insufficient or excessive steering of vehicles or/and position of tire burst wheel, the direction of additional rotation angle θ_{eb} (+, −) of directive wheel is determined by tire burst steering system of vehicle.
(3). Active steering control for tire burst. On the basis of direction judging of relevant parameters, a balancing additional angle θ_{eb} that is independent to the driver's operation applied to actuator of active steering system (AFS) can be compensate to insufficiency or excessive steering of vehicle for tire burst. The actual angle θₑ of directive wheel of vehicle is vector sum of both of directive wheel steering angle θₑₐ determined by driver's operation and additional balancing rotation θ_{eb} for tire burst. The direction of additional balancing angle θ_{eb} for tire burst is opposite to the direction of steering angle θ_{eb}′ of wheel for of tire burst. In linear superposition of angle θ_{eb} and angle θ_{eb}′, the vector sum of angle θ_{eb} and angle θ_{eb}′ is 0. A control mode or/and model of additional balance angle θ_{eb} of directive wheel to tire burst are established by the modeling parameters which include yaw angle velocity ωᵣ of vehicle, sideslip angle β of vehicle to vehicle quality center, or/and lateral acceleration \dot{u}_{y}, adhesion coefficient φᵢ, or/and friction coefficient μᵢ, or/and slip Sᵢ of directive wheel. Or active steering control for tire burst adopts corresponding control algorithm of modern control theory, which include PID, sliding mode control, optimal control or fuzzy control, to determined additional balancing angle θ_{eb} for tire burst. Based on tire burst state parameters or/and stage determined by the state parameters, the target control value of additional steering angle θ_{eb} of directive wheel for tire burst is determined by using corresponding control mode or/and algorithm. Defining deviation e_{θ}(t) between of both of target control value θₑ₁ of directive wheel angle θₑ and its actual value θₑ₂, a control model of angle θₑ of directive wheel is established by modeling parameters that include deviation e_{θ}(t). The control adopted open-loop or closed-loop control. In the control cycle of period H_{y}, the active steering system AFS control a actuator that can superimpose movement of two vector of directive wheel angle θₑₐ and additional balanced angle θ_{eb} for tire burst. The actual value of rotation angle θₑ₂ of directive wheel is always tracked to its target control value θₑ₁. In the active steering control of tire burst, an independent control mode of rotation angle θₑ of directive wheel, or a coordinated control mode of rotation angle θₑ of directive wheel and electronic stability control program ESP of vehicle can be adopted by the active steering control for tire burst.

40. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Steering control of electronic servo power for tire burst is used.
(1). Direction determination of related parameters to active steering of driven by man vehicle for tire burst. According to coordinate system, judging rules, procedures and judging logic of tire burst direction determined by the system, direction judgement for tire burst mainly includes direction judgement of steering wheel angle and tire burst rotation moment, direction judgement of power assistance or resistance moment of steering.
(2). On the basis of direction determination of related parameters, the servo power steering control of active steering for tire burst uses one of the following steering control modes.
i. Control mode of servo power steering for tire burst vehicle. One of control model of steering assistance moment Mₐ or characteristic function in normal working condition are established by modeling parameters that include rotation moment M_{c} of steering wheel as control variable, speed uₓ and steering wheel angle δ as parameter, to determine steering assistance moment Mₐ₁, additional balancing moment Mₐ₂ for tire burst. The steering assistance moment Mₐ is sum of vectors Mₐ₁ and Mₐ₂. The tire burst rotation moment M_{b}′ can be balanced by additional balancing moment Mₐ₂. The target control value of steering assistance moment or resistance moment Mₐ of vehicle is determined.
ii. Control mode of steering assistance moment of steering wheel for tire burst. The control model and characteristic function under normal working condition are established by modeling parameters that include rotation angle δ of steering wheel, vehicle speed uₓ and rotation angle velocity \dot{δ} of steering wheel, to determine target control value of torque steering M_{c1} of steering wheel. The deviation ΔM_{c} between target control value M_{c1} of steering wheel rotation torque and real-time torque value M_{c2} measured by torque sensor of steering wheel is determined. Based on the function model with deviation the ΔM_{c}, the steering assistance or resistance moment Mₐ of steering wheel is determined under tire burst conditions is determined. In the logic cycle of steering control period H_{y} of vehicle, the assisting or resistance moment to steering wheel can be adjusted actively by electronic servo steering controller and power device at any steering position of steering wheel, therefrom, to realize power steering control of tire burst vehicle in real-time.

41. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. An active steering control of drive-by-wire of manned vehicle uses redundancy design. Combinations of drive-by-wire system for each steering wheel is set up. One of combination includes drive-by-wire steering of front-wheel and mechanical steering of rear-wheel, drive-by-wire steering of front axle and rear axle, drive-by-wire steering of four-wheel. Under tire burst working condition, a bus of drive-by-wire steering is used. The drive-by-wire active steering control is a kind control by connection of high-speed fault-tolerant bus and management of high-performance CPU control.
(1). Absolute or/and relative coordinate system for direction judgment of angle or/and torque can be set up. Direction of relevant rotation angle and torque is calibrated in the coordinate system. A mathematical logic of direction judgment of relevant angle or/and torque is established. On bases of the direction calibration and logic direction judgement, the parameter directions for vehicle steering can be determined. According to the different setting of angle or torque parameters or/and the different setting of detecting sensor, direction determination mode of relevant steering parameters for tire burst is determined.
(2). The tire burst active steering by drive-by-wire adopts control and control mode conversion of program type or coordination type, which mainly includes control and control mode conversion between tire burst and non tire burst of vehicle, control and control mode conversion of relevant angle and torque parameters in the cycle of periods Hₙ of control parameters or control type.
(3). Drive-by-wire steering control of vehicle driven by includes rotation angle θₑ control of directive wheel and road sense control of steering wheel. Under normal condition, rotation angle θₑₐ of directive wheel is determined by steering wheel angle δ. Under tire burst working condition, vehicle understeer or oversteer steering caused by tire burst is balanced or compensated by an directive wheel additional angle θ_{eb} that is not controlled by the driver within the critical speed range of vehicle. The steering wheel angle θₑ is vector sum of both of steering wheel angle θₑₐ and additional balance angle θ_{eb}. The steering control of directive wheel adopts the coupling or coordinating control mode of two parameter of rotary angle θₑ and rotary driving moment Mₕ of directive wheel to determine target control value of coordinated or coupled control of control variable the θₑ and the Mₕ. Based on dynamic equation of steering system, a dynamic model for tire burst control is established by modeling parameters that includes rotation angle θₑ of directive wheel, and rotation driving moment Mₕ transmitted by power device of steering system, or/and rotation moment Mₖ of directive wheel exerted by ground. Based on structure of steering system, the dynamic model of steering system which includes power device, steering mechanism with gear and rack and wheel is established. Or the model is transformed to transfer function by Laplace transform. According to modern control theory that includes algorithm of PID, or fuzzy, or neural network or optimal, a corresponding steering control is designed, to solve technical issues about response time and overshoot of steering vehicle under condition of which tire burst rotation angle, value of rotation driving torque and direction of vehicle changes sharply.
i. In control of turning to left and right of vehicle, according to the regulations of angle and torque direction of coordinate system, the zero point of absolute coordinate system of vehicle is the origin of rotation angle δ of steering wheel; the rotation direction of left steering and right steering of vehicle is determined. In the origin of left side and right side of vehicle steering control, that is, the zero position of rotation angle of steering wheel, the electronic control unit set steering controller makes a translation to direction of the electronic control parameters that include current or/and voltage, from this, to realize a converting of driving direction of electric device under condition of production of tire rotation moment M_{b}′. The translation or/and converting is adapt to coupling or coordinate control of both of rotation angle δ of steering wheel and driving torque rotational torque Mₕ of directive wheel under condition of which rotation torque for tire burst is produced. The running direction of the electric driving device includes the rotation direction of the motor or the driving direction of translation device.
ii. Rotation angle θₑ control of directive wheel for tire burst. In the coordinate system determined by this system, the steering angle of vehicle and wheel, yaw angle velocity of vehicle, insufficient or excessive steering of vehicles are vectors.
First. Angle θₑₐ of directive wheel is determined by rotation angle δₑ of steering wheel to normal working conditions. Under tire burst working conditions, an additional burst tire balanced angle θ_{eb} which is independent to driver's steering operation is applied to directive wheel of steering system by controller. Within critical speed range of vehicle steady-state control, the insufficiency or oversteering steering of tire burst vehicle is compensated by the θ_{eb}. The target angle θₑ of directive wheel is sum of vector of angle θₑₐ and the additional balance angle θ_{eb} of directive wheel.
Second. The transmission ratio Cₙ between steering wheel angle δₑ and directive wheel angle θₑ is a constant value or dynamic value. The dynamic value is determined by mathematical model with parameter including vehicle speed uₓ.
Third. A mathematical model of additional balance angle θ_{eb} for tire burst is established by modeling parameters including vehicle speed uₓ, rotation angle δ of steering wheel, yaw angle velocity deviation e_{ωr}(t) of vehicle, sideslip angle e_{β}(t) to mass center of vehicle, or/and ground friction coefficient and lateral acceleration \dot{u}_{y} of vehicle. The target control value of θ_{eb} is determined.
Fourth. Setting control period H_{y} of vehicle steering. The H_{y} is a set value, or the H_{y} is a dynamic value. Deviation e_{δ}(t) between the target control value of steering wheel angle δ₁ and its actual value δ₂ is determined. According to positive and negative of the deviation e_{δ}(t), the direction of driving torque of directive wheel under normal working conditions is determined.
(4). Rotary driving torque control of steering wheel for tire burst
The deviation e_{θ}(t) between the target control value of directive wheel angle θₑ₁ and its actual value θₑ₂ is determined. Based on dynamic equation of steering system, a control model of rotation driving moment Mₕ of directive wheel of manned vehicle is established by coordinated control variables θₑ and Mₕ, modeling parameters which include the rotation force Mₖ of directive wheel exerted by ground, deviation e_{δ}(t) of target control value of steering wheel rotation angle δ and its actual angle or/and rotation angle velocity \dot{δ}ₑ. On the basis of the control model, target control value of Mₕ is determined. According to the positive and negative of deviation e_{δ}(t) between the target control value δ₁ and its actual value δ₂ of steering wheel, direction of rotation driving moment Mₕ of directive wheel is determined. The rotation moment Mₖ of directive wheel exerted by ground includes the rotation moment M_{b}′ of tire burst. When tire burst of vehicle occurs, the value and direction of M_{b}′ change. Rotation angle θₑ of directive wheel is controlled by θₑ₁ and θₑ₂, and rotation driving moment Mₕ of directive wheel is adjusted in real time. Various modes are used to determine rotation driving moment Mₕ. The following one of modes of determining rotation driving moment Mₕ is adopted.
i. One of modes: rotation driving moment Mₕ is determined by rotation torque sensor set in the between directive wheel and the mechanical transmission device of steering system.
ii. Two of modes: The rotation moment Mₕ is determined by differential equation:
Mₕ−Mₖ=jᵤ\ddot{θ}ₑ−Bᵤ\dot{θ}ₑ
where jᵤ is equivalent moment of inertia, Bᵤ is equivalent resistance coefficient of the steering system. Defining deviation eₘ(t) of rotary driving moment between value Mₕ₂ detected by sensor and target control value Mₕ₁ of rotary driving moment of directive wheel, open-loop or closed-loop control is adopted during logical cycle of control period H_{y} of directive steering. The target control value Mₕ₁ of rotary driving moment of directive wheel is always tracked by actual value of driving force Mₕ₂ by feedback control of deviation eₘ(t) under the action of rotating driving moment Mₕ. The rotation angle θₑ control of directive wheel is a control that make the deviation e_{θ}(t) become 0. At any corner position of turning to left direction or right direction of vehicle, the coordinate of control of rotation driving torque Mₕ and rotation angle θₑ is realized by action of rotation moment Mₖ of steering wheel exerted by ground and steering drive torque Mₕ of steering system. The angle θₑ of directive wheel is controlled by an active or self-adaptive joint adjustment of rotation moment Mₖ of ground and rotation driving torque Mₕ.

42. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Control planning and decision-making of active steering for tire burst vehicle are adopted by driverless vehicle.
(1). Direction determination of relevant parameter of active steering for tire burst vehicle. The coordinate system, rule of direction judgement of relevant parameters that include steering angle, torque and judgement logic are established. The judgement of understeer and oversteer of vehicle are determined by positive (+) and negative (−) of yaw angle rate deviation e_{ωr}(t), or/and the position of tire burst wheel are determined, or/and direction of relevant parameter of active steering for tire burs are determined.
(2). Environmental perception and identification. Among them, vehicle distance detection mainly includes vehicle distance monitoring determined by machine vision or/and vehicle distance monitoring determined by information commutation way (VICW) of vehicles. Machine vision mainly uses optical or electronic camera and computer processing system. Environment identification mainly includes: environment identification of information commutation way (VICW) of vehicles or/and environment identification of road traffic vehicle network.
(3). Active Steering Control of Driverless vehicle
Central control of driverless vehicle. The central master controller includes sub-controllers of environment perception and identification, positioning and navigation, path planning, control decision to normal and tire burst working state; it mainly related to fields of tire burst vehicle stability control, tire burst collision prevention, path tracking, addressing to parking and path planning of parking. The central controller sets up various sensors for environmental identification and vehicle control, and set up machine vision, global satellite positioning, mobile communication, navigation, artificial intelligence controllers, or/and sets up controller of vehicle connection network of road traffic under normal and tire burst conditions. When entering signal iₐ of tire burst control arrives, the vehicle get into a control mode for tire burst. During state process and control period of tire burst vehicle, the steady state of wheels, stability and attitude control of vehicle, stable deceleration or acceleration control of whole vehicle in a entirety are planned by environment identification, positioning, navigation, path planning and control decision-making of vehicle, according to direction judgement of parameter for tire burst, tire burst control mode, model or/and algorithm of braking, driving, rotation force of steering wheel, active steering and suspension control. The central master controller plans coordination control of lane holding of tire-burst vehicle, anti-collision control of the vehicle to front and rear vehicles or/and obstacles. The central master controller makes a strategic decision to vehicle speed, running path and path tracking of vehicle, or/and makes a decision to parking location and path from the vehicle to parking site after vehicle tire-burst, to realize the parking control of tire burst vehicle.
(4). Path planning of tire burst vehicle
i. Information of road traffic that includes lanes and lane lines, road signs, road vehicles and obstacles are obtained by path planning sub-controller. The positioning and navigation of vehicle, the distance between the vehicle and the front, rear, left and right vehicles, lane lines, obstacles, relative speed of the front and rear vehicles are determined. The overall layout of positioning, environment status and driving planning between the vehicle and surrounding vehicles are made.
ii. Based on the environment perception, positioning, navigation and stability control of vehicle, the sub controller adopts a control mode or/and algorithm of wheel, steering of vehicle and vehicle under normal and tire burst conditions, to determine parameters that include vehicle speed uₓ, rotation steering angle θₗᵣ of vehicle, rotation angle θₑ of steering wheel. The control modes or/and algorithm can be established by modeling parameters that include distance Lₛ between the vehicle and the left, right lane, distance L_{g} between the vehicle and right, left vehicle, distance Lₜ of the vehicle and front and rear vehicle, positioning angle θ_{w} of lane or lane line in coordinates, turning half diameter Rₛ of lane or vehicle track or curvature, steering wheel slip rate Sᵢ, ground friction coefficient μᵢ, from these, to formulate position coordinates and change diagram of vehicle, to plan vehicle driving diagram, to determine vehicle driving path, and to complete driving path and lane planning of the vehicle according to the driving diagram and driving path.

43. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Steering control of driverless vehicle for tire burst.
(1). The main control computer calls or mobilizes the control mode conversion subroutine to automatically realize the conversions of control and control mode, which includes the conversions of control and control mode between tire burst and non tire burst control mode, and control and control mode conversion of relevant angle and torque parameters in the cycle of periods Hₙ of control parameters or control type.
(2). Direction determination of relevant parameter of active steering for tire burst vehicle. One or combination of following decision modes is used. The coordinate system, rule of direction judgement of parameters and judgement logic are determined to determine direction of relevant parameters that include steering angle and torque of wheel and vehicle. Understeer and oversteer of vehicle are determined by positive (+) and negative (−) of yaw angle rate deviation e_{ωr}(t); or/and position of tire burst wheel are determined.
(3). Steering control of driverless vehicle.
The vehicle speed uₓ, rotation steering angle θₗᵣ of vehicle, rotation angle θₑ of directive wheel are determined by coordinated control mode of steady-state control of steering, braking, driving, anti-collision vehicle for tire burst.
i. The coordinated control of lane keeping and path tracking of vehicle, attitude and collision avoidance of the vehicle can be carried out under normal and tire burst conditions. Ideal steering angle θₗᵣ of vehicle and steering angle θₑ of directive wheel are determined by the mathematical model or/and algorithm of the above parameters that include uₓ, θₗᵣ, θₑ. The modeling structure of the model mainly includes: the θₗᵣ and θₑ are decreasing function with increment of the Rₛ and uₓ. The θₗᵣ and θₑ are an increasing function with increment of wheel slip ratio. The coordinate position of lane line, surrounding vehicles, obstacles and the vehicle are determine by parameters that include L_{g} [symbol] Lₜ [symbol] θ_{w} [symbol] Rₛ [symbol] uₓ. The direction and size of the ideal control value of steering wheel angle θₑ and vehicle rotation steering angle θₗᵣ of vehicle are determined by parameters that include L_{g} [symbol] Lₜ [symbol] θ_{w} [symbol] Rₛ [symbol] uₓ. In the parameters, the L_{g} is distance from the vehicle to left vehicles or/and right vehicles, Lₛ is distance from the vehicle to obstacle or/and vehicle Lane, the Lₜ is distance from the vehicle to front vehicle or rear vehicle or/and obstacle, the θ_{w} is the orientation angle of the lane that includes the lane line in coordinates, the Rₛ is turning radius of gyration or curvature of running path of lane or vehicle, the Sᵢ is slip ratio of directive wheel and the μᵢ is ground friction coefficient of tire-burst vehicle.
ii. Defining three types of deviations of vehicles and wheels.
Deviation 1: the deviation e_{θT}(t) between ideal steering angle θₗᵣ of the vehicle to path planning and path tracking determined by the central controller and actual steering angle θₑ′ of directive wheel is defined. The actual steering angle θₑ′ of directive wheel contains the steering angle caused by tire burst rotating moment M_{b}′ under the condition of tire burst. Deviation 2: the deviation e_{θlr}(t) between ideal steering angle θₗᵣ of vehicle and actual steering angle θₗᵣ′ of vehicle is defined. Deviation 3: deviation e_{θ}(t) between ideal rotation angle θₑ of directive wheel and actual rotation angle θₑ′ of directive wheel is defined.
e_{θT}(t)=θₗₑ−θₑ′ [symbol] e_{θlr}(t)=θₗᵣ−θₗᵣ′ [symbol] e_{θ}(f)=θₑ−θₑ′
iii. A mathematical model of steering vehicle is established by modeling parameters that include θₗᵣ, θₑ, θₗᵣ′ their deviation e_{θT}(t), e_{θlr}(t) and e_{θ}(t), to determine target control values of steering of vehicle and wheels in real-time. The deviation e_{θT}(t) between ideal steering angle θₗᵣ of vehicle and actual steering angle θₑ′ of wheel can determine sideslip angle and sideslip state of directive wheel. Cycle of control period H_{θn} of rotation angle of directive wheel is set up. The period H_{θn} is a value set, or it is a dynamic value that may be determined by modeling parameters that includes vehicle speed uₓ, rotation angle θₑ of directive wheel, or/and angle deviation e_{θlr}(t) or e_{θ}(t) of vehicle. The θₑ and the θₗᵣ are main control parameters for lane planning, Lane maintenance and path tracking of driverless vehicles.

44. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. The steering control of driverless vehicle for tire burst mainly includes: anti-collision of tire burst vehicle, parking path planning, path tracking and safe parking control.
(1). Anti-collision control of driverless vehicle for tire burst
Based on coordinated control mode of anti-collision, braking, driving and stability of tire burst vehicle, the position of the vehicle, coordinates position from the vehicle to the front, rear, left, right vehicles and obstacles are determined by machine vision, ranging, communication, navigation and positioning in real time. The distance and relative speed between the vehicle and the front, rear, left, right vehicles and obstacles are calculated, according to control time zone of multiple levels which include safety, danger, no entry and collision. The collision-avoidance of vehicle, steady-state control of wheel and vehicle and deceleration or accelerate control of the tire burst vehicle are realized by independence or/and combination control of brake or driving A, B, C, D in logic cycle of period Hₕ, the conversion of control mode of braking and driving, coordination control of active steering and active braking. The collision-avoidance control of tire burst vehicle includes collision-avoidance control between the vehicle and front, rear, left right vehicles, and around obstacles. According to the route planned, path tracking of the tire burst vehicle is carried, to arrive safe parking position of the vehicle.
(2). Path planning, path tracking and safe parking of tire burst vehicle
i. Networked controller of Internet network of automotive vehicle is set up. Through global satellite positioning system and mobile communication system, the wireless digital transmission module set by networked controller of vehicle can send signals that include position, tire burst status, running and control status of the vehicle to coupling network of the passing vehicles of periphery region. The wireless digital transmission module of the tire burst vehicle can obtain the query information required by the tire burst vehicle, which includes addressing of parking position of the tire burst vehicle and planning path to the parking position by coupling network of the vehicle.
ii. A view processing analyzer of artificial intelligence is set up. During running process of vehicle, the processor and analyzer set by the controller classifies and processes to camera screenshots of surrounding road traffic and environment by category, and temporarily stores the typical images, or/and replace screenshots according to a certain period or/and level, and determine the stored typical images. The typical images stored in the main control computer include emergency parking lane, exiting of ramp and parking space of beside road of highway. The typical features and abstract features of image can be obtained. In tire burst control of the vehicle, the tire burst controller set in the networked vehicle uses mode of recognition of machine vision or/and search by networking, and processes and analyzes the images of road and surrounding environment taken by the machine vision in real-time. According to the image features and abstract features, the road image and its surrounding environment image taken from machine vision is compared with the typical classification image of parking location stored in the main control computer. The safely parking position of emergency parking lane, ramp exiting or beside road of highway is determined by analysis and judgment of computer. The tire burst vehicle can be driven to the planned parking position, according to the parking line planned.

45. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst condition, driverless vehicle uses drive-by-wire active steering control.
(1). The main control computer calls or mobilizes the control mode conversion subroutine to automatically realize the conversions of control and control mode, which includes the conversions of control and control mode between tire burst and non tire burst control mode, and control and control mode conversion of relevant angle and torque parameters of vehicle steering for tire burst in the cycle of periods Hₙ of control parameters or control type
(2). Active steering control by drive-by-wire adopts direction judgment of angle and torque of related parameter. According to control and control mode conversion of the program type, it can be realized to control and control mode conversion that include control and control mode conversion between tire burst and non-tire burst, control and control mode conversion of relevant angle and torque control parameters in cycle of control period Hₙ of active steering control, or/and the control and control mode conversion of active steering control mode or type.
(3). The active steering control is a kind control by connection of high-speed fault-tolerant bus and management of high-performance CPU control. The control adopts redundancy design. The control is sets up as a combination system of drive-by-wire steering of directive wheels of vehicle. The combination system includes various control modes and structures that are steering of front axle and rear axle or steering of four-wheel by drive-by-wire independently. The combination system sets central control computer, dual or triple steering control unit, dual or multiple software, two or three groups of electronic control unit, active steering units and power device provided by independent structure and combination structure. A steering control of vehicle is based on dynamic system constituted by steering motor, steering device and of steering wheel and acting force of wheels applied by the ground. Controller of directive wheel and sub-controller for drive-by-wire failure are set up. The driver-by-wire bus of steering vehicle is used by the controller. The information and data exchange of vehicle-mounted systems are realized by the vehicle-mounted data bus.
(4). Tire burst active steering control
Tire burst steering control is mainly uses parameters that include vehicle speed uₓ, steering angle θₗᵣ of vehicle, rotation angle θₑ of directive wheel, rotation driving torque Mₕ of directive wheel. Based on control parameters uₓ, Rₛ and θₗᵣ determined by path following control of vehicle, a coordinated or coupled control model or/and algorithm of rotation angle θₑ of directive wheel and rotation driving torque Mₕ of directive wheel are established, to determine target control value of coordinated or coupled control of control variable the θₑ and the Mₕ. The ideal or target control value of steering angle θₗᵣ of vehicle and rotation angle θₑ of directive wheel are determined under working condition to tire burst, where, the Rₛ is rotation steering radius of vehicle or/and vehicle lane, the Rₛ may be replaced by curvature of vehicle lane or vehicle lane line. Defining three types of deviations of vehicles and wheels: deviation e_{θT}(t) between ideal steering angle θₗᵣ of vehicle and actual steering angle θₑ of the wheel to path planning and path tracking; deviation e_{θlr}(t) between ideal steering angle θₗᵣ of vehicle and actual steering angle θₑ′ of vehicle, deviation e_{θ}(t) between ideal rotation angle θₑ of directive wheel and actual rotation angle θₑ′ of directive wheel. A dynamic control cycle H_{θn} is set. The H_{θn} is determined by equivalent model or/and algorithm with parameters that include speed uₓ, rotation angle θₑ of directive wheel, or/and steering angle deviation e_{θlr}(t) of vehicle. A control model of steering angle θₑ of directive wheel under the condition to tire burst is established by including deviation e_{θT}(t), e_{θlr}(t). The ideal or target control value of θₑ is determined. Based on deviation e_{θT-1}(t), e_{θlr-1}(t) and θₑ in cycle of previous period H_{θn-1}, and according to the control model of θₑ, the ideal or target control value of steering angle θₑ of directive wheel in this period H_{θn} of control cycle is determined. Closed loop control of steering angle θₑ of directive wheel is adopted. In each control H_{θn} of control cycle, the actual value of steering wheel angle 9f always tracks target control value of the θₑ.
(5). Rotation driving torque control of directive wheel for tire burst
i. In control process of turning to left and turning to right of vehicle, the zero point of absolute coordinate system of vehicle is origin of rotation angle δ of steering wheel according to the regulations of angle direction and torque direction of coordinate system, from this, the rotation direction of left steering and right steering of vehicle is determined. In the origin of left side and right side of steering control of vehicle, that is, the zero position of rotation angle of directive wheel, the electronic control unit set by steering controller makes a translation to direction of electronic control parameters, from this, to realize one converting of driving direction of electric device under condition of production of tire rotation moment M_{b}′. The translation or/and converting adapt to coupling or coordinate control of rotation angle δ of steering wheel and driving torque rotational torque Mₕ of directive wheel under condition of which rotation torque for tire burst is produced. The electric control parameters include current or/and voltage; the electric drive device includes motor or the driving translation device.
ii. When tire burst occurs, the deviation of rotation angle θₑ of directive wheel for tire burst is produced at any steering angle position of rotation angle θₑ of directive wheel. The active steering controller of drive-by-wire determines change of direction of tire burst rotation moment M_{b}′ and rotation moment Mₖ of directive wheel exerted by ground, change of control direction of rotation angle θₑ and driving moment Mₕ of directive wheel. At the moment of which tire burst rotational torque M_{b}′ occurs, the torque sensor installed between driving axle of steering system and the directive wheel detects actual rotation driving moment Mₕ₂ of directive wheel in real time. The deviation e_{θ}(t) between target control value of directive wheel angle θₑ₁ and its actual value θₑ₂ is determined. Based on dynamic equation of steering system, a coupling control model of rotation driving moment Mₕ of directive wheel of driverless vehicle is established by control coordinating of variables θₑ, Mₕ and modeling parameters that include the rotation force Mₖ of directive wheel exerted by ground, deviation e_{δ}(t) of target control value of steering wheel rotation angle δ and its actual angle value, or/and rotation angle velocity \dot{δ}ₑ. On the basis of control model, target control value of the Mₕ is determined. According to the positive and negative of deviation e_{θ}(t) between the target control value θₑ₁ and its actual value θₑ₂ of directive wheel, direction of rotation driving moment Mₕ of directive wheel is determined. The rotation moment Mₖ of directive wheel exerted by ground includes the rotation moment M_{b}′ to tire burst. When tire burst of vehicle occurs, the size and direction of M_{b}′ change. Defining deviation eₘ(t) of rotary driving moment between detected value Mₕ₂ of the sensor and target control value Mₕ₁ of rotary driving moment of directive wheel, open-loop or closed-loop control is adopted during cycle of steering control period H_{y}. The target control value of rotary driving moment Mₕ₁ of directive wheel is always tracked by actual value of driving force Mₕ₂ by feedback control of deviation eₘ(t) under the action of rotating driving moment Mₕ. At any angle of the left turn or right turn of vehicle, and under action of rotation moment Mₖ of directive wheel exerted by ground and rotation driving torque Mₕ of the directive wheel, the rotation angle θₑ of directive wheel is adjusted by active and coordinated control of rotation driving torque Mₕ of the directive wheel, to make actual value θₑ₂ of θₑ always tracks its target control value θₑ₁.

46. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following.
(1). Under tire burst working condition, controller calls subroutine of control and control mode conversion of program type or coordinated type, to realize conversion of control and control mode between braking and drive of vehicle is adopted in the cycle of control period.
(2). A characteristic function Wᵢ (Wₐᵢ [symbol] W_{bi}) which shows driver's willingness of acceleration and deceleration control of vehicle is introduced. According to the division of forward travel and backward travel of first travel, second travel, multiple travel of the driving pedal, a self-adaptive control model, control logic and conversion of control mode are established. A model include logic threshold model is used. Threshold value and control logic are set. When tire burst control entry signal iₐ arrives, no matter where is the position of the drive pedal, the power output of engine or drive device of electric vehicle will be terminated immediately when drive control of vehicle is in one travel of the driving pedal. In the positive travel of two or more times of driving pedal, and when value of characteristic function Wᵢ reaches threshold value cₕₐᵢ, the brake control for tire burst will exit and enter a conditional driving control according to threshold model and its control logic. In the return travel of the driving pedal for two or more trips, and when value of characteristic function Wᵢ reaches threshold value c_{hbi}, the drive control of vehicle exits and the tire burst brake control of vehicle returns actively.
(3). Entering or exiting of tire burst driving control is determined by characteristic function Wᵢ of driver's control intention. Based on the division of first, second or multiple travel of driving pedal and the direction division of positive (+) or negative (−) travel of driving pedal, a asymmetric function model in forward travel and reverse travel of vehicle drive pedal is established by parameter including travel parameter hᵢ of drive pedal. The model includes logic threshold model. The so-called asymmetric functions with parameters hᵢ and \dot{h}_{ι} is expressed by the following. In positive (+) travel and reverse negative (−) travel of characteristic function Wᵢ, structure of characteristic function Wᵢ is not completely different; it includes function value Wₐ of Wᵢ in positive travel of characteristic function Wᵢ is less than the function value W_{b} of Wᵢ in reverse or negative (−) travel when travel parameter hᵢ of drive pedal is in the same point set by characteristic function Wᵢ on positive travel and negative travel of driving pedal. Where, value of the characteristic function Wᵢ is absolute value. The positive (+) and negative (−) of travel hᵢ of driving pedal can indicate driver's willingness to accelerate or decelerate of the vehicle. Under operation of driving pedal, a self-adaptive logic threshold mode of exiting and entry of tire burst braking control is established. A decreasing set cₕₐᵢ and c_{hbi} of the logic threshold of each positive (+) travel and negative (−) travel of drive pedal are set. The judgement logic of threshold model is established. In positive (+) travel of two or more travel of driving pedal and when the value determined by characteristic function Wₐᵢ reaches threshold value cₕₐᵢ, tire burst driving control enters and tire burst braking control of vehicle exits. In negative travel (−) of two or more travel of driving pedal and when the value determined by characteristic function W_{bi} reaches threshold value c_{hbi}, the tire burst driving control of vehicle exits, and tire burst braking control returns actively when travel hᵢ of driving pedal is 0. In tire burst control of the second and multiple stroke of the driving pedal, tire burst drive control implemented by throttle and fuel injection of engine or driving device of electric vehicle is realized according to the control model with parameters that include travel or stroke hᵢ of driving pedal.

47. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. The system uses self-adaptive drive control for tire burst.
(1). Self-adaptive drive control for tire burst
One of comprehensive angle acceleration \dot{ω}ₚ of wheels, comprehensive driving slip ratio Sₚ of wheels and driving force Qₚ of vehicle is determined by parameters that include angle acceleration chi of wheels, driving slip ratio Sᵢ of wheels and driving force Qᵢ of wheels according to a certain algorithm that includes average or weighted average algorithm. One of self-adaptive control models \dot{ω}ₚ, Sₚ, Qₚ is established by one of modeling parameters that includes \dot{ω}ₚ, Sₚ, Qₚ. The models include: the Qₚₖ is determined by mathematical model with parameters γ and Qₚ, the \dot{ω}ₚₖ is determined by the mathematical model with parameters γ and \dot{ω}ₚ, the Sₚₖ is determined by mathematical model with parameters γ and Sₚ. In model, the γ is tire burst characteristic parameter. The γ is determined by mathematical model with parameters which includes collision avoidance time zone tₐᵢ, yaw angle velocity deviation e_{ω}_{ᵣ}(t) of vehicle, sideslip angle deviation e_{β}(t) to mass center of vehicle, or/and equivalent relative angle velocity deviation e(ωₑ) and angle acceleration deviation e(\dot{ω}ₑ) of two wheel for balance wheelset of tire burst vehicle. The modeling structures of models Qₚₖ, \dot{ω}ₚₖ and Sₚₖ are the following. The Qₚₖ, \dot{ω}ₚₖ, Sₚₖ are a decreasing functions with increment of γ. The γ is an incremental function with decrement of anti-collision control time zone tₐᵢ, and the γ is an incremental function of absolute value of increment of e_{ω}_{ᵣ}(t), e_{β}(t), e(ωₑ) and e(\dot{ω}ₑ). When the vehicle enters danger or forbidden time zone tₐᵢ of which the vehicle collides with front vehicle, the driving of the vehicle is relieved. When the vehicle exits from the dangerous time zone tₐᵢ of colliding with front vehicle, the vehicle returns to the drive control determined by drive operation interface or driverless vehicle.
(2). Allocation of one of target control value for control variables Qₚₖ [symbol] \dot{ω}ₚₖ and Sₚₖ of each wheel. The Qₚₖ [symbol] \dot{ω}ₚₖ or Sₚₖ is allocated to no-burst tire wheel, or two wheels of wheelset of driving axle, or/and two wheels of steering wheelset.
First. The tire burst driving control set by a drive shaft and a non-drive shaft of vehicle. When tire burst of one wheel of driving axle arises, the Qₚₖ or \dot{ω}ₚₖ or Sₚₖ is distributed to the wheelset of driving axle. Under action of differential speed mechanism of steering axle, two wheels of the wheel pair of driving axle obtain same tire force. When tire burst wheel of steering axle is driven to slipping, that is, the parameter value angle speed ω₁ or slip ratio Sₚₖ₁ of tire burst wheel is larger than the parameter value ω₂ or Sₚₖ₂ of the no burst tire wheel, the driving force provided by the driving axle fails to reach the target control values of Qₚₖ, the tire burst wheel of the steering axle can be braked, so that, values of the ω₁ and ω₂ of left wheel and right wheel of the driving axle may be equal, or Sₚₖ₁ is equal to Sₚₖ₂. When tire burst of one wheel of non-driving axle, the driving force is allocated to wheelset of the driving axle. For four-wheel vehicle with front drive axles and rear drive axles, the driving force is allocated to two wheel of wheelset of no tire burst drive axle under state of tire burst of one wheel of one drive axle.
Second, tire burst drive control of four wheel drive of electric vehicle or fuel engine. When vehicle sets two driving axles, or when four wheels are driven independently, the driving force may be assigned to two wheels of no tire burst wheelset, or the driving force is assigned to no tire burst wheel of tire burst wheelset. When the driving force is assigned to no tire burst wheel of tire burst wheelset, the driving force of the wheelset produces unbalanced yaw moment Mᵤ₁ to mass center of vehicle. The unbalanced yaw moment Mᵤ₁ to mass center of vehicle may is compensated by unbalanced yaw moment Mᵤ₂ produced by differential driving force exerted on the two wheels of no tire burst wheelset. The vector sum of Mᵤ₁ and Mᵤ₂ is 0. The sum of yaw moment exerting on the vehicle mass center of all wheels is 0, thus, to realize balanced driving for the whole vehicle.

48. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. The method uses a coordinated and stability control mode of driving and braking, or adopts balance control of active driving and stability steering for tire burst vehicle.
(1). Coordinated control of stability of driving and braking. In driving control of tire burst vehicle, it is adopted to a logical combination of braking or/and driving stability C control wheel braking stability A control of vehicle and, which include A⊂C [symbol] C or A. During the control cycle of its logical combination control, the additional yaw moment Mᵤ exerting on mass center of vehicle is formed by longitudinal tire force produced by differential braking or differential driving of each wheel. The Mᵤ is used to balance tire burst yaw moment Mᵤ′, unbalancing driving yaw moment Mₚ or/and the braking yaw moment Mₙ produced in steering of vehicle. The Mᵤ can be use to compensate insufficient or excessive steering of vehicle, to control the dual instability caused by tire burst of vehicle and control based on normal working of vehicle.
(2). Balance control of active driving and stability steering for tire burst vehicle. Based on steering wheel rotation angle δ or directive wheel rotation angle θₑₐ that can be not determined by operation of driver is exerted to actuator of the active steering system AFS. Within critical speed range of vehicle, the unbalanced driving moment M_{b}′ or/and brake yaw moment Mₙ produced in steering of vehicle can be compensated by yaw moment produced by additional rotation angle θ_{eb}, to balance insufficient or excessive steering of the vehicle. Based on the friction ellipse theory model of wheel, the distribution in wheels of additional yaw moment Mᵤ produced by differential braking or differential driving or braking of each wheel and control of additional angle θ_{eb} of vehicle is determined by distribution model with modeling parameters that include longitudinal slip ratio of wheel driving and transverse slip angle of steering of wheel in steering and brake of wheels.

49. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. In normal and tire burst conditions, a suspension control for tire burst is adopted by the system.
(1) The suspension control to tire burst vehicle adopts tire burst pattern recognition and tire burst judgment of detection tire pressure of sensor, or the state tire pressure pᵣₑ, or of one of characteristic tire pressure x_{b} [symbol] x_{c} [symbol] x_{d}.
(2). According to state process of tire burst vehicle, control and control mode conversion of suspension control of vehicle manly includes entry and exiting of tire burst control is determined under condition of which tire burst of vehicle judgment is established, control and control mode conversion of suspension travel for normal working condition and tire burst conditions, or/and control and control mode conversion of coordinate control of travel Sᵥ, damping resistance Bᵥ and stiffness Gᵥ of suspension according to state of tire burst vehicle.
(3). Under the condition of which tire burst judgment is established, the logic threshold model is adopted for the entry or exiting of suspension control of the tire burst vehicle. When tire burs signal iₐ arrives, the secondary judgment of suspension control is made according to the threshold model and judgement logic. If the second judgment is established, vehicle will enter the tire burst suspension control; otherwise, it will exit from tire burst control, and the controller will output entry and exiting signals iᵥₐ [symbol] i_{vb} of suspension control for tire burst.
(4). In the coordinated control mode and model, elastic element stiffness Gᵥ, damping Bᵥ of shock absorber, position height Sᵥ of suspension is used as control variable. The target control value of Gᵥ [symbol] Bᵥ [symbol] Sᵥ are determined. Or/and calculates amplitude and frequency of suspension in the vertical direction of vehicle body.
i. Deviation eᵥ(t) between measured value s of suspension position height Sᵥ′ and its target control value Sᵥ are defined. The position height of tire burst wheel or/and suspension position height of each wheel are adjusted by feedback control of deviation eᵥ(t). The body balance of the tire burst vehicle is adjusted, or/and load distribution of each wheel is adjusted by control of the suspension lift.
ii. Coordinate control of travel Sᵥ, damping resistance Bᵥ and stiffness Gᵥ of suspension. The coordinated control model of control variable Bᵥ [symbol] Sᵥ or/and Gᵥ is established. In adjusting of control variable Sᵥ, the value of \dot{S}ᵥ and \ddot{S}ᵥ are set, to make value of \dot{S}ᵥ and \ddot{S}ᵥ be suitable for damping Bᵥ of absorber of suspension. For shock absorber with damping fluid that includes magnetorheological fluid, the damping Bᵥ is adjust to a value that should adapt to \dot{S}ᵥ [symbol] \ddot{S}ᵥ controls; among, \dot{S}ᵥ and \ddot{S}ᵥ are first and second derivatives of travel Sᵥ of suspension.
(5). Suspension control program or software for tire burst. Based on the structure, flow, control mode, model or/and algorithm of suspension lifting control for tire burst, a tire burst suspension lifting control subroutine is developed. The subroutine mainly include secondary entering and exiting of suspension control of tire burst vehicle, the control mode, model conversion of tire burst and non-tire burst control modes, travel Sᵥ control of wheel suspension, or/and coordination control of Gᵥ [symbol] Bᵥ and Sᵥ of wheel suspension, and program module of servo control for input parameters.

50. A control method of safety and stability for vehicle tire burst, which is based on braking, driving, steering, engine and suspension system of vehicle, adopts safety and stability control mode, model or/and algorithm for vehicle for tire burst, to realize safety and stability control of tire burst vehicle. Characteristics of the method is the following. Under tire burst conditions, anti-collision control of tire burst vehicle includes one of following self-adaptive anti-collision control and mutual adaptive anti-collision control of the vehicle and around vehicles.
(1). Self-adaptive anti-collision control of tire burst vehicle
An anti-collision time zone tₐᵢ is determined by distance Lₜᵢ and relative speed u_{c} between the vehicle and the rear vehicle. The tₐᵢ is ratio of Lₜᵢ and u_{c}. An anti-collision threshold model with the parameter tₐᵢ of front vehicle and rear vehicle is established. A set Cₜ₁ (Cₜ₁ [symbol] Cₜ₂ [symbol] Cₜ₃ [symbol] . . . Cₜₙ) of decreasing threshold of the tₐᵢ is established. Based on threshold model, the anti-collision time zone tₐᵢ of the vehicle and front vehicle or rear vehicle is divided into levels tₐ₁ [symbol] tₐ₂ . . . tₐₙ that include safety, danger, forbidden and collision. Setting judgement conditions for collision between the vehicle and the rear vehicle: tₐₙ=cₜₙ. A coordinated control mode of collision avoidance, steady braking of wheel and vehicle is established. According to the single wheel model of braking D control of vehicle, the target control value of vehicle deceleration \dot{u}ₓ is determined. In limited range of a series target control values of vehicle, the brake A, B, C control, logic combination of brake A, B, C control are determined by parameter forms of angle deceleration \dot{ω}ᵢ or slip ratio Sᵢ of each wheel. The brake A, B, C control logic combination mainly includes C⊂B∪A [symbol] A⊂C [symbol] C⊂A. Vehicle speed \dot{u}ₓ as a control variable is assigned by each wheel according to parameter forms of angle deceleration \dot{ω}ᵢ or slip ratio Sᵢ or braking force Qᵢ. In cycle of period Hₕ of brake A, B, C control and their logic combinations, distribution of each wheel for differential braking force in vehicle steady state C control of vehicle is used preferentially. The angle deceleration \dot{ω}ᵢ or slip rate Sᵢ for braking B control orderly is decreased with decreasing of tₐᵢ or cₜᵢ step by step, to keep differential braking force of vehicle steady state braking C control of balanced wheelset for tire burst and no-tire burst. When vehicle enters time zone of collision of front vehicle and rear vehicle, all braking forces of each wheel are released, or drive control of vehicle is started, and the time zone tₐᵢ of collision avoidance between the vehicle and the rear vehicle is limited in a reasonable range between “safety and danger”, to ensure that the vehicle does not touch a collision limit of threshold cₜₙ, namely, tₐᵢ=cₜₙ, from this, coordinated control of collision avoidance, steady-state of braking wheel and vehicle are realized.
(2). Mutual adaptation anti-collision control for tire burst vehicle. The control can be used for vehicles which be not equipped with distance detection system or only equipped by ultrasonic distance detection sensor.
First. A mutual adaptive control mode of steady, moderate braking control of the front vehicle for tire burst and driver' collision prevention of vehicles located the back to the tire burst vehicle located front is adopted. Based on experiment of driver's braking and anti-collision, the driver's physiological response state to vehicle collision and a preview model of driver's braking anti-collision to tire burst front vehicle are determined.
Second. a braking control model that includes the driver's physiological reaction lag time, braking control response time, brake retention time are established after the driver who is in rear vehicle finds tire burst signal of ahead vehicle.
Third. The above two models are collectively referred as the tire burst braking control model of collision avoidance of front and rear vehicles. In the early stage and real tire burst stage, the brake controller set by the tire burst vehicle can implement a moderating brake control according to above two braking control model of collision avoiding of rear vehicle to tire burst front vehicle, from this, to realize moderating and limited braking of the tire burst vehicle on set time. The moderate or limited braking control model of braking A, B, C and their logical combination is determined; Based on the above two models and brake A, B, C, D control cycle of period Hₕ of control logic combination, coordinate and moderate braking control used by the front vehicle for tire burst on set time can offset or compensate time delay caused by the lag of physiological reaction and the reaction period of rear vehicle driver to collision avoiding, so as to avoid the dangerous period of collision caused by the braking of the rear vehicle and the front vehicle to tire burst, from this, to avoid risk period of rear vehicle collide to front vehicle.
(3). Anti-collision control of vehicle driven by man for tire burst. The vehicle anti-collision control to left and right direction adopts coordinated control mode, model or/and algorithm of braking, driving, rotation force of directive wheel or/and active steering. Based on rotation angle θₑₐ of directive wheel determined by active steering system AFS of vehicle, an actuator of AFS is exerted by additional angle θ_{eb} which is independent to driver operation. In the critical speed range of steady-state control of vehicle, an additional yaw moment which does not depend on driver's operation is determined to compensate the vehicle's insufficient or excessive steering caused by the tire burst. The actual steering angle θₑ of directive wheel is vector sum of the steering angle θₑₐ of directive wheel and the additional angle θ_{eb} for tire burst. In the active action of additional rotation angle θ_{eb}, the vector sum of tire burst rotation angle tied and additional rotation angle θ_{eb} is zero in theory. Running off of tire burst vehicle and excessive sideslip of directive wheel can be prevented by control of vehicle direction, wheel stability, vehicle attitude, stable acceleration and deceleration and path tracking of vehicle, to realize anti-collision control of the tire burst vehicle in left and right direction.

51. According to the safety and stability control method for tire burs vehicle described by right claim 2 or 3 term, the features of the method is following. According to state or type structure of non braking and non driving, driving, braking of tire burst identification of vehicle, the tire burst pattern recognition and tire burst judgement including pᵣₑ [x_{b}, x_{d}] of vehicle are used based on wheel state, steering state of vehicle and vehicle state, are adopted. The three types of running state and structure of vehicle are expressed by positive (+) and negative (−) of mathematical symbols.
(1). The structure or mode of non-braking and non-driving state of vehicle is characterized by positive (+) and negative (−). The judgment logic for tire burst is established in the running state of vehicle. In the state process, pressure pᵣₑ₁ is determined by equivalent mathematical model or/and algorithm. The mathematical model of pressure pᵣₑ₁ is established by relevant modeling parameters in which include yaw angle velocity deviation e_{ω}_{ᵣ}(t), side slip angle deviation e_{β}(t) to mass center of vehicle, non-equivalent relative angle velocity deviation e(ωₖ) of left and right wheels of wheelset, ground friction coefficient μᵢ, wheel load N_{zi} and rotation angle δ of steering wheel:
pᵣₑ₁=f(e(ωₖ),e_{β}(t),λᵢ) [symbol] λᵢ=f(μᵢ [symbol] N_{zi} [symbol] δ)
Based on state tire pressure pᵣₑ₁ and threshold model for tire burst judgement, tire burst judgement is determined. The absolute value of non-equivalent relative angle velocity deviation e(ωₖ) in balancing wheelset to front and rear axles is compared. The wheelset of which bigger absolute value of deviation e(ωₖ) is taken in the two balance wheelset is tire burst balancing wheelset, and the wheel of which bigger ωₖ value is taken in two wheels of the balance wheelset is tire burst wheel.
(2). Driving state structure or mode (+). In the state process, for the non-driving axle wheelset and the driving axle wheelset, the equivalent mathematical model of state pressure pᵣₑ is established by relevant modeling parameters in which include yaw angle velocity deviation e_{ω}_{ᵣ}(t), the sideslip angle deviation e_{β}(t) of vehicle, the non-equivalent or equivalent relative angle velocity deviation e(ωₖ), e(ωₑ) of the left wheel and right wheel of wheelsets, ground friction coefficient μᵢ, wheel load N_{zi} and steering wheel angle δ:
pᵣₑ₂=f(e_{ω}_{ᵣ}(t),e_{β}(t),e(ωₖ),e(\dot{ω}ₖ),λᵢ) or
pᵣₑ₂=f(e_{ω}_{ᵣ}(t),e(ωₑ),e(\dot{ω}ₑ),λᵢ) or
λᵢ=f(μᵢ [symbol] N_{zi} [symbol] δ)
The tire burst judgement is made by threshold model of state tire pressure pᵣₑ₂. After tire burst is determined, the equivalent relative angle velocity ωₑ of the left wheel and right wheel of the driving axle is compared. Based on the state tire pressure pᵣₑ₂ and the tire burst judgement threshold model, the non-equivalent relative angle velocity ωₖ of left wheel and right wheel of non-driving axle is compared, and the equivalent relative angle velocity ωₑ of left wheel and right wheel of driving axle is compared. The wheel with bigger value of ωₑ and ωₖ in two wheelsets of driving axle and non-driving axle is tire burst wheel, and the balance wheelset of which larger value of e(ωₑ) is taken in the two axles is tire burst balance wheelset. During the real tire burst time and inflection point time for tire burst, driving of the vehicle has be exited actually.
(3). Braking state structure or mode (+).
i. Braking state structure 1. Under braking condition of normal working, the left wheel and right wheel of front axle and rear axle have same braking force. If vehicle is not carried out steady state control of differential braking of wheels, it indicates that the vehicle is in normal condition or before time of tire burst. The mathematical model of tire pressure pᵣₑ₃ is established by relevant modeling parameters in which include e_{ω}_{ᵣ}(t), e(ωₖ), e_{β}(t), e(ωₑ), e(Qₖ) and λᵢ:
pᵣₑ₃=f(e_{ω}_{ᵣ}(t),e(ωₖ),e_{β}(t),e(ωₑ),e(Qₖ),λᵢ) [symbol] λᵢ=f(μᵢ [symbol] N_{zi} [symbol] δ)
Where, the e(Qₖ) is the non-equivalent relative braking force deviation of the balanced wheelset. After tire burst is determined, absolute values of e(ωₑ) and e(ωₖ) of front axle and rear axles are compared based on state tire pressure pᵣₑ₃ and threshold model of tire burst judgement. The wheel that takes a bigger absolute value of ωₑ or ωₖ is tire burst wheel, or the positive and negative sign of e(ωₖ) and e(ωₑ) can be used to determine tire burst wheel. The balanced wheelset with tire burst wheel is tire burst balanced wheelset.
ii. The braking state structure 2. The state structure or mode is a state structure of which tire burst vehicle enters steady state control of differential braking of the wheels. In this state structure or made, two ways are used to determine state tire pressure pᵣₑ. First way. The way is based on “braking state structure 1”, to determine state tire pressure pᵣₑ₄₁, that is, the pᵣₑ₃ is equal to the pᵣₑ₄₁, then, to determine tire burst of vehicle. Second way. For vehicle of which parameters of wheel braking force Qᵢ and angle velocity a); are taken as control variables, the state tire pressure pᵣₑ₄₁ is calculated under the condition of differential braking of wheels. The first algorithm of pᵣₑ₄ is based on judgment of tire burst of “the braking state structure or mode 1”; the two wheels of tire burst balancing wheelset are exerted by equal braking force; the following calculation model of determining state tire pressure pᵣₑ₄₁ is adopted. When the left wheel and right wheel of tire burst balancing wheelset are exerted by equal braking force Qᵢ, one of the same parameters in Eₙ is Qᵢ, it satisfies the condition of same braking force Qᵢ taken by two wheels of tire burst balancing wheelset, and effective rolling radius Rᵢ of two wheels of tire burst balancing wheelset is regards as a same; from this, the e(ωₖ) is equivalent to e(ωₑ). Under state of which differential braking of two wheels of non-tire burst balanced wheelset is carried by the following calculation model of pᵣₑ₄₂, the same parameters in the set Eₙ are taken as Qᵢ and Rᵢ, the parameters e(ωₑ) and e(\dot{ω}ₑ) in calculation model of pᵣₑ₄₂ simultaneously satisfy the condition of which the values of Qᵢ and Rᵢ of each wheels are equivalent or equivalent equality. Algorithm 2 of state tire pressure pᵣₑ₄. The unbalanced braking force of steady-state control of differential braking for vehicle is applied to two wheels of balanced wheelset of tire burst and no tire burst. The calculation model of pᵣₑ₄₃ is adopted. Under the state in which same parameter Rᵢ of each wheel in the set Eₙ is set, The parameters e(ωₑ) and e(\dot{ω}ₑ) should satisfy the conditions of which braking force Qᵢ and the effective rolling radius Rᵢ of two-wheel of balanced wheelset are equivalent or equivalent equality, and the e(Qₑ) in calculation model of pᵣₑ₄₃ may be replaced by the non-equivalent relative braking force deviation e(Qₖ) of two-wheels of balanced wheelset, and the “abnormal change” of vehicle yaw angle velocity deviation e_{ω}_{ᵣ}(t) in tire burst control is compensated by change of parameter e(Qₖ).
pᵣₑ₄₁=f(e_{ω}_{ᵣ}(t),e_{β}(t),e(ωₖ),e(\dot{ω}ₖ),λᵢ)
pᵣₑ₄₂=f(e_{ω}_{ᵣ}(t),e_{β}(t),e(ω_{c}),λᵢ)
pᵣₑ₄₃=f(e_{ωr}(t),e_{β}(t),e(ωₑ),e(Qₑ),λᵢ)
λᵢ=f(μᵢ [symbol] N_{zi} [symbol] δ)
The tire burst is determined based on state tire pressure pᵣₑ and the value of the tire burst threshold model. The absolute values of e(ωₑ) of the front axle and rear axle are compared after the tire burst is determined, and the balance wheelset in which the larger absolute value of e(ωₑ) is taken in the two axles is tire burst balance wheelset. The wheel of which the larger absolute value of e(ωₑ) or e(ωₖ) is taken are tire burst wheel. In the balancing wheelset for tire burst, the positive and negative sign of e(ωₖ) also is used to determine the tire burst wheel and tire burst balanced wheelset.

52. According to the safety and stability control method for tire burs vehicle described by right claim 6 or 7 term, the features of the method is following. Direction determination of tire burst of vehicle can use one of following modes and their union mode or their combination.
(1). Judgment mode of angle and torque for tire burs. Based on the origin rules of rotation angle δ and rotation torque M_{c} coordinate of steering wheel, the rules of rotation direction for Left and right angle δ, the rules of direction positive (+) negative (−) of rotation torque M_{c} and increment or decrease ΔM_{c} of M_{c} of steering wheel, and the rules of positive (+) negative (−) direction of tire burst rotation moment and steering assist moment Mₐ, it can be established to the judgment logic of positive (+) and negative (−) direction of burst tire rotation moment and steering assistant moment Mₐ when steering wheel or directive wheel turns to right or to left, or when it is in right-handed rotating. The judgment logic can be shown by the following logic chart of judgement mode of steering angle and torque direction. According to the logic chart of the judgment logic, the direction of burst tire rotation moment M_{b}′ and the steering assistant moment Mₐ can be determined. Direction determination of tire burst use the following model or their joint model.
(2). The direction judgement mode of steering angle and torque: right-hand rotating logic chart of direction of rotation angle δ. The direction of parameters is expressed by positive and negative symbol (+ and −)

| | M_{c}(right | | | |
|---|---|---|---|---|
| δ | rotation direction) | ΔM_{c} | M′_{b} | Mₐ |
| + | + | + or 0 | 0 | 0 |
| − | −(+ transferring to −) | − or 0 | 0 | 0 |
| − | + | − or 0 | 0 | 0 |
| + | − | + | + | − |
| + | −(+ transferring to −) | + | + | − |
| − | −(+ transferring to −) | + or 0 | 0 | 0 |
| − | + | + | − | + |

The direction judgement mode of rotation angle and rotation torque: left-handed logic diagram chart of angle δ can be omitted in this article. Based on the origin regulation of steering wheel angle δ and torque M_{c}, and when rotation angle δ of the steering wheel or the rotation angle θₑ of directive wheels is in left turning, the positive (+) and negative (−) regulation of steering wheel torque or the positive (+) negative (−) regulation of torque measured by sensor are contrary with the positive (+) and negative (−) regulation of right turning of steering wheel. According to the rules of positive (+) negative (−) of left-hand turn of steering wheel, the logic of the direction judgement of tire burst moment M_{b}′ and steering assistant moment Mₐ can be established when the rotation angle δ of steering wheel is left-handed rotating. Except for the rotation direction of angle δ of steering wheel and positive (+) negative (−) rules adopted by the steering wheel which is in left-handed turn are different to right turn, the parameters, structure, judgement flow and method used in direction judgment logic and logic chart of tire burst rotation moment M_{b}′ and steering assistant moment Mₐ are the same as those used in right turn of steering wheel.
(3). In the above tables, it is indicated that vehicle or wheel is in normal working when the rotation moment M_{b}″ of tire burst is 0. Tire burst of vehicle can be determined by the positive (+) or negative (−) of the tire burst rotation moment M_{b}′. When rotation moment M_{b}′ for tire burst is positive (+), it is indicates that the direction of M_{b}′ is consistent with the direction of the positive route of steering wheel angle δ, and the direction of steering assistant moment Mₐ is consistent with the direction of the negative route of angle δ of steering wheel. When tire burst rotation moment M_{b}′ is a negative (−), it indicates that the direction of M_{b}′ is consistent with the direction of the negative route of steering wheel angle δ, and the direction of steering assistant moment Mₐ is consistent with the direction of the positive route of steering wheel angle δ. When increment ΔM_{c} of steering assistant moment Mₐ is 0, it indicates that the rotation force Mₖ of steering wheel exerted by ground is in a force balance state, and it indicates that derivative Mₖ of parameter Mₖ is 0.

53. According to the safety and stability control method for tire burs vehicle described by one of right claim 12 term, the features of the method is following. Steady-state braking A control of wheels. The braking A control include steady-state control of tire burst wheel and anti-lock braking control of no tire burst wheel. In tire burst working conditions, slip rate Sᵢ of tire burst wheel do not have the specific meaning of peak value slip rate of anti-lock braking control. When tire burst control entering signal iₐ arrives, the braking controller terminates or reduce the braking force exerted to tire burst wheel, it can make tire burst wheel be in a pure rolling state without braking, or can make tire burst wheel be in steady-state braking, according to one of the parameter form of control variable \dot{ω}ᵢ [symbol] Sᵢ and Qᵢ for braking A control. In the control of tire burst braking A, the braking force of tire burst wheel is decreased in step by step on equal or unequal value based on characteristics of the motion state of tire burst wheel. The brake A controller take \dot{ω}ᵢ and Sᵢ as control variables and control objectives, and takes brake force Qᵢ as parameter variables; a mathematical model is established by the control variables and modeling parameters, to determine control structure and characteristics of braking A control by certain algorithm. Under braking A control, tire burst wheel and no tire burst wheels can obtain a dynamic and steady-state braking force. A general analytic mathematics formula can be adopted by the model of braking A control, or it can transformed into expression of state space, and the dynamics system of wheel is expressed by state equation. On this basis, the appropriate control algorithm is determined by modern control theory. Braking control period Hₕ of tire burst is set. In process of logical cycle of period Hₕ, the braking force Qᵢ is reduced step by step according to the characteristics of the movement state of the tire burst wheel, and reduction of braking force Qᵢ of tire burst wheel can be realized by the reducing of target control values \dot{ω}ₖᵢ and Sₖᵢ of control variables \dot{ω}ᵢ and Sᵢ, until \dot{ω}ₖᵢ and Sₖᵢ achieve a set value or zero. During the control process, the actual values \dot{ω}ᵢ and Sᵢ of tire burst wheel fluctuate around their target control values \dot{ω}ₖᵢ and Sₖᵢ. The braking force Qᵢ is decreased gradually, equally or unequally to 0, thus indirectly adjusting the braking force Qᵢ of wheels.

54. According to the safety and stability control method for tire burs vehicle described by one of right claim 11 [symbol] 12 [symbol] 13 [symbol] 14 [symbol] 15 term, braking stability C control of vehicle is the following. During logic cycle of the period Hₕ of brake A, B, C, D control and its combination, the vehicle stability control is adopted and brake C control has priority.
According to control parameter forms of one of angle deceleration \dot{ω}ᵢ or/and slip rate Sᵢ, additional yaw moment Mᵤ of brake C control of vehicle is used to direct or indirect distribution of braking force for each wheel. The distribution of additional yaw moment Mᵤ of brake C control for wheels can be expressed as the following. According to brake C control mode and model, and on basis of position relationship of tire burst wheel, yaw control wheels and non-yaw control wheels, the efficient yaw control wheel are determined by quantitative relationship in which additional yaw moment Mᵤ is vector sum of additional yaw moment Mᵤᵣ determined by longitudinal differential braking of wheels and additional yaw moment Mₙ determined by condition of braking state in vehicle steering. The distribution of additional yaw moment Mᵤ is determined to the efficient yaw control wheel and yaw control wheels by distribution model. The additional yaw moment Mᵤ is not allocated to the tire burst wheel.
(1). Under braking state of straight running of vehicle, the Mᵤ is equal Mᵤᵣ. The Mᵤᵣ is additional yaw moment produced by longitudinal differential braking of wheels. In the single wheel or two wheel, the Mᵤ can be allocated to any one or two of the yaw control wheels.
(2). Under braking state in steering of vehicle, and for vehicle in which front axle is steering axle, the allocation model of additional yaw moment Mᵤ to wheels is established by modeling parameters which include additional yaw moment Mᵤᵣ determined by longitudinal differential braking force of wheels, additional yaw moment Mₙ determined by braking of wheels in vehicle steering, slip rate Sᵢ, rotation angle δ of steering wheel or rotation angle θₑ of directive wheel and Load M_{zi} of yaw control wheels. Based on the allocation model of additional yaw moment Mᵤ, the allocation of Mᵤ to two yaw control wheels or to efficiency yaw control wheel can be determined.
i. For tire burst of right front wheel under state of right-turning of vehicle, the left front wheel can be determined as efficiency yaw control wheel according to vector model with modeling parameter Mᵤ, Mᵤᵣ, load N_{zi} of each wheel and their transfer amount ΔN_{zi} in tire burst. The Mᵤ is vector sum of Mᵤᵣ and Mₙ:
Mᵤ=Mᵤᵣ+Mₙ
When direction of Mᵤᵣ and Mₙ is the same, the maximum value of additional yaw moment Mᵤ is achieved under condition of certain differential braking force. For two yaw control wheels of left front and left rear, the distribution proportion of the Mᵤ is determined in the process of braking and steering. The distribution model of two yaw control wheels of left front and left rear is established by modeling parameters which include braking slip ratio Sᵢ of left front wheel and left rear wheel, and rotation angle θₑ of directive wheels. The distribution of additional yaw moment Mᵤ of the two yaw control wheel is realized by the distribution model. The steering of vehicle, longitudinal slip ratio Sᵢ and lateral slip angle of two yaw control wheels for left front wheel and left rear wheel are controlled by the distribution of additional yaw moment Mᵤ between two yaw control wheels. The tire burst yaw moment Mᵤ′ produced by tire burst of right front wheel is balanced by Mᵤᵣ and Mₙ, therefrom, Insufficient or excessive steering of vehicle is balanced or is eliminated.
ii. Tire burst of left front wheel under state of right-turning of vehicle. According to vector model with modeling parameter Mᵤ that includes Mᵤᵣ and Mₙ-.
Mᵤ=Mᵤᵣ+Mₙ
The Mᵤ is vector sum of Mᵤᵣ and Mₙ. Under certain differential braking force of wheels, the Mᵤ can achieve maximum value when the direction of Mᵤᵣ and Mₙ are the same. The right rear wheel is determined as the efficient yaw control wheel. Based on the load N_{zi} of each wheel and their transfer amount ΔN_{zi} in tire burst state, the distribution model of two yaw control wheels is established by parameters which include the rotation angle θₑ of front wheel or/and left front wheel, side or transverse slip angle and longitudinal slip ratio Sᵢ of right front wheel and longitudinal slip ratio Sᵢ of right rear wheel, and load N_{zi} of each wheel. Based on this model, the distribution of additional yaw moment Mᵤ between two yaw control wheels is realized. The steering of vehicle, s longitudinal lip rate Sᵢ of right front and right rear wheel are also controlled at the same time. The tire burst yaw moment Mᵤ′ produced by tire burst of left front is balanced by Mᵤᵣ and Mₙ, thus, Insufficient or excessive insufficient steering of tire burst vehicle is balanced or eliminated by Mᵤᵣ, Mₙ and their superposition.
iii. The tire burst of right rear wheel in state of right-turning of vehicle. According to the vector model of Mᵤ including Mᵤᵣ and Mₙ
Mᵤ=Mᵤᵣ+Mₙ
The Mᵤ is vector sum of Mᵤᵣ and Mₙ. Under certain differential braking force of wheels, the additional yaw moment Mᵤ of vehicle achieves the maximum value when direction of Mᵤᵣ and Mₙ are the same. The left rear wheel is efficient yaw control wheel, and the left front wheel and left rear wheel are yaw control wheels. Based on load N_{zi} of each wheel and their transfer amount ΔN_{zi} in tire burst state, the distribution model of two yaw control wheels is established by modeling parameters including the steering angle θₑ of front wheel, side slip angle and longitudinal slip ratio Sᵢ of front wheels, longitudinal slip ratio Sᵢ of left rear and load N_{zi} of each wheel. The coordinated distribution of additional yaw moment Mᵤ of two yaw control wheels of left front and left rear is realized. The steering of vehicle, the steering angle of left front wheel, and the longitudinal slip rate Sᵢ of left front and left rear wheels are controlled simultaneously by the distribution of additional yaw moment Mᵤ between left front wheel and left rear wheel. The combination of Mᵤᵣ and Mₙ can balance the tire burst yaw moment Mᵤ′ produced by tire burst of right rear wheel. Insufficient or excessive steering of tire burst vehicle is compensated or eliminated produced by superposition effect of Mᵤᵣ and Mₙ.
iv. The left rear wheel of right-turning vehicle. According to the vector model of parameter Mᵤ including Mₙ and Mᵤᵣ:
Mᵤ=Mᵤᵣ+Mₙ
The Mᵤ is vector sum of Mᵤᵣ and Mₙ. Under certain differential braking force of wheels, the Mᵤ achieves maximum value under condition of the same direction of Mᵤᵣ and Mₙ, therefrom it can be determined that right rear wheel is the efficient yaw control wheel. The right front wheel and right rear wheels are yaw control wheel. In tire burst control, the distribution model of the Mᵤ of two yaw control wheels is established by modeling parameters including steering angle θₑ of front wheel, side slip angle and longitudinal slip ratio Sᵢ of right front wheel, longitudinal slip ratio Sᵢ of right rear and load N_{zi} of each wheel, based on the load N_{zi} of each wheel and their transfer amount ΔN_{zi}. The steering angle θₑ of right front wheel and stable steering of the vehicle are controlled by distribution of additional yaw moment Mᵤ between the two yaw control wheels. The longitudinal direction slip rate Sᵢ of right front wheel and right rear wheel are controlled simultaneously. The combination control of Mᵤᵣ and Mₙ can balance tire burst yaw moment Mᵤ′ produced by left rear tire burst. Insufficient or excessive steering of tire burst vehicle is compensated or eliminated by superposition effect of Mᵤᵣ and Mₙ. Similarly, the controlled wheel selection, control principle, rules and system of tire burst control of the left-turn vehicle are same as those of the right-turn vehicle.

55. According to the safety and stability control method for tire burs vehicle described by right claim 11 or 12 or 13 or 14 or 15 term, tire burst braking A, B, C, D control and its logic combination are described by the following.
In duration from arriving of burst control entering signal iₐ to starting point of real burst time, or/and safety time of vehicle collision avoidance control, the braking A, C, B and D control may adopt the forms of B←A∪C or D←B∪A∪C logic combination and its logic cycle of period Hₕ. During real tire burst time, namely before time or after time of the real tire burst point, braking force of tire burst wheel is relieved or decreasing mode of braking force is adopted. When control combination A∪C and it logic cycle are adopted, the control combination of A∪C can be replaced by braking C control, that is, braking C control override A∪C control. The differential braking control variable of brake C control for each wheel may adopt one of the parameter forms of \dot{ω}_{c}, S_{c}, Q_{c}. The target control value \dot{ω}_{ck}, S_{ck} or Q_{ck} of control variable \dot{ω}_{c}, S_{c} or Q_{c} are determined by the difference between target control value Q_{ck1} [symbol] ω_{ck1} S_{ck1} of left wheel and the target control value of Q_{ck2} [symbol] \dot{ω}_{ck2} S_{ck2} of right wheel. According to the direction of the additional yaw moment Mᵤ of tire burst, the wheel in which one of control variable \dot{ω}_{c}, S_{c}, Q_{c} of left wheel and right wheel of wheelset is assigned by smaller value is determined. The smaller values of the control variables in the left wheel and right wheel may are taken as zero. The distribution rules of \dot{ω}_{ck}, S_{ck}, Q_{ck} are expressed as: value of one of \dot{ω}_{ck}, S_{ck}, Q_{ck} is allocated to no-tire burst wheelset, and are allocated to no tire burst wheel in the tire burst wheelset. During each control period after real starting point of tire burst, the difference braking force of balanced brake B control of each wheel are decreased or are terminated with the increase of the differential braking force of C control for each wheelset, thus, tire burst brake control enters the logical cycle of braking C control or braking A∪C control.

56. According to the safety and stability control method for tire burs vehicle described by right claim 18 term, the features of the method is the following. Braking of tire burst vehicle adopts braking control of engine for idle. Braking control of idle engine can be started-up in control period from early stage of tire burst control to the real tire burst time. According to state process of tire burst vehicle with the controller can enter idle brake control of the fuel engine in the early stage of tire burst control, or in any time before the actual tire burst time. The engine idle brake control adopts dynamic mode. In the process of engine idle brake, engine injection quantity of fuel oil is zero, that is, fuel injection quantity of engine is stopped. The idle braking force of engine is determined by model of opening of throttle control. The idle braking force of engine is an increasing function with the opening increment of throttle. A threshold value of engine idle braking is set. When the engine running speed reaches the threshold value, the engine idle braking is stopped. The threshold value is greater than the idling brake set value of engine. Specific exiting modes of brake control of engine is set by following. When the tire burst signal i_{b} arrives, or vehicle enters the collision risk time zone (tₐ) of vehicle, or yaw angle rate deviation e_{ω}_{ᵣ}(t) of vehicle is greater than the set threshold value, or equivalent relative angle speed deviation e(ωₑ) or the angle deceleration e(\dot{ω}ₑ) deviation or slip rate deviation e(Sₑ) of driving axle wheelset reaches the set value or the threshold value is achieved, Namely, one or more of the above conditions is met, the engine idling brake exits. Before starting of the tire burst brake control, the engine brake control can be carried out, to adapt control of abnormal state of the vehicle during the time of overlap and interim between normal and tire burst conditions.

57. According to the safety and stability control method for tire burs vehicle described by right claim 19 term, the features of the system is following. Based on the tire burst vehicle state process, an angle deceleration \dot{δ}_{bi} or/and angle δ_{bi} control mode of steering wheel is adopted in rotation moment control of steering wheel for tire burst. In steering control of vehicle for tire burst, a control mode and model of steering angle δ and rotation angle velocity \dot{δ} are adopted to limit the rotation angle of steering wheel and rotation angle velocity of vehicle, to balance and reduce the impact of tire burst rotation force to steering wheel and vehicle. The steering angle control of steering wheel adopts steering characteristic function Yₖᵢ. The function Yₖᵢ includes the function Y_{kbi} which can determine limited value of rotation angle, angle velocity of steering wheel and the function Yₖₐᵢ which can determine rotation angle of steering wheel.
(1). Steering characteristic function Y_{kbi}. A mathematical model of the steering characteristic function Y_{kbi} is established by modeling parameters which include vehicle speed uᵢₓ, ground comprehensive friction coefficient μₖ, vehicle weight N_{z}, steering angle δ_{bi} of steering wheel and its derivative δ_{bi}:
Y_{kbi}=f(δ_{bi},\dot{δ}_{bi},uₓᵢ,μₖ) or Y_{kbi}=f(δ_{bi},\dot{δ}_{bi},uₓᵢμₖ,N_{z},)
Among them, the μₖ is a standard value set or a real-time evaluation value, the μₖ is determined by the average or weighted average algorithm of friction coefficient of directive wheels. The value determined by Y_{kbi} is target control value or ideal value of rotation angle velocity of steering wheel. The value of Y_{kbi} is determined by the above mathematical model or/and field test. The model structure of Y_{kbi} is as follows: Y_{kbi} is incremental function of increasing of friction coefficient μₖ, and Y_{kbi} is incremental function of decreasing of speed uₓᵢ, and Y_{kbi} is incremental function of increasing of angle δ_{bi}. Based on series value uₓᵢ[uₓₙ . . . uₓ₃ [symbol] uₓ₂ [symbol] uₓ₄] of decreasing of vehicle speed uᵢₓ, the set Y_{kbi}[Y_{kbn} . . . Y_{kb3} [symbol] Y_{kb2} [symbol] Y_{kb1}] of target control values are determined by mathematical model with parameters rotation angle δ_{bi} of steering wheel and rotation angle velocity δ_{bi} at certain speed uₓᵢ. The values in the set Y_{kbi} are limit values or optimal values which can be reached by δ_{bi} and δ_{bi} of steering wheel under condition of which speed uₓᵢ, ground friction coefficient μₖ and vehicle weight N_{z} are certain values. The e_{ybi}(t) between series absolute value of the target control value Y_{kbi} of rotation angle velocity \dot{δ}_{ybi} for steering wheel and the series actual value of steering wheel rotation angle velocity \dot{δ}_{ybi}j of vehicle is defined under certain states of parameters uₓᵢ, μₖ, N_{z} and δ_{bi}. Under condition of certain vehicle speed uᵢₓ, and when e_{ybi}(t) is positive (+), it is indicated that rotation angle velocity \dot{δ}_{ybi} of steering wheel is in normal or normal working state. Under condition of which the vehicle speed uᵢₓ is certain value, and when the deviation e_{ybi}(t) is less than 0, the rotation angle speeded \dot{δ}_{ybi} of steering wheel is determined as tire burst control status. A mathematical model of steering assistant moment Mₐ₂ of steering wheel is established by modeling parameter of deviation e_{ybi}(t) of controller:
Mₐ₂=f(e_{ybi}(t))
In the logical cycle of control period Hₙ of rotation moment for steering wheel, the value of steering assistant moment Mₐ₂ of steering system is determined by mathematical model. Based on the positive (+) and negative (−) of deviation e_{ybi}(t), the steering assist moment or resistance moment to steering wheel is provided by steering assistant device, according to the direction of which absolutes value of rotation angle velocity for steering wheel is decreased. The rotation angle velocity of steering wheel is adjusted to make the deviation e_{ybi}(t) to 0. The rotation angle velocity deviation e_{ybi}(t) of steering wheel keeps tracking to its target control value, to limit the impact of tire burst rotary force to steering wheel.
(2). Steering characteristic function Yₖₐᵢ. A mathematical model of steering characteristic function Yₖₐᵢ is established by modeling parameters including vehicle speed uᵢₓ, ground comprehensive friction coefficient μₖ, vehicle weight N_{z}, steering wheel angle δₐᵢ and its derivative \dot{δ}ₐᵢ:
Yₖₐᵢ=f(δₐᵢ,uₓᵢ,μₖ) or Yₖₐᵢ=f(δₐᵢ,uₓᵢ,μₖ′N_{z})
Among them, the value of μₖ is set as standard value or real-time evaluation value. The value of μₖ is determined by average or weighted average algorithm of friction coefficient of steering wheels. The value of Yₖₐᵢ is target control value or ideal value of steering wheel angle. The value of Yₖₐᵢ is determined by the above mathematical model or/and field test. The modeling structure of Yₖₐᵢ is as follows: the Yₖₐᵢ is an incremental function of increasing of μₖ, the Yₖₐᵢ is an incremental function of decreasing of uᵢₓ, and the Yₖₐᵢ is an incremental function of increasing of steering angle δₐᵢ steering wheel. According to series value uₓᵢ[uₓₙ . . . uₓ₃ [symbol] uₓ₂ [symbol] uₓ₁] of decreasing of vehicle speed uₓᵢ, the set Yₖₐᵢ [Yₖₐₙ . . . Yₖₐ₃ [symbol] Yₖₐ₂ [symbol] Fₖₐ₁] of target control values of corresponding steering angle δₐᵢ of steering wheel are determined by mathematical model at each speed. The values in the Yₖₐᵢ set are a limit value or a optimal values of the steering angle of steering wheel at a certain speed uᵢₓ, ground comprehensive friction coefficient μₖ and vehicle weight N_{z}. The deviation e_{yai}(t) between the target control value Yₖₐᵢ of rotation angle of steering wheel and the actual value of rotation angle S_{yai} of steering wheel is defined under certain states of parameters uᵢₓ, μₖ and N_{z}. When deviation e_{yai}(t) is positive (+), it is indicated that rotation angle δ_{yai} of steering wheel at this time is within limit value of S_{yai}, and is indicated rotation angle of steering wheel δ_{yai} is within the normal range. When deviation e_{yai}(t) is negative (−), it is indicated that rotation angle δ_{yai} of steering wheel is beyond limited range which is determined by rotation angle control of steering wheel for tire burst. A mathematical model of steering assistant or resistance moment Mₐ₁ is established by modeling parameter of deviation e_{yai}(t). In logical cycle of control period Hₙ of rotary moment for steering wheel, the direction of which decrease of absolutes value of rotation angle δ for steering wheel is determined according to positive (+) and negative (−) of deviation e_{yai}(t), and steering assistant or resistance moment Mₐ₁ is determined by mathematical model. Based on steering assistant or resistance moment Mₐ₁, a rotation moment to steering system is provided by steering assist motor, to limit the increase of steering wheel angle δ. The target control value Yₖₐᵢ of rotation steering of steering wheel is tracked by its actual angle δ, until e_{yai}(t) is 0. The rotation angle δ of steering wheel under the condition of tire burst is limited in region of ideal or maximum value of steering slip angle of vehicle. The control may be not complete direction judgment of related parameters for tire burst.

58. According to the safety and stability control method for tire burs vehicle described by right claim 20 term, the features of the method is following. A control mode of power-assisted steering is adopted in rotation moment control of steering wheel for tire burst.
Assistance steering control for tire burst. The direction judgement of tire burst for the control uses two mode of torque angle or torque. On the basis of direction determination mode for tire burst, it is determined that direction of steering angle δ and torque M_{c} of steering wheel, or steering angle δ and torque M_{c} of directive wheel, and rotation moment Mₖ of directive wheel exerted by ground, rotation moment M_{b}′ for tire burst and steering assistance moment Mₐ. Among them, Mₖ includes the rectifying torque Mⱼ for wheel, tire burst rotation moment M_{b}′ and resistance moment of directive wheel exerted by ground. A control model of power assistance steering and characteristic function of tire burst are determined by control variable including rotation torque M_{c} of steering wheel and parameter variable including vehicle speed uₓ. First. On positive and negative travel of rotation angle δ of steering wheel, a control model of steering assistance moment is established by variable M_{c} and parameter uₓ under normal working condition:
Mₐ₁=f(M_{c},uₓ)
The characteristic function and characteristic curve of steering assist moment Mₐ₁ are determined by the model under normal working condition. The characteristic curve includes three types of straight line, broken line or curve. The modeling structure and characteristics of steering assistant moment Mₐ₁ are as follows. On positive and reverse travel of rotation angle of steering wheel, the characteristic functions and curves are same or different. The so-called “difference” refers to: on the positive and negative travel of rotation angle of steering wheel, the characteristic function adopted by control model of the Mₐ₁ is different, and value of the Mₐ₁ is different in same value or point of variable and parameter, otherwise it is same. The steering assistant moment Mₐ₁ is decreasing function of increment of vehicle speed uₓ; the Mₐ₁ is incremental function of absolute value of increment of rotation torque M_{c} of steering wheel. Based on calculated values of each parameters, a numerical chart which is stored in the electronic control unit is drawn. Under normal and tire burst conditions, the electronic control unit by means of looking-up table call power assistance steering control procedure and extracts the target control value of steering assistant moment Mₐ₁ of steering wheel, based on parameters of rotation torque M_{c} of steering wheel, vehicle speed uₓ and rotation angle δ of steering wheel. After the direction of tire burst rotation force M_{b}′ is determined, a mechanical equation of steering assistance control for tire burst are adopted to determine the target control value of tire burst rotation force M_{b}′. In steering assistant control for tire burst, the rotating moment M_{b}′ of tire burst is balanced by an additional assistant moment Mₐ₂, namely, the Mₐ₂ equals the M_{b}:
Mₐ₂=−M_{b}′=M_{b}
Under the condition of tire burst, the target control value of steering assistant moment Mₐ is vector sum of detection value Mₐ₁ of torque sensor of steering wheel and additional balanced steering assistant moment Mₐ₂ for tire burst. In rotary moment control of steering wheel, the phase advance compensation of steering assistant moment Mₐ is carried out by compensation model to improve response speed of power steering system EPS. When necessary, the steering assistance control and rotation angle control of steering wheel for the tire burst are constituted as a composite control. The stable steering control of tire burst vehicle can be realized effectively by limiting maximum angle or/and rotation angle velocity of steering wheel. According to the relationship model between steering assistant torque Mₐ and electrical control parameters of electrical power steering system, the steering assistance torque Mₐ is converted into control parameters of power device, in which it includes current iₘₐ or/and voltage Vₘₐ. The steering assistance control sets limiting value a_{b} of balance rotary moment |M_{b}| for tire burst. In control, |M_{b}| is less than a_{b} which is larger than the maximum value of the rotary moment of tire burst |M_{b}′|. The maximum value of |M_{b}′| is determined by field tests. A phase compensation model of assistance steering is established by tire burst steering assistance controller. The advance compensation of phase of the steering assistance moment Mₐ is carried out by the compensation model in the control, to improve the response speed of rotary force control of steering wheel.

59. According to the safety and stability control method for tire burs vehicle described by right claim 21 term, the features of the method is following. A rotary moment control mode of steering wheel for tire burst is adopted.
(1). Determining of tire burst direction. The determination of tire burst direction uses one of modes of angle and torque, angle, to realize judgement of direction of steering assistant moment Mₐ and operation direction of electric device directly. Direction determination model is described by following. Defining deviation ΔM_{c} between target control value of steering torque M_{c1} of steering wheel and the real-time value M_{c2} detected by torque sensor of steering wheel:
ΔM_{c}=M_{c1}−M_{c2}
The parameters direction of steering assistant moment Mₐ and the direction of steering power parameters of electric device are determined by the positive and negative deviation of ΔM_{c} (+, −). The direction of steering power parameters include the direction of the current iₘ of the motor or the rotating of the assistant motor. When increment ΔM_{c} of rotation torque M_{c} of steering wheel is positive, the direction of steering assistant moment Mₐ is the direction of increasing of assistant moment M_{c}; when ΔM_{c} is negative (−), the direction of steering assist moment Mₐ is the direction of decreasing of steering assistant moment Mₐ, that is, the direction of increasing of resistance moment Mₐ.
(2). Rotation torque control of steering wheel. A control mode, control model of rotation torque M_{c} of steering wheel and characteristic function are established by control variable rotation angle δ of steering wheel, parameter speed uₓ and rotation angle velocity \dot{δ} of steering wheel under normal working conditions:
M_{c}=f(δ,uₓ) or M_{c}=f(δ,\dot{δ},uₓ)
The model determines characteristic function and characteristic curve of rotation torque of steering wheel under normal working conditions. The characteristic curve includes three types: straight line, broken line or curve. The value determined by the control model of rotation torque M_{c} of steering wheel and characteristic function are target control value of steering wheel rotation torque of vehicle. The model structure and characteristics of the M_{c} are as follows. On the positive or negative travel of rotation angle of steering wheel, the characteristic function and curve are same or different, the so-called “difference” means: in the positive and reverse travel of rotation angle of steering wheel, the characteristic function for M_{c} is different, and the value of M_{c} is different at same point of variable and parameter, otherwise it is same. The steering wheel rotation torque M_{c} determined by control model of steering assistant moment is decreasing function of increment of the parameter uₓ, and is incremental function of the absolute value of increment of δ and \dot{δ}. Based on calculated values of each parameter, a numerical chart which is stored in the electronic control unit is drawn. Under normal and tire burst conditions, through look-up table system, control procedure of power assistant steering is called by electronic control unit, and target control value of steering assistant moment M_{c1} of steering wheel is extracted from the electronic unit, based on parameters of steering wheel angle δ, rotation angle velocity \dot{δ} of steering wheel and vehicle speed uₓ. The actual value of rotation torque M_{c2} of steering wheel is determined by the real-time detection value of torque sensor. Defining the deviation ΔM_{c} of rotation torque M_{c} of steering wheel between the target control value of steering wheel torque M_{c1} and the real-time detection value M_{c2} of torque sensor of steering wheel:
ΔM_{c}=M_{c1}−M_{c2}
The steering assistance or resistance moment Mₐ of steering wheel is determined by the function model of deviation ΔM_{c} under normal and tire burst conditions.
Mₐ=f(ΔM_{c})
Based on the steering characteristic function, the rotation torque control of steering wheel uses variety of modes. Mode 1. Basic rectifying torque type. Base on the mode, a function model of rotation torque M_{c} for steering wheel are set up by modeling parameters of vehicle speed uₓ and steering wheel angle δ:
M_{c}=f(δ,uₓ)
The target control value of M_{c1} is determined by specific function forms which include broken line and curve. At any point of rotation angle of steering wheel, the derivative of M_{c1} basically is the same as the derivative of aligning torque Mⱼ. Under action of the Mⱼ, driver of vehicle can obtain the best or better road sense from steering wheel. In function model of rotation torque M_{c1} of steering wheel, the M_{c1} and the Mⱼ are incremental function of the increase of steering wheel angle δ at certain speed uₓ, and M_{c1} is irrelevant to the steering wheel angle velocity \dot{δ}. The real-time detection value M_{c2} of torque sensor of steering wheel or/and road sense which is transmitted by steering wheel changes with the changing of the steering wheel angle velocity \dot{δ}. Mode 2: Balanced aligning torque model, function model of rotation torque M_{c} of steering wheel is established by modeling parameters of vehicle speed uₓ, rotation angle δ of steering wheel and rotating angle velocity \dot{δ}:
M_{c}=f(δ,\dot{δ},uₓ)
In the model of M_{c}, target control value M_{c1} of M_{c} is determined by concrete function form of the model. At any point of rotation angle of steering wheel, the derivative of M_{c1} basically is same as that of aligning torque My. The derivative of M_{c1} basically is same as the derivative of the aligning torque Mⱼ of directive wheel. In torque function model of the M_{c}, the M_{c1} increases with the increase of δ under condition of a certain speed uₓ. Meanwhile, the target control value M_{c1} of torque M_{c} of steering wheel and the real-time detection value M_{c2} determined by steering wheel torque sensor are correlated synchronously with angle velocity \dot{δ} of steering wheel. In each logic cycle of steering torque control period Hₙ of steering wheel, the M_{c1} and M_{c2} increase or decrease synchronously with the increasing or decreasing of δ on appropriate proportions in the positive and reverse travel of steering wheel angle δ. Based on the definition of rotation torque of steering wheel, the ΔM_{c} of rotation torque M_{c} of steering wheel is a difference value between M_{c1} and M_{c2}:
ΔM_{c}=M_{c1}−M_{c2}
A functional model of steering assistant moment Mₐ is established:
Mₐ=f(ΔM_{c})
Based on the functional model of Mₐ, the value of Mₐ is determined by model of difference ΔM_{c}. Under the action of steering assistance or resistance torque Mₐ, the driver can obtain the best feel or road feel from steering wheel of steering system, no matter what steering system is in normal or tire burst working condition. Adjustment force of steering assistance for steering wheel torque is enlarged. According to relationship model between rotation torque of steering wheel and power parameters, the ΔM_{c} is converted into power parameters of electric devices, in which the parameters M_{c}, current i_{cm} and voltage V_{mc} are vectors.

60. According to the safety and stability control method for tire burs vehicle described by right claim 24 or 28 term, the features of the system is following. Failure control of active steering of drive-by-wire for tire burst and no tire burst vehicle. The controller adopts the overall failure control mode. When steering of vehicle driver by man or driverless vehicles fails or lose efficacy, the controller of drive-by-wire steering set by central master controller processes to relevant datum according to a mode, model and algorithm of steering losing efficacy control. The controller outputs signals of unbalanced differential braking of wheels and controls hydraulic braking system (HBS) or the electronic hydraulic braking system (EHS), or the electronic mechanical braking system (EMS), to realize steering failure control by exerting an additional yaw moment to vehicle of drive-by-wire steering, which is produced by differential braking of wheels. The losing efficacy control is based on vehicle dynamics control system (VDC) or electronic stability program system (ESP), control modes of wheel steady-state braking A control, balance braking B control, vehicle steady-state braking C control and total braking force D control. When steering failure control signal i_{z} arrives, the controller take speed uₓ, ideal and actual yaw angle speed deviation e_{ω}_{ᵣ}(t) of vehicle, sideslip angle deviation e_{β}(t) for vehicle quality center, or/and deviation e_{θlr}(t) between ideal steering angle θₗᵣ of vehicle and the actual steering angle θₗᵣ′ of vehicle, or/and deviation e_{θT}(t) of steering angle of directive wheel and vehicle as modeling parameters, and adopts logical combination of brake A [symbol] B [symbol] C control, which includes A⊂B∪C [symbol] or/and A⊂C [symbol] or/and C⊂A. According to vehicle motion equations which include two freedom or multi degree freedom model of vehicle, the relationship model between rotation angle δₑ of steering wheel or rotation angle θₑ of directive wheel and vehicle yaw angle speed ωᵣ₁ is determined at a certain speed uₓ or/and the ground adhesion coefficient μ. The controller calculates ideal yaw rate ωᵣ₁ and sideslip angle of vehicle. The actual yaw angle rate ωᵣ₂ of vehicle is measured by yaw angle rate sensor in real time. The deviation e_{ω}_{ᵣ}(t) between ideal and actual yaw angle speed and the deviation e_{β}(t) between ideal and actual centroid sideslip angle are defined. A mathematical model of optimal steering additional yaw moment Mᵤ determined by differential braking force of wheels is established with modeling parameters of deviation of e_{ω}_{ᵣ}(t) and e_{β}(t). The mathematical model between rotation angle θₑ of directive wheel and yaw moment Mᵤ of drive-by-wire vehicle is established. Based on the mathematical model, the target control value of additional yaw moment Mᵤ of which can make vehicle achieve a certain steering angle θₗᵣ or can make wheel achieve a certain steering angle θₑ is determined by differential braking of wheels. Under normal, tire burst and other working conditions of vehicle, the distribution among wheels of optimal additional yaw moment Mᵤ which is used to vehicle steering can adopt one form of control variables of braking force Qᵢ, angle deceleration speed \dot{ω}ᵢ, negative increment Δωᵢ of angle velocity or slip rate Sᵢ of wheels. The steering failure control is realized by cycle of period H_{y} of logic combination for brake control A⊂B∪C [symbol] or/and A⊂C [symbol] or/and C⊂A. The overall failure control of drive-by-wire steering of vehicle and stable deceleration control of vehicle are realized through the logic cycle of brake period Hₕ.

61. According to the safety and stability control method for tire burs vehicle described by right claim 4 term. Tire burst control of vehicle sets manual control key (RCC).
(1). The control key adopts two control mode of multiple key position of knob key or multiple key position of many times of pressing key in a certain period. Key positions of “standby” U_{g} state of vehicle tire burst control and Key positions of “closing” U_{f} state of vehicle tire burst control are set by knob key or pressing key.
(2). Assigning values to the logic states U_{g} and U_{f} of the two control key positions, the number of electronic signals of knob key or the high level and low level of electronic signals of pressing key can be used as state identification of “standby” U_{g} and “closing” U_{f} state of the two key positions. The master controller or the electronic control unit set by master controller can identify logic state, change of the logic state of the two key position.
(3). When vehicle control system is exerted by electricity, the tire burst controller of the system is reset or cleared to 0. The logic state of “standby” U_{g} and “closing” U_{f} of the control key position of the RCC can be determined by key positions of knob key or pressing key. When the key position that indicates “standby” U_{g} state of tire burst control of vehicle and “closing” U_{f} state on of tire burst control of vehicle changes, the signals i_{g} and i_{f} of are output by controller set the system.
(4). When the tire burst controller of the system is reset or cleared to 0, and if the key position of knob key is in the “closing” U_{f} position, the display lamp set in background of the key position of knob key will be on, until the manual operation of the knob key is implemented, to make it get into the “standby” state U_{g} of key position of tire burst control of vehicle, thus the background display lamp will be off. When the tire burst controller of the system is exerted by power supply, key position of the pressing key can be set on the logic state of “standby” U_{g} of tire burst control of vehicle automatically.
(5). During vehicle running, control key of RCC shall always be placed in the key position of “standby” U_{g} of tire burst control of vehicle. The mutual transfer of the U_{g} state and the U_{f} state of two key positions can be realized by the control signals i_{g} and i_{f} between active control of tire burst of the system and manual key operation control. The control logic of the manual key operation is taken as priority, and it covers the active control logic of the tire burst controller of the system.
